(19) United States
(12) Patent Application Publication
(10) Pub. No.: US 2024/0154154 A1
(43) Pub. Date: May 9, 2024

(54) Si-SUBSTITUTED LITHIUM THIOBORATE MATERIAL WITH HIGH LITHIUM ION CONDUCTIVITY FOR USE AS SOLID-STATE ELECTROLYTE AND ELECTRODE ADDITIVE

(71) Applicant: California Institute of Technology, Pasadena, CA (US)

(72) Inventors: Forrest A.L. LASKOWSKI, Pasadena, CA (US); Daniel B. McHAFFIE, Pasadena, CA (US); Kimberly A. ROBB, Pasadena, CA (US)

(21) Appl. No.: 18/205,179

(22) Filed: Jun. 2, 2023

Related U.S. Application Data
(60) Provisional application No. 63/348,603, filed on Jun. 3, 2022.

(51) Int. Cl. H01M 10/0562

(52) U.S. Cl. CPC H01M 10/0562; H01M 2300/0068

(57) ABSTRACT

Aspects disclosed herein include materials comprising: a lithium thioborate composition characterized by formula FX1: Li_{3-z}[B+Q]₁[S+G]₃ (FX1); wherein Q is a first dopant being a substitute for B in the composition and being one or more elements each aliovalent with respect to B; wherein G is a second dopant being a substitute for S in the composition and being one or more elements each aliovalent with respect to S; wherein z is a number greater than 0 and less than or equal to 0.40, optionally less than or equal to 0.05; and wherein the composition comprises only the first dopant, only the second dopant, or both the first dopant and the second dopant.

### CROSS-REFERENCE TO RELATED APPLICATIONS

This application claims the benefit of priority to U.S. Provisional Patent Application No. 63/348,603, filed Jun. 3, 2022, which is hereby incorporated by reference in its entirety.

### BACKGROUND OF INVENTION

Solid state ion conducting materials have a number of useful applications, including as materials in a Li-ion all-solid-state battery (ASSB). To commercialize Li-ion ASSBs, a suitable Li-ion conducting solid-state electrolyte is required. A solid-state electrolyte should exhibit a wide electrochemical stability window and ionic conductivity near that of traditional liquid electrolytes. Three compounds with near-liquid-electrolyte conductivity (˜10⁻² S cm⁻¹) have been reported: Li₁₀GeP₂S₁₂ (LGPS), Li₆PS₅Br argyrodite, and a Li₇P₃S₁₁ glass ceramic. Unfortunately, all three discovered electrolytes exhibit electrochemical instability against the Li anode, limiting application in commercial products. Some materials are known or are predicted to have a wide electrochemical stability window, sufficient for resisting electron injection from the Li anode, but suffer from prohibitively low ionic conductivity in their pure or intrinsic form. Accordingly, there is a need for ion conducting solid state materials suitable as solid state electrolytes for battery technologies.

### SUMMARY OF THE INVENTION

Aspects disclosed herein include materials comprising: a lithium thioborate composition characterized by formula FX1: Li_{3-z}[B+Q]₁[S+G]₃ (FX1); wherein Q is a first dopant being a substitute for B in the composition and being one or more elements each aliovalent with respect to B; wherein G is a second dopant being a substitute for S in the composition and being one or more elements each aliovalent with respect to S; wherein z is 0 or a number greater than 0 and less than or equal to 0.40, optionally less than or equal to 0.05; and wherein the composition comprises only the first dopant, only the second dopant, or both the first dopant and the second dopant.

Aspects disclosed herein include solid state electrolytes comprising: a lithium solid state electrolyte comprising Li, one or more principal elements, and at least one dopant; wherein the dopant substitutes for a portion of the one of the one or more principal elements of the lithium solid state electrolyte and is aliovalent with the respective substituted principal elements; wherein the ionic conductivity of the lithium solid state electrolyte is greater than or equal to 1·10⁻⁵ S/cm at 25° C.

Aspects disclosed herein include doped lithium solid state electrolytes comprising: a doped inorganic composition having at least one dopant; wherein the doped composition has up to 20 at. % of one or more principal elements substituted with the at least one dopant relative to a reference composition of a reference lithium solid state electrolyte; wherein each dopant is one or more elements each aliovalent with the respective substituted principal element; wherein the presence of the one or more dopants provides for an ionic conductivity greater than or equal to 1·10⁻⁵ S/cm at 25° C.

Aspects disclosed herein include methods for increasing an ionic conductivity of a reference lithium solid state electrolyte, the method comprising: forming a doped lithium solid state electrolyte having a doped composition; wherein the reference lithium solid state electrolyte has a reference composition, and wherein the doped composition has up to 20 at. % of one or more principal elements substituted with at least one dopant relative to the reference composition; wherein each element of the at least one dopant is aliovalent with respect to the respective substituted principal element; and wherein the doped lithium solid state electrolyte has a greater ionic conductivity than the reference lithium solid state electrolyte by a factor of at least 10.

Without wishing to be bound by any particular theory, there may be discussion herein of beliefs or understandings of underlying principles relating to the devices and methods disclosed herein. It is recognized that regardless of the ultimate correctness of any mechanistic explanation or hypothesis, an embodiment of the invention can nonetheless be operative and useful.

### BRIEF DESCRIPTION OF THE DRAWINGS

FIG. 1: Schematic of the semi-supervised machine learning approach. Li-containing structures are aggregated from the ICSD and MP database. Each input structure is simplified and transformed to yield a unique descriptor representation. The descriptor representations are clustered with hierarchical agglomerative clustering. Each cluster is then labeled with experimental σ_{25° C.} data and the intracluster conductivity variance is calculated. Comparison of the composite intracluster conductivity variance (intracluster conductivity variance summed across all clusters) enables identification of descriptors that are well correlated with ionic conductivity.

FIG. 2: The composite intracluster conductivity variance (W_{Q}) for the first 50 clusters generated using each descriptor. Half-violin plots show the raw W_{σ} score for each cluster as symbols next to the violin distribution. Simplification-descriptor combinations are sorted in order of ascending mean. The control is a random assignment of clusters, with W_{σ} values averaged over 100 randomly assigned sets. The smooth overlap of atomic positions (SOAP) descriptor outperforms all other descriptors. Although not shown here, SOAP continues to outperform for all depths of clustering through 300.

FIG. 3: Agglomerative clustering dendrogram for the 2^{nd}-order SOAP descriptor. The hierarchical clustering representation is shown for the first 241 clusters. An arbitrary variance cutoff is placed such that 9 large clusters are produced to facilitate analysis. The violin plots show the σ_{25° C.} distribution for the labels within the 9 large clusters. Three outlier clusters are grouped into two additional clusters and are hereafter ignored. The density (per 241 clusters) of low Eₐ (<0.6 eV) and high conductivity (σ_{25° C.}>10⁻⁵ S cm⁻¹) labels is shown underneath the agglomerative dendrogram. The results illustrate that agglomerative clustering on the 2^{nd}-order SOAP descriptor results in favorable aggregation of most high-conductivity labels.

FIG. 4: W_{σ} vs. cluster number for three different SOAP-CAN models compared with the best-performing models for density-CAN, mXRD-A40, orbital field matrix, and structure heterogeneity-A40. The three SOAP-CAN models are those with the lowest W_{σ} mean for the clustering ranges: 2-100, 101-200, and 201-300. Almost all SOAP-CAN models outperformed the best non-SOAP models, irrespective of the specific combination of rcut, nmax, and Imax hyperparameters.

FIG. 5: The W_{Ea} for the first 50 clusters generated using each descriptor. Half-violin plots show the raw W_{Ea} score for each cluster as symbols next to the violin distribution. Simplification-descriptor combinations are sorted in order of ascending mean. The control is a random assignment of clusters, with W_{Ea} values averaged over 100 randomly assigned sets.

FIG. 6: The best performing 2^{nd} order descriptor: SOAP-CAN mixed with the sine Coulomb descriptor. The clustering performance is shown for the full label set of 219. Since the mXRD—A40 representation is also compatible with the full label set, it is shown for reference. The 2^{nd} order descriptor outperforms the 1^{st} order SOAP-CAN descriptor at most depths of clustering.

FIG. 7: The partial agglomerative dendrogram generated for the 2^{nd}-order SOAP-CAN descriptor-simplification. The area shown is the 2^{nd} mega cluster taken from FIG. 3 of the main text. At a clustering depth of 241, the 21 high-conductivity labels are sorted into 5 clusters which account for 2.2% of the input structures.

FIG. 8: The 2×2×2 supercell of Li₃VS₄ used for the CI-NEB calculation of Li migration energy. Blue atoms represent the Li position from the CI-NEB output images.

FIG. 9: The primitive cell of Na₃Li₃Al₂F₁₂ used for the CI-NEB calculation of Li migration energy. Blue atoms represent the Li position from the CI-NEB output images.

FIG. 10: The 2×2×2 supercell of Li₂Te used for the CI-NEB calculation of Li migration energy. Blue atoms represent the Li position from the CI-NEB output images.

FIG. 11: The 2×2×1 supercell of LiAlTe₂ used for the CI-NEB calculation of Li migration energy. Blue atoms represent the Li position from the CI-NEB output images.

FIG. 12: The 2×2×1 supercell of LiInTe₂ used for the CI-NEB calculation of Li migration energy. Blue atoms represent the Li position from the CI-NEB output images.

FIG. 13: The 2×2×2 supercell of Li₆MnS₄ used for the CI-NEB calculation of Li migration energy. Blue atoms represent the Li position from the CI-NEB output images.

FIG. 14: The 2×2×1 supercell of LiGaTe₂ used for the CI-NEB calculation of Li migration energy. Blue atoms represent the Li position from the CI-NEB output images.

FIG. 15: The 2×1×2 supercell of Li₃BS₃ used for the CI-NEB calculation of Li migration energy. Blue, green, and orange atoms represent the Li position from the CI-NEB output images.

FIG. 16: The 2×2×2 supercell of KLi₆TaO₆ used for the CI-NEB calculation of Li migration energy. Blue and orange atoms represent the Li position from the CI-NEB output images.

FIG. 17: The 2×1×2 supercell of Li₃CuS₂ used for the CI-NEB calculation of Li migration energy. Blue atoms represent the Li position from the CI-NEB output images.

FIG. 18: Nyquist data for a-Li_{2.95}B_{0.95}Si_{0.05}S₃ near room temperature. The partially resolved semi-circular features suggests the presence of at least two RC circuit elements.

FIG. 19: The 31 promising structures that are predicted to be stable and to exhibit Li-hopping activation energy below 600 meV.

FIG. 20A: Explored for use as both an anode³⁴⁰ and a cathode³⁴¹. NEB has been employed to predict an activation energy of 95 meV.³⁴² All Li occupies tetrahedral sites that are edge sharing with adjacent V tetrahedra.

FIG. 20B: The structure appears to be unexplored. Discussion of structural motifs by Geller et al.³⁴³ All Li atoms are in a tetrahedral bonding environment.

FIG. 20C: A screening approach using bond valence site energy calculations identified the oxide as a promising structure: Li₂Te₂O₅.³⁴⁴ All Li are in tetrahedral bonding environment.

FIG. 20D: All Li are in a tetrahedral environment with corner sharing. The structure hasn't been examined as an ionic conductor—ongoing research is focused on optoelectronic properties.³⁴⁵

FIG. 20E: All Li are in a tetrahedral environment with corner sharing. The structure hasn't been examined as an ionic conductor—ongoing research is focused on optoelectronic properties.³⁴⁶

FIG. 20F: All Li are in an edge-sharing tetrahedral bonding environment. Augustine et al. posit that the structure could be a viable cathode material. They performed ab-initio calculations to measure the enthalpy of formation and have concluded that the structure should be stable.³⁴⁷

FIG. 20G: All Li are in a tetrahedral environment with corner sharing. The structure hasn't been examined as an ionic conductor—ongoing research is focused on optoelectronic properties.³⁴⁸ Isaenko et al. report an experimental band gap of 2.41 eV.

FIG. 20H: All Li are in a tetrahedral bonding environment. Recent NEB work suggests an activation barrier of 250 meV.³⁴⁹

FIG. 20I: All Li are in a tetrahedral bonding environment with edge or corner sharing. Recent electrochemical characterization by Suzuki et al. found an ionic conductivity near 10⁻⁵ S cm⁻¹ with aliovalent substitution of Sn.³⁵⁰

FIG. 20J: All Li are in an edge-sharing tetrahedral bonding environment. Explored for use as a cathode by Kawasaki et al. in 2021.³⁵¹ They found an initial charge-discharge capacity of 380 mAh g⁻¹ with average voltage of 2.1 V vs. Li/Li⁺.

FIG. 20K: All Li are in an edge-sharing tetrahedral bonding environment. Never explored for battery purposes. Synthesis by Huang et al.³⁵²

FIG. 20L: All Li sits in four- and five-coordinate environments. Kahle et al. previously screened ˜1400 Li-containing compounds and identified Li₄Re₆S₁₁ as a potentially promising SSE using molecular dynamics simulation.³⁵³ Their simulations failed to resolve RT diffusion but found promising diffusivity at elevated temperatures.

FIG. 20M: All Li are in a tetrahedral bonding environment.

FIG. 20N: All Li are in an octahedral bonding environment. Muy et al. identify Li₃ErBr₆ as one of eighteen promising compounds using a phonon-band descriptor approach.³⁵⁴ They synthesize the Cl analogue and report an experimental conductivity of 0.05-0.3 mS cm⁻¹. The material also mentioned briefly in perspective by Li et al.³⁵⁵

FIG. 20O: All Li are in a tetrahedral bonding environment.

FIG. 20P: All Li are in a tetrahedral bonding environment. Sendek et al. identified Li₂HIO as promising using a combined ML and DFT approach.³⁵⁶ They predicted a RT diffusion barrier of 350 meV.

FIG. 20Q: All Li are in an edge-sharing tetrahedral bonding environment. Synthesis via Huang et al.³⁵²

FIG. 20R: Li ions are in a distorted octahedral and some 5-coordinate bonding environments.

FIG. 20S: All Li are in an octahedral bonding environment. Mentioned briefly in perspective by Li et al.³⁵⁵

FIG. 20T: All Li are in an octahedral bonding environment. Discussed briefly in perspective by Li et al.³⁵⁵ Predicted by Kahle et al. to be a fast ionic conductor using molecular dynamics simulations.³⁵³ They predict an activation energy of 350 meV.

FIG. 20U: All Li are in a tetrahedral bonding environments.

FIG. 20V: All Li are in a three coordinate bonding environment.

FIG. 20W: All Li are in a tetrahedral bonding environment. Optical properties and air-stability have been briefly discussed by Kim et al.³⁵⁷

FIG. 20X: All Li are in an edge-sharing tetrahedral bonding environment. Synthetic accounts appear to exist in some books.

FIG. 20Y: Li are all in an edge-sharing tetrahedral bonding environment. Wang et al. predicted that this might be a high-conductivity structure by using a “structure matching” algorithm.³⁵⁸

FIG. 20Z: All Li are in a 5-coordinate bonding environment. A hydrothermal synthetic method has been described by Li et al.³⁵⁹

FIG. 20AA: All Li are in 3-coordinate or 2-coordinate bonding environments. Identified by Snydacker et al. as a suitable coating for Li anode passivation via convex hull calculations.³⁶⁰

FIG. 20AB: All Li are in octahedral or tetrahedral bonding environments. The tetrahedra sit between the octahedral layers. Amorphous Li₄TiS₄ is thought to form upon discharge of TiS₄-based cathodes.³⁶¹

FIG. 20AC: All Li are in a tetrahedral bonding environment. Wang et al. predicted that LiGaS₂ might be a high-conductivity structure by using a “structure matching” algorithm.³⁵⁸ Separately, He et al. used ab initio calculation to predict the same.³⁶²

FIG. 20AD: All Li are in a corner-sharing tetrahedral bonding environments.

FIG. 20AE: Li are mostly in tetrahedral bonding environments, although some 5-coordinate environments exist. Kahle et al. identified Li₁₀B₁₄Cl₂O₂₅ as a potentially promising SSE material using a “pinball” model.³⁵³

FIG. 21: The 21 promising structures that are predicted to be within 15 meV of Eₕᵤₗₗ and to exhibit Li-hopping activation energy below 600 meV.

FIG. 22A: Li are in 8-coordinate sites surrounded by oxygens.

FIG. 22B: All Li are in tetrahedral bonding environments—corner sharing with Zn and P tetrahedra. Richard's et al. used NEB to predict that Li₁₀Zn₇P₈S₃₂ has a 252 meV activation energy for Li diffusion.³⁶³ They also predict a RT conductivity of 3.44 mS cm⁻¹.

FIG. 22C: All Li are in tetrahedral bonding environments—corner sharing with Zn and P tetrahedra. Richard's et al. used NEB to predict that Li₆Zn₃P₄S₁₆ has a 181 meV activation energy for Li diffusion.³⁶³ They also predict a RT conductivity of 27.7 mS cm⁻¹.

FIG. 22D: All Li are in tetrahedral bonding environments.

FIG. 22E: All Li are in tetrahedral bonding environments.

FIG. 22F: All Li are in tetrahedral bonding environment.

FIG. 22G: Octahedral Li layers with Li tetrahedra interspersed between.

FIG. 22H: All Li are in tetrahedral bonding environments.

FIG. 22I: All Li are in edge-sharing tetrahedral bonding environments. Previously examined as a cathode material by Chen et al.³⁶⁴

FIG. 22J: All Li are in tetrahedral bonding environments.

FIG. 22K: All Li are in tetrahedral bonding environments.

FIG. 22L: All Li are in tetrahedral bonding environments.

FIG. 22M: All Li are in tetrahedral bonding environments. Devlin et al. have previously published a synthetic method for Li₂MnSnS₄.³⁶⁵

FIG. 22N: All Li are in edge-sharing tetrahedral bonding environments.

FIG. 22O: All Li are in edge-sharing octahedral bonding environments. A synthetic method has been published by Steiner et al.³⁶⁶

FIG. 22P: All Li are in tetrahedral bonding environments.

FIG. 22Q: All Li are in corner-sharing tetrahedral bonding environments. Li₁₀Si₃P₃S₂₃Cl was theoretically studied by Rao et al.³⁶⁷ They used it is a model system for a neural-network molecular dynamics pipeline.

FIG. 22R: All Li are in tetrahedral or octahedral bonding environments.

FIG. 22S: All Li are in octahedral bonding environments. Muy et al. examined LiSnCl₃ using a phonon-band descriptor approach.³⁵⁴ Despite a promising band-center value, they suggest it has a low stability window. Körbel et al. identify it as a promising piezoelectric material.³⁶¹

FIG. 22T: All Li are in tetrahedral bonding environments.

FIG. 22U: All Li are in distorted tetrahedral bonding environments.

FIG. 23: The six promising structures that lack Materials Project data but are predicted to exhibit Li-hopping activation energy below 600 meV.

FIG. 24A: All Li are in tetrahedral bonding environments. Synthetic method by Prömper et al.³⁶⁹

FIG. 24B: All Li are in 5-coordinate bonding environments. Previously studied by Abdel-Khalek et al. in a glass ceramic.³⁷⁰ Discussed in some detail by Rousse et al.³⁷¹

FIG. 24C: All Li are in octahedral bonding environments.

FIG. 24D: All Li are in tetrahedral bonding environments. Synthetic method by Branford et al.³⁷²

FIG. 24E: All Li are in tetrahedral bonding environments. A melt flux synthesis has been developed by Li et al—they examined the material for second-harmonic generation response.³⁷³

FIG. 24F: Most Li are in tetrahedral bonding environments, with some partial substitution onto the octahedral Ti sites.

FIG. 25: Steady-state current of Au/a-Li_{2.95}B_{0.95}Si_{0.05}S₃/Au cell for different voltage polarizations. Measurements were done at 25° C. with applied voltages of 0.125 V, 0.25 V, 0.375 V, 0.5 V and 1.0 V.

FIGS. 26A-26G: Characterization of Li₃BS₃ with vacancy engineering. FIG. 26A: XRD patterns for Li₃BS₃, 2.5% Si substituted Li₃BS₃ (Li_{2.975}B_{0.975}Si_{0.025}S₃), 5% Si substituted Li₃BS₃ (Li_{2.95}B_{0.95}Si_{0.05}S₃), and amorphized 5% Si substituted Li₃BS₃ (a-Li_{2.95}B_{0.95}Si_{0.05}S₃). No impurities are observed in any pattern. FIG. 26B: Arrhenius fits for Li₃BS₃. FIG. 26C: Lattice parameter comparison for Li₃BS₃, Li_{2.975}B_{0.975}Si_{0.025}S₃, and Li_{2.95}B_{0.95}B_{0.05}S₃. FIG. 26D: Arrhenius fits for Li_{2.95}B_{0.95}Si_{0.05}S₃, and a-Li_{2.95}B_{0.95}Si_{0.05}S₃. FIG. 26E: Electrochemical impedance spectroscopy for the a-Li_{2.95}B_{0.95}Si_{0.05}S₃ at various temperatures. FIG. 26F: ⁷Li NMR and (FIG. 26G) ¹¹B NMR of the Li₃BS₃, Li_{2.95}B_{0.95}Si_{0.05}S₃, and a-Li_{2.95}B_{0.95}Si_{0.05}S₃. Results show that combined aliovalent substitution and amorphization can improve the ionic conductivity of Li₃BS₃ by over four orders of magnitude.

### STATEMENTS REGARDING CHEMICAL COMPOUNDS AND NOMENCLATURE

In general, the terms and phrases used herein have their art-recognized meaning, which can be found by reference to standard texts, journal references and contexts known to those skilled in the art. The following definitions are provided to clarify their specific use in the context of the invention.

The term “dopant” is used herein broadly to refer to one or more elements intentionally provided in a material's composition to improve or enhance one or more properties or functionalities of the resulting doped material to compared to the undoped reference form of the material, which is typically intrinsic and stoichiometric. A doped composition is optionally referred to as an extrinsic composition, whereas the undoped composition is optionally referred to as the intrinsic or reference composition. As used herein, the term dopant is used broadly to include low concentration impurities or low concentration additive element(s), such that providing said dopant may be referred to as doping and/or alloying as these terms are known in the art. As used herein, a dopant is a substitute for another or principal element, where the dopant replaces or substitutes for a portion of the amount or concentration of the principal element relative to the amount or concentration the principal element in the undoped composition. For clarity and as a convenient handle, each element of a reference undoped composition may be referred to as a “principal element”. Generally, a principal element is an element identified (or which would be identified by one of skill in a relevant art) in a chemical formula of a composition and is exclusive of impurity elements present in the composition at less than 0.05 at. %, less than 0.05 mol. %, and/or less than 0.05 wt. % (optionally less than 0.04 at. %, less than 0.04 mol. %, and/or less than 0.04 wt. %; optionally less than 0.03 at. %, less than 0.03 mol. %, and/or less than 0.03 wt. %; optionally less than 0.02 at. %, less than 0.02 mol. %, and/or less than 0.02 wt. %; optionally less than 0.01 at. %, less than 0.01 mol. %, and/or less than 0.01 wt. %). Therefore, for example: Li, B, and S are principal elements of the composition Li₃BS₃; Li, V, and S are the principal elements of the composition Li₃VS₄; Na, Li, Al, and F are the principal elements of the composition Na₃Li₃Al₂F₁₂; Li and Te are the principal elements of the composition Li₂Te; Li, Al, and Te are the principal elements of the composition LiAlTe₂; Li, In, and Te are the principal elements of the composition LiInTe₂; Li, Mn, and S are the principal elements of the composition Li₆MnS₄; Li, Ga, and Te are the principal elements of the composition LiGaTe₂; K, Li, Ta, and O are the principal elements of the composition KLi₆TaO₆; Li, Cu, and S are the principal elements of the composition Li₃CuS₂; etc. Generally, materials disclosed herein comprise one or more dopants that are substitutes for one or more principal elements (optionally, non-Li principal elements) of a composition (i.e., a principal element other than Li of a composition, such as any of those listed in the prior sentence; e.g., a dopant may be a substitute for B or S in Li₃BS₃, where the B and S are principal elements (optionally, non-Li principal elements) of the composition Li₃BS₃). As used herein, a dopant is optionally one element being substitute for a principal element of a composition (e.g., Si being a dopant for B in Li₃BS₃). As used herein, a dopant is optionally two elements being substitutes for a principal element of a composition (e.g., Si and Ge together being a dopant for B in Li₃BS₃). As used herein, a dopant is optionally three or more elements being substitutes for a principal element of a composition. Herein, the terms “doped” and “substituted” are generally used interchangeably when referring to a material or composition having one or more dopants, as disclosed herein, substituting one or more principal elements, such as one or more principal elements (optionally, non-Li principal elements). A doped composition may have one dopant or more than one dopants. For example, a doped composition may have a first dopant (or, first type of dopant) being a dopant or substitute for a first principal element (optionally, a non-Li principal element) of a composition (e.g., B of Li₃BS₃) and the same doped composition may have a second dopant (or, second type of dopant) being a dopant or substitute for a second principal element (optionally, a non-Li principal element) of a composition (e.g., S of Li₃BS₃). As used herein, a dopant element may be present in the structure of the doped composition substitutionally (as a substitutional dopant element), interstitially (as an interstitial dopant element), or both substitutionally and interstitially. As used herein, a dopant element is preferably aliovalent with respect to the principal element it replaces or for which it is a substitute. For example, a dopant element for B (e.g., in Li₃BS₃) is preferably aliovalent with respect to B, such that said dopant element is a member of an element Group other than Group 13 of the Periodic Table of Elements (e.g., Si, being a member of Group 14). For example, a dopant element for S (e.g., in Li₃BS₃) is preferably aliovalent with respect to S, such that said dopant element is a member of an element Group other than Group 16 of the Periodic Table of Elements (e.g., Cl, being a member of Group 17). In some aspects, the material or composition thereof having the one or more dopants is characterized as a solid solution. In some aspects, the introduction of one or more dopants to a material or composition thereof obeys Vegard's law where the one or more dopants incorporate into the material's lattice or structure as a solid solution.

The term “amorphizing” refers to a process that reduces grain sizes (average, median, and/or bounds of a 95% confidence interval) of a material (or composition thereof), reduces crystallite sizes (average, median, and/or bounds of a 95% confidence interval) of a material (or composition thereof), increasing amorphous content of a material (or composition thereof), decreasing total crystallinity of a material (or composition thereof), and/or increasing an amount or concentration of defects in a material (or composition thereof). A defect generally refers to a crystallographic defect. As recognized by those skilled in the relevant art such as materials science or crystallography in particular, a defect may be a point defect, a line defect, a planar defect, and/or a bulk defect. A vacancy (or, “vacancy defect”), such as a vacancy of a principal element such as B in Li₃BS₃, is an example of a defect. A broken or dangling bond, which is optionally but not necessarily a result of a vacancy defect, is another example of a defect. Generally, but not necessarily, amorphizing refers to a process performed on a material after said material is formed or made. Thus, generally but not necessarily, amorphizing does not refer to the process of doping or making a doped composition (although doping may introduce defects such as interstitial defects), but rather to a separate or subsequent processing step performed on a material that has been formed. An example of an amorphizing process is ball milling, or any similar processes. In some aspects, the term amorphizing refers to a process that necessarily increases amorphous content of a material (or composition thereof) and decreases total crystallinity of the material (or composition thereof), while also optionally reducing grain sizes (average, median, and/or bounds of a 95% confidence interval) of the material (or composition thereof), optionally reducing crystallite sizes (average, median, and/or bounds of a 95% confidence interval) of the material (or composition thereof), and/or optionally increasing an amount or concentration of defects in the material (or composition thereof).

The term “ionic conductivity” is intended to be consistent with the term as it is readily known by one skilled in relevant arts, particularly in the art of semiconductors and/or solid state electrolytes, and refers the property of ionic conductivity as it would relate to the performance of a material or composition thereof as an ionically conductive solid state electrolyte in an electrochemical cell such as a battery. In some aspects, ionic conductivity particularly refers to ionic conductivity of Li⁺ ions in a material or a composition thereof. As used herein, unless explicitly otherwise stated, ionic conductivity of a material (or composition thereof) refers to ionic conductivity within or through the material, such as through a thickness or lateral dimension of the material (e.g., through the thickness of a thin film), instead of a surface ionic conductivity along a film's surface longitudinally. Unless otherwise explicitly stated, the term ionic conductivity refers to a combination of grain boundary transport of ions and bulk ionic conductivity. Preferably, but not necessarily, an ionic conductivity claimed herein is an average ionic conductivity, being an average of at least three repeated measurements. Further to the descriptions in Examples 1A-3 provided herein, useful techniques, assumptions, parameters, calculations, etc., for measuring ionic conductivity in materials disclosed herein is found in P. Vadhva, et al. (“Electrochemical Impedance Spectroscopy for All-Solid-State Batteries: Theory, Methods and Future Outlook”, first published in ChemElectroChem; Volume 8; Issue 11; 2021; Pages 1930-1947; DOI: 10.1002/celc.202100108), which is incorporated herein in its entirety.

The term “electronic conductivity” is intended to be consistent with the term as it is readily known by one skilled in relevant arts, particularly in the art of semiconductors and/or solid state electrolytes, and refers the property of electronic conductivity (conductivity or transport of electrons) as it would relate to the performance of a material or composition thereof as an ionically conductive (and preferably electronically insulating) solid state electrolyte in an electrochemical cell such as a battery. For clarity, electronic conductivity does not refer to nor include ionic conductivity. As used herein, unless explicitly otherwise stated, electronic conductivity of a material (or composition thereof) refers to electronic conductivity within or through the material, such as through a thickness or lateral dimension of the material (e.g., through the thickness of a thin film), instead of a surface electronic conductivity along a film's surface longitudinally. Unless otherwise explicitly stated, the term electronic conductivity may be inclusive of any and all possible mechanisms of electronic transport (i.e., transport/conductivity of electrons; e.g., including Poole-Frenkel emission, hopping conduction, ohmic conduction, space-charge-limited conduction, and/or grain-boundary-limited conduction). Further to the descriptions in Examples 1A-3 provided herein, useful techniques, assumptions, parameters, calculations, etc., for measuring electronic conductivity in materials disclosed herein is found in P. Vadhva, et al. (“Electrochemical Impedance Spectroscopy for All-Solid-State Batteries: Theory, Methods and Future Outlook”, published in ChemElectroChem; Volume 8; Issue 11; 2021; Pages 1930-1947; DOI: 10.1002/celc.202100108), which is incorporated herein in its entirety.

The term “electrochemical cell” refers to devices and/or device components that convert chemical energy into electrical energy or electrical energy into chemical energy. Electrochemical cells have two or more electrodes (e.g., positive and negative electrodes) and one or more electrolytes. For example, an electrolyte may be a fluid electrolyte or a solid electrolyte. In aspects disclosed herein, electrochemical cells comprise at least one solid state electrolyte (optionally but not necessarily also having a fluid electrolyte), the solid state electrolyte comprising a material or composition disclosed herein. The solid state electrolyte is an ionically conductive (e.g., for Li⁺ ions), and preferably electronically insulating to prevent electrical/electronic shorting between oppositely-charged electrodes within the electrochemical cell or battery. Reactions occurring at the electrode, such as sorption and desorption of a chemical species or such as an oxidation or reduction reaction, contribute to charge transfer processes in the electrochemical cell. Electrochemical cells include, but are not limited to, primary (non-rechargeable) batteries and secondary (rechargeable) batteries. In certain aspects, the term electrochemical cell includes metal hydride batteries, metal-air batteries, fuel cells, supercapacitors, capacitors, flow batteries, solid-state batteries, and catalysis or electrocatalytic cells (e.g., those utilizing an alkaline aqueous electrolyte). In some aspects, an electrochemical cell is a Li-ion or Li-ion based battery.

The term “gravimetric capacity”, consistent with the term as used in the art, particularly in the art of battery devices and electrochemistry, refers to amount of charge that can be stored per unit mass. The units are typically mAh/g or C/g. Generally, in the art, gravimetric capacity is normalized by the mass of active material in a cathode or anode, with the balance-of-plant ignored (carbon, binder, etc.) to allow for comparison between active materials. With respect to a battery, the capacity of the battery is normalized to the entire cell which includes all the “inactive” components like carbons, the current collectors, electrolyte, etc. Solid state electrolytes are normally reported as a way to enable Li metal anodes, which have a much higher gravimetric capacity than commercialized graphite anodes. For example, even though solid-state electrolytes are heavier/denser than liquid electrolytes, a solid-state battery could have higher capacity if the solid-state electrolyte is paired with a Li metal anode.

The term “stability”, as used herein in reference to a solid state electrolyte or a material, or composition thereof, that is a candidate solid state electrolyte generally refers to chemical and electrochemical stability (thermodynamic and kinetic) of the electrolyte or material, or composition thereof, with respect to reduction by a Li metal anode at voltages relevant to the operation of a battery having said electrolyte or material. Further to the descriptions in Examples 1A-3 provided herein, useful background, description, techniques, assumptions, parameters, calculations, etc., for determining stability of solid state electrolytes and materials that are candidate solid state electrolytes is found in H. Park, et al. (“Predicting Charge Transfer Stability between Sulfide Solid Electrolytes and Li Metal Anodes”, ACS Energy Lett. 2021, 6, 1, 150-157; DOI: 10.1021/acsenergylett.0c02372), which is incorporated herein in its entirety.

As used herein, total crystallinity refers to the sum of the wt. % of all crystal phases present in the material or a composition thereof. Optionally in any aspect disclosed herein, a material disclosed herein is characterized by a total crystallinity equal to or less than about 25% by weight (wt. %), optionally equal to or less than about 20 wt. %, optionally equal to or less than about 15 wt. %, optionally equal to or less than about 10 wt. %, optionally equal to or less than about 8 wt. %, optionally equal to or less than about 5 wt. %, optionally equal to or less than about 4 wt. %, optionally equal to or less than about 3 wt. %, optionally equal to or less than about 2 wt. %, optionally equal to or less than about 1 wt. %, optionally equal to or less than about 0.8 wt. %, optionally equal to or less than about 0.5 wt. %, optionally equal to or less than about 0.2 wt. %, optionally equal to or less than about 0.1 wt. %, optionally equal to or less than about 0.08 wt. %, optionally equal to or less than about 0.05 wt. %, optionally equal to or less than about 0.01 wt. %. The total crystallinity of a material or composition thereof can be determined through Rietveld quantitative analysis of X-ray diffraction (XRD) data measured from the material or a representative sample thereof. For example, the XRD may be measured using a sheet, film, pellet, powder, or such, of the material, for example. Optionally, XRD data is collected using a powder x-ray diffraction technique with a scan from 5 to 80 degrees, unless otherwise specified. For example, the Rietveld quantitative analysis method may employ a least squares method to model the XRD data and then determine the concentration of crystal phase(s) in the sample based on known lattice(s) and scale factor(s)s for the identified phase(s). However, it is understood that different methods and instrumentation for determining total crystallinity can also be employed.

In an embodiment, a composition or compound of the invention, such as an alloy or precursor to an alloy, is isolated or substantially purified. In an embodiment, an isolated or purified compound is at least partially isolated or substantially purified as would be understood in the art. In an embodiment, a substantially purified composition, compound or formulation of the invention has a chemical purity of 95%, optionally for some applications 99%, optionally for some applications 99.9%, optionally for some applications 99.99%, and optionally for some applications 99.999% pure.

### DETAILED DESCRIPTION OF THE INVENTION

In the following description, numerous specific details of the devices, device components and methods of the present invention are set forth in order to provide a thorough explanation of the precise nature of the invention. It will be apparent, however, to those of skill in the art that the invention can be practiced without these specific details.

The Li-ion all-solid-state battery (ASSB) is a promising template for next-generation energy storage. To commercialize Li-ion ASSBs, a suitable solid-state electrolyte is required. A solid-state electrolyte must exhibit a wide electrochemical stability window and ionic conductivity near that of traditional liquid electrolytes. Three compounds with near-liquid-electrolyte conductivity (˜10⁻² S cm⁻¹) have been discovered: Li₁₀GeP₂S₁₂ (LGPS), Li₆PS₅Br argyrodite, and a Li₇P₃S₁₁ glass ceramic. All three discovered electrolytes exhibit electrochemical instability against the Li anode, limiting application in commercial products. Li₃BS₃ is predicted to have a wide electrochemical stability window, sufficient for resisting electron injection from the Li anode.¹ However, the ionic conductivity of pure or intrinsic Li₃BS₃ is prohibitively low (10⁻⁷-10⁻⁶ S cm⁻¹).

In aspects herein, we present a method to significantly enhance the ionic conductivity of materials such as Li₃BS₃, which are candidates for solid state lithium ion conductivity electrolytes, through incorporation of Si and subsequent amorphization. Also disclosed here are ionically conductive materials, such as doped or substituted Li₃BS₃. For example, by substituting up to 5%, for example, of the B sites with Si, Li₃₋ₓB₁₋ₓSiₓS₃ achieves an ionic conductivity surpassing 10⁻⁵ S cm⁻¹ at room temperature. When the doped product is further amorphized, for example through continuous ball milling, the ionic conductivity is further enhanced to above 10⁻³ S cm⁻¹ at room temperature.

Pure or intrinsic Li₃BS₃ has been studied and characterized in the past. The pure structure exhibits an ionic conductivity in the range of 10⁻⁷-10⁻⁶ S cm⁻¹, which is unfavorably low for the material to be useful as a solid state lithium ion conductor. Ionic conductivity of pure/intrinsic Li₃BS₃ can be enhanced via extended ball milling to near 10⁻⁴ S cm⁻¹, 2 aspects disclosed herein include materials and associated methods demonstrating further significant enhancement in ionic conductivity of materials that are candidates for solid state lithium ion conductors (e.g., for use in a solid state electrolyte), such as Li₃BS₃.

In aspects, substitution of a principal element such as B, S, or both B and S in Li₃BS₃ with an aliovalent dopant element also reduces the amount of Li in the composition relative to the undoped composition. For example, in aspects, the relative amount of Li is reduced according to formula FX2: Li_{3-x-y}B₁₋ₓ[Q]ₓS_{3-y}[G]_{y}, where Q (“first dopant”) is one or more (“first”) dopant elements aliovalent with respect to B, G (“second dopant”) is one or more (“second”) dopant elements each aliovalent with respect to S, x is a number (e.g., selected from range of 0.005 to 0.20) corresponding to the relative amount of substitution of B, and y is a number (e.g., selected from range of 0.005 to 0.20) corresponding to the relative amount of substitution of S. Generally, this reduction in Li occurs to maintain overall charge neutrality of the structure assuming formal oxidation states.

For example, aliovalent substitution of Si into the Li₃BS₃ lattice may introduce vacancies which can act as charge carrying defects. Aliovalent substitution for 5% of the B, for example, results in Li_{2.95}B_{0.95}Si_{0.05}S₃ which exhibits a room temperature ionic conductivity of 1.82·10⁻⁵ S cm⁻¹. In aspects, extended amorphization of the Li_{2.95}B_{0.95}Si_{0.05}S₃ further improves the ionic conductivity to between 1·10⁻³ and 3·10⁻³ S cm⁻¹. Thus, through aliovalent substitution and amorphization, in aspects, the ionic conductivity of Li₃BS₃ is improved to near that of conventional liquid electrolytes.

In aspects, doped materials and compositions thereof disclosed herein, such as amorphous Li_{2.95}B_{0.95}Si_{0.05}S₃ (a-Li_{2.95}B_{0.95}Si_{0.05}S₃), offer many unique advantages over most solid-state electrolyte candidates. The synthesis occurs at a relatively low temperature (˜800° C.) and pelletization can occur at room temperature. In some aspects, unlike most oxide candidates, doped materials and compositions thereof disclosed herein, such as a-Li_{2.95}B_{0.95}Si_{0.05}S₃, exhibit superb inter-grain conductivity without the need for a high-temperature grain-boundary sintering step. The precursor materials are also relatively inexpensive. For example, in comparing to LGPS, the a-Li_{2.95}B_{0.95}Si_{0.05}S₃ swaps Ge (˜$2400/kg) and P (˜$5/kg) for B (˜200/kg) and Si ($1/kg). Additionally, all four constituent elements have a low atomic mass, which is conducive to making ASSBs with high gravimetric capacity.

In some aspects, materials disclosed herein may be useful in a variety of aspects and applications beyond solid-state electrolytes. For example, the doped or substituted materials and compositions thereof disclosed herein, such as Li_{2.95}B_{0.95}Si_{0.05}S₃, may be employed as an artificial interphase on the Li anode surface. In such an application, doped materials and compositions thereof, such as Li_{2.95}B_{0.95}Si_{0.05}S₃, may facilitate ionic conduction while preventing the Li anode from reducing an adjacent SSE.

In some aspects, materials disclosed herein may also be employed as an additive for electrodes. In some aspects, materials disclosed herein may also be employed in glass electrolyte mixtures. In such applications, for example, doped materials and compositions thereof, such as Li_{2.95}B_{0.95}Si_{0.05}S₃, may serve either or both of the following roles: (1) improving electrochemical stability of the electrode/electrolyte and (2) improving ionic conductivity of the electrode/electrolyte.

### REFERENCES CITED ABOVE

1. Park, H., Yu, S. & Siegel, D. J. Predicting Charge Transfer Stability between Sulfide Solid Electrolytes and Li Metal Anodes. ACS Energy Lett. 6, 150-157 (2021).
2. Kimura, T. et al. Characteristics of a Li₃BS₃ Thioborate Glass Electrolyte Obtained via a Mechanochemical Process. ACS Appl. Energy Mater. 5, 1421-1426 (2022).

The substituted or doped compositions disclosed herein generally have a low concentration or a low relative amount of one or more dopants. Preferably, a total dopant concentration (concentration of the one or more dopants in a composition) in a material or composition thereof is less than or equal to 30 at. %, optionally less than or equal to 28 at. %, optionally less than or equal to 25 at. %, optionally less than or equal to 22 at. %, optionally less than or equal to 21 at. %, optionally less than or equal to 20 at. %, optionally less than or equal to 19 at. %, optionally less than or equal to 18 at. %, optionally less than or equal to 17 at. %, optionally less than or equal to 16 at. %, optionally less than or equal to 15 at. %, optionally less than or equal to 14 at. %, optionally less than or equal to 13 at. %, optionally less than or equal to 12 at. %, optionally less than or equal to 11 at. %, optionally less than or equal to 10 at. %, optionally less than or equal to 9 at. %, optionally less than or equal to 8 at. %, optionally less than or equal to 7 at. %, optionally less than or equal to 6 at. %, optionally less than or equal to 5.0 at. %, optionally less than or equal to 4.5 at. %, optionally less than or equal to 4.0 at. %, optionally less than or equal to 3.5 at. %, optionally less than or equal to 3.0 at. %, optionally less than or equal to 2.7 at. %, optionally less than or equal to 2.5 at. %, optionally less than or equal to 2.3 at. %, optionally less than or equal to 2.1 at. %, optionally less than or equal to 2.0 at. %, optionally less than or equal to 1.9 at. %, optionally less than or equal to 1.7 at. %, optionally less than or equal to 1.5 at. %, optionally less than or equal to 1.3 at. %, optionally less than or equal to 1.0 at. %, optionally less than or equal to 0.8 at. %, optionally less than or equal to 0.7 at. %, optionally less than or equal to 0.6 at. %, optionally less than or equal to 0.5 at. %, optionally less than or equal to 0.4 at. %, optionally less than or equal to 0.3 at. %, optionally less than or equal to 0.2 at. %. Preferably, a total dopant concentration (concentration of the one or more dopants in a composition) in a material or composition thereof is greater than or equal to 0.1 at. % (optionally greater than or equal to 0.12%, optionally greater than or equal to 0.14%, optionally greater than or equal to 0.15%, optionally greater than or equal to 0.16%, optionally greater than or equal to 0.17%, optionally greater than or equal to 0.19%, optionally greater than or equal to 0.20%, optionally greater than or equal to 0.21%, optionally greater than or equal to 0.22%, optionally greater than or equal to 0.23%, optionally greater than or equal to 0.25%, optionally greater than or equal to 0.27%, optionally greater than or equal to 0.29%, optionally greater than or equal to 0.30%, optionally greater than or equal to 0.35%, optionally greater than or equal to 0.40%, optionally greater than or equal to 0.45%, optionally greater than or equal to 0.50%, optionally greater than or equal to 0.55%, optionally greater than or equal to 0.65%, optionally greater than or equal to 0.70%, optionally greater than or equal to 0.75%, optionally greater than or equal to 0.80%, optionally greater than or equal to 0.85%, optionally greater than or equal to 0.95%, optionally greater than or equal to 1.0%, optionally greater than or equal to 1.2%, optionally greater than or equal to 1.5%, optionally greater than or equal to 1.7%, optionally greater than or equal to 2.0%, optionally greater than or equal to 2.2%, optionally greater than or equal to 2.5%) and less than or equal to 30 at. % (optionally less than or equal to 28 at. %, optionally less than or equal to 25 at. %, optionally less than or equal to 22 at. %, optionally less than or equal to 21 at. %, optionally less than or equal to 20 at. %, optionally less than or equal to 19 at. %, optionally less than or equal to 18 at. %, optionally less than or equal to 17 at. %, optionally less than or equal to 16 at. %, optionally less than or equal to 15 at. %, optionally less than or equal to 14 at. %, optionally less than or equal to 13 at. %, optionally less than or equal to 12 at. %, optionally less than or equal to 11 at. %, optionally less than or equal to 10 at. %, optionally less than or equal to 9 at. %, optionally less than or equal to 8 at. %, optionally less than or equal to 7 at. %, optionally less than or equal to 6 at. %, optionally less than or equal to 5.0 at. %, optionally less than or equal to 4.5 at. %, optionally less than or equal to 4.0 at. %, optionally less than or equal to 3.5 at. %, optionally less than or equal to 3.0 at. %, optionally less than or equal to 2.7 at. %, optionally less than or equal to 2.5 at. %, optionally less than or equal to 2.3 at. %, optionally less than or equal to 2.1 at. %, optionally less than or equal to 2.0 at. %, optionally less than or equal to 1.9 at. %, optionally less than or equal to 1.7 at. %, optionally less than or equal to 1.5 at. %, optionally less than or equal to 1.3 at. %, optionally less than or equal to 1.0 at. %, optionally less than or equal to 0.8 at. %, optionally less than or equal to 0.7 at. %, optionally less than or equal to 0.6 at. %, optionally less than or equal to 0.5 at. %, optionally less than or equal to 0.4 at. %, optionally less than or equal to 0.3 at. %, optionally less than or equal to 0.2 at. %). Any value and range of total dopant concentration (concentration of the one or more dopants in a composition) between 0.1 at. % and 30 at. % is explicitly contemplated and disclosed herein. For example, optionally a total dopant concentration (concentration of the one or more dopants in a composition) in a material or composition thereof is selected from the range of 0.1 at. % to 20 at. %, optionally selected from the range of 0.1 at. % to 15 at. %, optionally selected from the range of 0.1 at. % to 10 at. %, optionally selected from the range of 0.1 at. % to 5 at. %, optionally selected from the range of 0.1 at. % to 4.0 at. %, optionally selected from the range of 0.1 at. % to 3.0 at. %, optionally selected from the range of 0.1 at. % to 2.5 at. %, optionally selected from the range of 0.1 at. % to 2.0 at. %, optionally selected from the range of 0.1 at. % to 1.5 at. %, optionally selected from the range of 0.1 at. % to 1.0 at. %, optionally selected from the range of 0.1 at. % to 0.95 at. %.

Preferably for some aspects or applications, a total dopant concentration (concentration of the one or more dopants in a composition) in a material or composition thereof is less than or equal to 30 mol. %, optionally less than or equal to 28 mol. %, optionally less than or equal to 25 mol. %, optionally less than or equal to 22 mol. %, optionally less than or equal to 21 mol. %, optionally less than or equal to 20 mol. %, optionally less than or equal to 19 mol. %, optionally less than or equal to 18 mol. %, optionally less than or equal to 17 mol. %, optionally less than or equal to 16 mol. %, optionally less than or equal to 15 mol. %, optionally less than or equal to 14 mol. %, optionally less than or equal to 13 mol. %, optionally less than or equal to 12 mol. %, optionally less than or equal to 11 mol. %, optionally less than or equal to 10 mol. %, optionally less than or equal to 9 mol. %, optionally less than or equal to 8 mol. %, optionally less than or equal to 7 mol. %, optionally less than or equal to 6 mol. %, optionally less than or equal to 5.0 mol. %, optionally less than or equal to 4.5 mol. %, optionally less than or equal to 4.0 mol. %, optionally less than or equal to 3.5 mol. %, optionally less than or equal to 3.0 mol. %, optionally less than or equal to 2.7 mol. %, optionally less than or equal to 2.5 mol. %, optionally less than or equal to 2.3 mol. %, optionally less than or equal to 2.1 mol. %, optionally less than or equal to 2.0 mol. %, optionally less than or equal to 1.9 mol. %, optionally less than or equal to 1.7 mol. %, optionally less than or equal to 1.5 mol. %, optionally less than or equal to 1.3 mol. %, optionally less than or equal to 1.0 mol. %, optionally less than or equal to 0.8 mol. %, optionally less than or equal to 0.7 mol. %, optionally less than or equal to 0.6 mol. %, optionally less than or equal to 0.5 mol. %, optionally less than or equal to 0.4 mol. %, optionally less than or equal to 0.3 mol. %, optionally less than or equal to 0.2 mol. %. Preferably, a total dopant concentration (concentration of the one or more dopants in a composition) in a material or composition thereof is greater than or equal to 0.1 mol. % (optionally greater than or equal to 0.12%, optionally greater than or equal to 0.14%, optionally greater than or equal to 0.15%, optionally greater than or equal to 0.16%, optionally greater than or equal to 0.17%, optionally greater than or equal to 0.19%, optionally greater than or equal to 0.20%, optionally greater than or equal to 0.21%, optionally greater than or equal to 0.22%, optionally greater than or equal to 0.23%, optionally greater than or equal to 0.25%, optionally greater than or equal to 0.27%, optionally greater than or equal to 0.29%, optionally greater than or equal to 0.30%, optionally greater than or equal to 0.35%, optionally greater than or equal to 0.40%, optionally greater than or equal to 0.45%, optionally greater than or equal to 0.50%, optionally greater than or equal to 0.55%, optionally greater than or equal to 0.65%, optionally greater than or equal to 0.70%, optionally greater than or equal to 0.75%, optionally greater than or equal to 0.80%, optionally greater than or equal to 0.85%, optionally greater than or equal to 0.95%, optionally greater than or equal to 1.0%, optionally greater than or equal to 1.2%, optionally greater than or equal to 1.5%, optionally greater than or equal to 1.7%, optionally greater than or equal to 2.0%, optionally greater than or equal to 2.2%, optionally greater than or equal to 2.5%) and less than or equal to 30 mol. % (optionally less than or equal to 28 mol. %, optionally less than or equal to 25 mol. %, optionally less than or equal to 22 mol. %, optionally less than or equal to 21 mol. %, optionally less than or equal to 20 mol. %, optionally less than or equal to 19 mol. %, optionally less than or equal to 18 mol. %, optionally less than or equal to 17 mol. %, optionally less than or equal to 16 mol. %, optionally less than or equal to 15 mol. %, optionally less than or equal to 14 mol. %, optionally less than or equal to 13 mol. %, optionally less than or equal to 12 mol. %, optionally less than or equal to 11 mol. %, optionally less than or equal to 10 mol. %, optionally less than or equal to 9 mol. %, optionally less than or equal to 8 mol. %, optionally less than or equal to 7 mol. %, optionally less than or equal to 6 mol. %, optionally less than or equal to 5.0 mol. %, optionally less than or equal to 4.5 mol. %, optionally less than or equal to 4.0 mol. %, optionally less than or equal to 3.5 mol. %, optionally less than or equal to 3.0 mol. %, optionally less than or equal to 2.7 mol. %, optionally less than or equal to 2.5 mol. %, optionally less than or equal to 2.3 mol. %, optionally less than or equal to 2.1 mol. %, optionally less than or equal to 2.0 mol. %, optionally less than or equal to 1.9 mol. %, optionally less than or equal to 1.7 mol. %, optionally less than or equal to 1.5 mol. %, optionally less than or equal to 1.3 mol. %, optionally less than or equal to 1.0 mol. %, optionally less than or equal to 0.8 mol. %, optionally less than or equal to 0.7 mol. %, optionally less than or equal to 0.6 mol. %, optionally less than or equal to 0.5 mol. %, optionally less than or equal to 0.4 mol. %, optionally less than or equal to 0.3 mol. %, optionally less than or equal to 0.2 mol. %). Any value and range of total dopant concentration (concentration of the one or more dopants in a composition) between 0.1 mol. % and 30 mol. % is explicitly contemplated and disclosed herein. For example, optionally a total dopant concentration (concentration of the one or more dopants in a composition) in a material or composition thereof is selected from the range of 0.1 mol. % to 20 mol. %, optionally selected from the range of 0.1 mol. % to 15 mol. %, optionally selected from the range of 0.1 mol. % to 10 mol. %, optionally selected from the range of 0.1 mol. % to 5 mol. %, optionally selected from the range of 0.1 mol. % to 4.0 mol. %, optionally selected from the range of 0.1 mol. % to 3.0 mol. %, optionally selected from the range of 0.1 mol. % to 2.5 mol. %, optionally selected from the range of 0.1 mol. % to 2.0 mol. %, optionally selected from the range of 0.1 mol. % to 1.5 mol. %, optionally selected from the range of 0.1 mol. % to 1.0 mol. %, optionally selected from the range of 0.1 mol. % to 0.95 mol. %.

Preferably for some aspects or applications, a total dopant concentration (concentration of the one or more dopants in a composition) in a material or composition thereof is less than or equal to 30 wt. %, optionally less than or equal to 28 wt. %, optionally less than or equal to 25 wt. %, optionally less than or equal to 22 wt. %, optionally less than or equal to 21 wt. %, optionally less than or equal to 20 wt. %, optionally less than or equal to 19 wt. %, optionally less than or equal to 18 wt. %, optionally less than or equal to 17 wt. %, optionally less than or equal to 16 wt. %, optionally less than or equal to 15 wt. %, optionally less than or equal to 14 wt. %, optionally less than or equal to 13 wt. %, optionally less than or equal to 12 wt. %, optionally less than or equal to 11 wt. %, optionally less than or equal to 10 wt. %, optionally less than or equal to 9 wt. %, optionally less than or equal to 8 wt. %, optionally less than or equal to 7 wt. %, optionally less than or equal to 6 wt. %, optionally less than or equal to 5.0 wt. %, optionally less than or equal to 4.5 wt. %, optionally less than or equal to 4.0 wt. %, optionally less than or equal to 3.5 wt. %, optionally less than or equal to 3.0 wt. %, optionally less than or equal to 2.7 wt. %, optionally less than or equal to 2.5 wt. %, optionally less than or equal to 2.3 wt. %, optionally less than or equal to 2.1 wt. %, optionally less than or equal to 2.0 wt. %, optionally less than or equal to 1.9 wt. %, optionally less than or equal to 1.7 wt. %, optionally less than or equal to 1.5 wt. %, optionally less than or equal to 1.3 wt. %, optionally less than or equal to 1.0 wt. %, optionally less than or equal to 0.8 wt. %, optionally less than or equal to 0.7 wt. %, optionally less than or equal to 0.6 wt. %, optionally less than or equal to 0.5 wt. %, optionally less than or equal to 0.4 wt. %, optionally less than or equal to 0.3 wt. %, optionally less than or equal to 0.2 wt. %. Preferably, a total dopant concentration (concentration of the one or more dopants in a composition) in a material or composition thereof is greater than or equal to 0.1 wt. % (optionally greater than or equal to 0.12%, optionally greater than or equal to 0.14%, optionally greater than or equal to 0.15%, optionally greater than or equal to 0.16%, optionally greater than or equal to 0.17%, optionally greater than or equal to 0.19%, optionally greater than or equal to 0.20%, optionally greater than or equal to 0.21%, optionally greater than or equal to 0.22%, optionally greater than or equal to 0.23%, optionally greater than or equal to 0.25%, optionally greater than or equal to 0.27%, optionally greater than or equal to 0.29%, optionally greater than or equal to 0.30%, optionally greater than or equal to 0.35%, optionally greater than or equal to 0.40%, optionally greater than or equal to 0.45%, optionally greater than or equal to 0.50%, optionally greater than or equal to 0.55%, optionally greater than or equal to 0.65%, optionally greater than or equal to 0.70%, optionally greater than or equal to 0.75%, optionally greater than or equal to 0.80%, optionally greater than or equal to 0.85%, optionally greater than or equal to 0.95%, optionally greater than or equal to 1.0%, optionally greater than or equal to 1.2%, optionally greater than or equal to 1.5%, optionally greater than or equal to 1.7%, optionally greater than or equal to 2.0%, optionally greater than or equal to 2.2%, optionally greater than or equal to 2.5%) and less than or equal to 30 wt. % (optionally less than or equal to 28 wt. %, optionally less than or equal to 25 wt. %, optionally less than or equal to 22 wt. %, optionally less than or equal to 21 wt. %, optionally less than or equal to 20 wt. %, optionally less than or equal to 19 wt. %, optionally less than or equal to 18 wt. %, optionally less than or equal to 17 wt. %, optionally less than or equal to 16 wt. %, optionally less than or equal to 15 wt. %, optionally less than or equal to 14 wt. %, optionally less than or equal to 13 wt. %, optionally less than or equal to 12 wt. %, optionally less than or equal to 11 wt. %, optionally less than or equal to 10 wt. %, optionally less than or equal to 9 wt. %, optionally less than or equal to 8 wt. %, optionally less than or equal to 7 wt. %, optionally less than or equal to 6 wt. %, optionally less than or equal to 5.0 wt. %, optionally less than or equal to 4.5 wt. %, optionally less than or equal to 4.0 wt. %, optionally less than or equal to 3.5 wt. %, optionally less than or equal to 3.0 wt. %, optionally less than or equal to 2.7 wt. %, optionally less than or equal to 2.5 wt. %, optionally less than or equal to 2.3 wt. %, optionally less than or equal to 2.1 wt. %, optionally less than or equal to 2.0 wt. %, optionally less than or equal to 1.9 wt. %, optionally less than or equal to 1.7 wt. %, optionally less than or equal to 1.5 wt. %, optionally less than or equal to 1.3 wt. %, optionally less than or equal to 1.0 wt. %, optionally less than or equal to 0.8 wt. %, optionally less than or equal to 0.7 wt. %, optionally less than or equal to 0.6 wt. %, optionally less than or equal to 0.5 wt. %, optionally less than or equal to 0.4 wt. %, optionally less than or equal to 0.3 wt. %, optionally less than or equal to 0.2 wt. %). Any value and range of total dopant concentration (concentration of the one or more dopants in a composition) between 0.1 wt. % and 30 wt. % is explicitly contemplated and disclosed herein. For example, optionally a total dopant concentration (concentration of the one or more dopants in a composition) in a material or composition thereof is selected from the range of 0.1 wt. % to 20 wt. %, optionally selected from the range of 0.1 wt. % to 15 wt. %, optionally selected from the range of 0.1 wt. % to 10 wt. %, optionally selected from the range of 0.1 wt. % to 5 wt. %, optionally selected from the range of 0.1 wt. % to 4.0 wt. %, optionally selected from the range of 0.1 wt. % to 3.0 wt. %, optionally selected from the range of 0.1 wt. % to 2.5 wt. %, optionally selected from the range of 0.1 wt. % to 2.0 wt. %, optionally selected from the range of 0.1 wt. % to 1.5 wt. %, optionally selected from the range of 0.1 wt. % to 1.0 wt. %, optionally selected from the range of 0.1 wt. % to 0.95 wt. %.

The substituted or doped compositions disclosed herein generally have only a small amount of a principal element substituted for or replaced with a dopant (the dopant being one or more elements aliovalent with respect to the substituted or replaced principal element). Optionally, the relative amount of any principal element of a composition that is substituted with a dopant is less than or equal to 20 at. %, optionally less than or equal to 19 at. %, optionally less than or equal to 18 at. %, optionally less than or equal to 17 at. %, optionally less than or equal to 16 at. %, optionally less than or equal to 15 at. %, optionally less than or equal to 14 at. %, optionally less than or equal to 13 at. %, optionally less than or equal to 12 at. %, optionally less than or equal to 11 at. %, optionally less than or equal to 10 at. %, optionally less than or equal to 9 at. %, optionally less than or equal to 8 at. %, optionally less than or equal to 7 at. %, optionally less than or equal to 6 at. %, optionally less than or equal to 5.0 at. %, optionally less than or equal to 4.5 at. %, optionally less than or equal to 4.0 at. %, optionally less than or equal to 3.5 at. %, optionally less than or equal to 3.0 at. %, optionally less than or equal to 2.7 at. %, optionally less than or equal to 2.5 at. %, optionally less than or equal to 2.3 at. %, optionally less than or equal to 2.1 at. %, optionally less than or equal to 2.0 at. %, optionally less than or equal to 1.9 at. %, optionally less than or equal to 1.7 at. %, optionally less than or equal to 1.5 at. %, optionally less than or equal to 1.3 at. %, optionally less than or equal to 1.0 at. %, optionally less than or equal to 0.8 at. %, optionally less than or equal to 0.7 at. %, optionally less than or equal to 0.6 at. %, optionally less than or equal to 0.5 at. %, optionally less than or equal to 0.4 at. %, optionally less than or equal to 0.3 at. %, optionally less than or equal to 0.2 at. %. Optionally, the relative amount of any principal element of a composition that is substituted with a dopant is greater than or equal to 0.1 at. % (optionally greater than or equal to 0.12%, optionally greater than or equal to 0.14%, optionally greater than or equal to 0.15%, optionally greater than or equal to 0.16%, optionally greater than or equal to 0.17%, optionally greater than or equal to 0.19%, optionally greater than or equal to 0.20%, optionally greater than or equal to 0.21%, optionally greater than or equal to 0.22%, optionally greater than or equal to 0.23%, optionally greater than or equal to 0.25%, optionally greater than or equal to 0.27%, optionally greater than or equal to 0.29%, optionally greater than or equal to 0.30%, optionally greater than or equal to 0.35%, optionally greater than or equal to 0.40%, optionally greater than or equal to 0.45%, optionally greater than or equal to 0.50%, optionally greater than or equal to 0.55%, optionally greater than or equal to 0.65%, optionally greater than or equal to 0.70%, optionally greater than or equal to 0.75%, optionally greater than or equal to 0.80%, optionally greater than or equal to 0.85%, optionally greater than or equal to 0.95%, optionally greater than or equal to 1.0%, optionally greater than or equal to 1.2%, optionally greater than or equal to 1.5%, optionally greater than or equal to 1.7%, optionally greater than or equal to 2.0%, optionally greater than or equal to 2.2%, optionally greater than or equal to 2.5%) and less than or equal to 20 at. % (optionally less than or equal to 19 at. %, optionally less than or equal to 18 at. %, optionally less than or equal to 17 at. %, optionally less than or equal to 16 at. %, optionally less than or equal to 15 at. %, optionally less than or equal to 14 at. %, optionally less than or equal to 13 at. %, optionally less than or equal to 12 at. %, optionally less than or equal to 11 at. %, optionally less than or equal to 10 at. %, optionally less than or equal to 9 at. %, optionally less than or equal to 8 at. %, optionally less than or equal to 7 at. %, optionally less than or equal to 6 at. %, optionally less than or equal to 5.0 at. %, optionally less than or equal to 4.5 at. %, optionally less than or equal to 4.0 at. %, optionally less than or equal to 3.5 at. %, optionally less than or equal to 3.0 at. %, optionally less than or equal to 2.7 at. %, optionally less than or equal to 2.5 at. %, optionally less than or equal to 2.3 at. %, optionally less than or equal to 2.1 at. %, optionally less than or equal to 2.0 at. %, optionally less than or equal to 1.9 at. %, optionally less than or equal to 1.7 at. %, optionally less than or equal to 1.5 at. %, optionally less than or equal to 1.3 at. %, optionally less than or equal to 1.0 at. %, optionally less than or equal to 0.8 at. %, optionally less than or equal to 0.7 at. %, optionally less than or equal to 0.6 at. %, optionally less than or equal to 0.5 at. %, optionally less than or equal to 0.4 at. %, optionally less than or equal to 0.3 at. %, optionally less than or equal to 0.2 at. %). Any value and range of the relative amount, of any principal element of a composition that is substituted with a dopant, between 0.1 at. % and 20 at. % is explicitly contemplated and disclosed herein. For example, optionally, the relative amount of any principal element of a composition that is substituted with a dopant is selected from the range of 0.1 at. % to 20 at. %, optionally selected from the range of 0.1 at. % to 15 at. %, optionally selected from the range of 0.1 at. % to 10 at. %, optionally selected from the range of 0.1 at. % to 5 at. %, optionally selected from the range of 0.1 at. % to 4.0 at. %, optionally selected from the range of 0.1 at. % to 3.0 at. %, optionally selected from the range of 0.1 at. % to 2.5 at. %, optionally selected from the range of 0.1 at. % to 2.0 at. %, optionally selected from the range of 0.1 at. % to 1.5 at. %, optionally selected from the range of 0.1 at. % to 1.0 at. %, optionally selected from the range of 0.1 at. % to 0.95 at. %.

Optionally, the relative amount of any principal element of a composition that is substituted with a dopant is less than or equal to 20 mol. %, optionally less than or equal to 19 mol. %, optionally less than or equal to 18 mol. %, optionally less than or equal to 17 mol. %, optionally less than or equal to 16 mol. %, optionally less than or equal to 15 mol. %, optionally less than or equal to 14 mol. %, optionally less than or equal to 13 mol. %, optionally less than or equal to 12 mol. %, optionally less than or equal to 11 mol. %, optionally less than or equal to 10 mol. %, optionally less than or equal to 9 mol. %, optionally less than or equal to 8 mol. %, optionally less than or equal to 7 mol. %, optionally less than or equal to 6 mol. %, optionally less than or equal to 5.0 mol. %, optionally less than or equal to 4.5 mol. %, optionally less than or equal to 4.0 mol. %, optionally less than or equal to 3.5 mol. %, optionally less than or equal to 3.0 mol. %, optionally less than or equal to 2.7 mol. %, optionally less than or equal to 2.5 mol. %, optionally less than or equal to 2.3 mol. %, optionally less than or equal to 2.1 mol. %, optionally less than or equal to 2.0 mol. %, optionally less than or equal to 1.9 mol. %, optionally less than or equal to 1.7 mol. %, optionally less than or equal to 1.5 mol. %, optionally less than or equal to 1.3 mol. %, optionally less than or equal to 1.0 mol. %, optionally less than or equal to 0.8 mol. %, optionally less than or equal to 0.7 mol. %, optionally less than or equal to 0.6 mol. %, optionally less than or equal to 0.5 mol. %, optionally less than or equal to 0.4 mol. %, optionally less than or equal to 0.3 mol. %, optionally less than or equal to 0.2 mol. %. Optionally, the relative amount of any principal element of a composition that is substituted with a dopant is greater than or equal to 0.1 mol. % (optionally greater than or equal to 0.12%, optionally greater than or equal to 0.14%, optionally greater than or equal to 0.15%, optionally greater than or equal to 0.16%, optionally greater than or equal to 0.17%, optionally greater than or equal to 0.19%, optionally greater than or equal to 0.20%, optionally greater than or equal to 0.21%, optionally greater than or equal to 0.22%, optionally greater than or equal to 0.23%, optionally greater than or equal to 0.25%, optionally greater than or equal to 0.27%, optionally greater than or equal to 0.29%, optionally greater than or equal to 0.30%, optionally greater than or equal to 0.35%, optionally greater than or equal to 0.40%, optionally greater than or equal to 0.45%, optionally greater than or equal to 0.50%, optionally greater than or equal to 0.55%, optionally greater than or equal to 0.65%, optionally greater than or equal to 0.70%, optionally greater than or equal to 0.75%, optionally greater than or equal to 0.80%, optionally greater than or equal to 0.85%, optionally greater than or equal to 0.95%, optionally greater than or equal to 1.0%, optionally greater than or equal to 1.2%, optionally greater than or equal to 1.5%, optionally greater than or equal to 1.7%, optionally greater than or equal to 2.0%, optionally greater than or equal to 2.2%, optionally greater than or equal to 2.5%) and less than or equal to 20 mol. % (optionally less than or equal to 19 mol. %, optionally less than or equal to 18 mol. %, optionally less than or equal to 17 mol. %, optionally less than or equal to 16 mol. %, optionally less than or equal to 15 mol. %, optionally less than or equal to 14 mol. %, optionally less than or equal to 13 mol. %, optionally less than or equal to 12 mol. %, optionally less than or equal to 11 mol. %, optionally less than or equal to 10 mol. %, optionally less than or equal to 9 mol. %, optionally less than or equal to 8 mol. %, optionally less than or equal to 7 mol. %, optionally less than or equal to 6 mol. %, optionally less than or equal to 5.0 mol. %, optionally less than or equal to 4.5 mol. %, optionally less than or equal to 4.0 mol. %, optionally less than or equal to 3.5 mol. %, optionally less than or equal to 3.0 mol. %, optionally less than or equal to 2.7 mol. %, optionally less than or equal to 2.5 mol. %, optionally less than or equal to 2.3 mol. %, optionally less than or equal to 2.1 mol. %, optionally less than or equal to 2.0 mol. %, optionally less than or equal to 1.9 mol. %, optionally less than or equal to 1.7 mol. %, optionally less than or equal to 1.5 mol. %, optionally less than or equal to 1.3 mol. %, optionally less than or equal to 1.0 mol. %, optionally less than or equal to 0.8 mol. %, optionally less than or equal to 0.7 mol. %, optionally less than or equal to 0.6 mol. %, optionally less than or equal to 0.5 mol. %, optionally less than or equal to 0.4 mol. %, optionally less than or equal to 0.3 mol. %, optionally less than or equal to 0.2 mol. %). Any value and range of the relative amount, of any principal element of a composition that is substituted with a dopant, between 0.1 mol. % and 20 mol. % is explicitly contemplated and disclosed herein. For example, optionally, the relative amount of any principal element of a composition that is substituted with a dopant is selected from the range of 0.1 mol. % to 20 mol. %, optionally selected from the range of 0.1 mol. % to 15 mol. %, optionally selected from the range of 0.1 mol. % to 10 mol. %, optionally selected from the range of 0.1 mol. % to 5 mol. %, optionally selected from the range of 0.1 mol. % to 4.0 mol. %, optionally selected from the range of 0.1 mol. % to 3.0 mol. %, optionally selected from the range of 0.1 mol. % to 2.5 mol. %, optionally selected from the range of 0.1 mol. % to 2.0 mol. %, optionally selected from the range of 0.1 mol. % to 1.5 mol. %, optionally selected from the range of 0.1 mol. % to 1.0 mol. %, optionally selected from the range of 0.1 mol. % to 0.95 mol. %.

Optionally, the relative amount of any principal element of a composition that is substituted with a dopant is less than or equal to 20 wt. %, optionally less than or equal to 19 wt. %, optionally less than or equal to 18 wt. %, optionally less than or equal to 17 wt. %, optionally less than or equal to 16 wt. %, optionally less than or equal to 15 wt. %, optionally less than or equal to 14 wt. %, optionally less than or equal to 13 wt. %, optionally less than or equal to 12 wt. %, optionally less than or equal to 11 wt. %, optionally less than or equal to 10 wt. %, optionally less than or equal to 9 wt. %, optionally less than or equal to 8 wt. %, optionally less than or equal to 7 wt. %, optionally less than or equal to 6 wt. %, optionally less than or equal to 5.0 wt. %, optionally less than or equal to 4.5 wt. %, optionally less than or equal to 4.0 wt. %, optionally less than or equal to 3.5 wt. %, optionally less than or equal to 3.0 wt. %, optionally less than or equal to 2.7 wt. %, optionally less than or equal to 2.5 wt. %, optionally less than or equal to 2.3 wt. %, optionally less than or equal to 2.1 wt. %, optionally less than or equal to 2.0 wt. %, optionally less than or equal to 1.9 wt. %, optionally less than or equal to 1.7 wt. %, optionally less than or equal to 1.5 wt. %, optionally less than or equal to 1.3 wt. %, optionally less than or equal to 1.0 wt. %, optionally less than or equal to 0.8 wt. %, optionally less than or equal to 0.7 wt. %, optionally less than or equal to 0.6 wt. %, optionally less than or equal to 0.5 wt. %, optionally less than or equal to 0.4 wt. %, optionally less than or equal to 0.3 wt. %, optionally less than or equal to 0.2 wt. %. Optionally, the relative amount of any principal element of a composition that is substituted with a dopant is greater than or equal to 0.1 wt. % (optionally greater than or equal to 0.12%, optionally greater than or equal to 0.14%, optionally greater than or equal to 0.15%, optionally greater than or equal to 0.16%, optionally greater than or equal to 0.17%, optionally greater than or equal to 0.19%, optionally greater than or equal to 0.20%, optionally greater than or equal to 0.21%, optionally greater than or equal to 0.22%, optionally greater than or equal to 0.23%, optionally greater than or equal to 0.25%, optionally greater than or equal to 0.27%, optionally greater than or equal to 0.29%, optionally greater than or equal to 0.30%, optionally greater than or equal to 0.35%, optionally greater than or equal to 0.40%, optionally greater than or equal to 0.45%, optionally greater than or equal to 0.50%, optionally greater than or equal to 0.55%, optionally greater than or equal to 0.65%, optionally greater than or equal to 0.70%, optionally greater than or equal to 0.75%, optionally greater than or equal to 0.80%, optionally greater than or equal to 0.85%, optionally greater than or equal to 0.95%, optionally greater than or equal to 1.0%, optionally greater than or equal to 1.2%, optionally greater than or equal to 1.5%, optionally greater than or equal to 1.7%, optionally greater than or equal to 2.0%, optionally greater than or equal to 2.2%, optionally greater than or equal to 2.5%) and less than or equal to 20 wt. % (optionally less than or equal to 19 wt. %, optionally less than or equal to 18 wt. %, optionally less than or equal to 17 wt. %, optionally less than or equal to 16 wt. %, optionally less than or equal to 15 wt. %, optionally less than or equal to 14 wt. %, optionally less than or equal to 13 wt. %, optionally less than or equal to 12 wt. %, optionally less than or equal to 11 wt. %, optionally less than or equal to 10 wt. %, optionally less than or equal to 9 wt. %, optionally less than or equal to 8 wt. %, optionally less than or equal to 7 wt. %, optionally less than or equal to 6 wt. %, optionally less than or equal to 5.0 wt. %, optionally less than or equal to 4.5 wt. %, optionally less than or equal to 4.0 wt. %, optionally less than or equal to 3.5 wt. %, optionally less than or equal to 3.0 wt. %, optionally less than or equal to 2.7 wt. %, optionally less than or equal to 2.5 wt. %, optionally less than or equal to 2.3 wt. %, optionally less than or equal to 2.1 wt. %, optionally less than or equal to 2.0 wt. %, optionally less than or equal to 1.9 wt. %, optionally less than or equal to 1.7 wt. %, optionally less than or equal to 1.5 wt. %, optionally less than or equal to 1.3 wt. %, optionally less than or equal to 1.0 wt. %, optionally less than or equal to 0.8 wt. %, optionally less than or equal to 0.7 wt. %, optionally less than or equal to 0.6 wt. %, optionally less than or equal to 0.5 wt. %, optionally less than or equal to 0.4 wt. %, optionally less than or equal to 0.3 wt. %, optionally less than or equal to 0.2 wt. %). Any value and range of the relative amount, of any principal element of a composition that is substituted with a dopant, between 0.1 wt. % and 20 wt. % is explicitly contemplated and disclosed herein. For example, optionally, the relative amount of any principal element of a composition that is substituted with a dopant is selected from the range of 0.1 wt. % to 20 wt. %, optionally selected from the range of 0.1 wt. % to 15 wt. %, optionally selected from the range of 0.1 wt. % to 10 wt. %, optionally selected from the range of 0.1 wt. % to 5 wt. %, optionally selected from the range of 0.1 wt. % to 4.0 wt. %, optionally selected from the range of 0.1 wt. % to 3.0 wt. %, optionally selected from the range of 0.1 wt. % to 2.5 wt. %, optionally selected from the range of 0.1 wt. % to 2.0 wt. %, optionally selected from the range of 0.1 wt. % to 1.5 wt. %, optionally selected from the range of 0.1 wt. % to 1.0 wt. %, optionally selected from the range of 0.1 wt. % to 0.95 wt. %.

### CERTAIN ASPECTS AND EMBODIMENTS

Various aspects are contemplated and disclosed herein, several of which are set forth in the paragraphs below. It is explicitly contemplated and disclosed that any aspect or portion thereof can be combined to form an aspect. In addition, it is explicitly contemplated and disclosed that: any reference to Aspect 1 includes reference to Aspects 1a, 1b, 1c, 1d, 1e, 1f, 1g, 1h, 1i, 1j, 1k, and/or 11, and any combination thereof; any reference to Aspect 3 includes reference to Aspects 3a, 3b, and/or 3c; and so on (i.e., any reference to an aspect includes reference to that aspect's lettered versions). Moreover, the terms “any preceding aspect” and “any one of the preceding aspects” means any aspect that appears prior to the aspect that contains such phrase (for example, the sentence “Aspect 15: The material, device, electrolyte, or method of any preceding Aspect . . . ” means that any Aspect prior to Aspect 15 is referenced, including letter versions, including aspects 1a through 14b). For example, it is contemplated and disclosed that, optionally, any composition, method, or formulation of any the below aspects may be useful with or combined with any other aspect provided below. Further, for example, it is contemplated and disclosed that any embodiment or aspect described above may, optionally, be combined with any of the below listed aspects.
Aspect 1a: A material comprising:
a lithium thioborate composition characterized by formula FX1:

Li_{3-z}[B+Q]₁[S+G]₃ (FX1);
wherein Q is a first dopant being a substitute for B in the composition and being one or more elements each aliovalent with respect to B;
wherein G is a second dopant being a substitute for S in the composition and being one or more elements each aliovalent with respect to S;
wherein z is 0 or a number greater than 0 and less than or equal to 0.40 (optionally less than or equal to 0.35, optionally less than or equal to 0.30, optionally less than or equal to 0.25, optionally less than or equal to 0.20, optionally less than or equal to 0.18, optionally less than or equal to 0.16, optionally less than or equal to 0.15, optionally less than or equal to 0.13, optionally less than or equal to 0.11, optionally less than or equal to 0.10, optionally less than or equal to 0.09, optionally less than or equal to 0.08, optionally less than or equal to 0.07, optionally less than or equal to 0.06, optionally less than or equal to 0.05, optionally less than or equal to 0.04, optionally less than or equal to 0.03, optionally less than or equal to 0.025); and
wherein the composition comprises only the first dopant, only the second dopant, or both the first dopant and the second dopant.
Aspect 1b: A device comprising:
a material, the material comprising:
a lithium thioborate composition characterized by formula FX1:

Li_{3-z}[B+Q]₁[S+G]₃ (FX1);
wherein Q is a first dopant being a substitute for B in the composition and being one or more elements each aliovalent with respect to B;
wherein G is a second dopant being a substitute for S in the composition and being one or more elements each aliovalent with respect to S;
wherein z is 0 or a number greater than 0 and less than or equal to 0.40 (optionally less than or equal to 0.35, optionally less than or equal to 0.30, optionally less than or equal to 0.25, optionally less than or equal to 0.20, optionally less than or equal to 0.18, optionally less than or equal to 0.16, optionally less than or equal to 0.15, optionally less than or equal to 0.13, optionally less than or equal to 0.11, optionally less than or equal to 0.10, optionally less than or equal to 0.09, optionally less than or equal to 0.08, optionally less than or equal to 0.07, optionally less than or equal to 0.06, optionally less than or equal to 0.05, optionally less than or equal to 0.04, optionally less than or equal to 0.03, optionally less than or equal to 0.025); and
wherein the composition comprises only the first dopant, only the second dopant, or both the first dopant and the second dopant.
Aspect 1c: A solid state electrolyte comprising:
a lithium thioborate composition characterized by formula FX1:

Li_{3-z}[B+Q]₁[S+G]₃ (FX1);
wherein Q is a first dopant being a substitute for B in the composition and being one or more elements each aliovalent with respect to B;
wherein G is a second dopant being a substitute for S in the composition and being one or more elements each aliovalent with respect to S;
wherein z is 0 or a number greater than 0 and less than or equal to 0.40 (optionally less than or equal to 0.35, optionally less than or equal to 0.30, optionally less than or equal to 0.25, optionally less than or equal to 0.20, optionally less than or equal to 0.18, optionally less than or equal to 0.16, optionally less than or equal to 0.15, optionally less than or equal to 0.13, optionally less than or equal to 0.11, optionally less than or equal to 0.10, optionally less than or equal to 0.09, optionally less than or equal to 0.08, optionally less than or equal to 0.07, optionally less than or equal to 0.06, optionally less than or equal to 0.05, optionally less than or equal to 0.04, optionally less than or equal to 0.03, optionally less than or equal to 0.025); and
wherein the composition comprises only the first dopant, only the second dopant, or both the first dopant and the second dopant.
Aspect 1d: A method of making a material, the method comprising:
combining a plurality of precursors comprising lithium, boron, sulfur, and at least one of a first dopant and a second dopant; and heating the combined plurality of precursors to form the material having a lithium thioborate composition;
wherein the lithium thioborate composition is characterized by formula FX1:

Li_{3-z}[B+Q]₁[S+G]₃ (FX1);
wherein Q is the first dopant being a substitute for B in the composition and being one or more elements each aliovalent with respect to B;
wherein G is the second dopant being a substitute for S in the composition and being one or more elements each aliovalent with respect to S;
wherein z is 0 or a number greater than 0 and less than or equal to 0.40 (optionally less than or equal to 0.35, optionally less than or equal to 0.30, optionally less than or equal to 0.25, optionally less than or equal to 0.20, optionally less than or equal to 0.18, optionally less than or equal to 0.16, optionally less than or equal to 0.15, optionally less than or equal to 0.13, optionally less than or equal to 0.11, optionally less than or equal to 0.10, optionally less than or equal to 0.09, optionally less than or equal to 0.08, optionally less than or equal to 0.07, optionally less than or equal to 0.06, optionally less than or equal to 0.05, optionally less than or equal to 0.04, optionally less than or equal to 0.03, optionally less than or equal to 0.025); and
wherein the composition comprises only the first dopant, only the second dopant, or both the first dopant and the second dopant.
Aspect 1e: An electrolyte comprising:
a lithium solid state electrolyte comprising Li, one or more principal elements (optionally, non-Li principal elements), and at least one dopant;
wherein the dopant substitutes for a portion of the one of the one or more principal elements (optionally, non-Li principal elements) of the lithium solid state electrolyte and is aliovalent with the respective substituted principal elements (optionally, non-Li principal elements);
wherein the ionic conductivity of the lithium solid state electrolyte is greater than or equal to 1·10⁻⁵ S/cm at 25° C.
Aspect 1f: A doped lithium solid state electrolyte comprising:
a doped inorganic composition having at least one dopant;
wherein the doped composition has up to 20 at. % (optionally up to 15 at. %, optionally up to 12 at. %, optionally up to 10 at. %, optionally up to 8 at. %, optionally up to 5 at. %, optionally up to 3 at. %, optionally up to 2 at. %, optionally up to 1 at. %, optionally up to 0.9 at. %, optionally up to 0.8 at. %, optionally up to 0.7 at. %, optionally up to 0.5 at. %) of one or more principal elements (optionally, non-Li principal elements) substituted with the at least one dopant relative to a reference composition of a reference lithium solid state electrolyte;
wherein each dopant is one or more elements each aliovalent with the respective substituted principal element (optionally, a non-Li principal element);
wherein the presence of the one or more dopants provides for an ionic conductivity greater than or equal to 1·10⁻⁵ S/cm at 25° C.
Aspect 1g: A method for increasing an ionic conductivity of a reference lithium solid state electrolyte, the method comprising:
forming a doped lithium solid state electrolyte having a doped composition;
wherein the reference lithium solid state electrolyte has a reference composition, and wherein the doped composition has up to 20 at. % (optionally up to 15 at. %, optionally up to 12 at. %, optionally up to 10 at. %, optionally up to 8 at. %, optionally up to 5 at. %, optionally up to 3 at. %, optionally up to 2 at. %, optionally up to 1 at. %, optionally up to 0.9 at. %, optionally up to 0.8 at. %, optionally up to 0.7 at. %, optionally up to 0.5 at. %) of one or more principal elements (optionally, non-Li principal elements) substituted with at least one dopant relative to the reference composition;
wherein each element of the at least one dopant is aliovalent with respect to the respective substituted principal element (optionally, a non-Li principal element); and
wherein the doped lithium solid state electrolyte has a greater ionic conductivity than the reference lithium solid state electrolyte by a factor of at least 2 (optionally at least 3, optionally at least 4, optionally at least 5, optionally at least 6, optionally at least 7, optionally at least 8, optionally at least 9, optionally at least 10, optionally at least 11, optionally at least 12, optionally at least 13, optionally at least 14, optionally at least 15, optionally at least 18, optionally at least 20, optionally at least 21, optionally at least 22, optionally at least 23, optionally at least 24, optionally at least 25, optionally at least 50, optionally at least 75, optionally at least 100, optionally at least 125, optionally at least 150, optionally at least 175, optionally at least 200, optionally at least 300, optionally at least 400, optionally at least 500, optionally at least 600, optionally at least 700, optionally at least 800, optionally at least 900, optionally at least 1000, optionally at least 1100, optionally at least 1200, optionally at least 1300, optionally at least 1400).
Aspect 1h: The material, device, electrolyte, or method of Aspect 1, wherein z is greater than 0 and less than 1 (optionally less than or equal to 0.50, optionally less than or equal to 0.45, optionally less than or equal to 0.40, optionally less than or equal to 0.35, optionally less than or equal to 0.30, optionally less than or equal to 0.25, optionally less than or equal to 0.20, optionally less than or equal to 0.18, optionally less than or equal to 0.16, optionally less than or equal to 0.15, optionally less than or equal to 0.13, optionally less than or equal to 0.11, optionally less than or equal to 0.10, optionally less than or equal to 0.09, optionally less than or equal to 0.08, optionally less than or equal to 0.07, optionally less than or equal to 0.06, optionally less than or equal to 0.05, optionally less than or equal to 0.04, optionally less than or equal to 0.03, optionally less than or equal to 0.025).

The material, device, electrolyte, or method of Aspect 1, wherein z is greater than 0 and less than 0.40 (optionally less than or equal to 0.35, optionally less than or equal to 0.30, optionally less than or equal to 0.25, optionally less than or equal to 0.20, optionally less than or equal to 0.18, optionally less than or equal to 0.16, optionally less than or equal to 0.15, optionally less than or equal to 0.13, optionally less than or equal to 0.11, optionally less than or equal to 0.10, optionally less than or equal to 0.09, optionally less than or equal to 0.08, optionally less than or equal to 0.07, optionally less than or equal to 0.06, optionally less than or equal to 0.05, optionally less than or equal to 0.04, optionally less than or equal to 0.03, optionally less than or equal to 0.025).
Aspect 1j: The material, device, electrolyte, or method of Aspect 1, wherein the material or the composition thereof is a solid solution.
Aspect 1k: Any material or composition disclosed herein, such as any of those disclosed in Examples 1A and 1B, optionally further doped/substituted and/or optionally amorphized.
Aspect 11: The material, device, electrolyte, or method of Aspect 1, wherein z is greater than 0 and less than 0.15.
Aspect 2: The material, device, electrolyte, or method of any preceding Aspect, having a greater ionic conductivity than that of an undoped stoichiometric Li₃BS₃ material by a factor of at least 2 (optionally at least 3, optionally at least 4, optionally at least 5, optionally at least 6, optionally at least 7, optionally at least 8, optionally at least 9, optionally at least 10, optionally at least 11, optionally at least 12, optionally at least 13, optionally at least 14, optionally at least 15, optionally at least 18, optionally at least 20, optionally at least 21, optionally at least 22, optionally at least 23, optionally at least 24, optionally at least 25, optionally at least 50, optionally at least 75, optionally at least 100, optionally at least 125, optionally at least 150, optionally at least 175, optionally at least 200, optionally at least 300, optionally at least 400, optionally at least 500, optionally at least 600, optionally at least 700, optionally at least 800, optionally at least 900, optionally at least 1000, optionally at least 1100, optionally at least 1200, optionally at least 1300, optionally at least 1400) at 25° C., wherein the undoped stoichiometric Li₃BS₃ material is free of Q and G.
Aspect 3a: The material, device, electrolyte, or method of any preceding Aspect being characterized by an ionic conductivity (such as average ionic conductivity) greater than 6·10⁻⁶ S/cm (optionally greater than or equal to 7·10⁻⁶ S/cm, optionally greater than or equal to 8·10⁻⁶ S/cm, optionally greater than or equal to 9·10⁻⁶ S/cm, optionally greater than or equal to 1.0·10⁻⁵ S/cm, optionally greater than or equal to 1.2·10⁻⁵ S/cm, optionally greater than or equal to 1.4·10⁻⁵ S/cm, optionally greater than or equal to 1.5·10⁻⁵ S/cm, optionally greater than or equal to 1.6·10⁻⁵ S/cm, optionally greater than or equal to 1.9·10⁻⁵ S/cm, optionally greater than or equal to 2.0·10⁻⁵ S/cm, optionally greater than or equal to 2.5·10⁻⁵ S/cm, optionally greater than or equal to 3.0·10⁻⁵ S/cm, optionally greater than or equal to 3.5·10⁻⁵ S/cm, optionally greater than or equal to 4.0·10⁻⁵ S/cm, optionally greater than or equal to 4.5·10⁻⁵ S/cm, optionally greater than or equal to 5.0·10⁻⁵ S/cm, optionally greater than or equal to 5.5·10⁻⁵ S/cm, optionally greater than or equal to 6.0·10⁻⁵ S/cm, optionally greater than or equal to 6.5·10⁻⁵ S/cm, optionally greater than or equal to 7.0·10⁻⁵ S/cm, optionally greater than or equal to 7.5·10⁻⁵ S/cm, optionally greater than or equal to 8.0·10⁻⁵ S/cm, optionally greater than or equal to 8.5·10⁻⁵ S/cm, optionally greater than or equal to 9.0·10⁻⁵ S/cm, optionally greater than or equal to 9.5·10⁻⁵ S/cm, optionally greater than or equal to 1.0·10⁻⁴ S/cm, optionally greater than or equal to 1.2·10⁻⁴ S/cm, optionally greater than or equal to 1.5·10⁻⁴ S/cm, optionally greater than or equal to 1.7·10⁻⁴ S/cm, optionally greater than or equal to 1.9·10⁻⁴ S/cm, optionally greater than or equal to 2.0·10⁻⁴ S/cm, optionally greater than or equal to 2.5·10⁻⁴ S/cm, optionally greater than or equal to 3.0·10⁻⁴ S/cm, optionally greater than or equal to 3.5·10⁻⁴ S/cm, optionally greater than or equal to 4.0·10⁻⁴ S/cm, optionally greater than or equal to 4.5·10⁻⁴ S/cm, optionally greater than or equal to 5.0·10⁻⁴ S/cm, optionally greater than or equal to 5.5·10⁻⁴ S/cm, optionally greater than or equal to 6.0·10⁻⁴ S/cm, optionally greater than or equal to 6.5·10⁻⁴ S/cm, optionally greater than or equal to 7.0·10⁻⁴ S/cm, optionally greater than or equal to 7.5·10⁻⁴ S/cm, optionally greater than or equal to 8.0·10⁻⁴ S/cm, optionally greater than or equal to 8.5·10⁻⁴ S/cm, optionally greater than or equal to 9.0·10⁻⁴ S/cm, optionally greater than or equal to 9.3·10⁻⁴ S/cm, optionally greater than or equal to 9.5·10⁻⁴ S/cm, optionally greater than or equal to 9.7·10⁻⁴ S/cm, optionally greater than or equal to 1.0·10⁻³ S/cm, optionally greater than or equal to 1.1·10⁻³ S/cm, optionally greater than or equal to 1.2·10⁻³ S/cm, optionally greater than or equal to 1.5·10⁻³ S/cm, optionally greater than or equal to 1.6·10⁻³ S/cm, optionally greater than or equal to 1.7·10⁻³ S/cm, optionally greater than or equal to 1.8·10⁻³ S/cm, optionally greater than or equal to 1.9·10⁻³ S/cm, optionally greater than or equal to 2.0·10⁻³ S/cm, optionally greater than or equal to 2.1·10⁻³ S/cm, optionally greater than or equal to 2.2·10⁻³ S/cm, optionally greater than or equal to 2.5·10⁻³ S/cm, optionally greater than or equal to 2.7·10⁻³ S/cm, optionally greater than or equal to 2.9·10⁻³ S/cm, optionally greater than or equal to 3.0·10⁻³ S/cm, optionally greater than or equal to 3.1·10⁻³ S/cm) at 25° C.
Aspect 3b: The material, device, electrolyte, or method of any preceding Aspect being characterized by an ionic conductivity (such as average ionic conductivity) selected from the range of 6·10⁻⁶ S/cm to 5·10⁻² S/cm, and wherein any value and range of ionic conductivity therebetween is explicitly contemplated and disclosed herein. Aspect 3c: The material, device, electrolyte, or method of any preceding Aspect being characterized by an ionic conductivity (such as average ionic conductivity) selected from the range of 6·10⁻⁶ S/cm to 1·10⁻² S/cm, optionally selected from the range of 1·10⁻⁴ S/cm to 1·10⁻² S/cm, optionally selected from the range of 5·10⁻⁴ S/cm to 1·10⁻² S/cm, optionally selected from the range of 1·10⁻³ S/cm to 1·10⁻² S/cm.
Aspect 4a: The material, device, electrolyte, or method of any preceding Aspect, wherein the composition is characterized by the ratio Q/(B+Q) being greater than 0.001 and less than 0.20, and wherein any value and range therebetween is explicitly contemplated and disclosed herein. Aspect 4b: The material, device, electrolyte, or method of any preceding Aspect, wherein the composition is characterized by the ratio Q/(B+Q) being selected from the range of 0.01 to 0.20, optionally selected from the range of 0.02 to 0.20, optionally selected from the range of 0.01 to 0.15, optionally selected from the range of 0.01 to 0.12, optionally selected from the range of 0.02 to 0.10.
Aspect 5: The material, device, electrolyte, or method of any preceding Aspect, wherein the composition is characterized by the ratio Q/(B+Q) being greater than 0.020 and less than 0.075.
Aspect 6a: The material, device, electrolyte, or method of any preceding Aspect, wherein Q is one or more Group 14 elements and/or one or more metal elements such as transition metal elements. Aspect 6b: The material, device, electrolyte, or method of any preceding Aspect, wherein Q is one or more Group 14 elements. Aspect 6c: The material, device, electrolyte, or method of any preceding Aspect, wherein Q is one Group 14 element. Aspect 6d: The material, device, electrolyte, or method of any preceding Aspect, wherein Q is one or more metal elements, such as one or more transition metal elements.
Aspect 7a: The material, device, electrolyte, or method of any preceding Aspect, wherein Q is Si, Ge, Sn, and/or Zr. Aspect 7b: The material, device, electrolyte, or method of any preceding Aspect, wherein Q is Si and/or Ge. Aspect 7c: The material, device, electrolyte, or method of any preceding Aspect, wherein Q comprises Si. Aspect 7d: The material, device, electrolyte, or method of any preceding Aspect, wherein Q is Si.
Aspect 8a: The material, device, electrolyte, or method of any preceding Aspect, wherein the composition is characterized by the ratio G/(S+G) being greater than 0.001 and less than 0.20, and wherein any value and range therebetween is explicitly contemplated and disclosed herein. Aspect 8b: The material, device, electrolyte, or method of any preceding Aspect, wherein the composition is characterized by the ratio Q/(B+Q) being selected from the range of 0.01 to 0.20, optionally selected from the range of 0.02 to 0.20, optionally selected from the range of 0.01 to 0.15, optionally selected from the range of 0.01 to 0.12, optionally selected from the range of 0.02 to 0.10.
Aspect 9: The material, device, electrolyte, or method of any preceding Aspect, wherein the composition is characterized by the ratio G/(S+G) being greater than 0.020 and less than 0.2, and wherein any value and range therebetween is explicitly contemplated and disclosed herein.
Aspect 10a: The material, device, electrolyte, or method of any preceding Aspect, wherein G is one or more Group 17 (halogen) elements. Aspect 10b: The material, device, electrolyte, or method of any preceding Aspect, wherein G is one Group 17 (halogen) element.
Aspect 11a: The material, device, electrolyte, or method of any preceding Aspect, wherein G is Cl and/or Br. Aspect 11 b: The material, device, electrolyte, or method of any preceding Aspect, wherein G comprises Cl. Aspect 11c: The material, device, electrolyte, or method of any preceding Aspect, wherein G is Cl.
Aspect 12a: The material, device, electrolyte, or method of any preceding Aspect, wherein the composition is characterized by formula FX2, FX3, or FX4:

Li_{3-x-y}B₁₋ₓ[Q]ₓS_{3-y}[G]_{y} (FX2);

Li₃₋ₓB₁₋ₓ[Q]ₓS₃ (FX3);

Li_{3-y}B₁S_{3-y}[G]_{y} (FX4); wherein:
x is selected from the range of 0.005 (optionally 0.007, optionally 0.009, optionally 0.01, optionally 0.015, optionally 0.02, optionally 0.025, optionally 0.03, optionally 0.035, optionally 0.04, optionally 0.045, optionally 0.05, optionally 0.055, optionally 0.06) to 0.20 (optionally 0.19, optionally 0.18, optionally 0.17, optionally 0.16, optionally 0.15, optionally 0.14, optionally 0.13, optionally 0.12, optionally 0.11, optionally 0.10, optionally 0.09, optionally 0.08, optionally 0.07, optionally 0.06); and
y is selected from the range of 0.005 (optionally 0.007, optionally 0.009, optionally 0.01, optionally 0.015, optionally 0.02, optionally 0.025, optionally 0.03, optionally 0.035, optionally 0.04, optionally 0.045, optionally 0.05, optionally 0.055, optionally 0.06) to 0.20 (optionally 0.19, optionally 0.18, optionally 0.17, optionally 0.16, optionally 0.15, optionally 0.14, optionally 0.13, optionally 0.12, optionally 0.11, optionally 0.10, optionally 0.09, optionally 0.08, optionally 0.07, optionally 0.06). Therefore, in Aspect 12, the variable z of claim 1 is equal to or approximately equal to x (in FX3), y (in FX4), or x+y (in FX2).
Aspect 12b: The material, device, electrolyte, or method of any preceding Aspect, wherein the composition is characterized by formula FX3; and wherein x is greater than 0 and less than or equal to 0.05, y is 0, and z is equal to or approximately equal to x.
Aspect 13a: The material, device, electrolyte, or method of any preceding Aspect, wherein the composition is characterized by formula FX3; and wherein x is greater than 0.025 (optionally greater than 0.03, optionally greater than 0.04) and less than or equal to 0.05 (optionally less than or equal to 0.06), y is 0, and z is equal to or approximately equal to x. Aspect 13b: The material, device, electrolyte, or method of any preceding Aspect, wherein the composition is characterized by formula FX3; and wherein x is about 0.05, y is 0, and z is equal to or approximately equal to x.
Aspect 14a: The material, device, electrolyte, or method of any preceding Aspect, wherein the material or the composition thereof is amorphous or substantially amorphous. Aspect 14b: The material, device, electrolyte, or method of any preceding Aspect, wherein the material or the composition thereof is has a total crystallinity less than 50 wt. %. Aspect 14c: The material, device, electrolyte, or method of any preceding Aspect, wherein the material or the composition thereof is has a total crystallinity less than or equal to about 35 wt. %, optionally less than or equal to about 30 wt. %, optionally less than or equal to about 25 wt. %, optionally less than or equal to about 20 wt. %, optionally less than or equal to about 15 wt. %, optionally equal to or less than about 10 wt. %, optionally equal to or less than about 8 wt. %, optionally equal to or less than about 5 wt. %, optionally equal to or less than about 4 wt. %, optionally equal to or less than about 3 wt. %, optionally equal to or less than about 2 wt. %, optionally equal to or less than about 1 wt. %, optionally equal to or less than about 0.8 wt. %, optionally equal to or less than about 0.5 wt. %, optionally equal to or less than about 0.2 wt. %, optionally equal to or less than about 0.1 wt. %, optionally equal to or less than about 0.08 wt. %, optionally equal to or less than about 0.05 wt. %, optionally equal to or less than about 0.01 wt. %.
Aspect 15: The material, device, electrolyte, or method of any preceding Aspect, being characterized by an ionic conductivity greater than or equal to 1·10⁻⁵ S/cm at 25° C.
Aspect 16: The material, device, electrolyte, or method of any preceding Aspect, being characterized by an ionic conductivity greater than or equal to 1·10⁻³ S/cm at 25° C.
Aspect 17: The material, device, electrolyte, or method of any preceding Aspect, being characterized by an ionic conductivity selected from the range of 1·10⁻⁵ S/cm to 1·10⁻² at 25° C.
Aspect 18: The material, device, electrolyte, or method of any preceding Aspect, being characterized by an electronic conductivity less than 5·10⁻¹⁰ S/cm (optionally less than or equal to about 4.8·10⁻¹⁰ S/cm, optionally less than or equal to about 4.5·10⁻¹⁰ S/cm, optionally less than or equal to about 4.3·10⁻¹⁰ S/cm, optionally less than or equal to about 4.1·10⁻¹⁰ S/cm, optionally less than or equal to about 4.0·10⁻¹⁰ S/cm, optionally less than or equal to about 3.8·10⁻¹⁰ S/cm, optionally less than or equal to about 3.5·10⁻¹⁰ S/cm, optionally less than or equal to about 3.2·10⁻¹⁰ S/cm, optionally less than or equal to about 3.0·10⁻¹⁰ S/cm, optionally less than or equal to about 2.0·10⁻¹⁰ S/cm, optionally less than or equal to about 1.0·10⁻¹⁰ S/cm) at 25° C.
Aspect 19: The material, device, electrolyte, or method of any preceding Aspect, being characterized by an activation energy (Eₐ) for an ionic conductivity of less than or equal to about 500 meV (optionally less than or equal to about 475 meV, optionally less than or equal to about 450 meV, optionally less than or equal to about 425 meV, optionally less than or equal to about 400 meV, optionally less than or equal to about 375 meV, optionally less than or equal to about 350 meV, optionally less than or equal to about 325 meV, optionally less than or equal to about 300 meV, optionally less than or equal to about 275 meV, optionally less than or equal to about 250 meV, optionally less than or equal to about 225 meV, optionally less than or equal to about 200 meV, optionally less than or equal to about 175 meV) when its temperature-dependent ionic conductivity is fit to equation EQ1:

$$σ = \frac{{σ}_{0}}{T} {e}^{\frac{- {E}_{a}}{{k}_{B} T}} ; \qquad ( EQ1 )$$

wherein:
σ is the ionic conductivity;
σ₀ is a conductivity prefactor;
T is temperature;
k_{B} is the Boltzmann's constant; and
Eₐ is the activation energy for ionic conductivity.
Aspect 20: A device comprising the material of any of the preceding Aspects.
Aspect 21: The device of Aspect 20 being an electrochemical cell.
Aspect 22: The device of Aspect 21, being a rechargeable lithium battery.
Aspect 23: The device of Aspect 21 or 22 having a solid state electrolyte comprising the material of any one of the preceding claims.
Aspect 24: The device of Aspect 21, 22, or 23 having a coating on a Li anode, the coating comprising the material of any one of the preceding claims.
Aspect 25: A device comprising:
a material, the material comprising:
a lithium thioborate composition characterized by formula FX1:

Li_{3-z}[B+Q]₁[S+G]₃ (FX1);
wherein Q is a first dopant being a substitute for B in the composition and being one or more elements each aliovalent with respect to B;
wherein G is a second dopant being a substitute for S in the composition and being one or more elements each aliovalent with respect to S;
wherein z is 0 or a number greater than 0 and less than or equal to 0.40 (optionally less than or equal to 0.35, optionally less than or equal to 0.30, optionally less than or equal to 0.25, optionally less than or equal to 0.20, optionally less than or equal to 0.18, optionally less than or equal to 0.16, optionally less than or equal to 0.15, optionally less than or equal to 0.13, optionally less than or equal to 0.11, optionally less than or equal to 0.10, optionally less than or equal to 0.09, optionally less than or equal to 0.08, optionally less than or equal to 0.07, optionally less than or equal to 0.06, optionally less than or equal to 0.05, optionally less than or equal to 0.04, optionally less than or equal to 0.03, optionally less than or equal to 0.025); and
wherein the composition comprises only the first dopant, only the second dopant, or both the first dopant and the second dopant.
Aspect 26: The device of Aspect 25 being an electrochemical cell.
Aspect 27: The device of Aspect 26, wherein the electrochemical cell comprises a solid state electrolyte having the material.
Aspect 28: The device of Aspect 26 or 27, being a rechargeable lithium battery.
Aspect 29: A solid state electrolyte comprising:
a lithium thioborate composition characterized by formula FX1:

Li_{3-z}[B+Q]₁[S+G]₃ (FX1);
wherein Q is a first dopant being a substitute for B in the composition and being one or more elements each aliovalent with respect to B;
wherein G is a second dopant being a substitute for S in the composition and being one or more elements each aliovalent with respect to S;
wherein z is 0 or a number greater than 0 and less than or equal to 0.40 (optionally less than or equal to 0.35, optionally less than or equal to 0.30, optionally less than or equal to 0.25, optionally less than or equal to 0.20, optionally less than or equal to 0.18, optionally less than or equal to 0.16, optionally less than or equal to 0.15, optionally less than or equal to 0.13, optionally less than or equal to 0.11, optionally less than or equal to 0.10, optionally less than or equal to 0.09, optionally less than or equal to 0.08, optionally less than or equal to 0.07, optionally less than or equal to 0.06, optionally less than or equal to 0.05, optionally less than or equal to 0.04, optionally less than or equal to 0.03, optionally less than or equal to 0.025); and
wherein the composition comprises only the first dopant, only the second dopant, or both the first dopant and the second dopant.
Aspect 30: A method of making a material, the method comprising:
combining a plurality of precursors comprising lithium, boron, sulfur, and at least one of a first dopant and a second dopant; and
heating the combined plurality of precursors to form the material having a lithium thioborate composition;
wherein the lithium thioborate composition is characterized by formula FX1:

Li_{3-z}[B+Q]₁[S+G]₃ (FX1);
wherein Q is the first dopant being a substitute for B in the composition and being one or more elements each aliovalent with respect to B;
wherein G is the second dopant being a substitute for S in the composition and being one or more elements each aliovalent with respect to S;
wherein z is 0 or a number greater than 0 and less than or equal to 0.40 (optionally less than or equal to 0.35, optionally less than or equal to 0.30, optionally less than or equal to 0.25, optionally less than or equal to 0.20, optionally less than or equal to 0.18, optionally less than or equal to 0.16, optionally less than or equal to 0.15, optionally less than or equal to 0.13, optionally less than or equal to 0.11, optionally less than or equal to 0.10, optionally less than or equal to 0.09, optionally less than or equal to 0.08, optionally less than or equal to 0.07, optionally less than or equal to 0.06, optionally less than or equal to 0.05, optionally less than or equal to 0.04, optionally less than or equal to 0.03, optionally less than or equal to 0.025); and
wherein the composition comprises only the first dopant, only the second dopant, or both the first dopant and the second dopant.
Aspect 31: The method of Aspect 30 further comprising amorphizing the material to increase its ionic conductivity.
Aspect 32a: The method of Aspect 31, wherein the step of amorphizing comprises reducing grain sizes of the lithium thioborate composition, increasing amorphous content of the lithium thioborate composition, decreasing a total crystallinity of the lithium thioborate composition, and/or increasing a concentration of defects in the lithium thioborate composition. Aspect 32b: The method of Aspect 31, wherein the step of amorphizing comprises increasing amorphous content of the lithium thioborate composition and decreasing a total crystallinity of the lithium thioborate composition.
Aspect 33: The method of any of Aspects 30-32, wherein the plurality of precursors comprises a lithium-containing precursor, a boron-containing precursor, and a sulfur-containing precursor.
Aspect 34: The method of any of Aspects 30-33, wherein the step of combining comprises mixing and/or milling.
Aspect 35: The method of any of Aspects 30-34, wherein the step of heating comprises melting the plurality of precursors at a temperature less than 1500° C. (optionally less than or equal to 1400° C., optionally less than or equal to 1300° C., optionally less than or equal to 1200° C., optionally less than or equal to 1100° C., optionally less than or equal to 1000° C., optionally less than or equal to 975° C., optionally less than or equal to 950° C., optionally less than or equal to 900° C., optionally less than or equal to 875° C., optionally less than or equal to 850° C., optionally less than or equal to 825° C., optionally less than or equal to 800° C.) to form a melt comprising lithium, boron, sulfur, and at least of the first dopant and the second dopant.
Aspect 36: The method of Aspect 35, wherein the step of heating further comprises cooling the melt thereby forming the material as a solid.
Aspect 37: An electrolyte comprising:
a lithium solid state electrolyte comprising Li, one or more principal elements (optionally, non-Li principal elements), and at least one dopant;
wherein the dopant substitutes for a portion of the one of the one or more principal elements (optionally, non-Li principal elements) of the lithium solid state electrolyte and is aliovalent with the respective substituted principal elements (optionally, non-Li principal elements);
wherein the ionic conductivity of the lithium solid state electrolyte is greater than or equal to 1·10⁻⁵ S/cm (optionally selected from the range of 1·10⁻⁵ S/cm to 5·10⁻² S/cm) at 25° C.
Aspect 38: The electrolyte of Aspect 37, wherein the lithium solid state electrolyte is obtained from doping (or forming a doped or substituted variation of) a material characterized by formula FX5, FX6, FX7, FX8, FX9, FX10, FX11, FX12, or FX13:

Li₃VS₄ (FX5);

Na₃Li₃Al₂F₁₂ (FX6);

Li₂Te (FX7);

LiAlTe₂ (FX8);

LiInTe₂ (FX9);

Li₆MnS₄ (FX10);

LiGaTe₂ (FX11);

KLi₆TaO₆ (FX12); or

Li₃CuS₂ (FX13).
Aspect 39: A doped lithium solid state electrolyte comprising:
a doped inorganic composition having at least one dopant;
wherein the doped composition has up to 20 at. % (optionally up to 15 at. %, optionally up to 12 at. %, optionally up to 10 at. %, optionally up to 8 at. %, optionally up to 5 at. %, optionally up to 3 at. %, optionally up to 2 at. %, optionally up to 1 at. %, optionally up to 0.9 at. %, optionally up to 0.8 at. %, optionally up to 0.7 at. %, optionally up to 0.5 at. %) of one or more principal elements (optionally, non-Li principal elements) substituted with the at least one dopant relative to a reference composition of a reference lithium solid state electrolyte;
wherein each dopant is one or more elements each aliovalent with the respective substituted principal element (optionally, a non-Li principal element);
wherein the presence of the one or more dopants provides for an ionic conductivity greater than or equal to 1·10⁻⁵ S/cm at 25° C.
Aspect 40: The material of Aspect 39, wherein the doped inorganic composition has up to 10 at. % of each of the one or more principal element (optionally, a non-Li principal element) substituted with a respective dopant.
Aspect 41: The method of Aspect 39 or 40, wherein the doped composition has up to 10 at. % of a cationic principal element, such as B, (optionally, a non-Li principal element) substituted with a first dopant, the first dopant being one or more elements each aliovalent with respect to said cationic principal element (optionally, a non-Li principal element).
Aspect 42: The method of any of Aspects 39-41, wherein the doped composition has up to 10 at. % of an anionic principal element, such as S, (optionally, a non-Li principal element) substituted with a second dopant, the second dopant being one or more elements each aliovalent with respect to said anionic principal element (optionally, a non-Li principal element).
Aspect 43: The material of any of Aspects 39-42, wherein the presence of the one or more dopants provides for the doped lithium solid state electrolyte having an ionic conductivity greater than that of the reference lithium solid state electrolyte by a factor of at least 2 (optionally at least 3, optionally at least 4, optionally at least 5, optionally at least 6, optionally at least 7, optionally at least 8, optionally at least 9, optionally at least 10, optionally at least 11, optionally at least 12, optionally at least 13, optionally at least 14, optionally at least 15, optionally at least 18, optionally at least 20, optionally at least 21, optionally at least 22, optionally at least 23, optionally at least 24, optionally at least 25, optionally at least 50, optionally at least 75, optionally at least 100, optionally at least 125, optionally at least 150, optionally at least 175, optionally at least 200, optionally at least 300, optionally at least 400, optionally at least 500, optionally at least 600, optionally at least 700, optionally at least 800, optionally at least 900, optionally at least 1000, optionally at least 1100, optionally at least 1200, optionally at least 1300, optionally at least 1400).
Aspect 44: The material of any of Aspects 39-43, wherein the reference composition is characterized by formula FX5, FX6, FX7, FX8, FX9, FX10, FX11, FX12, or FX13:

Li₃VS₄ (FX5);

Na₃Li₃Al₂F₁₂ (FX6);

Li₂Te (FX7);

LiAlTe₂ (FX8);

LiInTe₂ (FX9);

Li₆MnS₄ (FX10);

LiGaTe₂ (FX11);

KLi₆TaO₆ (FX12); or

Li₃CuS₂ (FX13).
Aspect 45: A method for increasing an ionic conductivity of a reference lithium solid state electrolyte, the method comprising:
forming a doped lithium solid state electrolyte having a doped composition;
wherein the reference lithium solid state electrolyte has a reference composition, and wherein the doped composition has up to 20 at. % (optionally up to 15 at. %, optionally up to 12 at. %, optionally up to 10 at. %, optionally up to 8 at. %, optionally up to 5 at. %, optionally up to 3 at. %, optionally up to 2 at. %, optionally up to 1 at. %, optionally up to 0.9 at. %, optionally up to 0.8 at. %, optionally up to 0.7 at. %, optionally up to 0.5 at. %) of one or more principal elements (optionally, non-Li principal elements) substituted with at least one dopant relative to the reference composition;
wherein each element of the at least one dopant is aliovalent with respect to the respective substituted principal element (optionally, a non-Li principal element); and
wherein the doped lithium solid state electrolyte has a greater ionic conductivity than the reference lithium solid state electrolyte by a factor of at least 2 (optionally at least 3, optionally at least 4, optionally at least 5, optionally at least 6, optionally at least 7, optionally at least 8, optionally at least 9, optionally at least 10, optionally at least 11, optionally at least 12, optionally at least 13, optionally at least 14, optionally at least 15, optionally at least 18, optionally at least 20, optionally at least 21, optionally at least 22, optionally at least 23, optionally at least 24, optionally at least 25, optionally at least 50, optionally at least 75, optionally at least 100, optionally at least 125, optionally at least 150, optionally at least 175, optionally at least 200, optionally at least 300, optionally at least 400, optionally at least 500, optionally at least 600, optionally at least 700, optionally at least 800, optionally at least 900, optionally at least 1000, optionally at least 1100, optionally at least 1200, optionally at least 1300, optionally at least 1400).
Aspect 46: The method of Aspect 45, wherein the doped composition has up to 10 at. % of a cationic principal element (optionally, a non-Li principal element) substituted with a first dopant, the first dopant being one or more elements each aliovalent with respect to said cationic principal element (optionally, a non-Li principal element).
Aspect 47: The method of Aspect 45 or 46, wherein the doped composition has up to 10 at. % of an anionic principal element (optionally, a non-Li principal element) substituted with a second dopant, the second dopant being one or more elements each aliovalent with respect to said anionic principal element (optionally, a non-Li principal element).
Aspect 48: The method of any of Aspects 45-47, wherein the step of forming comprises amorphizing the material to increase its ionic conductivity.
Aspect 49a: The method of Aspect 48, wherein the step of amorphizing comprises reducing grain sizes of the lithium thioborate composition, increasing amorphous content of the lithium thioborate composition, and/or increasing a concentration of defects in the lithium thioborate composition. Aspect 49b: The method of Aspect 48, wherein the step of amorphizing comprises increasing amorphous content of the lithium thioborate composition and decreasing a total crystallinity of the lithium thioborate composition.
Aspect 50: The method of any of Aspects 45-49, wherein the reference lithium solid state electrolyte and the doped lithium solid state electrolyte are inorganic materials.
Aspect 51a: The material, device, electrolyte, or method of any preceding Aspect, wherein the composition is further doped with the O (oxygen) such that the lithium borate composition further comprises O. Aspect 51b: The material, device, electrolyte, or method of any preceding Aspect, wherein the composition is further doped with the O (oxygen) such that the lithium borate composition further comprises O being greater than 0 at. % but less than 0.3 at. % O, optionally less than 0.2 at. % O, optionally less than or equal to 0.1 at. % O, optionally less than or equal to 0.08 at. % O, optionally less than or equal to 0.06 at. % O, optionally less than or equal to 0.05 at. % O, optionally less than or equal to 0.03 at. % O, optionally less than or equal to 0.02 at. % O, optionally less than or equal to 0.01 at. % O).
Aspect 52a: The material, device, electrolyte, or method of any preceding Aspect other than Aspect 51, wherein the composition is free of O (oxygen) such that the content of O is less than that measurable (e.g., below noise/background level) by techniques known in the art. Aspect 52b: The material, device, electrolyte, or method of any preceding Aspect other than Aspect 51, wherein the composition is free of O (oxygen) or the content of O is less than 0.01 at. %, optionally less than 0.009 at. %.
Aspect 53: The material, device, electrolyte, or method of any preceding Aspect, wherein the composition comprises both ionic and covalent bonding. Optionally, for example, assuming the Li—S correlations are ionic and the B—S correlations are covalent, the composition may have about 80% ionic bonding and about 20% covalent bonding.
Aspect 54: The material, device, electrolyte, or method of any preceding Aspect, wherein the composition comprises a vacancy defect concentration about equal to z (where z is approximately x+y).

The invention can be further understood by the following non-limiting examples.

Overview of Examples 1-3: Despite ongoing efforts to identify high-performance electrolytes for solid-state Li-ion batteries, thousands of prospective Li-containing structures remain unexplored. Here, we employ a semi-supervised learning approach to expedite identification of superionic conductors. We screen 180 unique descriptor representations and use agglomerative clustering to cluster ˜26,000 Li-containing structures. The clusters are then labeled with experimental ionic conductivity data to assess the fitness of the descriptors. By inspecting clusters containing the highest conductivity labels, we identify 212 promising structures that are further screened using bond valence site energy and nudged elastic band calculations. Li₃BS₃ is identified as a potential high-conductivity material and selected for experimental characterization. With sufficient defect engineering, we show that Li₃BS₃ is a superionic conductor with room temperature ionic conductivity greater than 1 mS cm⁻¹. While the semi-supervised method shows promise for identification of superionic conductors, the results illustrate a continued need for descriptors that explicitly encode for defects.

### Example 1A: Semi-Supervised Machine Learning Approach for Identification of Candidate Solid State Li-ion Conductors or Lithium Solid State Electrolytes

Identifying new materials that could improve solid-state ion battery prospects is an ongoing challenge. The search for an ideal solid-state Li electrolyte is a prime example. Research has focused on eight classes of materials: LISICON-type structures, argyrodites, garnets, NASICON-type structures, Li-nitrides, Li-hydrides, perovskites, and Li-halides¹. However, only three compounds with near-liquid-electrolyte conductivity (˜10⁻² S cm⁻¹) have been discovered: Li₁₀GeP₂S₁₂ (LGPS)², Li₆PS₅Br argyrodite³, and Li₇P₃S₁₁ ceramic-glass^{1,4}. Although promising discoveries, all three high-conductivity structures are unstable against the Li anode⁵⁻¹⁰. While investigations to limit instability are ongoing^{11,12}, identification of additional superionic structures is desirable. Discovery of new structures that support superionic conductivity improves the odds of identifying or engineering a stable electrode|SSE interface. For example, engineering solutions that fail to stabilize the Li|argyrodite interface may prove more successful when applied to not-yet-discovered superionic conductors. Discovery of new superionic conductors may also enable stable architectures via multi-electrolyte approaches which have been proposed as more promising than single-electrolyte architectures for achieving stability against Li metal and cathode materials¹³. High-performing structures that enable new battery chemistries may exist outside of the eight classes. However, exploration under the traditional Edisonian approach prioritizes small perturbations to well-known variable spaces.

Machine learning (ML) is a promising tool for expediting the discovery of useful solid-state materials. By describing prospective materials with physically meaningful descriptors, ML models can identify high-dimensional patterns in large datasets that are not readily apparent¹⁴⁻²⁰. Ongoing descriptor engineering²¹⁻²⁶ has enabled discovery of battery components^{27,28}, electrocatalysts^{15,29}, photovoltaic components^{16,30}, piezoelectrics³¹, new metallic glasses¹⁴ and new alloys³². However, application of ML for discovery of SSEs and other emerging technologies can be challenging. Supervised ML approaches require empirical data for use as “labels”. For example, graph neural network (GNN) approaches have been successful in many domains but generally require thousands to tens of thousands of labels to avoid overfitting³³. By contrast, relatively few SSEs have been experimentally characterized compared to the ˜26,000 known Li-containing structures^{19,34-36}. Characterized materials often exhibit ill-defined properties owing to the variety of synthetic approaches and non-standardized testing methods³⁷. Well-performing materials often contain charge-carrying defects that are not explicitly characterized or reported³⁸. Negative examples, i.e. materials with undesirable properties, are useful for ML models but are seldom reported.

Semi-supervised ML can guide synthetic prioritization of SSEs by overcoming the issues associated with label scarcity. Supervised ML requires labels because it infers correlation functions by mapping the input descriptors to the labels³⁹. Semi-supervised ML prioritizes comparison of descriptors to identify relationships between the descriptors in a dataset^{36,39}. The input compositions are clustered (or grouped) by comparison of descriptors using a similarity metric. The clustering process does not consider labels, and thus circumvents the need for abundant labels. The resultant clusters can be labeled ex post facto to examine correlation between the descriptor and a physical property of interest. For semi-supervised ML, ideal descriptors result in a set of clusters where each cluster has similar labels and thus the label variance is minimized. Promising synthetic targets may then be identified by their membership in clusters that contain desirable labels.

A key insight of this work is that semi-supervised ML can be used to rank descriptors in terms of their correlation to physical properties of interest. Descriptors are representations of the input materials that encode the chemistry, composition, structure, and/or other system properties. An ideal descriptor should be a unique representation, a continuous function of the structure, exhibit rotational/translational invariance, and be readily comparable across all structures in the dataset²⁴⁻²⁶. Recently, Zhang et al. demonstrated that a modified X-Ray diffraction (mXRD) descriptor lead to favorable clustering for Li SSEs³⁴. By labeling the resultant clusters with experimental room-temperature Li-ion conductivities, they identified 16 prospective fast-ion conductors. However, an ideal descriptor is not known a priori, and no comprehensive descriptor screening has yet been pursued for correlation with SSE properties. Descriptor screening is desirable for both experimentalists and computationalists. For experimentalists, ranking of descriptors affords insight into what aspects of materials are most correlated with target properties. For computationalists, descriptors rankings enable improved regression and supervised learning models by guiding the selection of input representation(s). Descriptor transformations for inorganic structures have been curated in a variety of software packages, including: Matminer²⁴, Dscribe²⁵, SchNet⁴⁰, and Aenet⁴¹

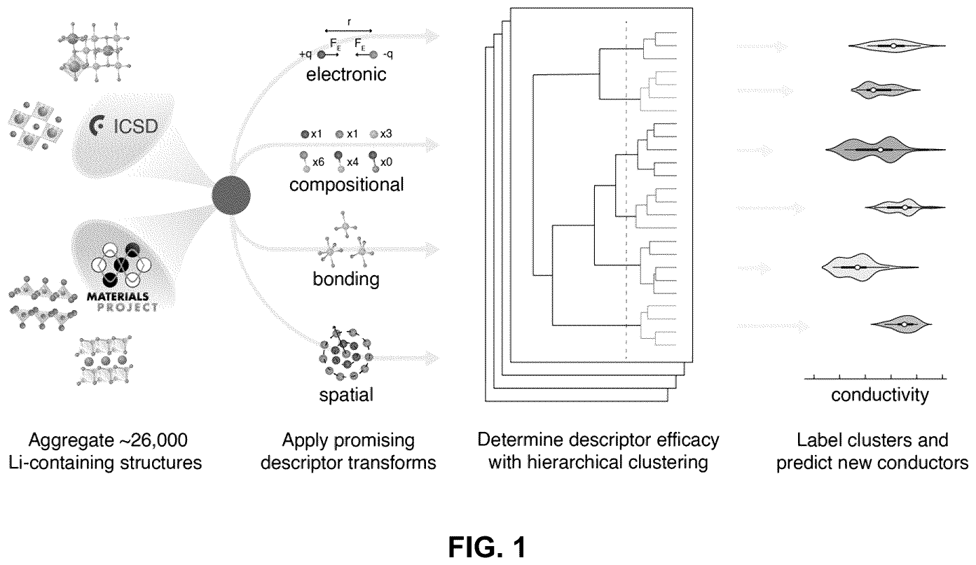

Herein, we employ hierarchical agglomerative clustering to screen many descriptors, without assuming correlation to ionic conductivity. The performance of 20 descriptors is assessed for semi-supervised identification of Li SSEs. Each descriptor is paired with 9 structural simplification strategies, yielding a total of 180 unique representations per input structure. The approach is applied to a dataset of ˜26,000 Li-containing phases, encompassing all Li-containing structures contained in the Inorganic Crystal Structure Database (ICSD—v.4.4.0) and the Materials Project (MP—v.2020.09.08) database (FIG. 1). A set of 220 experimental room temperature ionic conductivities (σ_{25° C.}) are aggregated from literature reports and used as labels. Experimental labels are selected because they may bias models towards identifying structures that are synthetically tractable and processable. Descriptors that encode the spatial environment are found to be most correlated with the ionic conductivity labels. Whereas descriptors that encode the electronic, compositional, or bonding environment have less predictive power. For the structural descriptors, simplifications that neglect the mobile ion perform best. The descriptor screening results suggest that ionic conductivity is most sensitive to the spatial environment of the framework lattice.

Using the descriptors, the semi-supervised approach can identify potential fast solid-state Li-ion conductors. By selecting structures in clusters containing high conductivity labels, the ˜26,000 input structures are down selected to just 212 promising structures. Practical considerations, a semi-empirical bond valence site energy (BVSE) method,⁴² and the Nudged Elastic Band (NEB) method are employed to rank the structures. From the ten highest ranking structures, Li₃BS₃ is selected for model validation. Synthesis of pure Li₃BS₃ yields a poor conductor. However, by employing defect engineering strategies we demonstrate that Li₃BS₃ is a superionic conductor with an ionic conductivity greater than 10⁻³ S cm⁻¹.

Screening Simplification-Descriptor Combinations:

A set of 20 descriptors is selected for screening the semi-supervised learning approach (Table 1). The descriptors generally encode four types of information: the spatial environment, the chemical bonding environment, the electronic environment, and composition. All descriptors are implemented in Python using the Matminer²⁴ or Dscribe²⁵ libraries. The code is published to a github repository and is available for download (https://github.com/FALL-ML/materials-discovery). Zhang et al. illustrated that structure simplification prior to learning can produce lower variance outcomes³⁴. Their mXRD descriptor was found to work best with removal of all cations, all the anions replaced by a single representative anion, and the structure volume scaled to 40 Å³ per anion. Inspired by the previous success in using structure simplification, we screen eight structure simplifications in addition to the unperturbed structure. For simplifications the following categories of atoms are replaced with a representative specie: (1) Cations are represented as Al, (2) Anions are represented as S, (3) Mobile ions are represented as Li, and (4) Neutral atoms are represented as Mg. Categories of atom are removed as to yield the four simplifications: CAMN (all atoms retained), CAN (mobile ions removed), AM (cations and neutral atoms removed), and A (only anions retained). Four additional simplifications are formed by scaling each lattice volume to 40 Å³ per anion: CAMN-40, CAN-40, AM-40, and A-40.

TABLE 1
The descriptors used for agglomerative clustering. Descriptor vectors are attained
by simplifying the input structures and then applying the descriptor transformation.
In total, 180 unique descriptor vectors are screened for each structure.

| Descriptor | Descriptor Description | Refs |
|---|---|---|
| Bond Fraction | “Bag of bonds” approach described in Hansen et. al. wherein | 43 |
| | pairwise nuclear charges and distances are encoded. | |
| Band Center | Estimation of band center from constituent atoms' | 44 |
| | electronegativity values described by Butler et al. | |
| Crystal Structure Analysis by | Calculation of the largest sphere that can pass through the | 45 |
| Voronoi Decomposition | lattice-sans-mobile-ion using Voronoi decomposition of | |
| (CAVD) | structures. | |
| Chemical Ordering | Warren-Cowley-like ordering method to determine how different | 46 |
| | the structure's ordering is from random. | |
| Density Features | Calculates density, volume per atom, and the packing fraction. | 47 |
| Electronegativity Difference | Composition weighted calculation of the electronegativity | 48 |
| | difference between cations and anions. | |
| Ewald Energy | Sum of coulomb interaction energies across all lattice sites | 49 |
| | described by Ewald et al. | |
| Global Instability Index | Averaged square root of the sum of squared differences over | |
| | the bond valence sums. | |
| Jarvis | Diverse set of descriptors from the Jarvis-ML library. | 50 |
| Maximum Packing Efficiency | A measure of the void space within the unit cell. | 46 |
| Meredig | Composite descriptor from Meredig et al. | 51 |
| Modified XRD (mXRD) | Powder diffraction pattern calculated using Bragg's law. | 47 |
| Orbital Field Matrix | Descriptor that encodes the distribution of valence shell | 52 |
| | electrons for each input structure. | |
| Oxidation States | Concentration weighted oxidation state statistics. | 48 |
| Radial Distribution Function | Radial distribution function for each structure. | 47 |
| Sine Coulomb Matrix | Coulomb matrix for periodic lattices, developed by Faber et al. | 53,54 |
| Smooth Overlap of Atomic | Geometric encoder that is rotationally/transitionally invariant | 25 |
| Positions (SOAP) | through use of spherical harmonics and radial basis functions. | |
| | Atoms are represented by a smeared gaussian. | |
| Structural Complexity | The Shannon information entropy for a given structure. | 55 |
| Structure Variance | Bond length and atomic volume variance for each structure. | 46 |
| Valence Orbital | Structure averaged number of valence electrons in each orbital. | 48,56 |
| Control | A control descriptor is not explicitly used. Instead, clustering | |
| | outcomes are randomly assigned. For composite intracluster | |
| | variance calculations, 100 control iterations are averaged. | |

Agglomerative clustering is performed on all Li-containing structures from the ICSD and MP repositories. Agglomerative clustering is a “bottom-up” approach to clustering where each structure starts in its own cluster of one. Clusters are merged according to Ward's Minimum Variance criterion in Euclidean space, which minimizes the global descriptor variance⁵⁷.

$$W = {\sum }_{k = 1}^{{n}_{c}} {\sum }_{i ∈ {C}_{k}} {[ {d}_{i} - {\overline{d}}_{k} ]}^{2}$$

where n_{C} is the number of clusters in a set, Cₖ is cluster k, di is a descriptor representation for structure i, and d̅ₖ is the average descriptor representation in cluster k. Each cluster merger results in the lowest variance set of clusters, relative to all other possible mergers. Other common linkage criteria (average, complete, and single linkages) and metrics (I1, I2, manhatten, cosine) were screened but are found to result in clustering outcomes with larger W. For each simplification-descriptor combination, all clustering sets from 2-300 are computed. Physically relevant labels are applied to the resultant clustering sets to assess how well each simplification-descriptor combination performs. To compare between the 180 different simplification-descriptions combinations, the data is labeled with 155 experimental room temperature conductivity (σ_{RT}) values aggregated from the literature reports (see Example 1B: sections I-IV). A secondary label set is also screened, comprised of 6845 activation energies (Eₐ) computationally generated using a bond valence energy approach (see Example 1B: section V).

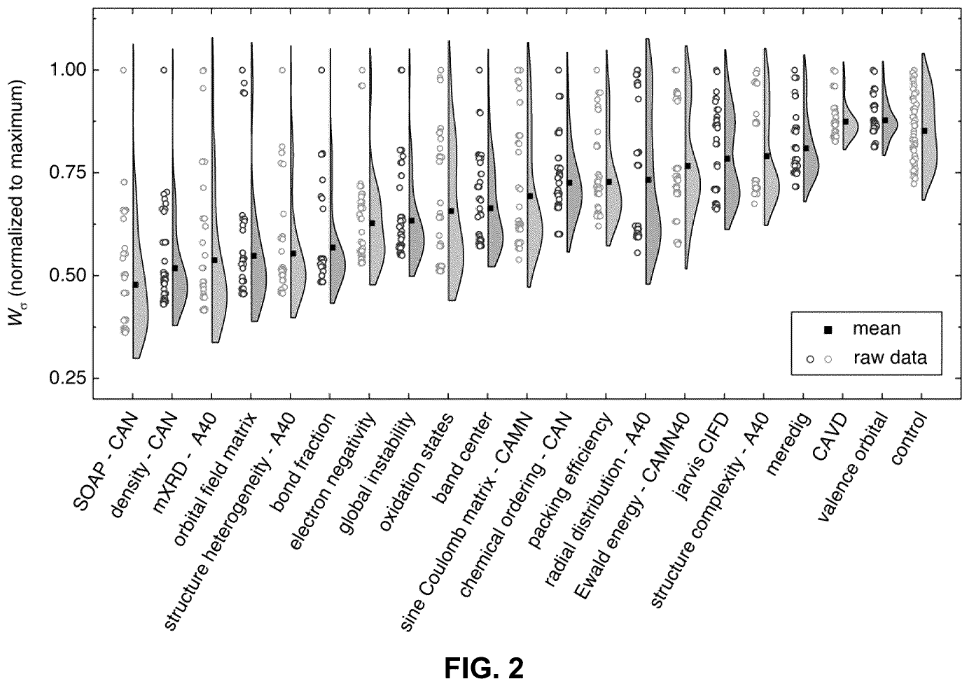

An ideal simplification-descriptor combination results in clustering where each cluster contains labels with similar σ_{RT} values. Ward's minimum variance method is applied to the conductivity labels as a measure of clustering efficacy:

$${W}_{σ} = {\sum }_{k = 1}^{{n}_{c}} {\sum }_{i ∈ {C}_{k}} {[ {log ( {σ}_{R T} )}_{i} - {\overline{log ( {σ}_{R T} )}}_{k} ]}^{2}$$

where n_{C} is the number of clusters in a set, Cₖ is cluster k, and l̅o̅g̅(̅σ̅_̅{̅R̅T̅}̅)̅ₖ̅denotes the mean for all labels in cluster k. Since clusters containing only one label effectively drop out of the W_{σ} calculation, a frozen-state strategy is employed when needed (see Example 1B: section IV). Each descriptor's W_{σ} results are shown in FIG. 2 for the first 50 clustering outcomes (i.e. the W_{σ} is shown for each set of 2, 3, . . . , 49, and 50 clusters). For simplicity, only the best-performing simplification-descriptor combination is shown for each descriptor.

Using σ_{25° C.} labels, the best semi-supervised ML performance is attained when using the SOAP descriptor. SOAP is a spatial descriptor that employs smeared gaussians to represent atomic positions for each crystal structure²⁵. Predictions using the SOAP descriptor have exhibited similar performance to state-of-the-art graph neural networks (GCNs) on a variety of materials science datasets⁵⁸. Optimization of SOAP hyper-parameters (radial cutoff, number of radial basis functions, degree of spherical harmonics) is explored in section VI of the supplemental information. SOAP is found to perform best when combined with the CAN structure simplification. That is, the simplification where the mobile Li atoms are removed, and the remaining atoms are simplified into three representative species: cations, anions, and neutral atoms. SOAP outperforms all other descriptors for all depths of clustering. The SOAP descriptor can be modestly improved (2-3% decrease in W_{Q}) by mixing with other descriptors to make a 2^{nd} order SOAP descriptor (see Example 1B: section VI).

Semi-Supervised Identification of Prospective Li-Ion Conductors:

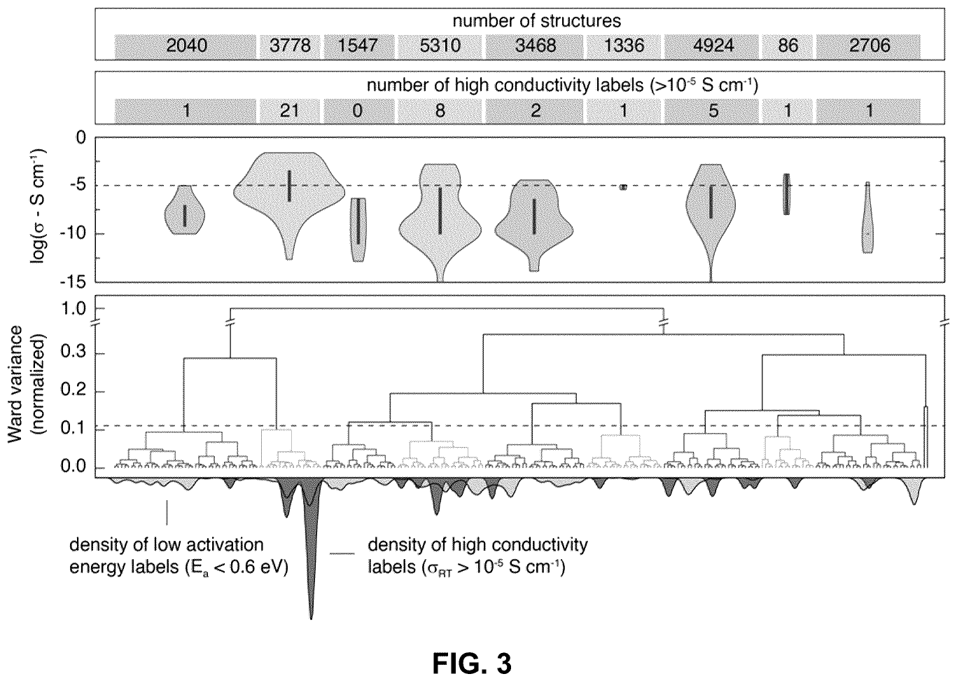

Agglomerative clustering with the 2^{nd} order SOAP descriptor is used to identify prospective ionic conductors. W_{σ} minimization is prioritized over W_{Ea} minimization because Eₐ alone is not necessarily a good predictor of conductivity; σ_{25° C.} may be affected by properties including the ionic carrier concentration, hopping attempt frequency, and the presence of concerted migration modes⁵⁹. The agglomerative dendrogram for the 2^{nd} order SOAP is shown in FIG. 3, with the label densities plotted below. The agglomerative dendrogram is depicted to 241 clusters, after which the W_{Q} does not appreciably decrease. To facilitate discussion, an arbitrary cutoff is placed to yield 9 large clusters. The results show that although cluster #2 contains only 15% of the input structures, it accounts for over half of the high-conductivity (σ_{25° C.}>10⁻⁵ S cm⁻¹) labels. By the 17^{th} clustering step, the densest cluster accounts for 6.2% of the structures while containing over half (52%) of the high-conductivity labels.

Candidates for next-generation SSEs can be identified by evaluating clusters that either contain or are near high conductivity labels. Clusters #2, #4, and #7 are promising because they account for 85% of the high σ_{25° C.} labels. However, targeting these clusters would necessitate screening thousands of structures. Instead, we search from the 241^{st} cluster depth, targeting all clusters that contain or are directly adjacent (i.e. the nearest cluster in the Euclidean feature space) to high σ_{25° C.} labels. The promising structures are further screened using calculated stability (E vs. Eₕᵤₗₗ) and band gap (E_{g}) properties from the Materials Project, and the BVSE Eₐ values. We select the structures that have (1) an Eₕᵤₗₗ of 70 meV or lower,⁶⁰ (2) an E_{g} of at least 1 eV, and (3) a BVSE-calculated Eₐ below a conservative 0.6 eV. We note that while a true E_{g} value of 1 eV would be problematic for an SSE, the bandgaps reported on Materials Project are typically underestimated by about 40%⁶¹. The approach identifies 212 structures as prospective ionic conductors. Climbing image nudged elastic band (CI-NEB) is employed to calculate the Eₐ for Li-ion hopping on the ten materials with the lowest BVSE-calculated Eₐ and an Eₕᵤₗₗ of 0 eV. The CI-NEB functionals and parameters can be found in the supporting information section VII. The top 10 prospective structures are tabulated in Table 2.

TABLE 2
The top 10 prospective structures from the semi-supervised learning model as
ranked by BVSE−calculated Eₐ. Structures in or directly adjacent to high-
conductivity clusters were identified as promising. The list of promising structures was then
further simplified by removing structures with Materials Project reported Eₕᵤₗₗ values greater
than 0 V and E_{g} values less than 1 eV. To rank the remaining structures, the Eₐ
was calculated using BVSE and NEB approaches.

| | | | | E vs. Eₕᵤₗₗ | E_{g} | Eₐ_{_{—}}_{calc} (meV) | |
|---|---|---|---|---|---|---|---|
| compound | space group | MP_ID | ICSD_ID | (eV/atom) | (eV) | BVSE | NEB |
| Li₃VS₄ | P4̅3m (#215) | mp-760375 | | 0 | 1.88 | 160 | 390 |
| Na₃Li₃Al₂F₁₂ | Ia3̅d (#230) | mp-6711 | 9923 | 0 | 7.85 | 230 | 340 |
| Li₂Te | Fm3̅m (#225) | mp-2530 | 60434 | 0 | 2.49 | 260 | 320 |
| LiAlTe₂ | I4̅2d (#122) | mp-4586 | 280226 | 0 | 2.46 | 260 | 310 |
| LiInTe₂ | I4̅2d (#122) | mp-20782 | 658016 | 0 | 1.49 | 270 | 450 |
| Li₆MnS₄ | P4₂/nmc (#137) | mp-756490 | | 0 | 1.55 | 270 | 466 |
| LiGaTe₂ | I4̅2d (#122) | mp-5048 | 162555 | 0 | 1.59 | 270 | 340 |
| Li₃BS₃ | Pnma (#62) | mp-5614 | 380104 | 0 | 2.89 | 280 | 260 |
| KLi₆TaO₆ | R3̅m (#166) | mp-9059 | 73159 | 0 | 4.27 | 300 | 404 |
| Li₃CuS₂ | Ibam (#72) | mp-1177695 | | 0 | 2.03 | 310 | 440 |

The CI-NEB calculations generally agree with the BVSE calculated Eₐ values, suggesting favorable activation energies (<500 meV). Discrepancies between the two values may arise because BVSE does not allow framework ions to relax during Li⁺ migration and does not account for repulsive interactions between atoms of the mobile ion species. BVSE also does not capture cooperative conduction mechanisms or those involving the so-called paddlewheel effect. Despite these limitations, we note that the model identifies numerous diverse structures beyond those routinely explored. Table 1 includes four tellurides, a vanadium sulfide, and multiple transition-metal-containing structures. Of the structures in Table 1, 70% avoid the space groups for the best-performing SSEs discovered to date: LPS (62), LGPS (137), the argyrodites (216), and LLZO (230).

Data Processing and Semi-Supervised Learning:

The ˜26,000 input compositions are exported from the Inorganic Crystalline Structure Database (ICSD v. 4.4.0) and Material's Project (MP—v.2020.09.08) as crystallographic information files (.cif). All structures containing Li are imported. Although transition metals could produce undesirable redox activity, transition metal containing structures are not screened out. Some of the best-performing SSEs contain transition metals (e.g. LLZO and LLTO). Entries that existed in both ICSD and MP are merged. Data manipulations and structure simplifications are performed using the Python libraries NumPy (v1.19.1), Pandas (v1.0.5), ASE (v3.19.1), and Pymatgen (v2020.8.3). Descriptor transformations are performed using the Python libraries Pymatgen (v2020.8.3), Matminer (v0.6.3), and Dscribe. Agglomerative hierarchical clustering is performed using the Python library scipy (v1.5.0). All code has been successfully executed on a custom-built CPU with an AMD Ryzen Threadripper 3990x Processor and 256 GB of RAM, in Ubuntu 20.04 running on Windows Subsystem for Linux 2. All code is made available on the github (https://github.com/FALL-ML/materials-discovery).

CI-NEB:

Migration barriers for Li ion hopping are evaluated with the Climbing Image—Nudged Elastic Band (CI-NEB) method as implemented in the QuantumESPRESSO PWneb software package⁸¹⁻⁸⁴. Density-functional theory (DFT) calculations are performed using the Perdew-Burke-Ernzerfof (PBE) generalized gradient approximation functional and projector-augmented wave (PAW) sets^{85,86}. Convergence testing for the kinetic-energy cutoff of the plane-wave basis and the k-point sampling is performed for each structure to ensure an accuracy of 1 meV per atom. The lattice parameters and atomic positions of the as-retrieved structure are optimized. Supercells are created for each structure that are a minimum of 10 Å in each lattice direction to minimize interactions between periodic images of the mobile ion. To study the migration barrier in the dilute limit, a single Li vacancy is created in the boundary endpoint structures of each studied pathway. A uniform background charge is used to balance excess charge. Each boundary configuration is relaxed until the force on each atom is less than 3×10⁻⁴ eV/Å. Images are created by linearly interpolating framework atomic positions between the initial and final boundary configurations. The initial pathway for the mobile ion is generated from the BVSE output minimum energy pathway to promote faster convergence of the NEB calculation. An NEB force convergence threshold of 0.05 eV/Å is used. The calculation is first converged using the default NEB algorithm and then restarted with the CI scheme to allow for the maximum energy of the pathway to be determined.

### Example 1B: Additional Aspects and Details for Semi-Supervised Machine Learning Approach for Identification of Candidate Solid State Li-ion Conductors or Lithium Solid State Electrolytes

Section I. Digitized Labels for Lithium-Ion Conductors: RT Conductivity, Activation Energy, and Corresponding ICSD Identifier

Data labels for the semi-supervised learning approach were ultimately digitized from over 300 literature publications. Many more publications were initially examined. The stepwise decision chart below was used as a guide for deciding what data to digitize. Room temperature conductivity data was only digitized if it originated from an equivalent circuit fit (where a blocking feature was clearly present) or if calculated from NMR. DC techniques were categorically discounted because they cannot differentiate between electronic and ionic conductivity.

All of the digitized data is presented in the subsequent tableI. Activation energies were also digitized when available. The activation energies were not used in the manuscript but are still presented here to aid future machine learning endeavors. The digitized data was manually matched with the appropriate ICSD ID, so that the crystallographic information file (.cif) can be downloaded.

| | σ_{25° C.} | Eₐ | Space | Space | Other | | |
|---|---|---|---|---|---|---|---|
| Compound | (S cm⁻¹) | (eV) | Group | Group # | names | ICSD | Citation |
| LiAlSi₃O₈ | 1.30E−10 | | C1̅ | 2 | | 81980 | 1 |
| LiSn₂(PO₄)₃ | 2.04E−9 | | P1̅ | 2 | | 83832 | 2 |
| Li₇BiO₆ | 8.80E−07 | 0.58 | P1̅ | 2 | | 155950 | 3 |
| Li₇SbO₆ | 6.70E−08 | 0.7 | P1̅ | 2 | | 413370 | 3 |
| Li₇P₃S₁₁ | 1.70E−02 | 0.17 | P1̅ | 2 | | 157654 | 4 |
| Li₇P₃S₁₁ | 3.2E−3 | 0.124 | P1̅ | 2 | | 157654 | 5 |
| LiV(PO₄)F | 8.1E−7 | 0.23 | P1̅ | 2 | | 183876 | 6 |
| Li₂B₃PO₈ | 5.80E−15 | 0.76 | P1̅ | 2 | | 248343 | 7 |
| Li₃BP₂O₈ | 9.60E−12 | 0.62 | P1̅ | 2 | | 248343 | 7 |
| Li₂NaBP₂O₈ | 4.40E−18 | 1.21 | P1̅ | 2 | | 291512 | 7 |
| Li₄P₂O₇ | <1E−10 | 1.617 | P1̅ | 2 | | 248414 | 8 |
| LiMgSO₄F | 5.40E−08 | 0.54 | P1̅ | 2 | | 281119 | 9 |
| Li₆CuB₄O₁₀ | 1.00E−13 | 0.92 | P1̅ | 2 | β-Li₆CuB₄O₁₀ | 4819 | 10 |
| Li_{0.91}Hf_{2.022}(PO₄)₃ | <1E−10 | 0.47 | C1̅ | 2 | | | 11 |
| Li₇P₃S₁₁ | 8.6E−3 | 0.29 | P1̅ | 2 | | | 12 |
| Li₂ZnGeO₄ | 1.00E−07 | 0.4 | Pc | 7 | | 34362 | 13 |
| Li_{3.8}Ge_{0.8}P_{0.2}S₄ | 1.78E−6 | 0.47 | P2₁/m | 11 | | | 14 |
| Li_{3.6}Ge_{0.6}P_{0.4}S₄ | 1.75E−4 | 0.34 | P2₁/m | 11 | | | 14 |
| Li_{3.4}Ge_{0.4}P_{0.6}S₄ | 6.54E−4 | 0.28 | P2₁/m | 11 | | | 14 |
| Li_{3.35}Ge_{0.35}P_{0.65}S₄ | 1.54E−3 | 0.23 | P2₁/m | 11 | | | 14 |
| Li_{3.3}Ge_{0.3}P_{0.7}S₄ | 1.74E−3 | 0.22 | P2₁/m | 11 | | | 14 |
| Li_{3.25}Ge_{0.25}P_{0.75}S₄ | 2.2E−03 | 0.207 | P2₁/m | 11 | | | 14 |
| Li_{3.2}Ge_{0.2}P_{0.8}S₄ | 5.55E−4 | 0.27 | P2₁/m | 11 | | | 14 |
| Li₄SiS₄ | 5.00E−08 | 0.56 | P2₁/m | 11 | | 59708 | 15 |
| Li_{7.22}Si_{1.5}P_{0.5}O₈ | 1.64E−7 | 0.48 | P2₁/m | 11 | | 238602 | 16 |
| Li₄SiO₄ | 5.00E−10 | 0.55 | P2₁/m | 11 | | 238603 | 17 |
| Li₄SiS₄ | 1.59E−8 | 0.56 | P2₁/m | 11 | | | 18 |
| Li_{3.8}Si_{0.8}P_{0.2}S₄ | 8.11E−7 | 0.37 | P2₁/m | 11 | | | 18 |
| Li_{3.6}Si_{0.6}P_{0.4}S₄ | 7.19E−5 | 0.34 | P2₁/m | 11 | | | 18 |
| Li_{3.5}Si_{0.5}P_{0.5}S₄ | 1.66E−4 | 0.34 | P2₁/m | 11 | | | 18 |
| Li_{3.4}Si_{0.4}P_{0.6}S₄ | 6.62E−4 | 0.29 | P2₁/m | 11 | | | 18 |
| Li_{3.3}Si_{0.3}P_{0.7}S₄ | 1.02E−5 | 0.36 | P2₁/m | 11 | | | 18 |
| Li_{3.2}Si_{0.2}P_{0.8}S₄ | 3.20E−6 | 0.37 | P2₁/m | 11 | | | 18 |
| Li₄SiS₄ | 1.62E−8 | 0.56 | P2₁/m | 11 | | | 18 |
| Li_{3.8}Si_{0.8}P_{0.2}S₄ | 8.07E−7 | 0.37 | P2₁/m | 11 | | | 18 |
| Li_{3.6}Si_{0.6}P_{0.4}S₄ | 7.11E−5 | 0.34 | P2₁/m | 11 | | | 18 |
| Li_{3.5}Si_{0.5}P_{0.5}S₄ | 1.61E−4 | 0.34 | P2₁/m | 11 | | | 18 |
| Li_{3.4}Si_{0.4}P_{0.6}S₄ | 6.49E−4 | 0.29 | P2₁/m | 11 | | | 18 |
| Li_{3.3}Si_{0.3}P_{0.7}S₄ | 9.84E−6 | 0.36 | P2₁/m | 11 | | | 18 |
| Li_{3.2}Si_{0.2}P_{0.8}S₄ | 3.05E−6 | 0.37 | P2₁/m | 11 | | | 18 |
| Li_{3.1}P_{0.9}Si_{0.1}O₄ | 7.47E−8 | | P2₁/m | 11 | | | 19 |
| Li_{3.5}P_{0.5}Si_{0.5}O₄ | 2.89E−6 | | P2₁/m | 11 | | | 19 |
| Li_{3.9}P_{0.1}Si_{0.9}O₄ | 1.99E−8 | | P2₁/m | 11 | | | 19 |
| Li_{3.7}P_{0.3}Si_{0.7}O₄ | 3.84E−7 | | P2₁/m | 11 | | 35168 | 19 |
| Li3InCl6 | 2.04E−3 | 0.35 | C2/m | 12 | | 89617 | 20 |
| Li₂P₂S₆ | 7.80E−11 | 0.48 | C2/m | 12 | | 253894 | 21 |
| Li_{0.6}[Li_{0.2}Sn_{0.8}S₂] | 1.2E−4 | 0.17 | C2/m | 12 | | | 22 |
| Li₃(Mo₈S₈O₈(OH)₈(HWO₅(H₂O)))*(H₂O)₁₈ | 3.8E−7 | 0.62 | C2/m | 12 | | 412011 | 23 |
| Li₁₇Sb₁₃S₂₈ | 1.05E−9 | 0.4 | C2/m | 12 | | 429902 | 24 |
| Li₃InBr₆ | 9.04E−4 | | C2/m | 12 | | | 25 |
| Li₃YBr₆ | 1.92E−3 | 0.37 | C2/m | 12 | | | 26 |
| Li_{0.84}Sn_{0.79}S₂ | 1.2E−4 | 0.17 | C2/m | 12 | | | 27 |
| LiAlSi₄O₁₀ | 1.01E−10 | | P2/c | 13 | | 194284 | 1 |
| LiPO₃ | 1.00E−09 | | P2/c | 13 | | 51630 | 28 |
| LiGaBr4 | 7.00E−6 | 0.54 | P2₁/c | 14 | | 61337 | 25 |
| Li₂SO₄ | 1.40E−14 | 1.1 | P2₁/c | 14 | | 2512 | 29 |
| Li₃BO₃ | 7.40E−11 | 0.63 | P2₁/c | 14 | | 9105 | 30 |
| Li₆Ge₂O₇ | 8.50E−07 | 0.43 | P2₁/c | 14 | | 31050 | 31 |
| LiAlCl₄ | 1.00E−06 | 0.47 | P2₁/c | 14 | | 35275 | 32 |
| LiYO₂ | 1.80E−08 | 0.72 | P2₁/c | 14 | | 45511 | 33 |
| LiBO₂ | 1.00E−08 | 0.71 | P2₁/c | 14 | | 200891 | 34 |
| LiClC₃H₇NO | 1.6E−4 | 0.881 | P2₁/c | 14 | | 238683 | 35 |
| LaLiO₂ | <1E−10 | 0.92 | P2₁/c | 14 | | 239278 | 36 |
| (La_{0.9}Sr_{0.1})LiO₂ | 6.29E−10 | 0.62 | P2₁/c | 14 | | 239279 | 36 |
| La(Li_{0.76}Mg_{0.08})O₂ | 7.27E−10 | 0.66 | P2₁/c | 14 | | 239280 | 36 |
| Li_{2.5}V₂(PO₄)₃ | 1.9E−7 | | P2₁/c | 14 | | 240269 | 37 |
| Li₄Zn(PO₄)₂ | <1E−10 | 1.3 | P2₁/c | 14 | α-Li₄Zn(PO₄)₂ | 255464 | 38 |
| LiSbO₂ | <1E−10 | 0.88 | P2₁/c | 14 | | 262075 | 39 |
| Li₂Sr₂Al(PO₄)₃ | <1E−10 | 1.02 | P2₁/c | 14 | | 431319 | 40 |
| Li₂ZrO₃ | 6.10E−10 | 0.78 | C2/c | 15 | | 94894 | 33 |
| Li₆Zr₂O₇ | 5.20E−10 | 0.68 | C2/c | 15 | | 73835 | 41 |
| Li₃AlF₆ | 5.00E−07 | 0.54 | C2/c | 15 | | 85171 | 42 |
| Li₂SnS₃ | 1.50E−05 | 0.59 | C2/c | 15 | | 251656 | 43 |
| LiTa₂PO₈ | 1.6E−3 | 0.32 | C2/c | 15 | | 267438 | 44 |
| LiBaP₂O₇ | 1.00E−10 | | C2/c | 15 | | 280927 | 45 |
| Li₃Na₅(TiS₄)₂ | 8.80E−06 | 0.4 | C2/c | 15 | | 391258 | 46 |
| LiGd(PO₃)₄ | <1E−10 | 1.7 | C2/c | 15 | | 416442 | 47 |
| LiVO3 | 2.048E−9 | | C2/c | 15 | | 51443 | 48 |
| Li₂CrCl₄ | <1E−10 | 1.22 | C2/c | 15 | | 202627 | 49 |
| Li₃ErI₆ | 9.92E−5 | 0.37 | C2/c | 15 | | | 50 |
| Li_{3.7}Zn_{0.7}Ga_{0.3}(PO₄)₂ | <1E−10 | 0.91 | P2₁2₁2₁ | 19 | β′- | 255466 | 38 |
| | | | | | Li_{3.7}Zn_{0.7}Ga_{0.3}(PO₄)₂ | | |
| Li₃SbS₄ | 1.5E−6 | 0.518 | Pmn2₁ | 31 | | 8407 | 51 |
| Li₃PS₄ | 2.60E−07 | 0.49 | Pmn2₁ | 31 | γ-Li₃PS₄ | 180318 | 52 |
| LiGaO₂ | 2.40E−14 | 0.86 | Pna2₁ | 33 | | 18152 | 53 |
| LiB₆OgF | 5.40E−24 | 1.38 | Pna2₁ | 33 | | 420286 | 54 |
| Li₃SbS₃ | 1.00E−07 | 0.4 | Pna2₁ | 33 | | 424834 | 55 |
| LiSi₂N₃ | 6.17E−08 | 0.64 | Cmc2₁ | 36 | | 34118 | 56 |
| Li₂(PO₂N) | <1E−10 | 0.57 | Cmc2₁ | 36 | | 188493 | 57 |
| LiGa₂GeS₆ | 3.80E−08 | 0.47 | Fdd2 | 43 | | 254406 | 58 |
| La_{0.64}Li_{0.08}TiO₃ | 3.35E−4 | | Pmmm | 47 | | 92228 | 59 |
| La_{0.62}Li_{0.14}TiO₃ | 4.42E−4 | | Pmmm | 47 | | 92231 | 59 |
| La_{0.595}Li_{0.215}TiO₃ | 8.53E−4 | | Pmmm | 47 | | 92234 | 59 |
| Li_{0.4}Na_{0.1}La_{0.5}Nb₂O₆ | 9.92E−6 | | Pmmm | 47 | | 180629 | 60 |
| Li_{0.3}Na_{0.2}La_{0.5}Nb₂O₆ | 1.11E−5 | | Pmmm | 47 | | 180630 | 60 |
| Li_{0.2}Na_{0.3}La_{0.5}Nb₂O₆ | 1.18E−5 | | Pmmm | 47 | | 180631 | 60 |
| Li_{0.1}Na_{0.4}La_{0.5}Nb₂O₆ | 1.21E−5 | | Pmmm | 47 | | 180632 | 60 |
| Li_{0.07}Na_{0.43}La_{0.5}Nb₂O₆ | 1.23E−5 | | Pmmm | 47 | | 180633 | 60 |
| Li_{0.04}Na_{0.46}La_{0.5}Nb₂O₆ | 5.91E−6 | | Pmmm | 47 | | 180634 | 60 |
| Li_{0.02}Na_{0.48}La_{0.5}Nb₂O₆ | 3.99E−6 | | Pmmm | 47 | | 180635 | 60 |
| (Ag_{0.33}Li_{0.67})_{0.27}La_{0.57}TiO₃ | 1E−4 | 0.30 | Pmmm | 47 | | | 61 |
| (Ag_{0.5}Li_{0.5})_{0.27}La_{0.57}TiO₃ | 2.3E−5 | 0.28 | Pmmm | 47 | | | 61 |
| (Ag_{0.67}Li_{0.33})_{0.27}La_{0.57}TiO₃ | 2E−7 | 0.37 | Pmmm | 47 | | | 61 |
| Pr_{0.56}Li_{0.34}TiO_{3.01} | 1E−6 | 0.47 | Pmmm | 47 | | | 62 |
| Nd_{0.55}Li_{0.34}TiO₃ | 8E−7 | 0.53 | Pmmm | 47 | | | 62 |
| Li_{0.09}La_{0.77}TiO₃ | 1.23E−4 | | Pmmm | 47 | | | 63 |
| Li_{0.15}La_{0.72}TiO₃ | 4.14E−4 | | Pmmm | 47 | | | 63 |
| Li_{0.24}La_{0.65}TiO₃ | 5.77E−4 | | Pmmm | 47 | | | 63 |
| Li_{0.12}La_{0.75}TiO₃ | 2.38E−4 | | Pmmm | 47 | | | 63 |
| Li_{0.16}La_{0.7}TiO₃ | 5.21E−4 | | Pmmm | 47 | | | 63 |
| Li_{0.23}La_{0.7}TiO₃ | 5.26E−4 | | Pmmm | 47 | | | 63 |
| Li₅AlO₄ | 5.00E−10 | 0.99 | Pmmn | 59 | | 16229 | 64 |
| Li₁₄Nd₅(Si₁₁N₁₉O₅)O₂F₂ | 1.7E−10 | 0.69 | Pmmn | 59 | | 262923 | 65 |
| Li₅GaO₄ | 5.00E−09 | 0.71 | Pbca | 61 | α-Li₅GaO₄ | 9082 | 64 |
| Li₂SiN₂ | 1.60E−07 | | Pbca | 61 | | 420126 | 66 |
| Li_{6.5}O₈P_{1.5}Si_{0.5} | 4.49E−07 | 0.44 | Pnma | 62 | | 238600 | 16 |
| Li_{3.4}Si_{0.7}S_{0.3}O₄ | 4.21E−7 | | Pnma | 62 | | 47145 | 67 |
| Li_{3.2}Si_{0.6}S_{0.4}O₄ | 1.32E−6 | | Pnma | 62 | | | 67 |
| Li_{3.1}Si_{0.55}S_{0.45}O₄ | 3.14E−7 | | Pnma | 62 | | | 67 |
| Li_{6.6}SiPO₈ | 1.48E−7 | 0.49 | Pnma | 62 | | 238601 | 16 |
| Li_{4.2}Si_{0.8}Al_{0.2}S₄ | 2.40E−8 | 0.53 | Pnma | 62 | | | 18 |
| Li_{4.4}Si_{0.6}Al_{0.4}S₄ | 3.04E−8 | 0.52 | Pnma | 62 | | | 18 |
| Li_{4.6}Si_{0.4}Al_{0.6}S₄ | 1.45E−8 | 0.52 | Pnma | 62 | | | 18 |
| Li_{4.8}Si_{0.2}Al_{0.8}S₄ | 2.25E−7 | 0.52 | Pnma | 62 | | | 18 |
| Li_{3.8}Si_{0.8}Al_{0.2}S₄ | 2.38E−8 | 0.53 | Pnma | 62 | | | 18 |
| Li_{3.6}Si_{0.6}Al_{0.4}S₄ | 3.06E−8 | 0.52 | Pnma | 62 | | | 18 |
| Li_{3.4}Si_{0.4}Al_{0.6}S₄ | 1.45E−8 | 0.52 | Pnma | 62 | | | 18 |
| Li_{3.2}Si_{0.2}Al_{0.8}S₄ | 2.28E−7 | 0.52 | Pnma | 62 | | | 18 |
| Li₄Zn(PO₄)₂ | <1E−10 | 1.1 | Pnma | 62 | β-Li₄Zn(PO₄)₂ | 255465 | 38 |
| Li_{3.5}Zn_{0.5}Ga_{0.5}(PO₄)₂ | <1E−10 | 1.02 | Pnma | 62 | β-Li_{3.5}Zn_{0.5}Ga_{0.5}(PO₄)₂ | 255468 | 38 |
| Li₃PS₄ | 1.60E−04 | 0.36 | Pnma | 62 | β-Li₃PS₄ | 180319 | 52 |
| Li₃PO₄ | <1E−10 | 1.14 | Pnma | 62 | γ-Li₃PO₄ | 20208 | 68 |
| Li₃PS₄ | 3.00E−7 | | Pnma | 62 | γ-Li₃PS₄ | 35018 | 69 |
| Li_{2.88}PO_{3.73}N_{0.14} | 1.4E−13 | 0.97 | Pnma | 62 | | 79426 | 70 |
| Li₃PO₄ | 4.2E−18 | 1.24 | Pnma | 62 | γ-Li₃PO₄ | 79427 | 70 |
| Li₄GeS₄ | 2E−7 | 0.53 | Pnma | 62 | | 92200 | 71 |
| Li₁₄Zn(GeO₄)₄ | 1.00E−06 | 0.24 | Pnma | 62 | | 100169 | 72 |
| Li_{3.75}Ge_{0.75}V_{0.25}O₄ | 5.66E−6 | | Pnma | 62 | | 150918 | 73 |
| Li_{3.70}Ge_{0.85}W_{0.15}O₄ | 3.80E−5 | | Pnma | 62 | | 150920 | 73 |
| Li_{0.2}Ca_{0.4}TaO₃ | 3.53E−9 | 0.54 | Pnma | 62 | | 151936 | 74 |
| Li_{0.2}(Ca_{0.36}Sr_{0.04})TaO₃ | 9.2E−9 | | Pnma | 62 | | 151937 | 74 |
| Li₂Mg₂(MoO₄)₃ | <1E−10 | 0.71 | Pnma | 62 | | 170956 | 75 |
| Li₄SnSe₄ | 2E−5 | 0.45 | Pnma | 62 | | 193768 | 76 |
| Li(BH₄) | 1E−8 | | Pnma | 62 | | 239763 | 77 |
| LiZnSO₄F | 2.80E−05 | 0.2455 | Pnma | 62 | | 261343 | 78 |
| Li₄GeS₄ | 2.00E−07 | 0.53 | Pnma | 62 | | 290831 | 79 |
| Li₄SnS₄ | 7.0E−5 | 0.29 | Pnma | 62 | | 290832 | 80 |
| Li₂ZnI₄ | 4.00E−08 | 0.58 | Pnma | 62 | | 402062 | 81 |
| Pr_{0.53}Li_{0.41}TiO₃ | 0.84E−7 | 0.462 | Pnma | 62 | | | 82 |
| Pr_{0.54}Li_{0.38}TiO₃ | 1.18E−6 | 0.452 | Pnma | 62 | | | 82 |
| Pr_{0.55}Li_{0.35}TiO₃ | 1.51E−6 | 0.441 | Pnma | 62 | | | 82 |
| Pr_{0.56}Li_{0.32}TiO₃ | 1.91E−6 | 0.437 | Pnma | 62 | | | 82 |
| Pr_{0.57}Li_{0.29}TiO₃ | 2.86E−6 | 0.429 | Pnma | 62 | | | 82 |
| Pr_{0.58}Li_{0.26}TiO₃ | 3.87E−6 | 0.421 | Pnma | 62 | | | 82 |
| Pr_{0.59}Li_{0.23}TiO₃ | 3.40E−6 | 0.425 | Pnma | 62 | | | 82 |
| Li_{2.5}Y_{0.5}Zr_{0.5}Cl₆ | 1.4E−3 | 0.33 | Pnma | 62 | | | 83 |
| Li_{2.633}Er_{0.633}Zr_{0.367}Cl₆ | 1.1E−3 | 0.35 | Pnma | 62 | | | 83 |
| Li_{3.33}Ge_{0.33}V_{0.67}O₄ | 6.94E−6 | | Pnma | 62 | | | 84 |
| Li_{3.6}Ge_{0.6}V_{0.4}O₄ | 1.97E−5 | 0.44 | Pnma | 62 | | | 84 |
| Li_{3.75}Ge_{0.75}V_{0.25}O₄ | 1.08E−5 | | Pnma | 62 | | | 84 |
| Li_{3.5}Ge_{0.5}V_{0.5}O₄ | 1.77E−5 | | Pnma | 62 | | 66576 | 84 |
| Li_{3.87}Sn_{0.87}As_{0.13}S₄ | 1.48E−5 | 0.39 | Pnma | 62 | | | 85 |
| Li_{3.855}Sn_{0.855}As_{0.145}S₄ | 1.31E−4 | 0.35 | Pnma | 62 | | | 85 |
| Li_{3.85}Sn_{0.85}As_{0.15}S₄ | 2.08E−4 | 0.31 | Pnma | 62 | | | 85 |
| Li_{3.84}Sn_{0.84}As_{0.16}S₄ | 5.85E−4 | 0.29 | Pnma | 62 | | | 85 |
| Li_{3.83}Sn_{0.83}As_{0.17}S₄ | 1.39E−3 | 0.21 | Pnma | 62 | | | 85 |
| Li_{3.825}Sn_{0.825}As_{0.175}S₄ | 5.18E−4 | 0.27 | Pnma | 62 | | | 85 |
| Li_{3.82}Sn_{0.82}As_{0.18}S₄ | 2.83E−4 | 0.35 | Pnma | 62 | | | 85 |
| Li_{3.8}Sn_{0.8}As_{0.2}S₄ | 1.06E−4 | 0.4 | Pnma | 62 | | | 85 |
| Li_{3.75}Sn_{0.75}As_{0.25}S₄ | 3.69E−6 | 0.48 | Pnma | 62 | | | 85 |
| Nd_{0.54}Li_{0.36}TiO₃ | 3.42E−8 | 0.50 | Pnma | 62 | | 81047 | 86 |
| Pr_{0.51}Li_{0.39}TiO_{2.96} | 5.34E−7 | 0.44 | Pnma | 62 | | 81048 | 86 |
| Sm_{0.52}Li_{0.38}TiO_{2.97} | 2E−7 | 0.64 | Pnma | 62 | | | 62 |
| Li₄GeO₄ | 2.80E−10 | 0.73 | Cmcm | 63 | | 18096 | 87 |
| LiCl*H₂O | 1E−8 | 0.777 | Cmcm | 63 | | 281198 | 88 |
| Li₂MgBr₄ | 7.80E−10 | 0.77 | Cmmm | 65 | | 73276 | 89 |
| Li_{0.22}La_{0.60}TiO₃ | 4.8E−4 | 0.391 | Cmmm | 65 | | | 90 |
| Li_{0.18}La_{0.61}TiO₃ | 2.0E−4 | 0.432 | Cmmm | 65 | | 99398 | 90 |
| LiBiO₂ | 3.80E−08 | 0.1 | Ibam | 72 | | 46022 | 30 |
| Li_{2.5}Zn_{0.25}PS₄ | 8.40E−4 | | I4̅ | 82 | | | 69 |
| LiZnPS₄ | 5.4E−8 | | I4̅ | 82 | | 95785 | 69 |
| Li₂Zn_{0.5}PS₄ | 1.30E−4 | 0.22 | I4̅ | 82 | | 264462 | 69 |
| (Li_{1.69}Zn_{0.66})PS₄ | 1.30E−4 | 0.181 | I4̅ | 82 | | 264462 | 69 |
| Li_{1.5}Zn_{0.75}PS₄ | 1.65E−5 | 0.25 | I4̅ | 82 | | 264463 | 69 |
| (Li_{1.19}Zn_{0.9})PS₄ | 0.65E−5 | 0.25 | I4̅ | 82 | | 264463 | 69 |
| (Li_{0.5}Ce_{0.5})(MoO₄) | 1.3E−8 | 0.4 | I4₁/a | 88 | | 186450 | 91 |
| (Li_{0.5}Ce_{0.25}Pr_{0.25})(MoO₄) | 1E−9 | 0.5 | I4₁/a | 88 | | 186451 | 91 |
| (Li_{0.5}Ce_{0.25}Sm_{0.25})(MoO₄) | 1.8E−10 | 0.5 | I4₁/a | 88 | | 186452 | 91 |
| Li₂TeO₄ | <1E−10 | 1.129 | P4₁22 | 91 | | 1485 | 92 |
| Li₃BN₂ | 1.60E−10 | 0.67 | P4₂2₁2 | 94 | α-Li₃BN₂ | 655673 | 93 |
| Li₂B₄O₇ | 1.00E−10 | | I4₁cd | 110 | | 65930 | 94 |
| LiY(BH₄)₄ | 1.26E−6 | | P4̅2c | 112 | | 239762 | 77 |
| LiPN₂ | 1.6E−7 | 0.40 | I4̅2d | 122 | | 66007 | 95 |
| La_{0.565}Li_{0.305}TiO₃ | 9.57E−4 | | P4/mmm | 123 | | 92235 | 59 |
| La_{0.5}Li_{0.5}TiO₃ | 9.25E−4 | 0.39 | P4/mmm | 123 | | 92236 | 59 |
| Li_{0.33}La_{0.5}TiO₃ | 1E−3 | 0.15 | P4/mmm | 123 | | 82671 | 96 |
| Li_{0.27}La_{0.57}TiO₃ | 3.4E−4 | 0.38 | P4/mmm | 123 | | | 61 |
| La_{0.61}Li_{0.18}TiO3 | 4.12e-4 | | P4/mmm | 123 | | | 97 |
| La_{0.55}Li_{0.36}TiO3 | 6.88E−4 | 0.35 | P4/mmm | 123 | | | 97 |
| La_{0.54}Li_{0.39}TiO3 | 6.51E−4 | | P4/mmm | 123 | | | 97 |
| La_{0.52}Li_{0.45}TiO3 | 5.01E−4 | | P4/mmm | 123 | | 50434 | 97 |
| La_{0.58}Li_{0.27}TiO3 | 5.99E−4 | | P4/mmm | 123 | | 82672 | 97 |
| La_{0.56}Li_{0.33}TiO3 | 6.68E−4 | | P4/mmm | 123 | | 504435 | 97 |
| Li_{0.31}La_{0.63}TiO₃ | 4.11E−4 | | P4/mmm | 123 | | | 63 |
| Li_{0.39}La_{0.59}TiO₃ | 8.83E−4 | | P4/mmm | 123 | | | 63 |
| Li_{0.49}La_{0.55}TiO₃ | 9.39E−4 | | P4/mmm | 123 | | | 63 |
| Li_{0.68}La_{0.49}TiO₃ | 1.03E−3 | | P4/mmm | 123 | | | 63 |
| Li_{0.24}La_{0.65}TiO₃ | 9.57E−4 | | P4/mmm | 123 | | | 63 |
| Li_{0.33}La_{0.58}TiO₃ | 8.93E−4 | | P4/mmm | 123 | | | 63 |
| Li_{0.36}La_{0.55}TiO₃ | 9.34E−4 | | P4/mmm | 123 | | | 63 |
| Li_{0.42}La_{0.52}TiO₃ | 8.47E−4 | | P4/mmm | 123 | | | 63 |
| Li_{0.29}La_{0.57}TiO₃ | 4.4E−5 | 0.453 | P4/mmm | 123 | | | 90 |
| La_{0.56}Li_{0.33}TiO₃ | 1.65E−4 | 0.41 | P4/mmm | 123 | | | 98 |
| La_{0.56}Li_{0.33}TiO₃-5 wt % Al₂O₃ | 1.66E−4 | 0.24 | P4/mmm | 123 | | | 98 |
| La_{0.56}Li_{0.33}TiO₃-10 wt % Al₂O₃ | 9.33E−4 | 0.17 | P4/mmm | 123 | | | 98 |
| La_{0.56}Li_{0.33}TiO₃-15 wt % Al₂O₃ | 9.56E−5 | 0.50 | P4/mmm | 123 | | | 98 |
| Li(LaTiO₄) | <1E−10 | 0.83 | P4/nmm Z | 129 | | 91843 | 99 |
| Li(NdTiO₄) | <1E−10 | 0.87 | P4/nmm Z | 129 | | 91844 | 99 |
| La_{0.65}Li_{0.05}(Mg_{0.5}W_{0.5})O₃ | 1.8E−7 | 0.46 | P4/nmm | 129 | | 151900 | 100 |
| La_{0.63}Li_{0.11}(Mg_{0.5}W_{0.5})O₃ | 6.8E−6 | 0.38 | P4/nmm | 129 | | 151901 | 100 |
| La_{0.62}Li_{0.14}(Mg_{0.5}W_{0.5})O₃ | 1.2E−5 | 0.37 | P4/nmm | 129 | | 151902 | 100 |
| Li₄PS₄I | 1.2E−4 | 0.37 | P4/nmm Z | 129 | | 432169 | 101 |
| Li_{9.75}Sn_{0.75}P_{2.25}S₁₂ | 3.57E−3 | | P4₂/nmc S | 137 | | | |
| Li₆ZnO₄ | 9.40E−09 | 0.61 | P4₂/nmc | 137 | | 62137 | 64 |
| Li_{9.42}Si_{1.02}P_{2.1}S_{9.96}O_{2.04} | 1.1E−4 | 0.238 | P4₂/nmc | 137 | | | 102 |
| Li_{9.54}Si_{1.74}P_{1.44}S_{11.7}C_{l0.3} | 2.53E−2 | 0.238 | P4₂/nmc | 137 | | | 102 |
| Li₁₀GeP₂S_{11.7}O_{0.3} | 1.15E−2 | 0.155 | P4₂/nmc | 137 | | | 102 |
| Li₁₀(Si_{0.5}Sn_{0.5})P₂S₁₂ | 4.28E−3 | 0.29 | P4₂/nmc | 137 | | | 102 |
| Li₉P₃S₉O₃ | 4.27E−5 | 0.311 | P4₂/nmc | 137 | | | 103 |
| Li_{10.05}Ge_{1.05}P_{1.95}S₁₂ | 1.22E−2 | 0.28 | P4₂/nmc4 | 137 | | | 104 |
| Li_{10.2}Ge_{1.2}P_{1.8}S₁₂ | 1.32E−2 | | P4₂/nmc4 | 137 | | | 104 |
| Li_{10.5}Ge_{1.5}P_{1.5}S₁₂ | 1.10E−2 | | P4₂/nmc4 | 137 | | | 104 |
| Li₁₀GePS₁₂ | 1.21E−2 | | P4₂/nmc | 137 | | 188887 | 104 |
| Li_{10.35}Ge_{1.35}P_{1.65}S₁₂ | 1.44E−2 | 0.269 | P4₂/nmc S | 137 | | 193947 | 104 |
| Li_{3.475}Si_{0.475}P_{0.525}S₄ | 5.27E−3 | | P4₂/nmc | 137 | | | 105 |
| Li_{3.45}Si_{0.45}P_{0.55}S₄ | 6.73E−3 | 0.27 | P4₂/nmc | 137 | | | 105 |
| Li_{3.425}Si_{0.425}P_{0.575}S₄ | 5.65E−3 | | P4₂/nmc | 137 | | | 105 |
| Li_{3.4}Si_{0.4}P_{0.6}S₄ | 4.21E−3 | | P4₂/nmc | 137 | | | 105 |
| Li_{3.335}Sn_{0.33}P_{0.67}S₄ | 3.73E−3 | | P4₂/nmc | 137 | | | 105 |
| Li_{3.3}Sn_{0.3}P_{0.7}S₄ | 3.65E−3 | | P4₂/nmc | 137 | | | 105 |
| Li_{3.285}Sn_{0.28}P_{0.72}S₄ | 4.36E−3 | | P4₂/nmc | 137 | | | 105 |
| Li_{3.27}Sn_{0.27}P_{0.73}S₄ | 4.96E−3 | | P4₂/nmc | 137 | | | 105 |
| Li_{3.26}Sn_{0.26}P_{0.74}S₄ | 4.53E−3 | | P4₂/nmc | 137 | | | 105 |
| Li_{3.25}Sn_{0.25}P_{0.75}S₄ | 3.6E−3 | | P4₂/nmc | 137 | | | 105 |
| Li₁₀SiP₂S₁₂ | 2.3E−3 | 0.196 | P4₂/nmc | 137 | | | 106 |
| Li₁₀SnP₂S₁₂ | 7E−3 | 0.27 | P4₂/nmc C | 137 | | 193755 | 107 |
| Li₁₀GeP₂S₁₂ | 2.46E−2 | 0.274 | P4₂/nmc | 137 | | 241439 | 108 |
| Li₁₀(Ge_{0.776}Sn_{0.224})P₂S₁₂ | 1.41E−2 | 0.276 | P4₂/nmc | 137 | | 255748 | 108 |
| Li₁₀SnP₂S₁₂ | 3.98E−3 | 0.305 | P4₂/nmc | 137 | | 255750 | 108 |
| Li₁₀(Ge_{0.416}Sn_{0.584})P₂S₁₂ | 7.43E−3 | 0.285 | P4₂/nmc | 137 | | 255757 | 108 |
| Li_{10.35}Si_{1.35}P_{1.65}S₁₂ | 6.5E−3 | | P4₂/nmc S | 137 | | 252037 | 109 |
| Li_{9.81}Sn_{0.81}P_{2.19}S₁₂ | 5.5E−3 | | P4₂/nmc | 137 | | 252040 | 109 |
| Li₁₀GeP₂S₁₂ | 1.20E−02 | 0.25 | P4₂/nmc | 137 | | 255749 | 110 |
| Li_{10.2}Si_{1.2}P_{1.8}S₁₂ | 4.16E−3 | | P4₂/nmc S | 137 | | | 111 |
| Li_{10.275}Si_{1.275}P_{1.725}S₁₂ | 5.61E−3 | | P4₂/nmc S | 137 | | | 111 |
| Li_{10.35}Si_{1.35}P_{1.65}S₁₂ | 6.68E−3 | | P4₂/nmc S | 137 | | | 111 |
| Li_{10.425}Si_{1.425}P_{1.575}S₁₂ | 5.22E−3 | | P4₂/nmc S | 137 | | | 111 |
| Li10GeP₂S₁₂ | 1.21E−2 | | P4₂/nmc S | 137 | | | 111 |
| Li_{10.05}Ge_{1.05}P_{1.95}S₁₂ | 1.25E−2 | | P4₂/nmc S | 137 | | | 111 |
| Li_{10.2}Ge_{1.2}P_{1.8}S₁₂ | 1.36E−2 | | P4₂/nmc S | 137 | | | 111 |
| Li_{10.35}Ge_{1.35}P_{1.65}S₁₂ | 1.41E−2 | | P4₂/nmc S | 137 | | | 111 |
| Li_{10.5}Ge_{1.5}P_{1.5}S₁₂ | 1.09E−2 | | P4₂/nmc S | 137 | | | 111 |
| Li_{9.79}Sn_{0.79}P_{2.21}S₁₂ | 4.56E−3 | | P4₂/nmc S | 137 | | | 111 |
| Li_{9.81}Sn_{0.81}P_{2.19}S₁₂ | 4.98E−3 | | P4₂/nmc S | 137 | | | 111 |
| Li_{9.87}Sn_{0.87}P_{2.13}S₁₂ | 4.32E−3 | | P4₂/nmc S | 137 | | | 111 |
| Li_{9.9}Sn_{0.9}P_{2.1}S₁₂ | 3.66E−3 | | P4₂/nmc S | 137 | | | 111 |
| Li₁₀SnP₂S₁₂ | 3.65E−3 | | P4₂/nmc S | 137 | | | 111 |
| Li_{10.2}(Sn_{0.2}Si_{0.8})1.2P_{1.8}S₁₂ | 7.82E−3 | | P4₂/nmc S | 137 | | 5667 | 111 |
| Li_{10.5}(Sn_{0.2}Si_{0.8})_{1.5}P_{1.5}S₁₂ | 8.79E−3 | | P4₂/nmc S | 137 | | 5668 | 111 |
| Li_{10.35}(Sn_{0.2}Si_{0.8})_{1.35}P_{1.65}S₁₂ | 1.08E−2 | | P4₂/nmc S | 137 | | 5669 | 111 |
| Li_{10.35}(Sn_{0.27}Si_{1.08})P_{1.65}S₁₂ | 1.1E−3 | 0.197 | P4₂/nmc S | 137 | | 257946 | 111 |
| Li_{10.2}(Sn_{0.2}Si_{0.8})_{1.2}P_{1.8}S₁₂ | 2.69E−3 | | P4₂/nmc S | 137 | | 257948 | 111 |
| Li₁₀GeP₂S₁₂ | 1.43E−3 | 0.24 | P4₂/nmc S | 137 | | | 112 |
| Li_{9.8}Ba_{0.1}GeP₂S₁₂ | 5.61E−4 | | P4₂/nmc S | 137 | | | 112 |
| Li_{9.6}Ba_{0.2}GeP₂S₁₂ | 5.72E−4 | | P4₂/nmc S | 137 | | | 112 |
| Li_{9.4}Ba_{0.3}GeP₂S₁₂ | 7.07E−4 | 0.29 | P4₂/nmc S | 137 | | | 112 |
| Li_{9.2}Ba_{0.4}GeP₂S₁₂ | 3.16E−4 | | P4₂/nmc S | 137 | | | 112 |
| Li₉Ba_{0.5}GeP₂S₁₂ | 9.98E−5 | | P4₂/nmc S | 137 | | | 112 |
| Li₁₀GeP₂S₁₂ | 5.0E−3 | 0.35 | P4₂/nmc | 137 | | | 113 |
| LiIaNb₂O₇ | <1E−8 | | I4/mmm | 139 | | 72566 | 114 |
| Li₄Sr₃Nb_{5.77}Fe_{0.23}O_{19.77} | <1E−10 | | I4/mmm | 139 | | 87823 | 115 |
| Li₄Sr₃Nb₆O₂₀ | <1E−10 | | I4/mmm | 139 | | 87824 | 115 |
| Li₄Sr_{3.056}Nb₆O₂₀ | <1E−10 | 0.74 | I4/mmm | 139 | | 109168 | 115 |
| LiScO₂ | 1.00E−12 | 0.87 | I4₁/amd | 141 | | 36124 | 33 |
| r-LiAlO₂ | 1.10E−12 | 0.97 | I4₁/amd | 141 | | 99517 | 33 |
| Li₃BN₂ | 8.70E−08 | 0.55 | I4₁/amd | 141 | β-Li₃BN₂ | 155126 | 93 |
| Li₄SrN₂ | 2.30E−13 | 0.9 | I4₁/amd | 141 | | 87413 | 116 |
| LiScO₂ | <1E−10 | 1.047 | I4₁/amd | 141 | | 257819 | 117 |
| Li_{0.9}SC_{0.9}Zr_{0.1}O₂ | <1E−10 | 0.912 | I4₁/amd | 141 | | 257820 | 117 |
| Li₇La₃HfO₁₂ | 9.85E−7 | 0.53 | I4₁/acdZ | 142 | “tetragonal-LLHO” | 174202 | 118 |
| Li₇LasZr₂O₁₂ | 1.63E−6 | 0.54 | I4₁/acdZ | 142 | “tetraganol-LLZO” | 183684 | 119 |
| Li₇La₃Zr₂O₁₂ | 5E−7 | 0.59 | I4₁/acdZ | 142 | | | 120 |
| Li₇La₃Zr₂O₁₂ | 9.9E−6 | 0.43 | I4₁/acdZ | 142 | | 238687 | 121 |
| LiGaSiO₄ | 3.00E−16 | 0.9 | R3H | 146 | | 65125 | 122 |
| LiGa_{0.5}Al_{0.5}GeO₄ | <1E−10 | 1.06 | R3H | 146 | | 257740 | 123 |
| LiAlGeO₄ | <1E−10 | 0.97 | R3H | 146 | | 257741 | 123 |
| LiGaGeO₄ | <1E−10 | 1.12 | R3̅ | 148 | | 257739 | 123 |
| LiTi₂(PO₄)₃ | 1.61E−4 | 0.21 | R3̅ | 148 | | | 124 |
| Li_{1.2}Ti_{1.8}Al_{0.2}(PO₄)₃ | 4.82E−3 | 0.18 | R3̅ | 148 | | | 124 |
| LiNaSO₄ | 8.80E−10 | | P31c | 159 | | 14364 | 125 |
| Li_{3.333}Mg_{0.333}P₂S₆ | 8.20E−8 | 0.517 | P3̅1m | 162 | | 95606 | 126 |
| Li_{2.667}Mg_{0.667}P₂S₆ | 4.00E−06 | 0.46 | P3̅1m | 162 | | 95607 | 126 |
| Li₄P₂S₆ | 2.38E−07 | 0.29 | P3̅1m | 162 | | 242170 | 127 |
| Li₄P₂S₆ | 1.6E−10 | 0.48 | P3̅1m | 162 | | | 128 |
| Li₃YCl₆ | 5.39E−4 | 0.40 | P3̅m1 | 164 | | | 26 |
| Li₃ErCl₆ | 3.3E−4 | 0.41 | P3̅m1 | 164 | | 50151 | 129 |
| Li_{4.4}Al_{0.4}Ge_{0.6}S₄ | 4.33E−5 | 0.38 | P3̅m1 | 164 | | 235201 | 130 |
| Li_{4.4}Al_{0.4}Sn_{0.6}S₄ | 3.6E−6 | 0.15 | P3̅m1 | 164 | | 235207 | 130 |
| Li₅NCl₂ | 1.20E−06 | 0.5 | R3̅m | 166 | | 84763 | 131 |
| LiHf₂(PO₄)₃ | 2.833E−7 | | R3̅cH | 167 | | | 2 |
| LiZr₂(PO₄)₃ | 2.96E−10 | | R3̅cH | 167 | | 201935 | 2 |
| LiGe₂(PO₄)₃ | 3.33E−7 | | R3̅cH | 167 | | 263767 | 2 |
| Li_{1.1}Ti_{1.9}Sc_{0.1}(PO₄)₃ | 3.89E−4 | 0.3 | R3̅cH | 167 | | | 132 |
| Li_{1.2}Ti_{1.8}Sc_{0.2}(PO₄)₃ | 2.51E−3 | 0.25 | R3̅cH | 167 | | | 132 |
| Li_{1.3}Ti_{1.7}Sc_{0.3}(PO₄)₃ | 7.91E−4 | 0.28 | R3̅cH | 167 | | | 132 |
| Li_{1.4}Ti_{1.6}Sc_{0.4}(PO₄)₃ | 1.99E−4 | 0.31 | R3̅cH | 167 | | | 132 |
| Li_{1.5}Ti_{1.5}Sc_{0.5}(PO₄)₃ | 9.74E−5 | 0.32 | R3̅cH | 167 | | | 132 |
| LiTi₂(PO₄)₃ | 7.61E−6 | 0.38 | R3̅cH | 167 | | 95979 | 132 |
| LiGe₂(PO₄)₃ | 4.83E−9 | 0.654 | R3̅cH | 167 | | 69763 | 133 |
| Li_{1.2}Al_{0.2}Ge_{1.8}(PO₄)₃ | 4.83E−5 | 0.387 | R3̅cH | 167 | | 263760 | 133 |
| Li_{1.4}A_{10.4}Ge_{1.6}(PO₄)₃ | 1.88E−4 | 0.407 | R3̅cH | 167 | | 263762 | 133 |
| Li_{1.5}A_{10.5}Ge_{1.5}(PO₄)₃ | 3.36E−4 | 0.426 | R3̅cH | 167 | | 263763 | 133 |
| Li_{1.7}Al_{0.7}Ge_{1.3}(PO₄)₃ | 2.64E−4 | 0.450 | R3̅cH | 167 | | 263765 | 133 |
| Li_{1.8}Al_{0.8}Ge_{1.2}(PO₄)₃ | 1.37E−4 | 0.429 | R3̅cH | 167 | | 263766 | 133 |
| LiTi₂(PO₄)₃ | 1.0E−4 | | R3̅cH | 167 | | | 134 |
| Li_{1.2}Ti₂Si_{0.2}P_{2.8}O₁₂ | 8.6E−5 | | R3̅cH | 167 | | | 134 |
| Li_{1.3}Ti₂Si_{0.3}P_{2.7}O₁₂ | 3.2E−4 | | R3̅cH | 167 | | | 134 |
| Li_{1.4}Ti₂Si_{0.4}P_{2.6}O₁₂ | 1.5E−4 | | R3̅cH | 167 | | | 134 |
| Li_{1.5}Ti₂Si_{0.5}P_{2.5}O₁₂ | 9.6E−5 | | R3̅cH | 167 | | | 134 |
| Li_{1.3}Al_{0.3}Ti_{1.7}(PO₄)₃ | 3E−3 | | R3̅cH | 167 | | | 134 |
| Li_{1.4}Al_{0.4}Ti_{1.6}(PO₄)₃ | 3.88E−4 | | R3̅cH | 167 | | | 134 |
| Li_{1.5}Al_{0.5}Ti_{1.5}(PO₄)₃ | 2.48E−4 | | R3̅cH | 167 | | | 134 |
| Li_{1.2}Cr_{0.2}Ti_{1.8}(PO₄)₃ | 1.82E−5 | | R3̅cH | 167 | | | 134 |
| Li_{1.3}Cr_{0.3}Ti_{1.7}(PO₄)₃ | 3.51E−5 | | R3̅cH | 167 | | | 134 |
| Li_{1.4}Cr_{0.4}Ti_{1.6}(PO₄)₃ | 1.49E−4 | | R3̅cH | 167 | | | 134 |
| Li_{1.5}Cr_{0.5}Ti_{1.5}(PO₄)₃ | 3.86E−4 | | R3̅cH | 167 | | | 134 |
| Li_{1.6}Cr_{0.6}Ti_{1.4}(PO₄)₃ | 1.26E−4 | | R3̅cH | 167 | | | 134 |
| Li_{1.7}Cr_{0.7}Ti_{1.3}(PO₄)₃ | 8.05E−6 | | R3̅cH | 167 | | | 134 |
| Li_{1.2}Ga_{0.2}Ti_{1.8}(PO₄)₃ | 1.62E−4 | | R3̅cH | 167 | | | 134 |
| Li_{1.3}Ga_{0.3}Ti_{1.7}(PO₄)₃ | 2.61E−4 | | R3̅cH | 167 | | | 134 |
| Li_{1.4}Ga_{0.4}Ti_{1.6}(PO₄)₃ | 1.28E−4 | | R3̅cH | 167 | | | 134 |
| Li_{1.5}Ga_{0.5}Ti_{1.5}(PO₄)₃ | 1.22E−4 | | R3̅cH | 167 | | | 134 |
| Li_{1.2}Fe_{0.2}Ti_{1.8}(PO₄)₃ | 1.80E−4 | | R3̅cH | 167 | | | 134 |
| Li_{1.3}Fe_{0.3}Ti_{1.7}(PO₄)₃ | 2.46E−4 | | R3̅cH | 167 | | | 134 |
| Li_{1.4}Fe_{0.4}Ti_{1.6}(PO₄)₃ | 3.92E−4 | | R3̅cH | 167 | | | 134 |
| Li_{1.2}Sc_{0.2}Ti_{1.8}(PO₄)₃ | 6.90E−4 | | R3̅cH | 167 | | | 134 |
| Li_{1.3}Sc_{0.3}Ti_{1.7}(PO₄)₃ | 7.03E−4 | | R3̅cH | 167 | | | 134 |
| Li_{1.4}Sc_{0.4}Ti_{1.6}(PO₄)₃ | 5.15E−4 | | R3̅cH | 167 | | | 134 |
| Li_{1.5}Sc_{0.5}Ti_{1.5}(PO₄)₃ | 2.53E−4 | | R3̅cH | 167 | | | 134 |
| Li_{1.2}In_{0.2}Ti_{1.8}(PO₄)₃ | 3.90E−4 | | R3̅cH | 167 | | | 134 |
| Li_{1.3}In_{0.3}Ti_{1.7}(PO₄)₃ | 3.93E−4 | | R3̅cH | 167 | | | 134 |
| Li_{1.4}In_{0.4}Ti_{1.6}(PO₄)₃ | 3.02E−4 | | R3̅cH | 167 | | | 134 |
| Li_{1.5}In_{0.5}Ti_{1.5}(PO₄)₃ | 2.04E−4 | | R3̅cH | 167 | | | 134 |
| Li_{1.2}La_{0.2}Ti_{1.8}(PO₄)₃ | 8.00E−5 | | R3̅cH | 167 | | | 134 |
| Li_{1.3}La_{0.3}Ti_{1.7}(PO₄)₃ | 5.23E−4 | | R3̅cH | 167 | | | 134 |
| Li_{1.4}La_{0.4}Ti_{1.6}(PO₄)₃ | 4.98E−4 | | R3̅cH | 167 | | | 134 |
| Li_{1.5}La_{0.5}Ti_{1.5}(PO₄)₃ | 2.81E−4 | | R3̅cH | 167 | | | 134 |
| Li_{1.5}Fe_{0.5}Ti_{1.5}(PO₄)₃ | 1.74E−4 | | R3̅cH | 167 | | 55751 | 134 |
| Li_{0.87}Hf_{2.032}P₃O₁₂ | 1.29E−05 | 0.33 | R3̅cH | 167 | | 83501 | 134 |
| Li_{1.2}Al_{0.2}Ti_{1.8}(PO₄)₃ | 5.95E−4 | | R3̅cH | 167 | | 427621 | 134 |
| Li(Ti_{1.4}Sn_{0.6})(PO₄)₃ | 2.28E−5 | 0.32 | R3̅cH | 167 | | 183672 | 135 |
| Li(Ti_{0.6}Sn_{1.4})(PO₄)₃ | 9.42E−6 | | R3̅cH | 167 | | 183676 | 135 |
| Li(Ti_{0.4}Sn_{1.6})(PO₄)₃ | 3.15E−6 | | R3̅cH | 167 | | 183677 | 135 |
| Li_{1.15}Y_{0.15}Zr_{1.85}(PO₄)₃ | 1.4E−4 | 0.39 | R3̅cH | 167 | | 191891 | 136 |
| LiZr2(PO4)3 | 1E−9 | 0.76 | R3̅cH | 167 | | 201935 | 137 |
| Li_{1.3}(Al_{0.3}Ti_{1.7})(PO₄)₃ | 8.02E−7 | | R3̅cH | 167 | | 253240 | 138 |
| Li_{1.3}(Al_{0.23}Ga_{0.07}Ti_{1.7})(PO₄)₃ | 4.46E−6 | | R3̅cH | 167 | | 253241 | 138 |
| Li_{1.3}(Al_{0.23}Sc_{0.07}Ti_{1.7})(PO₄)₃ | 1.94E−7 | | R3̅cH | 167 | | 253242 | 138 |
| Li_{1.3}(Al_{0.23}Y_{0.07}Ti_{1.7})(PO₄)₃ | 3.84E−8 | | R3̅cH | 167 | | 253243 | 138 |
| Li_{1.3}Al_{0.3}Ti_{1.7}(PO₄)₃ | 7E−4 | | R3̅cH | 167 | | 257190 | 139 |
| LiZr₂(PO₄)₃ | 8.5E−5 | | R3̅cH | 167 | | | 140 |
| Li_{1.025}Y_{0.025}Zr_{1.975}(PO₄)₃ | 1.28E−4 | | R3̅cH | 167 | | | 140 |
| Li_{1.05}Y_{0.05}Zr_{1.95}(PO₄)₃ | 1.3E−4 | | R3̅cH | 167 | | | 140 |
| Li_{1.1}Y_{0.1}Zr_{1.9}(PO₄)₃ | 1.0E−4 | | R3̅cH | 167 | | | 140 |
| Li_{1.1}Al_{0.1}Ge1_{.9}(PO₄)₃ | 1.29E−5 | | R3̅cH | 167 | | | 140 |
| Li_{1.2}Al_{0.2}Ge1_{.8}(PO₄)₃ | 1.89E−5 | 0.46 | R3̅cH | 167 | | | 140 |
| Li_{1.3}Al_{0.3}Ge1_{.7}(PO₄)₃ | 1.91E−4 | | R3̅cH | 167 | | | 140 |
| Li_{1.4}Al_{0.4}Ge1_{.6}(PO₄)₃ | 3.17E−4 | 0.37 | R3̅cH | 167 | | | 140 |
| Li_{1.5}Al_{0.5}Ge1_{.5}(PO₄)₃ | 3.45E−4 | | R3̅cH | 167 | | | 140 |
| Li_{1.6}Al_{0.6}Ge1_{.4}(PO₄)₃ | 3.94E−4 | 0.37 | R3̅cH | 167 | | | 140 |
| Li_{1.7}Al_{0.7}Ge1_{.3}(PO₄)₃ | 2.75E−4 | | R3̅cH | 167 | | | 140 |
| Li_{1.8}Al_{0.8}Ge1_{.2}(PO₄)₃ | 1.23E−4 | 0.43 | R3̅cH | 167 | | | 140 |
| LiGe₂(PO₄)₃ | 3.12E−9 | 0.60 | R3̅cH | 167 | | | 141 |
| Li_{0.86}Hf_{2.035}(PO₄)₃ | 9.2E−8 | 0.48 | R3̅cH | 167 | | | 11 |
| Li_{1.7}Al_{0.3}Ti_{1.6}(PO₄)₃ | 5E−5 | | R3̅cH | 167 | | | 142 |
| Li_{1.2}In_{0.2}Ti_{1.8}(PO₄)₃ | 8.22E−5 | 0.32 | R3̅cH | 167 | | | 143 |
| Li_{1.3}Al_{0.2}Sc_{0.1}Ti_{1.7}(PO₄)₃ | 9.72E−4 | 0.25 | R3̅cH | 167 | | | 144 |
| Li_{1.3}Al_{0.15}Sc_{0.15}Ti_{1.7}(PO₄)₃ | 1.24E−3 | 0.23 | R3̅cH | 167 | | | 144 |
| Li_{1.3}Al_{0.1}Sc_{0.2}Ti_{1.7}(PO₄)₃ | 4.29E−4 | 0.26 | R3̅cH | 167 | | | 144 |
| Li_{1.3}Sc_{0.3}Ti_{1.7}(PO₄)₃ | 4.52E−4 | 0.25 | R3̅cH | 167 | | | 144 |
| Li_{1.3}Al_{0.3}Ti_{1.7}(PO₄)₃ | 1.13E−3 | 0.23 | R3̅cH | 167 | | 257190 | 144 |
| LiTi(PO₄)₃ | 6E−5 | 0.33 | R3̅c | 167 | | | 145 |
| Li_{1.05}Al_{0.05}Ti_{0.95}(PO₄)₃ | 1.1E−3 | 0.31 | R3̅c | 167 | | | 145 |
| Li_{1.1}Al_{0.1}Ti_{0.9}(PO₄)₃ | 6.7E−4 | 0.32 | R3̅c | 167 | | | 145 |
| Li_{1.2}Al_{0.2}Ti_{0.8}(PO₄)₃ | 4.0E−3 | 0.31 | R3̅c | 167 | | | 145 |
| Li_{1.3}Al_{0.3}Ti_{0.7}(PO₄)₃ | 6.2E−3 | 0.30 | R3̅c | 167 | | | 145 |
| Li_{1.4}Al_{0.4}Ti_{0.6}(PO₄)₃ | 3.3E−3 | 0.29 | R3̅c | 167 | | | 145 |
| Li_{1.05}Cr_{0.05}Ti_{0.95}(PO₄)₃ | 1.8E−4 | 0.33 | R3̅c | 167 | | | 145 |
| Li_{1.1}Cr_{0.1}Ti_{0.9}(PO₄)₃ | 2.6E−4 | 0.32 | R3̅c | 167 | | | 145 |
| Li_{1.2}Cr_{0.2}Ti_{0.8}(PO₄)₃ | 4.3E−4 | 0.31 | R3̅c | 167 | | | 145 |
| Li_{1.3}Cr_{0.3}Ti_{0.7}(PO₄)₃ | 2.9E−4 | 0.32 | R3̅c | 167 | | | 145 |
| Li_{1.05}Fe_{0.05}Ti_{0.95}(PO₄)₃ | 1.3E−4 | 0.34 | R3̅c | 167 | | | 145 |
| Li_{1.1}Fe_{0.1}Ti_{0.9}(PO₄)₃ | 6.3E−4 | 0.34 | R3̅c | 167 | | | 145 |
| Li_{1.2}Fe_{0.2}Ti_{0.8}(PO₄)₃ | 1.4E−3 | 0.32 | R3̅c | 167 | | | 145 |
| Li_{1.3}Fe_{0.3}Ti_{0.7}(PO₄)₃ | 2.3E−3 | 0.31 | R3̅c | 167 | | | 145 |
| Li_{1.5}Fe_{0.5}Ti_{0.5}(PO₄)₃ | 2.7E−4 | 0.32 | R3̅c | 167 | | | 145 |
| LiGe₂(PO₄)₃ | 3.37E−7 | 0.38 | R3̅c | 167 | | | 146 |
| Li_{1.3}Al_{0.3}Ge_{1.7}(PO₄)₃ | 1.42E−4 | 0.37 | R3̅c | 167 | | | 146 |
| Li_{1.7}Al_{0.7}Ge_{1.3}(PO₄)₃ | 2.04E−4 | | R3̅c | 167 | | | 146 |
| Li_{1.3}Cr_{0.3}Ge_{1.7}(PO₄)₃ | 8.87E−5 | 0.39 | R3̅c | 167 | | | 146 |
| Li_{1.5}Cr_{0.5}Ge_{1.5}(PO₄)₃ | 1.21E−4 | 0.37 | R3̅c | 167 | | | 146 |
| Li_{1.7}Cr_{0.7}Ge_{1.3}(PO₄)₃ | 2.46E−5 | | R3̅c | 167 | | | 146 |
| Li_{1.3}Ga_{0.3}Ge_{1.7}(PO₄)₃ | 4.47E−5 | 0.38 | R3̅c | 167 | | | 146 |
| Li_{1.5}Ga_{0.5}Ge_{1.5}(PO₄)₃ | 2.01E−5 | | R3̅c | 167 | | | 146 |
| Li_{1.3}Fe_{0.3}Ge_{1.7}(PO₄)₃ | 2.99E−5 | 0.39 | R3̅c | 167 | | | 146 |
| Li_{1.5}Fe_{0.5}Ge_{1.5}(PO₄)₃ | 2.56E−5 | | R3̅c | 167 | | | 146 |
| Li_{1.3}Sc_{0.3}Ge_{1.7}(PO₄)₃ | 5.59E−5 | | R3̅c | 167 | | | 146 |
| Li_{1.3}In_{0.3}Ge_{1.7}(PO₄)₃ | 9.22E−6 | | R3̅c | 167 | | | 146 |
| Li_{1.5}In_{0.5}Ge_{1.5}(PO₄)₃ | 5.81E−6 | | R3̅c | 167 | | | 146 |
| Li_{1.5}Al_{0.5}Ge_{1.5}(PO₄)₃ | 2.86E−4 | 0.38 | R3̅c | 167 | | 263764 | 146 |
| LiIO₃ | 1.90E−07 | | P6₃ | 173 | | 35473 | 147 |
| Li₉Mg₃(PO₄)₄F₃ | <1E−10 | 0.835 | P6₃ | 173 | | 426103 | 148 |
| Pb_{6.12}Ca_{1.9}Li_{1.96}(PO₄)₆ | <1E−10 | 1.05 | P6₃/m | 176 | | 59615 | 149 |
| LiNdSiO₄ | <1E−10 | | P6₃/m | 176 | | | 150 |
| LiDySiO₄ | <1E−10 | | P6₃/m | 176 | | | 150 |
| Li₂La₈Si₆O₂₅ | <1E−10 | | P6₃/m | 176 | | | 150 |
| Li₃La₇Si₆O₂₄ | <1E−10 | | P6₃/m | 176 | | | 150 |
| Li_{0.284}Sm_{4.512}Si₃O_{12.91} | <1E−10 | | P6₃/m | 176 | | 83279 | 150 |
| LiLa₉Si₆O₂₆ | <1E−10 | | P6₃/m | 176 | | 291218 | 150 |
| LiEu₉Si₆O₂₆ | <1E−10 | | P6₃/m | 176 | | 291220 | 150 |
| LiAlSiO₄ | 2.00E−09 | 0.68 | P6₄22 | 181 | | 55665 | 151 |
| Li₃(NH₂)₂I | 1E−5 | 0.58 | P6₃mc | 186 | | 167528 | 152 |
| Ba₃LiTa₅ZrSi₄O₂₆ | <1E−10 | 0.79 | P6̅2m | 189 | | 239277 | 153 |
| Li₃N | 1.2E−3 | 0.25 | P6/mmm | 191 | | 26540 | 154 |
| Li₃N | 3.00E−04 | 0.26 | P6/mmm | 191 | | 156894 | 155 |
| Fe₂Na₂K(Li₃Si₁₂O₃₀) | <1E−10 | 1.22 | P6/mcc | 192 | | 235750 | 156 |
| Li₃P | 7.03E−4 | 0.18 | P6₃/mmc | 194 | | 642223 | 157 |
| Li_{5.5}K_{0.25}La_{2.75}Nb₂O₁₂ | 3.19E−3 | 0.49 | I2₁3 | 199 | | | 158 |
| Li_{5.5}La₃Nb_{1.75}In_{0.25}O₁₂ | 8.07E−3 | 0.49 | I2₁3 | 199 | | | 158 |
| Li₆BaLa₂Nb₂O₁₂ | 6E−6 | 0.44 | I2₁3 | 199 | | | 159 |
| Li₅La₃Nb₂O₁₂ | 8E−6 | 0.43 | I2₁3 | 199 | | 54865 | 159 |
| (K_{0.1}Li_{0.9})(SbO₃) | 1.36E−8 | | Pn3̅Z | 201 | | 200984 | 160 |
| Li₈GeP₄ | 1.8E−5 | 0.435 | Pa3̅ | 205 | α-Li₈GeP₄ | 235184 | 161 |
| Li₈SiP₄ | 4.5E−5 | 0.404 | Pa3̅ | 205 | | 235186 | 161 |
| Li₃AlN₂ | 5.00E−08 | 0.45 | Ia3̅ | 206 | | 257464 | 162 |
| Li₂MgTi₃O₈ | <1E−10 | 0.71 | P4₃32 | 212 | | 86165 | 163 |
| Li₂CoTi₃O₈ | <1E−10 | 1.33 | P4₃32 | 212 | | 86166 | 163 |
| Li₂CoGe₃O₈ | <1E−10 | 1.49 | P4₃32 | 212 | | 86167 | 163 |
| Li₂ZnGe₃O₈ | <1E−10 | 2.14 | P4₃32 | 212 | | 86169 | 163 |
| (Li_{0.61}Mg_{0.39})(Li_{0.46}Mg_{0.005}Ti_{0.035})Ti_{1.5}O₄ | 6.56E−10 | 0.685 | P4₃32 | 212 | | 168144 | 164 |
| (Li_{0.55}Mg_{0.45})(Li_{0.445}Mg_{0.055})Ti_{1.5}O₄ | 1.53E−11 | 0.786 | P4₃32 | 212 | | 168145 | 164 |
| Li₅NI₂ | 4.00E−6 | | F4̅3m | 216 | | 16800 | 165 |
| Li₂VCl₄ | 6.95E−6 | | F4̅3m | 216 | | 74959 | 166 |
| Li₆PS₅C_{l0.25}Br_{0.75} | 1.86E−3 | 0.328 | F4̅3m | 216 | | | 167 |
| Li₆PS₅Cl | 2.05E−3 | 0.452 | F4̅3m | 216 | | 259200 | 167 |
| Li₆PS₅Cl_{0.5}Br_{0.5} | 3.33E−3 | 0.367 | F4̅3m | 216 | | 259201 | 167 |
| Li₆PS₅Br | 1.15E−3 | 0.303 | F4̅3m | 216 | | 259202 | 167 |
| Li₆PS₅Br_{0.5}I_{0.5} | 2.62E−5 | 0.312 | F4̅3m | 216 | | 259203 | 167 |
| Li₆PS₅I | 1.3E−6 | 0.383 | F4̅3m | 216 | | 259204 | 167 |
| Li₆PS₅Cl_{0.75}Br_{0.25} | 2.26E−3 | 0.408 | F4̅3m | 216 | | 259206 | 167 |
| Li₆PS₅Br_{0.75}I_{0.25} | 1.12E−4 | 0.321 | F4̅3m | 216 | | 259209 | 167 |
| Li₆PS₅Br_{0.25}I_{0.75} | 4.72E−6 | 0.351 | F4̅3m | 216 | | 259211 | 167 |
| Li₆PS₅Br | 7.01E−4 | 0.194 | F4̅3m | 216 | | 234584 | 168 |
| Li_{6.025}P_{0.975}Si_{0.025}S₅Br | 8.78E−4 | 0.196 | F4̅3m | 216 | | 234585 | 168 |
| Li_{6.05}P_{0.95}Si_{0.05}S₅Br | 4.37E−4 | 0.173 | F4̅3m | 216 | | 234586 | 168 |
| Li_{6.075}P_{0.925}Si_{0.075}S₅Br | 8.73E−4 | 0.178 | F4̅3m | 216 | | 234587 | 168 |
| Li_{6.1}P_{0.95}Si_{0.1}S₅Br | 7.99E−4 | 0.22 | F4̅3m | 216 | | 234588 | 168 |
| Li_{6.125}P_{0.875}Si_{0.125}S₅Br | 9.02E−4 | 0.189 | F4̅3m | 216 | | 234589 | 168 |
| Li_{6.175}P_{0.825}Si_{0.175}S₅Br | 9.31E−4 | 0.142 | F4̅3m | 216 | | 234591 | 168 |
| Li_{6.2}P_{0.8}Si_{0.2}S₅Br | 1.69E−3 | 0.25 | F4̅3m | 216 | | 234592 | 168 |
| Li_{6.225}P_{0.775}Si_{0.225}S₅Br | 1.08E−3 | 0.248 | F4̅3m | 216 | | 234593 | 168 |
| Li_{6.25}P_{0.75}Si_{0.25}S₅Br | 1.41E−3 | 0.223 | F4̅3m | 216 | | 234594 | 168 |
| Li_{6.3}P_{0.7}Si_{0.3}S₅Br | 1.65E−3 | 0.236 | F4̅3m | 216 | | 234595 | 168 |
| Li_{6.35}P_{0.65}Si_{0.35}S₅Br | 2.34E−3 | 0.142 | F4̅3m | 216 | | 234596 | 168 |
| Li_{6.5}P_{0.5}Si_{0.5}S₅Br | 2.19E−3 | 0.27 | F4̅3m | 216 | | 234597 | 168 |
| Li₇Ge₃PS₁₂ | 1.1E−4 | 0.259 | F4̅3m | 216 | | 258187 | 169 |
| Li₆B_{0.9}PH_{3.6}S_{4.9} | 1.8E−3 | 0.166 | F4̅3m | 216 | | 264526 | 170 |
| Li₆PS₅Cl | 1.30E−03 | 0.33 | F4̅3m | 216 | | | 171 |
| Li₆PS₅Br | 2.77E−3 | 0.31 | F4̅3m | 216 | | 267193 | 172 |
| Li₆P(S_{4.9}Se_{0.1})Br | 3.20E−3 | 0.33 | F4̅3m | 216 | | 267194 | 172 |
| Li₆P(S_{4.8}Se_{0.2})Br | 3.92E−3 | 0.34 | F4̅3m | 216 | | 267195 | 172 |
| Li₆P(S_{4.7}Se_{0.3})Br | 3.62E−3 | 0.33 | F4̅3m | 216 | | 267196 | 172 |
| Li₆P(S_{4.6}Se_{0.4})Br | 3.64E−3 | 0.33 | F4̅3m | 216 | | 267197 | 172 |
| Li₆P(S_{4.5}Se_{0.5})Br | 2.68E−3 | 0.34 | F4̅3m | 216 | | 267198 | 172 |
| Li₆P(S_{4.4}Se_{0.6})Br | 2.78E−3 | 0.34 | F4̅3m | 216 | | 267199 | 172 |
| Li₆P(S_{4.3}Se_{0.7})Br | 3.01E−3 | 0.35 | F4̅3m | 216 | | 267200 | 172 |
| Li₆P(S_{4.2}Se_{0.8})Br | 3.48E−3 | 0.34 | F4̅3m | 216 | | 267201 | 172 |
| Li₆P(S_{4.1}Se_{0.9})Br | 3.82E−3 | 0.34 | F4̅3m | 216 | | 267202 | 172 |
| Li₆P(S₄Se)Br | 3.61E−3 | 0.34 | F4̅3m | 216 | | 267203 | 172 |
| Li₆PO₅Cl | 5.54E−10 | 0.66 | F4̅3m | 216 | | 421479 | 173 |
| Li₆PS₅Br | 3.2E−5 | 0.32 | F4̅3m | 216 | | 234598 | 174 |
| Li₆PS₅Cl | 3.3E−5 | 0.38 | F4̅3m | 216 | | 259205 | 174 |
| Li₆PS₅I | 2.2E−4 | 0.26 | F4̅3m | 216 | | 259212 | 174 |
| Li₆PS₅I | 1.26E−6 | 0.38 | F4̅3m | 216 | | | 175 |
| Li₆P_{0.92}Ge_{0.08}S₅I | 9.02E−6 | 0.39 | F4̅3m | 216 | | | 175 |
| Li₆P_{0.85}Ge_{0.15}S₅I | 3.99E−5 | 0.36 | F4̅3m | 216 | | | 175 |
| Li₆P_{0.75}Ge_{0.25}S₅I | 3.26E−5 | 0.36 | F4̅3m | 216 | | | 175 |
| Li₆P_{0.74}Ge_{0.26}S₅I | 1.51E−4 | 0.30 | F4̅3m | 216 | | | 175 |
| Li₆P_{0.64}Ge_{0.36}S₅I | 6.58E−4 | 0.24 | F4̅3m | 216 | | | 175 |
| Li₆P_{0.53}Ge_{0.47}S₅I | 1.52E−3 | 0.24 | F4̅3m | 216 | | | 175 |
| Li₆P_{0.48}Ge_{0.52}S₅I | 1.83E−3 | 0.23 | F4̅3m | 216 | | | 175 |
| Li₆P_{0.31}Ge_{0.69}S₅I | 5.16E−3 | 0.24 | F4̅3m | 216 | | | 175 |
| Li₆P_{0.21}Ge_{0.79}S₅I | 5.41E−3 | 0.25 | F4̅3m | 216 | | | 175 |
| Li₆PS₅Cl | 1.31E−6 | 0.38 | F4̅3m | 216 | | | 176 |
| Li₆PS₅Br | 2.41E−5 | 0.16 | F4̅3m | 216 | | 259208 | 176 |
| Li₆PS₅I | 4.1E−7 | 0.32 | F4̅3m | 216 | | 418489 | 176 |
| Li₆PS₅I | 9.24E−5 | | F4̅3m | 216 | | | 177 |
| Li_{6.1}P_{0.9}Sn_{0.1}S₅I | 1.61E−4 | | F4̅3m | 216 | | | 177 |
| Li_{6.2}P_{0.8}Sn_{0.2}S₅I | 2.32E−4 | | F4̅3m | 216 | | | 177 |
| Li_{6.25}P_{0.75}Sn_{0.25}S₅I | 2.92E−4 | | F4̅3m | 216 | | | 177 |
| Li_{6.3}P_{0.7}Sn_{0.3}S₅I | 3.06E−4 | | F4̅3m | 216 | | | 177 |
| Li_{6.5}P_{0.5}Sn_{0.5}S₅I | 2.35E−4 | | F4̅3m | 216 | | | 177 |
| Li_{6.4}P_{0.6}Ge_{0.4}S₅I | 2.51E−4 | | F4̅3m | 216 | | | 177 |
| Li_{6.45}P_{0.55}Ge_{0.45}S₅I | 3.65E−4 | | F4̅3m | 216 | | | 177 |
| Li_{6.5}P_{0.5}Ge_{0.5}S₅I | 5.42E−4 | | F4̅3m | 216 | | | 177 |
| Li_{6.55}P_{0.45}Ge_{0.55}S₅I | 4.11E−4 | | F4̅3m | 216 | | | 177 |
| Li_{6.6}P_{0.4}Ge_{0.6}S₅I | 2.74E−4 | | F4̅3m | 216 | | | 177 |
| Li_{6.8}P_{0.2}Ge_{0.8}S₅I | 5.21E−5 | | F4̅3m | 216 | | | 177 |
| LiCe(BH₄)₃Cl | 1.03E−4 | | I4̅3m | 217 | | 185218 | 178 |
| Li₇PN₄ | 1.60E−07 | 0.4 | P4̅3n | 218 | | 69017 | 95 |
| β-Li₈GeP₄ | 8.6E−5 | 0.394 | P4̅3n | 218 | β-Li₈GeP₄ | 235185 | 161 |
| Li₄B₇O₁₂Cl | 2.4E−5 | | F4̅3c | 219 | | 1125 | 179 |
| Fe_{0.16}La_{2.95}Li_{5.68}Zr₂O₁₂ | 9.35E−4 | 0.29 | I4̅3d | 220 | | 431391 | 180 |
| Fe_{0.19}La_{2.95}Li_{5.57}Zr₂O₁₂ | 1.38E−3 | 0.28 | I4̅3d | 220 | | 431392 | 180 |
| Li₃ClO | 2.5E−2 | | Pm3̅m | 221 | | | 181 |
| Li_{2.99}Ba_{0.005}Cl_{0.5}I_{0.5} | 2.5E−3 | 0.06 | Pm3̅m | 221 | | | 181 |
| Li_{0.31}La_{0.63}((Ti_{0.9}Co_{0.1})O₃ | 2.60E−4 | | Pm3̅m | 221 | | 151533 | 182 |
| (La_{0.49}Li_{0.461}Sr_{0.049})(TiO₃) | 7.09E−4 | 0.33 | Pm3̅m | 221 | | 190825 | 183 |
| (La_{0.46}Li_{0.429}Sr_{0.111})(TiO₃) | 1.97E−4 | 0.33 | Pm3̅m | 221 | | 190826 | 183 |
| (La_{0.402}Li_{0.368}Sr_{0.230})(TiO₃) | 2.87E−5 | 0.36 | Pm3̅m | 221 | | 190827 | 183 |
| Li₂(OH)_{0.9}F_{0.1}Cl | 3.86E−5 | 0.52 | Pm3̅m | 221 | | | 184 |
| Li₂(OH)Br | 1.20E−6 | 0.75 | Pm3̅m | 221 | | 200874 | 184 |
| Li₉NS₃ | 8.30E−07 | 0.52 | Pm3̅m | 221 | | 240749 | 185 |
| (La_{0.55}Li_{0.45})(Ti_{0.9}Al_{0.1})O₃ | 1.51E−3 | | Pm3̅m | 221 | | 254045 | 186 |
| (La_{0.6}Li_{0.4})(Ti_{0.8}Al_{0.2})O₃ | 5.68E−4 | | Pm3̅m | 221 | | 254046 | 186 |
| (La_{0.65}Li_{0.35})(Ti_{0.7}Al_{0.3})O₃ | 1.61E−4 | | Pm3̅m | 221 | | 254047 | 186 |
| (La_{0.7}Li_{0.3})(Ti_{0.6}Al_{0.4})O₃ | 1.04E−7 | | Pm3̅m | 221 | | 254048 | 186 |
| (Li_{0.16}Sr_{0.69})(Ga_{0.25}Ta_{0.75})O₃ | 3.69E−6 | 0.359 | Pm3̅m | 221 | | 291520 | 187 |
| Li_{0.375}Sr_{0.4375}Zr_{0.25}Ta_{0.75}O₃ | 2.0E−4 | 0.26 | Pm3̅m | 221 | | | 188 |
| Li_{0.25}Sr_{0.625}Ta_{0.5}Zr_{0.5}O₃ | 3.34E−7 | 0.42 | Pm3̅m | 221 | | | 188 |
| Li_{0.375}Sr_{0.4375}Hf_{0.25}Ta_{0.75}O₃ | 3.8E−4 | 0.36 | Pm3̅m | 221 | | | 189 |
| Li_{0.375}Sr_{0.4375}Zr_{0.25}Nb_{0.75}O₃ | 2.00E−5 | 0.26 | Pm3̅m | 221 | | | 190 |
| Li_{0.25}Sr_{0.625}Zr_{0.5}Nb_{0.5}O₃ | 2.75E−7 | 0.36 | Pm3̅m | 221 | | | 190 |
| Li_{2.99}Ba_{0.005}ClO | 2.5E−2 | 0.13 | Pm3̅m | 221 | | | 191 |
| Li_{2.99}Ba_{0.005}Cl_{0.5}I_{0.5}O | 3.37E−3 | | Pm3̅m | 221 | | | 191 |
| Sm_{0.5}Li_{0.42}TiO_{2.96} | 3.93E−10 | 0.58 | Pm3̅m | 221 | | | 86 |
| La_{0.52}Li_{0.35}TiO_{2.96} | 9.11E−4 | 0.32 | Pm3̅m | 221 | | | 86 |
| La_{0.61}Li_{0.15}TiO₃ | 2.06E−4 | | Pm3̅m | 221 | | | 192 |
| La_{0.58}Li_{0.24}TiO₃ | 7.22E−4 | | Pm3̅m | 221 | | | 192 |
| La_{0.55}Li_{0.33}TiO₃ | 1.58E−3 | | Pm3̅m | 221 | | | 192 |
| La_{0.54}Li_{0.36}TiO₃ | 9.79E−3 | | Pm3̅m | 221 | | | 192 |
| La_{0.52}Li_{0.42}TiO₃ | 7.21E−4 | | Pm3̅m | 221 | | | 192 |
| La_{0.5}Sr_{0.06}Li_{0.06}TiO₃ | 1.13E−5 | 0.37 | Pm3̅m | 221 | | | 193 |
| La_{0.56}Sr_{0.1}Li_{0.1}TiO₃ | 1.37E−5 | 0.37 | Pm3̅m | 221 | | | 193 |
| La_{0.51}Sr_{0.15}Li_{0.15}TiO₃ | 5.3E−5 | 0.38 | Pm3̅m | 221 | | | 193 |
| La_{0.41}Sr_{0.25}Li_{0.25}TiO₃ | 7.64E−5 | 0.35 | Pm3̅m | 221 | | | 193 |
| La_{0.385}Sr_{0.275}Li_{0.275}TiO₃ | 6.04E−5 | 0.37 | Pm3̅m | 221 | | | 193 |
| La_{0.36}Sr_{0.3}Li_{0.3}TiO₃ | 1.92E−5 | 0.35 | Pm3̅m | 221 | | | 193 |
| La_{0.61}Li_{0.18}TiO3 | 2.09E−4 | | Pm3̅m | 221 | | | 97 |
| La_{0.58}Li_{0.27}TiO3 | 8.32E−4 | | Pm3̅m | 221 | | | 97 |
| La_{0.56}Li_{0.33}TiO3 | 1.30E−3 | | Pm3̅m | 221 | | | 97 |
| La_{0.55}Li_{0.36}TiO3 | 1.54E−3 | 0.33 | Pm3̅m | 221 | | | 97 |
| La_{0.54}Li_{0.39}TiO3 | 1.25E−3 | | Pm3̅m | 221 | | | 97 |
| La_{0.52}Li_{0.45}TiO3 | 7.85E−4 | | Pm3̅m | 221 | | | 97 |
| La_{0.51}Li_{0.34}TiO_{2.94} | 7E−5 | 0.36 | Pm3̅m | 221 | | | 62 |
| Li₃OBr | 1.10E−06 | 0.74 | Pm3̅m | 221 | | 67265 | 194, 195 |
| Li_{7.2}N_{1.6}Cl_{2.4} | 8.4E−7 | 0.49 | Fm3̅m | 225 | | 49646 | 131 |
| Li₆NI₃ | 3.70E−06 | | Fm3̅m | 225 | | 83380 | 165 |
| Li_{0.19}La_{0.67}(Ti_{0.9}Co_{0.1})O₃ | 1.08E−4 | | Fm3̅m | 225 | | 151535 | 182 |
| Li₆NBr₃ | 1.00E−08 | 0.69 | Fm3̅m | 225 | | 84091 | 196 |
| LiI | 1E−7 | | Fm3̅m | 225 | | 414244 | 197 |
| Li(Li_{0.34}Ti_{1.66})O₄ | 6.03E−8 | 0.506 | Fd3̅m | 227 | | 168137 | 164 |
| (Li_{0.916}Mg_{0.084})(Li_{0.352}Mg_{0.016}Ti_{1.634})O₄ | 1.73E−8 | 0.564 | Fd3̅m | 227 | | 168139 | 164 |
| (Li_{0.826}Mg_{0.174})(Li_{0.374}Mg_{0.026}Ti_{1.60})O₄ | 4.24E−9 | 0.615 | Fd3̅m | 227 | | 168141 | 164 |
| (Li_{0.74}Mg_{0.26})(Li_{0.40}Mg_{0.04}Ti_{1.56})O₄ | 1.51E−9 | 0.639 | Fd3̅m | 227 | | 168142 | 164 |
| Li₂MnCl₄ | 4.79E−6 | | Fd3̅m | 227 | | 69678 | 166 |
| Li₂MgCl₄ | 6.24E−7 | | Fd3̅m | 227 | | 74957 | 166 |
| Li_{1.9}Mn_{0.9}Ga_{0.1}Cl₄ | 2.37E−7 | | Fd3̅m | 227 | | 50305 | 198 |
| Li_{1.65}Mn_{0.65}In_{0.35}Cl₄ | 9.9E−8 | | Fd3̅m | 227 | | 50306 | 198 |
| LiCdCl₄ | 5.80E−07 | 0.44 | Fd3̅m | 227 | | 74958 | 199 |
| LiSrNb₂O₆F | <1E−10 | 0.604 | Fd3̅m | 227 | | 236009 | 200 |
| LiSrTa₂O₆F | <1E−10 | 0.604 | Fd3̅m | 227 | | 236010 | 200 |
| LiSr_{0.9}Nb₂O₆F_{0.8} | <1E−10 | 0.709 | Fd3̅m | 227 | | 236011 | 200 |
| LiSr_{0.9}Ta₂O₆F_{0.8} | <1E−10 | 0.76 | Fd3̅m | 227 | | 236012 | 200 |
| Li_{1.1}SrNb_{1.9}Zr_{0.1}O₆F | <1E−10 | 0.622 | Fd3̅m | 227 | | 236013 | 200 |
| Li_{1.1}SrTa_{1.9}Zr_{0.1}O₆F | <1E−10 | 0.693 | Fd3̅m | 227 | | 236014 | 200 |
| Li₆SrLa₂Nb₂O₁₂ | 4.2E−6 | 0.5 | Ia3̅d | 230 | | 157628 | 159 |
| Li₆CaLa₂Nb₂O₁₂ | 1.6E−6 | 0.55 | Ia3̅d | 230 | | 161386 | 159 |
| Li_{5.25}Ba_{0.25}La_{2.75}Ta₂O₁₂ | 6.03E−6 | 0.479 | Ia3̅d | 230 | | | 201 |
| Li_{5.5}Ba_{0.5}La_{2.5}Ta₂O₁₂ | 1.35E−5 | 0.455 | Ia3̅d | 230 | | | 201 |
| Li_{6.25}Ba_{1.25}La_{1.75}Ta₂O₁₂ | 5.05E−5 | 0.395 | Ia3̅d | 230 | | | 201 |
| Li_{6.5}Ba_{1.5}La_{1.5}Ta₂O₁₂ | 3.2E−5 | 0.402 | Ia3̅d | 230 | | | 201 |
| Li_{6.75}Ba_{1.75}La_{1.25}Ta₂O₁₂ | 1.25E−5 | 0.418 | Ia3̅d | 230 | | | 201 |
| Li₇Ba₂LaTa₂O₁₂ | 3.00E−6 | 0.442 | Ia3̅d | 230 | | | 201 |
| Li₅La₃Ta₂O₁₂ | 4.33E−6 | 0.50 | Ia3̅d | 230 | | 154400 | 201 |
| Li₆BaLa₂Ta₂O₁₂ | 3.02E−5 | 0.419 | Ia3̅d | 230 | | 237201 | 201 |
| Li₇La₃Zr_{1.89}Al_{0.15}O₁₂ | 3.4E−4 | 0.334 | Ia3̅d | 230 | | | 202 |
| Li_{7.06}La₃Y_{0.06}Zr_{1.94}O₁₂ | 9.56E−4 | 0.26 | Ia3̅d | 230 | | | 203 |
| Li_{6.25}La₃Zr₂Ga_{0.25}O₁₂ | 3.5E−4 | | Ia3̅d | 230 | | | 204 |
| Li₇La₃Zr₂O₁₂ | 1.2E−4 | | Ia3̅d | 230 | | | 205 |
| Li_{6.8}La₃Zr_{1.8}Ta_{0.2}O₁₂ | 2.8E−4 | | Ia3̅d | 230 | | | 205 |
| Li_{6.6}La₃Zr_{1.6}Ta_{0.4}O₁₂ | 7.3E−4 | | Ia3̅d | 230 | | | 205 |
| Li_{6.5}La₃Zr_{1.5}Ta_{0.5}O₁₂ | 9.2E−4 | | Ia3̅d | 230 | | | 205 |
| Li_{6.4}La₃Zr_{1.4}Ta_{0.6}O₁₂ | 1.0E−3 | 0.35 | Ia3̅d | 230 | | | 205 |
| Li_{6.2}La₃Zr_{1.2}Ta_{0.8}O₁₂ | 3.2E−4 | | Ia3̅d | 230 | | | 205 |
| Li₆La₃ZrTaO₁₂ | 1.6E−4 | | Ia3̅d | 230 | | | 205 |
| Li₇La₃Zr₂O₁₂ | 1.2E−4 | | Ia3̅d | 230 | | | 205 |
| Li_{6.8}La₃Zr_{1.8}Ta_{0.2}O₁₂ | 2.8E−4 | | Ia3̅d | 230 | | | 205 |
| Li_{6.6}La₃Zr_{1.6}Ta_{0.4}O₁₂ | 7.3E−4 | | Ia3̅d | 230 | | | 205 |
| Li_{6.5}La₃Zr_{1.5}Ta_{0.5}O₁₂ | 9.2E−4 | | Ia3̅d | 230 | | | 205 |
| Li_{6.4}La₃Zr_{1.4}Ta_{0.6}O₁₂ | 1E−3 | 0.35 | Ia3̅d | 230 | | | 205 |
| Li_{6.2}La₃Zr_{1.2}Ta_{0.8}O₁₂ | 3.2E−4 | | Ia3̅d | 230 | | | 205 |
| Li₆La₃ZrTaO₁₂ | 1.6E−4 | | Ia3̅d | 230 | | | 205 |
| Li_{6.8}LasZr_{1.8}Ta_{0.2}O₁₂ | 7.8E−4 | | Ia3̅d | 230 | | | 206 |
| Li_{6.75}La₃Zr_{1.75}Ta_{0.25}O₁₂ | 8.8E−4 | | Ia3̅d | 230 | | | 206 |
| Li_{6.65}La₃Zr_{1.65}Ta_{0.35}O₁₂ | 7.7E−4 | | Ia3̅d | 230 | | | 206 |
| Li_{6.6}La₃Zr_{1.6}Ta_{0.4}O₁₂ | 7.2E−4 | | Ia3̅d | 230 | | | 206 |
| Li_{6.55}La₃Zr_{1.55}Ta_{0.45}O₁₂ | 6.9E−4 | | Ia3̅d | 230 | | | 206 |
| Li₆La₃ZrTaO₁₂ | 4.4E−4 | | Ia3̅d | 230 | | | 206 |
| Li₅La₃Ta₂O₁₂ | 1.6E−4 | | Ia3̅d | 230 | | | 206 |
| Li_{6.7}La₃Zr_{1.7}Ta_{0.3}O₁₂ | 9.6E−4 | 0.37 | Ia3̅d | 230 | | | 206 |
| Li_{6.5}La₃Zr_{1.5}Ta_{0.5}O₁₂ | 6.7E−4 | | Ia3̅d | 230 | | 183686 | 206 |
| Li_{6.05}Ga_{0.25}La₃Zr₂O_{11.8}F_{0.2} | 1.28E−3 | 0.28 | Ia3̅d | 230 | | | 207 |
| Li_{5.72}Al_{0.26}La₃Zr_{1.5}W_{0.25}O₁₂ | 4.9E−4 | 0.35 | Ia3̅d | 230 | | | 208 |
| Li_{6.8}La₃Zr_{1.9}Mo_{0.1}O₁₂ | 8.00E−5 | 0.46 | Ia3̅d | 230 | | | 209 |
| Li_{6.6}La₃Zr_{1.8}Mo_{0.2}O₁₂ | 3.11E−4 | 0.48 | Ia3̅d | 230 | | | 209 |
| Li_{6.4}La₃Zr_{1.7}Mo_{0.3}O₁₂ | 3.69E−4 | 0.49 | Ia3̅d | 230 | | | 209 |
| Li_{6.2}La₃Zr_{1.6}Mo_{0.4}O₁₂ | 3.40E−4 | 0.48 | Ia3̅d | 230 | | | 209 |
| Li_{6.5}La₃Zr_{1.75}Mo_{0.25}O₁₂ | 3.33E−4 | 0.39 | Ia3̅d | 230 | | 239128 | 209 |
| Li_{6.75}La₃Zr_{1.875}Te_{0.125}O₁₂ | 3.30E−4 | 0.41 | Ia3̅d | 230 | | | 210 |
| Li_{6.5}La₃Zr_{1.75}Te_{0.25}O₁₂ | 1.02E−3 | 0.38 | Ia3̅d | 230 | | | 210 |
| Li_{6.375}La₃Zr_{1.375}Nb_{0.625}O₁₂ | 1.37E−3 | 0.25 | Ia3̅d | 230 | | | 211 |
| Li₅La₃Ta₂O₁₂ | 1.2E−6 | 0.56 | Ia3̅d | 230 | | 154400 | 212 |
| Li₅La₃Nb₂O₁₂ | 1E−5 | 0.43 | Ia3̅d | 230 | | 171171 | 212 |
| Li₅La₃Bi₂O₁₂ | 4.00E−05 | 0.47 | Ia3̅d | 230 | | 158372 | 213 |
| Li₆La₂SrBi₂O₁₂ | 5.20E−05 | 0.43 | Ia3̅d | 230 | | 158373 | 213 |
| Li₅Nd₃Sb₂O₁₂ | 1.3E−7 | 0.67 | Ia3̅d | 230 | | 159426 | 214 |
| Li₄Nd₃TeSbO₁₂ | 1.96E−6 | 0.64 | Ia3̅d | 230 | | 159732 | 215 |
| Li₅La₃Sb₂O₁₂ | 8.2E−6 | 0.51 | Ia3̅d | 230 | | 161342 | 216 |
| Li₆SrLa₂Sb₂O₁₂ | 6.6E−6 | 0.54 | Ia3̅d | 230 | | 161343 | 216 |
| Li₆(La₂Ca)(NbO₆)₂ | 1.33E−6 | | Ia3̅d | 230 | | 161386 | 217 |
| Li₆(La₂Sr)(NbO₆)₂ | 3.69E−6 | | Ia3̅d | 230 | | 161387 | 217 |
| Li₆CaLa₂Ta₂O₁₂ | 2.2E−6 | 0.5 | Ia3̅d | 230 | | 163860 | 218 |
| Li₆BaLa₂Ta₂O₁₂ | 1.3E−5 | 0.44 | Ia3̅d | 230 | | 163861 | 218 |
| Li_{6.15}La₃Zr_{1.75}Ta_{0.25}Ga_{0.2}O₁₂ | 4.1E−4 | 0.27 | Ia3̅d | 230 | | | 219 |
| Li_{6.15}La₃Zr_{1.75}Ta_{0.25}Al_{0.2}O₁₂ | 3.7E−4 | 0.30 | Ia3̅d | 230 | | | 219 |
| Li_{6.75}La₃Zr_{1.75}Ta_{0.25}O₁₂ | 8.7E−4 | 0.22 | Ia3̅d | 230 | | 183873 | 219 |
| Li_{6.16}Al_{0.28}La₃Zr₂O₁₂ | 6.1E−4 | 0.34 | Ia3̅d | 230 | | 185539 | 220 |
| Li₇La₃Zr₂O₁₂ | 1.97E−6 | 0.49 | Ia3̅d | 230 | | | 221 |
| Li₇La₃Zr₂O₁₂-0.5 wt % Al | 1.58E−4 | | Ia3̅d | 230 | | | 221 |
| Li₇La₃Zr₂O₁₂-0.9 wt % Al | 3.2E−4 | 0.34 | Ia3̅d | 230 | | | 221 |
| Li_{6.06}Al_{0.2}LasZr₂O₁₂ | 4E−4 | 0.34 | Ia3̅d | 230 | | 185539 | 221 |
| Li₆BaLa₂Ta₂O₁₂ | 2.45E−5 | 0.40 | Ia3̅d | 230 | | 185602 | 222 |
| Nd₃Zr₂Al_{0.5}Li_{5.5}O₁₂ | 3.9E−5 | 0.56 | Ia3̅d | 230 | | 189530 | 223 |
| (Li_{6.26}Al_{0.24})La₃Zr₂O₁₂ | 3.1E−4 | 0.33 | Ia3̅d | 230 | | 195182 | 224 |
| Li₆La₃Nb_{1.5}Y_{0.5}O₁₂ | 1.88E−4 | | Ia3̅d | 230 | | 237141 | 225 |
| Li_{5.2}La₃Nb_{1.9}Y_{0.1}O₁₂ | 6.39E−5 | | Ia3̅d | 230 | | 237143 | 225 |
| Li_{5.4}La₃Nb_{1.8}Y_{0.2}O₁₂ | 6.74E−5 | | Ia3̅d | 230 | | 237144 | 225 |
| Li_{6.5}La₃Nb_{1.75}Y_{0.25}O₁₂ | 9.18E−5 | | Ia3̅d | 230 | | 237145 | 225 |
| Li_{6.5}La₃Nb_{1.25}Y_{0.75}O₁₂ | 3.43E−4 | | Ia3̅d | 230 | | 237146 | 225 |
| Li₆Ba_{0.5}Sr_{0.5}La₂Ta₂O₁₂ | 7.1E−6 | 0.45 | Ia3̅d | 230 | | 237199 | 226 |
| Li₆SrLa₂Ta₂O₁₂ | 5.4E−6 | 0.45 | Ia3̅d | 230 | | 237200 | 226 |
| Li₆BaLa₂Ta₂O₁₂ | 1.5E−5 | 0.47 | Ia3̅d | 230 | | 237201 | 226 |
| Li₆CaLa₂Ta₂O₁₂ | 2.2E−6 | 0.47 | Ia3̅d | 230 | | 237202 | 226 |
| Li₆BaLa₂Ta₂O₁₂ | 4E−5 | 0.4 | Ia3̅d | 230 | | | 227 |
| Li₆SrLa₂Ta₂O₁₂ | 7E−6 | 0.5 | Ia3̅d | 230 | | | 227 |
| Li₆SrLa₂Ta₂O₁₂ | 7E−6 | 0.5 | Ia3̅d | 230 | | 237200 | 227 |
| Li₆BaLa₂Ta₂O₁₂ | 4E−5 | 0.4 | Ia3̅d | 230 | | 237201 | 227 |
| Li_{5.74}La₃Zr_{1.5}Ta_{0.5}O₁₂ | 9.03E−4 | 0.435 | Ia3̅d | 230 | | 239663 | 228 |
| La₃Li_{5.08}Ta_{1.51}Zr_{0.39}O₁₂ | 1.03E−4 | 0.536 | Ia3̅d | 230 | | 239664 | 228 |
| Li_{51.2}Al_{1.6}La₂₄Zr₁₆O₉6 | 2.54E−4 | 0.36 | Ia3̅d | 230 | | 241475 | 229 |
| Li_{49.6}Al_{1.6}La₂₄Zr_{14.4}Ta_{1.6}O₉₆ | 6.14E−4 | 0.29 | Ia3̅d | 230 | | 241476 | 229 |
| Li_{6.5}La₃Hf_{1.5}Ta_{0.5}O₁₂ | 4.0E−4 | 0.40 | Ia3̅d | 230 | | 258921 | 230 |
| Li_{6.5}La₃Sn_{1.5}Ta_{0.5}O₁₂ | 1.9E−4 | 0.45 | Ia3̅d | 230 | | 258922 | 230 |
| Li₅La₃Ta₂O₁₂ | 1.59E−5 | | Ia3̅d | 230 | | 259164 | 231 |
| Li_{5.3}La₃Ta_{1.85}Sm_{0.15}O₁₂ | 7.11E−6 | | Ia3̅d | 230 | | 259165 | 231 |
| Li_{5.5}La₃Ta_{1.75}Sm_{0.25}O₁₂ | 5.17E−6 | | Ia3̅d | 230 | | 259166 | 231 |
| Li_{5.70}La₃Ta_{1.65}Sm_{0.35}O₁₂ | 2.15E−5 | | Ia3̅d | 230 | | 259167 | 231 |
| Li_{5.90}La₃Ta_{1.55}Sm_{0.45}O₁₂ | 1.18E−5 | | Ia3̅d | 230 | | 259168 | 231 |
| Li_{6.10}La₃Ta_{1.45}Sm_{0.55}O₁₂ | 1.40E−5 | | Ia3̅d | 230 | | 259169 | 231 |
| Li₇La₃Zr₂O₁₂ | 5.69E−04 | 0.36 | Ia3̅d | 230 | “cubic LLZO” | 422259 | 232 |
| Li₅La₃Nb₂O₁₂ | 4.99e-6 | | Ia3̅d | 230 | | | 233 |
| Li₅La₃Nb_{1.95}Y_{0.05}O₁₂ | 1.32E−5 | | Ia3̅d | 230 | | | 233 |
| Li₅La₃Nb_{1.9}Y_{0.1}O₁₂ | 1.43E−5 | | Ia3̅d | 230 | | | 233 |
| Li₅La₃Nb_{1.85}Y_{0.15}O₁₂ | 5.85E−6 | | Ia3̅d | 230 | | | 233 |
| Li₅La₃Nb_{1.8}Y0_{.2}O₁₂ | 9.05E−6 | | Ia3̅d | 230 | | | 233 |
| Li₅La₃Nb_{1.75}Y_{0.25}O₁₂ | 9.42E−6 | | Ia3̅d | 230 | | | 233 |
| Li_{6.24}La₃Zr₂Al_{0.24}O_{11.98} | 4.0E−4 | 0.26 | Ia3̅d | 230 | | | 234 |
| Li₇La₃Zr₂O₁₂—0.3Ga | 3.8E−5 | 0.37 | Ia3̅d | 230 | | | 235 |
| Li₇La₃Zr₂O₁₂—0.4Ga | 4.4E−5 | 0.36 | Ia3̅d | 230 | | | 235 |
| Li₇La₃Zr₂O₁₂—0.5Ga | 8.9E−5 | 0.36 | Ia3̅d | 230 | | | 235 |
| Li₇La₃Zr₂O₁₂—Ga | 5.4E−4 | 0.32 | Ia3̅d | 230 | | | 235 |
| La₃Zr₂Ga_{0.5}Li_{5.5}O₁₂ | 1E−4 | | Ia3̅d | 230 | | | 236 |
| Li_{6.8}La₃Zr_{1.8}Sb_{0.2}O₁₂ | 5.9E−5 | 0.39 | Ia3̅d | 230 | | | 237 |
| Li_{6.6}La₃Zr_{1.6}Sb_{0.4}O₁₂ | 7.7E−4 | 0.34 | Ia3̅d | 230 | | | 237 |
| Li_{6.4}La₃Zr_{1.4}Sb_{0.6}O₁₂ | 6.6E−4 | 0.36 | Ia3̅d | 230 | | | 237 |
| Li_{6.2}La₃Zr_{1.2}Sb_{0.8}O₁₂ | 4.5E−4 | 0.37 | Ia3̅d | 230 | | | 237 |
| Li₆La₃ZrSbO₁₂ | 2.6E−4 | 0.38 | Ia3̅d | 230 | | | 237 |
| Li_{6.5}La₃Zr_{1.75}Te_{0.25}O₁₂—0.07Al | 4E−4 | 0.33 | Ia3̅d | 230 | | | 238 |
| Li_{6.65}La_{2.75}Ba_{0.25}Zr_{1.4}Ta_{0.5}Nb_{0.1}O₁₂ | 5.27E−4 | 0.26 | Ia3̅d | 230 | | | 239 |
| Li_{6.4}La₃Zr_{1.4}Ta_{0.6}O₁₂ | 7.24E−4 | 0.24 | Ia3̅d | 230 | | | 239 |
| Li_{6.4}La₃Zr_{1.4}Ta_{0.5}Nb_{0.1}O₁₂ | 4.44E−4 | 0.27 | Ia3̅d | 230 | | | 239 |
| Li_{6.4}La₃Zr_{1.4}Ta_{0.4}Nb_{0.2}O₁₂ | 4.55E−4 | 0.28 | Ia3̅d | 230 | | | 239 |
| Li_{6.4}La₃Zr_{1.4}Ta_{0.3}Nb_{0.3}O₁₂ | 6.06E−4 | 0.26 | Ia3̅d | 230 | | | 239 |
| Li₇La₃Zr₂O₁₂ | 1.74E−4 | 0.26 | Ia3̅d | 230 | | | 239 |
| Li₃Nd₃Te₂O₁₂ | <1E−10 | 1.22 | Ia3̅d | 230 | | | 240 |
| Li_{7.131}La₃Zr₂O₁₂Al_{0.244} | 7.73E−5 | | Ia3̅d | 230 | | | 241 |
| Li_{6.949}La₃Zr₂O₁₂Al_{0.262} | 2.25E−4 | | Ia3̅d | 230 | | | 241 |
| Li_{6.835}La₃Zr₂O₁₂Al_{0.231} | 2.20E−4 | | Ia3̅d | 230 | | | 241 |
| Li_{6.660}La₃Zr₂O₁₂Al_{0.258} | 1.51E−4 | | Ia3̅d | 230 | | | 241 |
| Li_{6.75}La₃Zr_{1.75}Ta_{0.25}O₁₂ | 4.1E−4 | 0.42 | Ia3̅d | 230 | | | 121 |
| Li_{6.5}La₃Zr_{1.5}Ta_{0.5}O₁₂ | 6.1E−4 | 0.4 | Ia3̅d | 230 | | | 121 |
| Li₆La₃ZrTaO₁₂ | 2.1E−4 | 0.42 | Ia3̅d | 230 | | | 121 |
| Li₃Gd₃Te₂O₁₂ | <1E−10 | | Ia3̅d | 230 | | | 242 |
| Li₃Tb₃Te₂O₁₂ | <1E−10 | | Ia3̅d | 230 | | | 242 |
| Li₃Er₃Te₂O₁₂ | <1E−10 | | Ia3̅d | 230 | | | 242 |
| Li₃Lu₃Te₂O₁₂ | <1E10 | | Ia3̅d | 230 | | | 242 |
| Li₂S*P₂S₅ | 3.2E−03 | | | | | | 4 |
| 0.7Li₂S—0.3P₂S₅ | 5.4E−5 | | | | | | 4 |
| Li_{3.8}Ge_{0.8}P_{0.2}S₄ | 1.75E−6 | 0.466 | | | | | 14 |
| Li_{3.6}Ge_{0.6}P_{0.4}S₄ | 1.74E−4 | 0.339 | | | | | 14 |
| Li_{3.4}Ge_{0.4}P_{0.6}S₄ | 6.53E−4 | 0.275 | | | | | 14 |
| Li_{3.35}Ge_{0.35}P_{0.65}S₄ | 1.53E−3 | 0.229 | | | | | 14 |
| Li_{3.3}Ge_{0.3}P_{0.7}S₄ | 1.76E−3 | 0.221 | | | | | 14 |
| Li_{3.2}Ge_{0.2}P_{0.8}S₄ | 5.57E−4 | 0.275 | | | | | 14 |
| Li_{2.9}Ca_{0.05}InBr₆ | 2.16E−4 | | | | | | 25 |
| Li_{2.86}Ca_{0.07}InBr₆ | 4.04E−4 | | | | | | 25 |
| Li_{2.8}Ca_{0.1}InBr₆ | 3.00E−4 | | | | | | 25 |
| Li_{2.7}Ca_{0.15}InBr₆ | 6.97E−5 | | | | | | 25 |
| Li_{3.9}Zn_{0.05}GeS₄ | 2.72E−7 | 0.517 | | | | | 71 |
| Li_{3.8}Zn_{0.1}GeS₄ | 9.95E−8 | 0.545 | | | | | 71 |
| Li_{3.6}Zn_{0.2}GeS₄ | 5.90E−8 | 0.539 | | | | | 71 |
| Li₇GeS₃ | 9.7E−9 | | | | | | 71 |
| Li₇ZnGeS₄ | 1.4E−9 | | | | | | 71 |
| Li_{9.6}P₃S₁₂ | 1.2E−3 | 0.259 | | | | | 102 |
| Li_{1.3}Al_{0.3}Ge_{1.7}(PO₄)₃ | 8.24E−5 | 0.386 | | | | | 133 |
| Li_{1.6}Al_{0.6}Ge_{1.4}(PO₄)₃ | 2.84E−4 | 0.430 | | | | | 133 |
| LiTi₂(PO₄)₃—0.2Li₂O | 2.4E−4 | | | | | | 134 |
| LiTi₂(PO₄)₃—0.3Li₂O | 1.5E−3 | | | | | | 134 |
| LiTi₂(PO₄)₃—0.4Li₂O | 1.3E−4 | | | | | | 134 |
| Li_{1.3}Al_{0.3}Ti_{1.7}(PO₄)₃—0.3Li₂O | 3.5E−4 | | | | | | 134 |
| LiTi₂(PO₄)₃—_{0.1}Li₄P₂O₇ | 1.6E−4 | | | | | | 134 |
| Li_{1.4}Al_{0.4}Ti_{1.6}(PO₄)₃ | 3.38E−3 | 0.30 | | | LATP | | 243 |
| Li_{1.2}Ge_{0.2}Ti_{1.8}(PO₄)₃ | 7.94E−5 | 0.27 | | | LAGP | | 243 |
| Li_{1.5}Ge_{0.5}Ti_{1.5}(PO₄)₃ | 1.90E−4 | 0.33 | | | LAGP | | 243 |
| Li_{1.2}Al_{0.2}Ti_{1.8}(PO₄)₃ | 3.38E−3 | 0.28 | | | LATP | 427619 | 243 |
| Li₃ClO | 0.85E−3 | 0.26 | | | | | 194 |
| Li₃C_{10.5}Br_{0.50} | 1.94E−3 | 0.18 | | | | | 194 |
| Li₃OCl | 1.47E−4 | 0.26 | | | | | 194 |
| Li₃OCl_{0.5}Br_{0.5} | 9.49E−4 | 0.18 | | | | | 194 |
| Li_{6.6}La_{2.6}Ce_{0.4}Zr₂O₁₂ | 1.44E−5 | 0.48 | | | | | 244 |
| Li_{1.4}Al_{0.4}Ti_{1.6}(PO₄)₃ | 1.1E−03 | | | | | | 245 |
| 80Li₂S * 20P₂S₅ | 7.2E−04 | | | | | | 246 |
| 0.8Li₂S—0.2P₂S₅ | 7.2E−4 | | | | | | 246 |
| 0.75Li₂S—0.25P₂S₅ | 2.8E−4 | | | | | | 246 |
| Li₂S*P₂S₅*P₂S₃ | 5.4E−03 | | | | | | 247 |
| Li₇S*P₂S₅*Li₃N | 1.4E−03 | | | | | | 248 |
| Li₇La₃Nb_{1.9}Y_{0.1}O₁₂ | 1.44E−5 | 0.55 | | | | | 233 |
| Li₇La₃Zr₂O₁₂ | 2.35E−4 | 0.339 | | | | | 249 |
| Li_{6.88}La₃Zr_{1.88}Nb_{0.12}O₁₂ | 5.99E−4 | 0.319 | | | | | 249 |
| Li_{6.75}La₃Zr_{1.75}Nb_{0.25}O₁₂ | 7.71E−4 | 0.3 | | | | | 249 |
| Li_{6.62}La₃Zr_{1.62}Nb_{0.38}O₁₂ | 4.41E−4 | 0.31 | | | | | 249 |
| Li_{6.5}La₃Zr_{1.5}Nb_{0.5}O₁₂ | 2.98E−4 | 0.319 | | | | | 249 |
| Li₆La₃ZrNbO₁₂ | 1.50E−4 | 0.42 | | | | | 249 |
| Li₅La₃Nb₂O₁₂ | 3E−5 | 0.44 | | | | | 249 |
| Li₇La₃Hf₂O₁₂ | 2.4E−4 | 0.29 | | | | | 250 |
| Li₇GePS₈ | 7E−3 | 0.22 | | | | | 251 |
| Li₁₀(Ge_{0.95}Si_{0.05})P₂S₁₂ | 8.63E−3 | 0.251 | | | | | 252 |
| Li₁₀(Ge_{0.9}Si_{0.1})P₂S₁₂ | 8.07E−3 | 0.26 | | | | | 252 |
| Li₁₀(Ge_{0.8}Si_{0.2})P₂S₁₂ | 7.28E−3 | 0.261 | | | | | 252 |
| Li₁₀(Ge_{0.7}Si_{0.3})P₂S₁₂ | 5.82E−3 | 0.265 | | | | | 252 |
| Li₁₀(Ge_{0.6}Si_{0.4})P₂S₁₂ | 5.24E−3 | 0.28 | | | | | 252 |
| Li₁₀(Ge_{0.5}Si_{0.5})P₂S₁₂ | 4.2E−3 | 0.284 | | | | | 252 |
| Li₁₀(Ge_{0.2}Si_{0.8})P₂S₁₂ | 4.81E−3 | 0.269 | | | | | 252 |
| Li₁₀(Ge_{0.95}Sn_{0.05})P₂S₁₂ | 7.8E−3 | 0.254 | | | | | 252 |
| Li₁₀(Ge_{0.9}Sn_{0.1})P₂S₁₂ | 7.53E−3 | 0.256 | | | | | 252 |
| Li₁₀(Ge_{0.8}Sn_{0.2})P₂S₁₂ | 7.06E−3 | 0.252 | | | | | 252 |
| Li₁₀(Ge_{0.7}Sn_{0.3})P₂S₁₂ | 6.49E−3 | 0.254 | | | | | 252 |
| Li₁₀(Ge_{0.5}Sn_{0.5})P₂S₁₂ | 6.17E−3 | 0.249 | | | | | 252 |
| Li₁₀(Ge_{0.4}Sn_{0.6})P₂S₁₂ | 5.76E−3 | 0.265 | | | | | 252 |
| Li₁₀(Ge_{0.3}Sn_{0.7})P₂S₁₂ | 5.56E−3 | 0.261 | | | | | 252 |
| Li₁₀(Ge_{0.2}Sn_{0.8})P₂S₁₂ | 4.77E−3 | 0.269 | | | | | 252 |
| 0.5(Li₂O) * 0.5(P₂O₅) | 1.1E−9 | 0.71 | | | | | 253 |
| 0.58(Li₂O) * 0.5(P₂O₅) | 2E−8 | 0.60 | | | | | 253 |
| 0.6(Li₂O) * 0.5(P₂O₅) | 3E−8 | 0.61 | | | | | 253 |
| 0.63(Li₂O) * 0.5(P₂O₅) | 1.3E−7 | 0.56 | | | | | 253 |
| 0.66(Li₂O) * 0.5(P₂O₅) | 2.3E−7 | 0.55 | | | | | 253 |
| 0.7(Li₂O) * 0.5(P₂O₅) | 3E−7 | 0.57 | | | | | 253 |
| 0.2(Li₂S) 0.8(GeS₂) | 1.1E−7 | 0.52 | | | | | 253 |
| 0.3(Li₂S) 0.7(GeS₂) | 9.3E−7 | 0.48 | | | | | 253 |
| 0.4(Li₂S) 0.6(GeS₂) | 2.9E−6 | 0.42 | | | | | 253 |
| 0.5(Li₂S) 0.5(GeS₂) | 3.3E−5 | 0.35 | | | | | 253 |
| 0.6(Li₂S) 0.4(GeS₂) | 9.2E−5 | 0.32 | | | | | 253 |
| 0.63(Li₂S) 0.37(GeS₂) | 1.5E−4 | 0.34 | | | | | 253 |
| 0.66(Li₂S) 0.34(GeS₂) | 1.0E−4 | 0.37 | | | | | 253 |
| 0.7(Li₂S) 0.3(GeS₂) | 1.2E−4 | 0.34 | | | | | 253 |
| Li₂O—P₂O₅ | 1.1E−9 | 0.71 | | | | | 253 |
| 0.58Li₂O—0.42P₂O₅ | 2.0E−8 | 0.60 | | | | | 253 |
| 0.6Li₂O—0.4P₂O₅ | 3.0E−8 | 0.61 | | | | | 253 |
| 0.63Li₂O—0.37P₂O₅ | 1.3E−7 | 0.56 | | | | | 253 |
| 0.66Li₂O—0.34P₂O₅ | 2.3E−7 | 0.55 | | | | | 253 |
| 0.7Li₂O—0.3P₂O₅ | 3.0E−7 | 0.57 | | | | | 253 |
| 0.2Li₂S—0.8GeS₂ | 1.1E−7 | 0.52 | | | | | 253 |
| 0.3Li₂S—0.7GeS₂ | 9.3E−7 | 0.48 | | | | | 253 |
| 0.4Li₂S—0.6GeS₂ | 2.9E−6 | 0.42 | | | | | 253 |
| 0.5Li₂S—0.5GeS₂ | 3.3E−5 | 0.35 | | | | | 253 |
| 0.6Li₂S—0.4GeS₂ | 9.2E−5 | 0.32 | | | | | 253 |
| 0.63Li₂S—0.37GeS₂ | 1.5E−4 | 0.34 | | | | | 253 |
| 0.66Li₂S—0.34GeS₂ | 1.0E−4 | 0.37 | | | | | 253 |
| 0.7Li₂S—0.3GeS₂ | 1.2E−4 | 0.34 | | | | | 253 |
| Li_{6.55}La₃Zr₂Ga_{0.15}O₁₂ | 1.3E−3 | 0.3 | | | | | 254 |
| Li_{6.40}La₃Zr₂Ga_{0.2}O₁₂ | 9E−4 | 0.3 | | | | | 254 |
| Li_{6.10}La₃Zr₂Ga_{0.25}O₁₂ | 7E−5 | 0.3 | | | | | 254 |
| Li_{6.8}La₃Zr_{1.8}Sb_{0.2}O₁₂ | 5.9E−5 | 0.39 | | | | | 255 |
| Li_{6.6}La₃Zr_{1.6}Sb_{0.4}O₁₂ | 7.7E−4 | 0.34 | | | | | 255 |
| Li_{6.4}La₃Zr_{1.4}Sb_{0.6}O₁₂ | 6.6E−4 | 0.36 | | | | | 255 |
| Li_{6.2}La₃Zr_{1.2}Sb_{0.8}O₁₂ | 4.5E−4 | 0.37 | | | | | 255 |
| Li₆La₃ZrSbO₁₂ | 2.6E−4 | 0.38 | | | | | 255 |
| Li(In_{0.62}Li_{1.38})Br_{3.92} | 4.9E−6 | 0.58 | | | | | 256 |
| Li₃InBr₆ | 1.77E−4 | | | | | | 257 |
| Li₃InBr₄Cl₂ | 7.58E−6 | | | | | | 257 |
| Li₃InBr₃Cl₃ | 1.14E−4 | | | | | | 257 |
| Li₃InBr_{2.5}Cl_{3.5} | 3.60E−6 | | | | | | 257 |
| Li₃InBr₂Cl₄ | 6.89E−8 | | | | | | 257 |
| Li_{1.8}Mg_{1.1}Cl₄ | 1.52E−6 | | | | | | 258 |
| Li_{1.6}Mg_{1.2}Cl₄ | 3.07E−6 | | | | | | 258 |
| Li_{1.34}Mg_{1.33}Cl₄ | 3.07E−6 | | | | | | 258 |
| Li_{1.9}Mn_{1.05}Cl₄ | 4.61E−6 | | | | | | 258 |
| Li_{1.72}Mn_{1.14}Cl₄ | 3.62E−6 | | | | | | 258 |
| Li_{1.6}Mn_{1.2}Cl₄ | 1.45E−5 | | | | | | 258 |
| Li_{1.52}Mn_{1.24}Cl₄ | 1.85E−5 | | | | | | 258 |
| Li_{1.34}Mn_{1.33}Cl₄ | 9.57E−6 | | | | | | 258 |
| Li_{1.94}Cl_{1.03}Cl₄ | 2.56E−6 | | | | | | 258 |
| Li_{1.90}Cd_{1.05}Cl₄ | 3.50E−6 | | | | | | 258 |
| Li₂OHBrF | 7.10E−7 | | | | | | 259 |
| Li₂OHBr_{0.99}F_{0.01} | 9.16E−7 | | | | | | 259 |
| Li₂OHBr_{0.98}F_{0.02} | 1.11E−6 | | | | | | 259 |
| Li₂OHBr_{0.95}F_{0.05} | 6.75E−7 | | | | | | 259 |
| Li₂OHBr_{0.9}F_{0.1} | 6.80E−7 | | | | | | 259 |
| Li₂OHBr_{0.8}F_{0.2} | 5.44E−7 | | | | | | 259 |
| Li₃(OH)₂Cl | 2.72E−8 | 0.88 | | | | | 260 |
| Li₅(OH)₃Cl₂ | 2.52E−8 | 0.75 | | | | | 260 |
| Li₂OHCl | 4.28E−8 | 0.56 | | | | | 260 |
| Li₅(OH)₂Cl₃ | 1.48E−7 | 0.49 | | | | | 260 |
| Li₃OHCl₂ | 8.92E−8 | 0.67 | | | | | 260 |
| Li_{3.7}Zn_{0.15}GeO₄ | 4.63E−7 | | | | | | 261 |
| Li_{3.5}Zn_{0.25}GeO₄ | 2.42E−7 | | | | | | 261 |
| Li_{3.1}Zn_{0.45}GeO₄ | 9.89E−8 | | | | | | 261 |
| Li_{2.8}Zn_{0.6}GeO₄ | 1.27E−7 | | | | | | 261 |
| Li_{2.6}Zn_{0.7}GeO₄ | 5.79E−8 | | | | | | 261 |
| Li_{2.3}Zn_{0.85}GeO₄ | 4.23E−9 | | | | | | 261 |
| Li₇La_{2.75}Ca_{0.25}Zr_{1.75}Nb_{0.25}O₁₂ | 2.2E−4 | 0.35 | | | | | 262 |
| Li_{1.5}Cr_{0.5}Ti_{1.5}(PO₄)₃ | 1.98E−4 | 0.29 | | | | | 263 |
| Li₃V₂(PO₄)₃ | 2.09E−7 | | | | | | 263 |
| Li₃V_{1.8}Al_{0.2}(PO₄)₃ | 1.88E−6 | | | | | | 263 |
| Li₃V_{1.6}Al_{0.4}(PO₄)₃ | 6.21E−6 | | | | | | 263 |
| Li₃V_{1.4}Al_{0.6}(PO₄)₃ | 9.34E−7 | | | | | | 263 |
| Li₇P_{2.9}Mn_{0.1}S_{10.7}I_{0.3} | 5.6E−3 | 0.22 | | | | | 264 |
| 0.3 Li₂S * 0.7 SiS₂ | 1.6E−6 | 0.46 | | | | | 265 |
| 0.4 Li₂S * 0.6 SiS₂ | 2.8E−5 | 0.38 | | | | | 265 |
| 0.5 Li₂S * 0.5 SiS₂ | 1.0E−4 | 0.32 | | | | | 265 |
| 0.6 Li₂S * 0.4 SiS₂ | 5.0E−4 | 0.25 | | | | | 265 |
| (2Li₂S—P₂S₅) | 1.12E−4 | | | | | | 266 |
| (2Li₂S—P₂S₅)_{0.85}(LiI)_{0.15} | 2.35E−4 | | | | | | 266 |
| (2Li₂S—P₂S₅)_{0.75}(LiI)_{0.25} | 3.96E−4 | | | | | | 266 |
| (2Li₂S—P₂S₅)_{0.60}(LiI)_{0.40} | 7.60E−4 | | | | | | 266 |
| (2Li₂S—P₂S₅)_{0.55}(LiI)_{0.45} | 1.12E−3 | | | | | | 266 |
| 0.14SiS₂—0.09P₂S₅—0.47Li₂S—0.30LiI | 1.32E−3 | 0.34 | | | | | 267 |
| 0.26B₂S₃—0.3Li₂S—0.44LiI | 1.57E−3 | 0.3 | | | | | 268 |
| 0.26B₂S₃—0.31Li₂S—0.43LiI | 7.99E−4 | 0.33 | | | | | 268 |
| 0.27B₂S₃—0.32Li₂S—0.41LiI | 4.25E−4 | 0.35 | | | | | 268 |
| 0.5SiS₂—0.5Li₂S | 1.5E−4 | 0.34 | | | | | 269 |
| 0.1LiBr—0.45SiS₂—0.45Li₂S | 1.9E−4 | 0.30 | | | | | 269 |
| 0.2LiBr—0.4SiS₂—0.4Li₂S | 2.1E−4 | 0.33 | | | | | 269 |
| 0.25LiBr—0.38SiS₂—0.38Li₂S | 2.4E−4 | 0.31 | | | | | 269 |
| 0.3LiBr—0.3SiS₂—0.35Li₂S | 3.2E−4 | 0.33 | | | | | 269 |
| 0.35LiBr—0.33SiS₂—0.33Li₂S | 2.3E−4 | 0.38 | | | | | 269 |
| 0.4LiBr—0.3SiS₂—0.3Li₂S | 1.1E−4 | 0.42 | | | | | 269 |
| SiS₂—Li₂S | 1.20E−4 | 0.35 | | | | | 270 |
| 0.9(SiS₂—Li₂S)—0.1LiCl | 1.84E−4 | 0.34 | | | | | 270 |
| 0.8(SiS₂—Li₂S)—0.2LiCl | 2.35E−4 | 0.33 | | | | | 270 |
| 0.75(SiS₂—Li₂S)—0.25LiCl | 2.66E−4 | 0.35 | | | | | 270 |
| 0.7(SiS₂—Li₂S)—0.3LiCl | 2.33E−4 | 0.35 | | | | | 270 |
| 0.65(SiS₂—Li₂S)—0.35LiCl | 1.78E−4 | 0.36 | | | | | 270 |
| 0.6(SiS₂—Li₂S)—0.4LiCl | 0.93E−4 | 0.34 | | | | | 270 |
| (0.4SiS₂—0.6Li₂S) | 5.3E−4 | 0.33 | | | | | 271 |
| 0.9(0.4SiS₂—0.6Li₂S)—0.1LiI | 6.5E−4 | 0.31 | | | | | 271 |
| 0.8(0.4SiS₂—0.6Li₂S)—0.2LiI | 7.7E−4 | 0.30 | | | | | 271 |
| 0.7(0.4SiS₂—0.6Li₂S)—0.3LiI | 1.15E−3 | 0.29 | | | | | 271 |
| 0.6(0.4SiS₂—0.6Li₂S)—0.4LiI | 1.78E−3 | 0.28 | | | | | 271 |
| 0.55(0.4SiS₂—0.6Li₂S)—0.45LiI | 1.41E−3 | 0.29 | | | | | 271 |
| 0.24SiS₂—0.36Li₂S—0.4LiI | 1.8E−3 | 0.28 | | | | | 272 |
| 0.28SiS₂—0.42Li₂S—0.30LiI | 1.8E−3 | 0.31 | | | | | 273 |
| 0.14SiS₂—0.09P₂S₅—0.47Li₂S—0.30LiI | 2.1E−3 | 0.34 | | | | | 273 |
| 0.27SiS₂—0.03Al₂S₃—0.30Li₂S—0.40LiI | 1.2E−3 | 0.34 | | | | | 273 |
| 0.21SiS₂—0.09B₂S₃—0.30Li₂S—0.40LiI | 1.7E−3 | 0.30 | | | | | 273 |
| 0.30Li₂S—0.7GeS₂ | 4.4E−7 | 0.63 | | | | | 274 |
| 0.40Li₂S—0.60GeS₂ | 3.2E−6 | 0.52 | | | | | 274 |
| 0.50Li₂S—0.50GeS₂ | 4.0E−5 | 0.51 | | | | | 274 |
| 0.3Li₂S—0.7P₂S₅ | 1.7E−2 | 0.18 | | | | | 275 |
| 0.7Li₂S—0.3P₂S₅ | 3.2E−3 | 0.12 | | | | | 276 |
| 0.6Li₂S—0.4P₂S₅ | 1.5E−4 | 0.31 | | | | | 277 |
| 0.95(0.6Li₂S—0.4SiS₂)—0.05Li₄SiO₄ | 1.58E−3 | 0.34 | | | | | 278 |
| 0.9(0.6Li₂S—0.4SiS₂)—0.1Li₄SiO₄ | 4.34E−4 | 0.37 | | | | | 278 |
| 0.8(0.6Li₂S—0.4SiS₂)—0.2Li₄SiO₄ | 1.59E−4 | 0.43 | | | | | 278 |
| 0.95(0.6Li₂S—0.4SiS₂)—0.05Li₃PO₄ | 8.68E−4 | 0.35 | | | | | 278 |
| 0.7(0.6Li₂S—0.4SiS₂)—0.3Li₃PO₄ | 2.08E−5 | 0.46 | | | | | 278 |
| 0.6(0.6Li₂S—0.4SiS₂)—0.4Li₃PO₄ | 5.33E−6 | 0.51 | | | | | 278 |
| 0.95(0.6Li₂S—0.4SiS₂)—0.05Li₄GeO₄ | 1.19E−3 | 0.28 | | | | | 278 |
| 0.9(0.6Li₂S—0.4SiS₂)—0.1Li₄GeO₄ | 3.18E−4 | 0.35 | | | | | 278 |
| 0.85(0.6Li₂S—0.4SiS₂)—0.15Li₄GeO₄ | 1.14E−4 | 0.40 | | | | | 278 |
| 0.95(0.6Li₂S—0.4SiS₂)—0.05Li₃BO₃ | 1.44E−3 | 0.33 | | | | | 278 |
| 0.93(0.6Li₂S—0.4SiS₂)—0.07Li₃BO₃ | 3.84E−4 | 0.35 | | | | | 278 |
| 0.85(0.6Li₂S—0.4SiS₂)—0.15Li₃BO₃ | 3.42E−4 | 0.36 | | | | | 278 |
| 0.75(0.6Li₂S—0.4SiS₂)—0.25Li₃BO₃ | 7.06E−5 | 0.38 | | | | | 278 |
| 0.95(0.6Li₂S—0.4SiS₂)—0.05Li₃AlO₃ | 1.31E−3 | 0.31 | | | | | 278 |
| 0.94(0.6Li₂S—0.4SiS₂)—0.06Li₃AlO₃ | 6.83E−4 | 0.34 | | | | | 278 |
| 0.92(0.6Li₂S—0.4SiS₂)—0.08Li₃AlO₃ | 4.04E−4 | 0.34 | | | | | 278 |
| 0.825(0.6Li₂S—0.4SiS₂)—0.175Li₃AlO₃ | 1.31E−4 | 0.36 | | | | | 278 |
| 0.975(0.6Li₂S—0.4SiS₂)—0.025Li₃GaO₃ | 6.82E−4 | 0.31 | | | | | 278 |
| 0.95(0.6Li₂S—0.4SiS₂)—0.05Li₃GaO₃ | 3.25E−4 | 0.32 | | | | | 278 |
| 0.92(0.6Li₂S—0.4SiS₂)—0.08Li₃GaO₃ | 3.03E−4 | 0.35 | | | | | 278 |
| 0.89(0.6Li₂S—0.4SiS₂)—0.11Li₃GaO₃ | 1.13E−4 | 0.38 | | | | | 278 |
| 0.97(0.6Li₂S—0.4SiS₂)—0.03Li₃InO₃ | 3.09E−4 | 0.34 | | | | | 278 |
| 0.95(0.6Li₂S—0.4SiS₂)—0.05Li₃InO₃ | 3.25E−4 | 0.35 | | | | | 278 |
| 0.9(0.6Li₂S—0.4SiS₂)—0.1Li₃InO₃ | 6.84E−5 | 0.40 | | | | | 278 |
| 0.95(0.6Li₂S—0.4SiS₂)—0.05Li₄SiO₄ | 1.54E−3 | 0.38 | | | | | 279 |
| 0.9(0.6Li₂S—0.4SiS₂)—0.1Li₄SiO₄ | 4.39E−4 | 0.40 | | | | | 279 |
| 0.95(0.6Li₂S—0.4SiS₂)—0.05Li₂SO₄ | 4.53E−4 | 0.41 | | | | | 279 |
| 0.9(0.6Li₂S—0.4SiS₂)—0.1Li₂SO₄ | 4.70E−5 | 0.45 | | | | | 279 |
| 0.5Li₂O—0.1TiO₂—0.4P₂O₅ | 5.67E−8 | 0.56 | | | | | 280 |
| 0.5025Li₂O—0.0025Al₂O₃—0.095TiO₂—0.4P₂O₅ | 1.56E−8 | 0.55 | | | | | 280 |
| 0.505Li₂O—0.005Al₂O₃—0.09TiO₂—0.4P₂O₅ | 1.78E−7 | 0.50 | | | | | 280 |
| 0.5075Li₂O—0.0075Al₂O₃—0.085TiO₂—0.4P₂O₅ | 2.51E−7 | 0.57 | | | | | 280 |
| 0.51Li₂O—0.01Al₂O₃—0.08TiO₂—0.4P₂O₅ | 1.58E−7 | 0.55 | | | | | 280 |
| 0.515Li₂O—0.015Al₂O₃—0.07TiO₂—0.4P₂O₅ | 1.25E−7 | 0.56 | | | | | 280 |
| 0.525Li₂O—0.025Al₂O₃—0.05TiO₂—0.4P₂O₅ | 2.17E−7 | 0.56 | | | | | 280 |
| 0.53Li₂O—0.03Al₂O₃—0.04TiO₂—0.4P₂O₅ | 2.72E−7 | 0.54 | | | | | 280 |
| 0.54Li₂O—0.04Al₂O₃—0.02TiO₂—0.4P₂O₅ | 1.97E−7 | 0.55 | | | | | 280 |
| 0.545Li₂O—0.045Al₂O₃—0.01TiO₂—0.4P₂O₅ | 7.14E−8 | 0.56 | | | | | 280 |
| 0.95(0.6Li₂S—0.4SiS₂)—0.05Li₄SiO₄ | 1.51E−3 | 0.34 | | | | | 281 |
| 0.90(0.6Li₂S—0.4SiS₂)—0.1Li₄SiO₄ | 4.34E−4 | 0.37 | | | | | 281 |
| 0.8(0.6Li₂S—0.4SiS₂)—0.2Li₄SiO₄ | 1.63E−4 | 0.43 | | | | | 281 |
| 0.95(0.6Li₂S—0.4SiS₂)—0.05Li₃PO₄ | 9.32E−4 | 0.35 | | | | | 281 |
| 0.9(0.6Li₂S—0.4SiS₂)—0.1Li₃PO₄ | 4.55E−4 | 0.37 | | | | | 281 |
| 0.7(0.6Li₂S—0.4SiS₂)—0.3Li₃PO₄ | 2.08E−5 | 0.46 | | | | | 281 |
| 0.6(0.6Li₂S—0.4SiS₂)—0.4Li₃PO₄ | 5.33E−6 | 0.51 | | | | | 281 |
| 0.95(0.6Li₂S—0.4SiS₂)—0.05Li₄GeO₄ | 1.21E−3 | 0.28 | | | | | 281 |
| 0.9(0.6Li₂S—0.4SiS₂)—0.1Li₄GeO₄ | 3.18E−4 | 0.34 | | | | | 281 |
| 0.85(0.6Li₂S—0.4SiS₂)—0.15Li₄GeO₄ | 1.14E−4 | 0.41 | | | | | 281 |
| Li₇PS₆ | 8.0E−5 | | | | | | 282 |
| 0.7Li₂S—0.3P₂S₅ | 3.2E−3 | 0.12 | | | | | 283 |
| 0.95(0.6Li₂S—0.4SiS₂)—0.05Li₃BO₃ | 1.40E−3 | | | | | | 284 |
| 0.93(0.6Li₂S—0.4SiS₂)—0.07Li₃BO₃ | 3.71E−4 | | | | | | 284 |
| 0.85(0.6Li₂S—0.4SiS₂)—0.15Li₃BO₃ | 3.39E−4 | | | | | | 284 |
| 0.75(0.6Li₂S—0.4SiS₂)—0.25Li₃BO₃ | 7.15E−5 | | | | | | 284 |
| 0.95(0.6Li₂S—0.4SiS₂)—0.05Li₃AlO₃ | 1.22E−3 | | | | | | 284 |
| 0.94(0.6Li₂S—0.4SiS₂)—0.06Li₃AlO₃ | 6.67E−4 | | | | | | 284 |
| 0.92(0.6Li₂S—0.4SiS₂)—0.08Li₃AlO₃ | 3.94E−4 | | | | | | 284 |
| 0.825(0.6Li₂S—0.4SiS₂)—0.175Li₃AlO₃ | 1.25E−4 | | | | | | 284 |
| 0.975(0.6Li₂S—0.4SiS₂)—0.025Li₃GaO₃ | 7.05E−4 | | | | | | 284 |
| 0.95(0.6Li₂S—0.4SiS₂)—0.05Li₃GaO₃ | 3.36E−4 | | | | | | 284 |
| 0.92(0.6Li₂S—0.4SiS₂)—0.08Li₃GaO₃ | 3.06E−4 | | | | | | 284 |
| 0.89(0.6Li₂S—0.4SiS₂)—0.11Li₃GaO₃ | 1.20E−4 | | | | | | 284 |
| 0.97(0.6Li₂S—0.4SiS₂)—0.03Li₃InO₃ | 3.11E−4 | | | | | | 284 |
| 0.95(0.6Li₂S—0.4SiS₂)—0.05Li₃InO₃ | 2.99E−4 | | | | | | 284 |
| 0.90(0.6Li₂S—0.4SiS₂)—0.10Li₃InO₃ | 6.81E−5 | | | | | | 284 |
| (0.67Li₂S—0.33SiS₂)—(0.75Li₂S—0.25P₂S₅) | 1.2E−3 | 0.28 | | | | | 285 |
| 0.2Li₃N—0.8SiS₂ | 1.46E−6 | 0.45 | | | | | 286 |
| 0.3Li₃N—0.7SiS₂ | 2.97E−5 | 0.36 | | | | | 286 |
| 0.4Li₃N—0.6SiS₂ | 2.74E−4 | 0.30 | | | | | 286 |
| 0.5Li₃N—0.5SiS₂ | 4.47E−5 | 0.34 | | | | | 286 |
| 0.6Li₃N—0.4SiS₂ | 2.25E−8 | 0.63 | | | | | 286 |
| 0.6Li₂S—0.4P₂S₃ | 5.70E−6 | | | | | | 287 |
| 0.63Li₂S—0.37P₂S₃ | 2.55E−5 | | | | | | 287 |
| 0.667Li₂S—0.333P₂S₃ | 1.1E−4 | 0.40 | | | | | 287 |
| 0.7Li₂S—0.3P₂S₃ | 7.90E−5 | | | | | | 287 |
| 0.75Li₂S—0.25P₂S₃ | 5.08E−5 | | | | | | 287 |
| 0.6Li₂S—0.4SiS₂ | 5.1E−4 | 0.33 | | | | | 288 |
| 0.555Li₂S—0.4SiS₂—0.045Li₃N | 1.5E−3 | 0.28 | | | | | 288 |
| 0.525Li₂S—0.4SiS₂—0.075Li₃N | 9.6E−4 | 0.29 | | | | | 288 |
| 0.1Li₂O—0.1LiCl—0.65B₂O₃—0.1SiO₂—0.05Al₂O₃ | 1.9E−4 | 0.427 | | | | | 289 |
| 0.75Li₂O—0.25P₂S₅ | 1.80E−5 | 0.48 | | | | | 290 |
| 0.75(0.7Li₂O—0.3Li₂S)—0.25P₂S₅ | 2.42E−5 | 0.48 | | | | | 290 |
| 0.75(0.5Li₂O—0.5Li₂S)—0.25P₂S₅ | 2.83E−5 | 0.46 | | | | | 290 |
| 0.75(0.4Li₂O—0.6Li₂S)—0.25P₂S₅ | 4.99E−5 | 0.44 | | | | | 290 |
| 0.75(0.3Li₂O—0.7Li₂S)—0.25P₂S₅ | 8.89E−5 | 0.40 | | | | | 290 |
| 0.75(0.2Li₂O—0.8Li₂S)—0.25P₂S₅ | 1.63E−4 | 0.38 | | | | | 290 |
| 0.75(0.1Li₂O—0.9Li₂S)—0.25P₂S₅ | 2.27E−4 | 0.36 | | | | | 290 |
| 0.75Li₂S—0.25P₂S₅ | 1.80E−4 | 0.41 | | | | | 290 |
| 0.45Li₂—0.55SiS₂ | 1.08E−4 | 0.40 | | | | | 291 |
| 0.5Li₂—0.5SiS₂ | 3.36E−4 | 0.32 | | | | | 291 |
| 0.55Li₂—0.45SiS₂ | 6.53E−4 | 0.30 | | | | | 291 |
| 0.60Li₂—0.4SiS₂ | 1.19E−3 | 0.29 | | | | | 291 |
| 0.63Li₂—0.37SiS₂ | 1.05E−3 | 0.30 | | | | | 291 |
| 0.65Li₂—0.35SiS₂ | 7.41E−4 | 0.33 | | | | | 291 |
| 0.95(0.5Li₂—0.5SiS₂)—0.05(0.5Li₂O—0.5P₂O₅) | 4.27E−4 | 0.38 | | | | | 291 |
| 0.95(0.53Li₂—0.47SiS₂)—0.05(0.53Li₂O—0.47P₂O₅) | 5.91E−4 | 0.33 | | | | | 291 |
| 0.95(0.55Li₂—0.45SiS₂)—0.05(0.55Li₂O—0.45P₂O₅) | 1.01E−3 | 0.34 | | | | | 291 |
| 0.95(0.58Li₂—0.42SiS₂)—0.05(0.58Li₂O—0.42P₂O₅) | 1.06E−3 | 0.34 | | | | | 291 |
| 0.95(0.6Li₂—0.4SiS₂)—0.05(0.6Li₂O—0.4P₂O₅) | 1.01E−3 | 0.27 | | | | | 291 |
| 0.95(0.63Li₂—0.37SiS₂)—0.05(0.63Li₂O—0.37P₂O₅) | 8.71E−4 | 0.33 | | | | | 291 |
| 0.95(0.65Li₂—0.35SiS₂)—0.05(0.65Li₂O—0.35P₂O₅) | 5.34E−4 | 0.32 | | | | | 291 |
| 0.95(0.67Li₂—0.33SiS₂)—0.05(0.67Li₂O—0.33P₂O₅) | 1.99E−4 | 0.37 | | | | | 291 |
| 0.8(0.55Li₂—0.45SiS₂)—0.2(0.55Li₂O—0.45P₂O₅) | 7.88E−5 | 0.41 | | | | | 291 |
| 0.8(0.6Li₂—0.4SiS₂)—0.2(0.6Li₂O—0.4P₂O₅) | 7.69E−5 | 0.41 | | | | | 291 |
| 0.8(0.65Li₂—0.35SiS₂)—0.2(0.65Li₂O—0.35P₂O₅) | 5.21E−5 | 0.42 | | | | | 291 |
| 0.65Li₂S—0.35P₂S₅ | 4.14E−5 | | | | | | 292 |
| 0.675Li₂S—0.325P₂S₅ | 7.84E−5 | | | | | | 292 |
| 0.7Li₂S—0.3P₂S₅ | 1.58E−3 | 0.39 | | | | | 292 |
| 0.725Li₂S—0.275P₂S₅ | 4.51E−4 | | | | | | 292 |
| 0.75Li₂S—0.25P₂S₅ | 3.67E−4 | | | | | | 292 |
| 0.6Li₂S—0.4SiS₂ | 1.69E−4 | | | | | | 293 |
| 0.1LiI—0.9(0.6Li₂S—0.4SiS₂) | 2.35E−4 | | | | | | 293 |
| 0.2LiI—0.8(0.6Li₂S—0.4SiS₂) | 3.52E−4 | | | | | | 293 |
| 0.3LiI—0.7(0.6Li₂S—0.4SiS₂) | 7.42E−4 | | | | | | 293 |
| 0.5Li₂S—0.5SiS₂ | 1.58E−6 | | | | | | 293 |
| 0.1LiI—0.9(0.5Li₂S—0.5SiS₂) | 3.99E−5 | | | | | | 293 |
| 0.2LiI—0.8(0.6Li₂S—0.4SiS₂) | 1.23E−4 | | | | | | 293 |
| 0.3LiI—0.7(0.6Li₂S—0.4SiS₂) | 3.62E−4 | | | | | | 293 |
| Li₆Si₂S₇ | 4.11E−4 | 0.37 | | | | | 294 |
| 0.95Li₆Si₂S₇—0.05Li₆B₄O₉ | 4.11E−4 | 0.35 | | | | | 294 |
| 0.9Li₆Si₂S₇—0.1Li₆B₄O₉ | 3.76E−4 | 0.39 | | | | | 294 |
| 0.875Li₆Si₂S₇—0.125Li₆B₄O₉ | 2.77E−4 | 0.39 | | | | | 294 |
| 0.75Li₆Si₂S₇—0.25Li₆B₄O₉ | 1.42E−4 | 0.40 | | | | | 294 |
| 0.95Li₆Si₂S₇—0.05Li₆B₄S₉ | 4.90E−4 | 0.37 | | | | | 294 |
| 0.925Li₆Si₂S₇—0.075Li₆B₄S₉ | 3.65E−4 | 0.38 | | | | | 294 |
| 0.9Li₆Si₂S₇—0.1Li₆B₄S₉ | 4.73E−4 | 0.38 | | | | | 294 |
| 0.875Li₆Si₂S₇—0.125Li₆B₄S₉ | 4.40E−4 | 0.37 | | | | | 294 |
| 0.75Li₆Si₂S₇—0.25Li₆B₄S₉ | 5.02E−4 | 0.36 | | | | | 294 |
| 0.63Li₆Si₂S₇—0.37Li₆B₄S₉ | 4.39E−4 | 0.39 | | | | | 294 |
| (Li₂S)₆₀(SiS₂)₂₈(P₂S₅)₁₂ | 1.23E−3 | 0.34 | | | | | 295 |
| Li₇La₃Zr₂O₁₂-5 wt % LiPO₃ | 2.5E−6 | 0.51 | | | | | 120 |
| Li₇La₃Zr₂O₁₂-3 wt % | 1.5E−5 | 0.44 | | | | | 120 |
| 65Li₂O•27B₂O₃•8SiO₂ | | | | | | | |
| Li₇La₃Zr₂O₁₂-5 wt % | 2.5E−5 | 0.39 | | | | | 120 |
| 40.2Li₂O•5.7Y₂O₃•54.1SiO₂ | | | | | | | |
| 0.6Li₂S—0.4P₂S₅ | 3.32E−6 | 0.52 | | | | | 296 |
| 0.667Li₂S—0.333P₂S₅ | 3.836E−5 | 0.44 | | | | | 296 |
| 0.7Li₂S—0.3P₂S₅ | 3.77E−5 | 0.45 | | | | | 296 |
| 0.75Li₂S—0.25P₂S₅ | 2.79E−4 | 0.40 | | | | | 296 |
| 0.8Li₂S—0.2P₂S₅ | 1.32E−4 | 0.44 | | | | | 296 |
| (0.75Li₂S—0.25P₂S₅) | 2.68E−4 | 0.26 | | | | | 297 |
| 0.95(0.75Li₂S—0.25P₂S₅)—0.05LiBH₄ | 3.98E−4 | 0.25 | | | | | 297 |
| 0.89(0.75Li₂S—0.25P₂S₅)—0.11LiBH₄ | 6.18E−4 | 0.26 | | | | | 297 |
| 0.67(0.75Li₂S—0.25P₂S₅)—0.33LiBH₄ | 1.13E−3 | 0.21 | | | | | 297 |
| Li₇P_{2.9}S_{10.85}Mo_{0.01} | 4.8E−3 | 0.24 | | | | | 298 |
| Li₇P₃S₁₁ | 2.6E−3 | 0.29 | | | | | 298 |
| Li₇P_{2.9}Mn_{0.1}S_{10.7}I_{0.3} | 5.6E−3 | 0.22 | | | | | 299 |
| Li₁₁AlP₂S₁₂ | 8.02E−4 | 0.26 | | | | | 300 |
| Li₃PS₄ | 1.78E−4 | 0.33 | | | | | 301 |
| Li₃PS₄ - 2 wt % Al₂O₃ | 2.27E−4 | 0.35 | | | | | 301 |
| Li₃PS₄ - 5 wt % Al₂O₃ | 1.96E−4 | 0.35 | | | | | 301 |
| Li₃PS₄ - 8 wt % Al₂O₃ | 1.60E−4 | 0.36 | | | | | 301 |
| Li₃PS₄ - 10 wt % Al₂O₃ | 1.50E−4 | 0.36 | | | | | 301 |
| Li₃PS₄ - 30 wt % Al₂O₃ | 9.96E−5 | 0.36 | | | | | 301 |
| Li₃PS₄ - 50 wt % Al₂O₃ | 9.38E−7 | 0.44 | | | | | 301 |
| Li₃PS₄ - 70 wt % Al₂O₃ | 3.92E−8 | 0.60 | | | | | 301 |
| Li₃PS₄ - 90 wt % Al₂O₃ | 1.54E−9 | 0.79 | | | | | 301 |
| Li₃PS₄ - 2 wt % SiO₂ | 2.28E−4 | 0.32 | | | | | 301 |
| Li₃PS₄ - 5 wt % SiO₂ | 1.96E−4 | 0.33 | | | | | 301 |
| Li₃PS₄ - 8 wt % SiO₂ | 1.60E−4 | 0.33 | | | | | 301 |
| Li₃PS₄ - 10 wt % SiO₂ | 1.50E−4 | 0.33 | | | | | 301 |
| Li₃PS₄ - 30 wt % SiO₂ | 1.00E−4 | 0.35 | | | | | 301 |
| Li₃PS₄ - 50 wt % SiO₂ | 3.80E−5 | 0.36 | | | | | 301 |
| Li₃PS₄ - 70 wt % SiO₂ | 5.92E−6 | 0.38 | | | | | 301 |
| Li₃PS₄ - 90 wt % SiO₂ | 8.53E−9 | 0.41 | | | | | 301 |
| Li₃PS₄ - 5 wt % Li₆ZnNb₄O₁₄ | 2.28E−4 | 0.29 | | | | | 301 |
| Li₃PS₄ - 10 wt % Li₆ZnNb₄O₁₄ | 2.43E−4 | 0.31 | | | | | 301 |
| Li₃PS₄ - 15 wt % Li₆ZnNb₄O₁₄ | 2.41E−4 | 0.32 | | | | | 301 |
| Li₃PS₄ - 20 wt % Li₆ZnNb₄O₁₄ | 2.22E−4 | 0.33 | | | | | 301 |
| Li₃PS₄ - 30 wt % Li₆ZnNb₄O₁₄ | 1.87E−4 | 0.34 | | | | | 301 |
| Li₃PS₄ - 50 wt % Li₆ZnNb₄O₁₄ | 1.42E−4 | 0.36 | | | | | 301 |
| Li₃PS₄ - 70 wt % Li₆ZnNb₄O₁₄ | 7.23E−5 | 0.38 | | | | | 301 |
| Li₃PS₄ - 90 wt % Li₆ZnNb₄O₁₄ | 2.99E−7 | 0.40 | | | | | 301 |
| Li₃PS₄ | 1.46E−4 | 0.38 | | | | | 302 |
| Li₃PS₄ - 10 wt % Li₇La₃Zr₂O₁₂ | 2.96E−4 | 0.36 | | | | | 302 |
| Li₃PS₄ - 20 wt % Li₇La₃Zr₂O₁₂ | 3.70E−4 | 0.35 | | | | | 302 |
| Li₃PS₄ - 25 wt % Li₇La₃Zr₂O₁₂ | 4.10E−4 | 0.35 | | | | | 302 |
| Li₃PS₄ - 30 wt % Li₇La₃Zr₂O₁₂ | 5.38E−4 | 0.36 | | | | | 302 |
| Li₃PS₄ - 35 wt % Li₇La₃Zr₂O₁₂ | 4.00E−4 | 0.36 | | | | | 302 |
| Li₃PS₄ - 40 wt % Li₇La₃Zr₂O₁₂ | 3.33E−4 | 0.36 | | | | | 302 |
| Li₃PS₄ - 60 wt % Li₇La₃Zr₂O₁₂ | 2.19E−4 | 0.40 | | | | | 302 |
| Li₃PS₄ - 70 wt % Li₇La₃Zr₂O₁₂ | 1.26E−5 | 0.43 | | | | | 302 |
| Li₃PS₄ - 90 wt % Li₇La₃Zr₂O₁₂ | 6.04E−6 | 0.44 | | | | | 302 |
| Li₇La₃Zr₂O₁₂ | 5.20E−8 | 0.47 | | | | | 302 |
| Li_{3.45}Ge_{0.45}P_{0.55}S_{3.1}Se_{0.9} | 9.8E−4 | | | | | | 303 |
| Li_{3.4}Ge_{0.4}P_{0.6}S_{3.2}Se_{0.8} | 1.17E−3 | | | | | | 303 |
| Li_{3.35}Ge_{0.35}P_{0.65}S_{3.3}Se_{0.7} | 1.20E−3 | | | | | | 303 |
| Li_{3.3}Ge_{0.3}P_{0.7}S_{3.4}Se_{0.6} | 1.33E−3 | | | | | | 303 |
| Li_{3.25}Ge_{0.25}P_{0.75}S_{3.5}Se_{0.5} | 5.03E−4 | | | | | | 303 |
| Li_{3.20}Ge_{0.20}P_{0.8}S_{3.6}Se_{0.4} | 1.08E−3 | | | | | | 303 |
| Li_{3.15}Ge_{0.15}P_{0.85}S_{3.7}Se_{0.3} | 8.16E−4 | | | | | | 303 |
| Li_{3.1}Ge_{0.1}P_{0.9}S_{3.8}Se_{0.2} | 1.13E−3 | | | | | | 303 |
| Li_{3.05}Ge_{0.05}P_{0.95}S_{3.9}Se_{0.1} | 1.41E−3 | | | | | | 303 |
| Li₃PS₄ | 9.35E−4 | | | | | | 303 |
| 0.8Li₂0—0.2P₂S₅ | 1.54E−5 | | | | | | 304 |
| 0.05Li₂S—0.75Li₂O—0.2P₂S₅ | 1.39E−5 | | | | | | 304 |
| 0.1Li₂S—0.7Li₂O—0.2P₂S₅ | 1.59E−5 | | | | | | 304 |
| 0.15Li₂S—0.65Li₂O—0.2P₂S₅ | 2.32E−5 | | | | | | 304 |
| 0.2Li₂S—0.6Li₂O—0.2P₂S₅ | 2.89E−5 | | | | | | 304 |
| 0.25Li₂S—0.55Li₂O—0.2P₂S₅ | 3.80E−5 | | | | | | 304 |
| 0.3Li₂S—0.5Li₂O—0.2P₂S₅ | 4.35E−5 | | | | | | 304 |
| 0.35Li₂S—0.45Li₂O—0.2P₂S₅ | 5.26E−5 | | | | | | 304 |
| 0.4Li₂S—0.4Li₂O—0.2P₂S₅ | 4.45E−5 | | | | | | 304 |
| 0.45Li₂S—0.35Li₂O—0.2P₂S₅ | 6.35E−5 | | | | | | 304 |
| 0.5Li₂S—0.3Li₂O—0.2P₂S₅ | 8.11E−5 | | | | | | 304 |
| 0.55Li₂S—0.25Li₂O—0.2P₂S₅ | 1.12E−4 | | | | | | 304 |
| 0.6Li₂S—0.2Li₂O—0.2P₂S₅ | 1.12E−4 | | | | | | 304 |
| 0.65Li₂S—0.15Li₂O—0.2P₂S₅ | 1.13E−4 | | | | | | 304 |
| 0.7Li₂S—0.1Li₂O—0.2P₂S₅ | 1.09E−4 | | | | | | 304 |
| 0.75Li₂S—0.05Li₂O—0.2P₂S₅ | 1.43E−4 | | | | | | 304 |
| 0.8Li₂S—0.2P₂S₅ | 2.99E−4 | | | | | | 304 |
| 0.75Li₂O—0.25P₂S₅ | 1.55E−5 | | | | | | 304 |
| 0.05Li₂S—0.7Li₂O—0.25P₂S₅ | 1.42E−5 | | | | | | 304 |
| 0.1Li₂S—0.65Li₂O—0.25P₂S₅ | 2.52E−5 | | | | | | 304 |
| 0.15Li₂S—0.6Li₂O—0.25P₂S₅ | 2.67E−5 | | | | | | 304 |
| 0.2Li₂S—0.55Li₂O—0.25P₂S₅ | 2.74E−5 | | | | | | 304 |
| 0.25Li₂S—0.5Li₂O—0.25P₂S₅ | 3.80E−5 | | | | | | 304 |
| 0.3Li₂S—0.45Li₂O—0.25P₂S₅ | 5.88E−5 | | | | | | 304 |
| 0.35Li₂S—0.4Li₂O—0.25P₂S₅ | 1.33E−5 | | | | | | 304 |
| 0.4Li₂S—0.35Li₂O—0.25P₂S₅ | 2.44E−5 | | | | | | 304 |
| 0.45Li₂S—0.3Li₂O—0.25P₂S₅ | 2.30E−5 | | | | | | 304 |
| 0.5Li₂S—0.25Li₂O—0.25P₂S₅ | 9.56E−6 | | | | | | 304 |
| 0.55Li₂S—0.2Li₂O—0.25P₂S₅ | 7.06E−5 | | | | | | 304 |
| 0.6Li₂S—0.15Li₂O—0.25P₂S₅ | 9.27E−5 | | | | | | 304 |
| 0.65Li₂S—0.1Li₂O—0.25P₂S₅ | 1.15E−4 | | | | | | 304 |
| 0.7Li₂S—0.05Li₂O—0.25P₂S₅ | 9.76E−5 | | | | | | 304 |
| 0.75Li₂S—0.25P₂S₅ | 1.60E−4 | | | | | | 304 |
| 0.7Li₂0—0.3P₂S₅ | 5.78E−11 | | | | | | 304 |
| 0.05Li₂S—0.65Li₂O—0.3P₂S₅ | 1.51E−8 | | | | | | 304 |
| 0.1Li₂S—0.6Li₂O—0.3P₂S₅ | 7.78E−8 | | | | | | 304 |
| 0.15Li₂S—0.55Li₂O—0.3P₂S₅ | 2.90E−7 | | | | | | 304 |
| 0.2Li₂S—0.5Li₂O—0.3P₂S₅ | 1.67E−5 | | | | | | 304 |
| 0.25Li₂S—0.45Li₂O—0.3P₂S₅ | 8.64E−7 | | | | | | 304 |
| 0.3Li₂S—0.4Li₂O—0.3P₂S₅ | 1.62E−6 | | | | | | 304 |
| 0.35Li₂S—0.35Li₂O—0.3P₂S₅ | 3.68E−6 | | | | | | 304 |
| 0.4Li₂S—0.3Li₂O—0.3P₂S₅ | 5.86E−6 | | | | | | 304 |
| 0.45Li₂S—0.25Li₂O—0.3P₂S₅ | 5.10E−6 | | | | | | 304 |
| 0.5Li₂S—0.2Li₂O—0.3P₂S₅ | 8.33E−6 | | | | | | 304 |
| 0.55Li₂S—0.15Li₂O—0.3P₂S₅ | 1.01E−5 | | | | | | 304 |
| 0.6Li₂S—0.1Li₂O—0.3P₂S₅ | 2.29E−5 | | | | | | 304 |
| 0.65Li₂S—0.05Li₂O—0.3P₂S₅ | 2.48E−5 | | | | | | 304 |
| 0.7Li₂S—0.3P₂S₅ | 5.34E−5 | | | | | | 304 |
| 0.9Li₃PS₄•10ZnO | 2.9E−4 | | | | | | 305 |
| 0.7Li₂S—0.3P₂S₅ | 7.10E−4 | 0.23 | | | | | 306 |
| 0.7Li₂S—0.29P₂S₅—0.01Li₃PO₄ | 1.83E−3 | 0.19 | | | | | 306 |
| 0.7Li₂S—0.28P₂S₅—0.02Li₃PO₄ | 9.89E−4 | 0.21 | | | | | 306 |
| 0.7Li₂S—0.27P₂S₅—0.03Li₃PO₄ | 4.40E−4 | 0.25 | | | | | 306 |
| 0.7Li₂S—0.25P₂S₅—0.05Li₃PO₄ | 2.67E−4 | 0.29 | | | | | 306 |
| 0.7Li₂S—0.3P₂S₅ | 1.67E−3 | 0.23 | | | | | 307 |
| 0.99(0.7Li₂S—0.3P₂S₅)—0.01Li₂ZrO₃ | 2.86E−3 | 0.18 | | | | | 307 |
| 0.98(0.7Li₂S—0.3P₂S₅)—0.02Li₂ZrO₃ | 1.22E−3 | 0.25 | | | | | 307 |
| 0.95(0.7Li₂S—0.3P₂S₅)—0.05Li₂ZrO₃ | 7.42E−4 | 0.29 | | | | | 307 |
| Li_{2.7}PO_{3.9} | 7E−8 | 0.68 | | | | | 308 |
| Li_{3.6}(Si_{0.19}P_{0.82})O_{4.2} | 2.0E−7 | 0.57 | | | | | 308 |
| Li_{3.1}PO_{3.8}N_{0.16} | 2.00E−6 | 0.57 | | | | | 308 |
| Li_{3.3}PO_{3.8}N_{0.22} | 2.40E−6 | 0.56 | | | | | 308 |
| Li_{2.9}PO_{3.3}N_{0.46} | 3.30E−6 | 0.54 | | | | | 308 |
| Li_{4.4}PO_{4.3} | 9.39E−7 | 0.64 | | | | | 309 |
| Li_{4.0}PO_{3.9}N_{0.4} | 1.70E−6 | 0.62 | | | | | 309 |
| Li_{3.7}PO_{3.4}N_{0.7} | 2.36E−6 | 0.60 | | | | | 309 |
| Li_{3.5}PO_{3.2}N_{0.8} | 2.59E−6 | 0.59 | | | | | 309 |
| Li_{3.4}PO_{3.1}N_{0.9} | 2.81E−6 | 0.58 | | | | | 309 |
| Li_{3.2}PO_{3.0}N | 2.99E−6 | 0.57 | | | | | 309 |
| Li_{2.9}PO_{2.6}N_{0.91} | 2.1E−6 | 0.52 | | | | | 310 |
| Li_{1.8}PO_{1.2}N_{1.5} | 1.7E−6 | 0.49 | | | | | 310 |
| Li_{3.3}PO_{2.9}N_{0.83} | 3.1E−6 | 0.47 | | | | | 310 |
| 0.45B₂S₃—0.55Li₂S | 8.19E−5 | 0.23 | | | | | 311 |
| 0.815(0.45B₂S₃—0.55Li₂S)—0.185LiI | 3.08E−4 | 0.20 | | | | | 311 |
| 0.69(0.45B₂S₃—0.55Li₂S)—0.31LiI | 7.58E−4 | 0.23 | | | | | 311 |
| 0.33B₂S₃—0.67Li₂S | 2.26E−4 | 0.31 | | | | | 311 |
| 0.95(0.33B₂S₃—0.67Li₂S)—0.05LiI | 4.37E−4 | 0.29 | | | | | 311 |
| 0.9(0.33B₂S₃—0.67Li₂S)—0.1LiI | 4.81E−4 | 0.28 | | | | | 311 |
| 0.85(0.33B₂S₃—0.67Li₂S)—0.15LiI | 4.92E−4 | 0.28 | | | | | 311 |
| 0.75(0.33B₂S₃—0.67Li₂S)—0.25LiI | 6.10E−4 | 0.27 | | | | | 311 |
| 0.66(0.33B₂S₃—0.67Li₂S)—0.34LiI | 5.22E−4 | 0.32 | | | | | 311 |
| 0.6(0.33B₂S₃—0.67Li₂S)—0.4LiI | 4.89E−4 | 0.35 | | | | | 311 |
| 0.29B₂S₃—0.71Li₂S | 2.71E−4 | 0.32 | | | | | 311 |
| 0.95(0.29B₂S₃—0.71Li₂S)—0.05LiI | 3.72E−4 | 0.31 | | | | | 311 |
| 0.875(0.29B₂S₃—0.71Li₂S)—0.125LiI | 6.27E−4 | 0.29 | | | | | 311 |
| 0.78(0.29B₂S₃—0.71Li₂S)—0.22LiI | 6.56E−4 | 0.29 | | | | | 311 |
| 0.64(0.29B₂S₃—0.71Li₂S)—0.36LiI | 8.10E−4 | 0.36 | | | | | 311 |
| | 3.03E−4 | 0.36 | | | | | 311 |
| 0.92(0.25B₂S₃—0.75Li₂S)—0.08LiI | 3.83E−4 | 0.30 | | | | | 311 |
| 0.89(0.25B₂S₃—0.75Li₂S)—0.11LiI | 3.48E−4 | 0.33 | | | | | 311 |
| 0.5Li₂S—0.5SiS₂ | 4.80E−5 | | | | | | 312 |
| 0.985(0.5Li₂S—0.5SiS₂)—0.015Li₃PO₄ | 6.28E−5 | | | | | | 312 |
| 0.975(0.5Li₂S—0.5SiS₂)—0.025Li₃PO₄ | 8.76E−5 | | | | | | 312 |
| 0.95(0.5Li₂S—0.5SiS₂)—0.05Li₃PO₄ | 8.68E−5 | | | | | | 312 |
| 0.9(0.5Li₂S—0.5SiS₂)—0.1Li₃PO₄ | 6.76E−5 | | | | | | 312 |
| | 1.85E−4 | | | | | | 312 |
| 0.99(0.6Li₂S—0.4SiS₂)—0.01Li₃PO₄ | 2.53E−4 | | | | | | 312 |
| 0.97(0.6Li₂S—0.4SiS₂)—0.03Li₃PO₄ | 3.97E−4 | | | | | | 312 |
| 0.95(0.6Li₂S—0.4SiS₂)—0.05Li₃PO₄ | 2.03E−4 | | | | | | 312 |
| 0.9(0.6Li₂S—0.4SiS₂)—0.1Li₃PO₄ | 5.20E−5 | | | | | | 312 |
| 0.61Li₂S—0.39SiS₂ | 5.24E−4 | | | | | | 312 |
| 0.99(0.61Li₂S—0.39SiS₂)—0.01Li₃PO₄ | 5.05E−4 | | | | | | 312 |
| 0.985(0.61Li₂S—0.39SiS₂)—0.015Li₃PO₄ | 5.96E−4 | | | | | | 312 |
| 0.98(0.61Li₂S—0.39SiS₂)—0.02Li₃PO₄ | 7.69E−4 | | | | | | 312 |
| 0.975(0.61Li₂S—0.39SiS₂)—0.025Li₃PO₄ | 6.36E−4 | | | | | | 312 |
| 0.97(0.61Li₂S—0.39SiS₂)—0.03Li₃PO₄ | 5.83E−4 | | | | | | 312 |
| 0.95(0.61Li₂S—0.39SiS₂)—0.05Li₃PO₄ | 4.68E−4 | | | | | | 312 |
| 0.9(0.61Li₂S—0.39SiS₂)—0.1Li₃PO₄ | 1.28E−4 | | | | | | 312 |
| 0.99(0.65Li₂S—0.35SiS₂)—0.01Li₃PO₄ | 3.60E−4 | | | | | | 312 |
| 0.97(0.65Li₂S—0.35SiS₂)—0.03Li₃PO₄ | 2.62E−4 | | | | | | 312 |
| 0.95(0.65Li₂S—0.35SiS₂)—0.05Li₃PO₄ | 1.81E−4 | | | | | | 312 |
| 0.9(0.65Li₂S—0.35SiS₂)—0.1Li₃PO₄ | 7.13E−5 | | | | | | 312 |
| 0.7Li₂S—0.3P₂S₅ | 5.2E−3 | | | | | | 313 |
| LiI | 3.07E−7 | | | | | | 314 |
| 0.998LiI—0.002CaI₂ | 9.80E−7 | | | | | | 314 |
| 0.99LiI—0.01CaI₂ | 5.54E−6 | 0.43 | | | | | 314 |
| LiI | 2.74E−8 | 0.43 | | | | | 315 |
| 0.8LiI—0.2Al₂O₃ | 6.84E−6 | 0.35 | | | | | 315 |
| 0.7LiI—0.3Al₂O₃ | 2.07E−5 | 0.33 | | | | | 315 |
| 0.6LiI—0.4Al₂O₃ | 3.94E−5 | 0.33 | | | | | 315 |
| 0.5LiI—0.5Al₂O₃ | 2.58E−5 | 0.33 | | | | | 315 |
| 0.4LiI—0.6Al₂O₃ | 6.76E−6 | 0.37 | | | | | 315 |
| Li_{3.5}P_{0.5}Si_{0.5}O₄ | 4.27E−7 | 0.57 | | | | | 19 |
| Li_{3.5}P_{0.5}Ge_{0.5}O₄ | 7.89E−6 | 0.56 | | | | | 19 |
| Li_{3.5}As_{0.5}Si_{0.5}O₄ | 4.05E−6 | 0.55 | | | | | 19 |
| Li_{3.5}V_{0.5}Si_{0.5}O₄ | 1.20E−5 | 0.53 | | | | | 19 |
| Li_{3.5}As_{0.5}Ge_{0.5}O₄ | 2.83E−5 | 0.51 | | | | | 19 |
| Li_{3.5}V_{0.5}Ge_{0.5}O₄ | 3.00E−5 | | | | | | 19 |
| Li_{3.5}As_{0.5}Ti_{0.5}O₄ | 3.22E−5 | 0.52 | | | | | 19 |
| Li_{3.5}As_{0.5}V_{0.5}O₄ | 4.01E−5 | 0.49 | | | | | 19 |
| LiHf₂(PO₄)₃—0.1Li₂O | 1.12E−4 | | | | | | 19 |
| LiHf₂(PO₄)₃—0.2Li₂O | 2.78E−5 | | | | | | 19 |
| LiHf₂(PO₄)₃—0.3Li₂O | 2.58E−5 | | | | | | 19 |
| LiHf₂(PO₄)₃—0.4Li₂O | 3.40E−5 | | | | | | 19 |
| LiTi₂(PO₄)₃ | 1.69E−6 | 0.30 | | | | | 316 |
| 0.95LiTi₂(PO₄)₃—0.05Li₃PO₄ | 5.52E−5 | 0.29 | | | | | 316 |
| 0.9LiTi₂(PO₄)₃—0.1Li₃PO₄ | 1.38E−4 | 0.28 | | | | | 316 |
| 0.8LiTi₂(PO₄)₃—0.2Li₃PO₄ | 1.93E−4 | 0.31 | | | | | 316 |
| 0.7LiTi₂(PO₄)₃—0.3Li₃PO₄ | 2.45E−4 | 0.30 | | | | | 316 |
| 0.95LiTi₂(PO₄)₃—0.05Li₃BO₃ | 3.59E−5 | 0.30 | | | | | 316 |
| 0.9LiTi₂(PO₄)₃—0.1Li₃BO₃ | 2.54E−4 | 0.30 | | | | | 316 |
| 0.8LiTi₂(PO₄)₃—0.2Li₃BO₃ | 2.97E−4 | 0.30 | | | | | 316 |
| 0.7LiTi₂(PO₄)₃—0.3Li₃BO₃ | 2.45E−4 | 0.29 | | | | | 316 |
| 0.5LiTi₂(PO₄)₃—0.5Li₃BO₃ | 2.73E−5 | 0.31 | | | | | 316 |
| LiTi₂(PO₄)₃ | 1.00E−4 | | | | | | 317 |
| LiTi₂(PO₄)₃—0.15LiPO₄ | 6.00E−4 | | | | | | 317 |
| LiTi₂(PO₄)₃—0.3LiPO₄ | 9.92E−4 | | | | | | 317 |
| LiTi₂(PO₄)₃—0.6LiPO₄ | 1.23E−3 | | | | | | 317 |
| LiTi₂(PO₄)₃—0.9LiPO₄ | 1.10E−3 | | | | | | 317 |
| LiTi₂(PO₄)₃—0.15LiBO₃ | 4.80E−4 | | | | | | 317 |
| LiTi₂(PO₄)₃—0.3LiBO₃ | 1.66E−3 | | | | | | 317 |
| LiTi₂(PO₄)₃—0.6LiBO₃ | 1.12E−3 | | | | | | 317 |
| LiTi₂(PO₄)₃—0.9LiBO₃ | 8.91E−4 | | | | | | 317 |
| LiTi₂(PO₄)₃—1.5LiBO₃ | 6.48E−4 | | | | | | 317 |
| LiTi₂(PO₄)₃—0.2Li₂SO₄ | 8.35E−4 | | | | | | 317 |
| LiTi₂(PO₄)₃—0.4Li₂SO₄ | 1.66E−3 | | | | | | 317 |
| LiTi₂(PO₄)₃—0.6Li₂SO₄ | 5.67E−4 | | | | | | 317 |
| LiTi₂(PO₄)₃—0.4LiCl | 6.45E−4 | | | | | | 317 |
| LiTi₂(PO₄)₃—0.8LiCl | 1.28E−3 | | | | | | 317 |
| LiTi₂(PO₄)₃—1.2LiCl | 1.02E−3 | | | | | | 317 |
| LiTi₂(PO₄)₃—0.4LiNO₃ | 1.18E−3 | | | | | | 317 |
| LiTi₂(PO₄)₃—0.8LiNO₃ | 1.49E−3 | | | | | | 317 |
| LiTi₂(PO₄)₃—1.2LiNO₃ | 9.95E−4 | | | | | | 317 |
| Li_{0.39}La_{0.54}TiO₃ | 1.08E−3 | 0.316 | | | | | 318 |
| (Li_{0.39}La_{0.54})_{1.006}Al_{0.006}Ti_{0.994}O₃ | 1.13E−3 | 0.308 | | | | | 318 |
| (Li_{0.39}La_{0.54})_{1.01}Al_{0.02}Ti_{0.98}O₃ | 1.58E−3 | 0.278 | | | | | 318 |
| (Li_{0.39}La_{0.54})_{1.03}Al_{0.06}Ti_{0.94}O₃ | 1.39E−3 | 0.290 | | | | | 318 |
| (Li_{0.39}La_{0.54})_{1.005}Cr_{0.01}Ti_{0.99}O₃ | 9.52E−4 | 0.300 | | | | | 318 |
| | 1.01E−3 | 0.315 | | | | | 318 |
| (Li_{0.39}La_{0.54})_{1.025}Cr_{0.05}Ti_{0.95}O₃ | 1.04E−3 | 0.298 | | | | | 318 |
| La_{0.51}Li_{0.34}TiO_{2.94} | 1E−3 | 0.38 | | | | | 319 |
| La_{0.57}Li_{0.26}TiO_{2.99} | 1E−3 | 0.34 | | | | | 319 |
| La_{0.6}Li_{0.16}TiO_{3.01} | 6.3E−4 | 0.33 | | | | | 319 |
| La_{0.64}Li_{0.067}TiO₃ | 7.9E−5 | 0.36 | | | | | 319 |
| (La_{0.5}Li_{0.5})_{0.95}Sr_{0.05}TiO₃ | 1.49E−3 | | | | | | 319 |
| (La_{0.5}Li_{0.5})_{0.9}Sr_{0.1}TiO₃ | 1.30E−3 | | | | | | 319 |
| (La_{0.5}Li_{0.5})_{0.75}Sr_{0.25}TiO₃ | 8.99E−5 | | | | | | 319 |
| (La_{0.5}Li_{0.5})_{0.95}Ba_{0.05}TiO₃ | 7.61E−4 | | | | | | 319 |
| La_{0.63}Li_{0.1}Mg_{0.5}W_{0.5}O₃ | 1.69E−6 | 0.39 | | | | | 319 |
| Li_{0.5}La_{0.5}TiO₃ | 8.67E−4 | 0.28 | | | | | 320 |
| Li_{0.5}La_{0.5}Ti_{0.98}Sn_{0.02}O₃ | 4.86E−4 | | | | | | 320 |
| Li_{0.5}La_{0.5}Ti_{0.96}Sn_{0.04}O₃ | 3.89E−4 | | | | | | 320 |
| Li_{0.5}La_{0.5}Ti_{0.94}Sn_{0.06}O₃ | 3.52E−4 | 0.294 | | | | | 320 |
| Li_{0.5}La_{0.5}Ti_{0.9}Sn_{0.1}O₃ | 2.60E−4 | | | | | | 320 |
| Li_{0.5}La_{0.5}Ti_{0.98}Zr_{0.02}O₃ | 4.16E−4 | | | | | | 320 |
| Li_{0.5}La_{0.5}Ti_{0.96}Zr_{0.04}O₃ | 2.86E−4 | | | | | | 320 |
| Li_{0.5}La_{0.5}Ti_{0.94}Zr_{0.06}O₃ | 2.23E−4 | | | | | | 320 |
| Li_{0.5}La_{0.5}Ti_{0.9}Zr_{0.1}O₃ | 7.05E−5 | | | | | | 320 |
| Li_{0.5}La_{0.5}Ti_{0.998}Mn_{0.002}O₃ | 9.12E−4 | | | | | | 320 |
| Li_{0.5}La_{0.5}Ti_{0.996}Mn_{0.004}O₃ | 9.64E−4 | | | | | | 320 |
| Li_{0.5}La_{0.5}Ti_{0.994}Mn_{0.006}O₃ | 1.08E−3 | | | | | | 320 |
| Li_{0.5}La_{0.5}Ti_{0.992}Mn_{0.008}O₃ | 1.13E−3 | | | | | | 320 |
| Li_{0.5}La_{0.5}Ti_{0.99}Mn_{0.01}O₃ | 1.13E−3 | | | | | | 320 |
| Li_{0.5}La_{0.5}Ti_{0.998}Ge_{0.002}O₃ | 9.12E−4 | | | | | | 320 |
| Li_{0.5}La_{0.5}Ti_{0.996}Ge_{0.004}O₃ | 9.64E−4 | | | | | | 320 |
| Li_{0.5}La_{0.5}Ti_{0.994}Ge_{0.006}O₃ | 1.08E−3 | | | | | | 320 |
| Li_{0.5}La_{0.5}Ti_{0.992}Ge_{0.008}O₃ | 1.13E−3 | 0.265 | | | | | 320 |
| Li_{0.5}La_{0.5}Ti_{0.99}Ge_{0.01}O₃ | 1.13E−3 | | | | | | 320 |
| La_{0.58}Li_{0.36}Ti_{0.95}Mg_{0.05}O₃ | 2.1E−4 | 0.29 | | | | | 321 |
| La_{0.56}Li_{0.36}Ti_{0.95}Al_{0.05}O₃ | 6.4E−4 | 0.26 | | | | | 321 |
| La_{0.55}Li_{0.36}Ti_{0.95}Mn_{0.05}O₃ | 1.9E−4 | 0.29 | | | | | 321 |
| La_{0.55}Li_{0.36}Ti_{0.95}Ge_{0.05}O₃ | 3.6E−4 | 0.29 | | | | | 321 |
| La_{0.55}Li_{0.36}Ti_{0.95}Ru_{0.05}O₃ | 5.2E−5 | 0.28 | | | | | 321 |
| La_{0.51}Li_{0.36}Ti_{0.95}W_{0.05}O₃ | 7.3E−4 | 0.27 | | | | | 321 |
| La_{0.55}Li_{0.36}Ti_{0.9}W_{0.1}O₃ | 4.4E−4 | 0.27 | | | | | 321 |
| La_{0.55}Li_{0.36}Ti_{0.995}Al_{0.005}O₃ | 1.1E−3 | 0.28 | | | | | 321 |
| La_{0.55}Li_{0.36}Ti_{0.992}Al_{0.008}O₃ | 6.5E−4 | 0.29 | | | | | 321 |
| La_{0.54}Li_{0.36}Ti_{0.995}W_{0.005}O₃ | 2.6E−4 | 0.30 | | | | | 321 |
| La_{0.54}Li_{0.36}TiO₃ | 8.9E−4 | 0.29 | | | | | 321 |
| La_{0.606}Li_{0.06}Ti_{0.94}Al_{0.06}O₃ | 1.68E−6 | 0.36 | | | | | 322 |
| La_{0.566}Li_{0.1}Ti_{0.9}Al_{0.1}O₃ | 7.34E−6 | 0.35 | | | | | 322 |
| La_{0.516}Li_{0.15}Ti_{0.85}Al_{0.15}O₃ | 9.66E−6 | 0.36 | | | | | 322 |
| La_{0.466}Li_{0.2}Ti_{0.8}Al_{0.2}O₃ | 4.28E−5 | 0.33 | | | | | 322 |
| La_{0.416}Li_{0.25}Ti_{0.75}Al_{0.25}O₃ | 7.66E−5 | 0.35 | | | | | 322 |
| La_{0.366}Li_{0.3}Ti_{0.7}Al_{0.3}O₃ | 1.72E−5 | 0.33 | | | | | 322 |
| Li_{0.12}La_{0.63}TiO₃ | 2.00E−4 | | | | | | 323 |
| Li_{0.18}La_{0.61}TiO₃ | 4.43E−4 | | | | | | 323 |
| Li_{0.24}La_{0.59}TiO₃ | 9.93E−4 | | | | | | 323 |
| Li_{0.3}La_{0.57}TiO₃ | 1.10E−3 | | | | | | 323 |
| Li_{0.39}La_{0.54}TiO₃ | 1.02E−3 | | | | | | 323 |
| Li_{0.45}La_{0.52}TiO₃ | 9.05E−4 | | | | | | 323 |
| LiZr₂(PO₄)₃ | 4.77E−7 | | | | | | 324 |
| Li_{1.05}Al_{0.05}Zr_{1.9}(PO₄)₃ | 5.79E−7 | | | | | | 324 |
| Li_{1.1}Al_{0.1}Zr_{1.8}(PO₄)₃ | 6.35E−7 | | | | | | 324 |
| Li_{1.2}Al_{0.2}Zr_{1.6}(PO₄)₃ | 1.90E−6 | 0.48 | | | | | 324 |
| Li_{1.225}Al_{0.225}Zr_{1.55}(PO₄)₃ | 2.13E−6 | 0.48 | | | | | 324 |
| Li_{1.25}Al_{0.25}Zr_{1.5}(PO₄)₃ | 2.06E−6 | 0.48 | | | | | 324 |
| Li_{1.275}Al_{0.275}Zr_{1.45}(PO₄)₃ | 3.05E−6 | 0.48 | | | | | 324 |
| Li_{1.3}Al_{0.3}Zr_{1.4}(PO₄)₃ | 1.91E−6 | 0.48 | | | | | 324 |
| LiHf₂(PO₄)₃ | 3.42E−6 | | | | | | 325 |
| LiHfTi(PO₄)₃ | 5.63E−7 | | | | | | 325 |
| Li_{0.1}Zr_{1.1}Nb_{0.9}P₃O₁₂ | 6E−6 | | | | | | 325 |
| LiTi₂(PO₄)₃ | 1.04E−7 | | | | | | 326 |
| Li_{1.1}Sc_{0.1}Ti_{1.9}(PO₄)₃ | 1.75E−5 | | | | | | 326 |
| Li_{1.2}Sc_{0.2}Ti_{1.8}(PO₄)₃ | 4.11E−5 | 0.34 | | | | | 326 |
| Li_{1.3}Sc_{0.3}Ti_{1.7}(PO₄)₃ | 4.06E−5 | | | | | | 326 |
| Li_{1.4}Sc_{0.4}Ti_{1.6}(PO₄)₃ | 9.43E−6 | | | | | | 326 |
| Li_{1.5}Sc_{0.5}Ti_{1.5}(PO₄)₃ | 5.42E−7 | | | | | | 326 |
| Li_{1.1}Y_{0.1}Ti_{1.9}(PO₄)₃ | 2.94E−7 | | | | | | 326 |
| Li_{1.2}Y_{0.2}Ti_{1.8}(PO₄)₃ | 7.95E−7 | | | | | | 326 |
| Li_{1.3}Y_{0.3}Ti_{1.7}(PO₄)₃ | 1.01E−6 | 0.40 | | | | | 326 |
| Li_{1.4}Y_{0.4}Ti_{1.6}(PO₄)₃ | 2.97E−7 | | | | | | 326 |
| LiTi₂(PO₄)₃—0.5LiF | 2.318E−4 | 0.28 | | | | | 327 |
| LiTi₂(PO₄)₃ | 7.181E−6 | 0.48 | | | | | 327 |
| 14Li₂O—9Al₂O₃—38TiO₂—39P₂O₅ | 1.3E−3 | 0.33 | | | | | 328 |
| Li_{6.6}La₃Zr_{1.6}Ta_{0.4}O₁₂ | 3.13E−4 | 0.38 | | | | | 329 |
| Li_{6.6}La_{2.875}Y_{0.125}Zr_{1.6}Ta_{0.4}O₁₂ | 3.17E−4 | 0.35 | | | | | 329 |
| Li_{6.6}La_{2.75}Y_{0.25}Zr_{1.6}Ta_{0.4}O₁₂ | 4.36E−4 | 0.34 | | | | | 329 |
| Li_{6.6}La_{2.5}Y_{0.5}Zr_{1.6}Ta_{0.4}O₁₂ | 2.26E−4 | 0.39 | | | | | 329 |
| Li₂ZrS₃ | 7.3E−6 | | | | | | 330 |
| Li_{2.2}Zn_{0.1}Zr_{0.9}S₃ | 1.2E−4 | | | | | | 330 |
| 0.7Li₂S—0.3P₂S₅ | 8.1E−5 | 0.425 | | | | | 12 |
| Li₇PS₆ | 1.61E−6 | 0.16 | | | | | 176 |

Section II. Labels for Comparing all Descriptors-Simplification Combinations

A subset of the digitized labels was used for comparing between the different semi-supervised learning models. In total, the label subset is comprised of 155 structures. The subset is required because not all structures are compatible with all the descriptor transformations. Some descriptor-structure combinations produce coding errors, imaginary values, or infinite values. To directly compare all the descriptors, its necessary to have a common set of labels. The 155 labels that worked for all descriptors is listed in the subsequent table:

| | σ_{25° C.} | Eₐ | Space | Space | Other | | |
|---|---|---|---|---|---|---|---|
| Compound | (S cm⁻¹) | (eV) | Group | Group # | names | ICSD | Citation |
| Li₄P₂O₇ | <1E−10 | 1.617 | P1̅ | 2 | | 248414 | 8 |
| Li₇P₃S₁₁ | 3.2E−3 | 0.124 | P1̅ | 2 | | 157654 | 5 |
| Li₇BiO₆ | 8.80E−07 | 0.58 | P1̅ | 2 | | 155950 | 3 |
| Li₇SbO₆ | 6.70E−08 | 0.7 | P1̅ | 2 | | 413370 | 3 |
| Li₆CuB₄O₁₀ | 1.00E−13 | 0.92 | P1̅ | 2 | β-Li₆CuB₄O₁₀ | 4819 | 10 |
| LiAlSi₃O₈ | 1.30E−10 | | C1̅ | 2 | | 81980 | 1 |
| Li₃BP₂O₈ | 9.60E−12 | 0.62 | P1̅ | 2 | | 248343 | 7 |
| LiSn₂(PO₄)₃ | 2.04E−9 | | P1̅ | 2 | | 83832 | 2 |
| LiV(PO₄)F | 8.1E−7 | 0.23 | P1̅ | 2 | | 183876 | 6 |
| Li₂NaBP₂O₈ | 4.40E−18 | 1.21 | P1̅ | 2 | | 291512 | 7 |
| LiMgSO₄F | 5.40E−08 | 0.54 | P1̅ | 2 | | 281119 | 9 |
| Li₂ZnGeO₄ | 1.00E−07 | 0.4 | Pc | 7 | | 34362 | 13 |
| Li₄SiO₄ | 5.00E−10 | 0.55 | P2₁/m | 11 | | 238603 | 17 |
| Li_{3.7}P_{0.3}Si_{0.7}O₄ | 3.84E−7 | | P2₁/m | 11 | | 35168 | 19 |
| Li_{7.22}Si_{1.5}P_{0.5}O₈ | 1.64E−7 | 0.48 | P2₁/m | 11 | | 238602 | 16 |
| Li₃InCl₆ | 2.04E−3 | 0.35 | C2/m | 12 | | 89617 | 20 |
| Li₂P₂S₆ | 7.80E−11 | 0.48 | C2/m | 12 | | 253894 | 21 |
| LiPO₃ | 1.00E−09 | | P2/c | 13 | | 51630 | 28 |
| LiAlSi₄O₁₀ | 1.01E−10 | | P2/c | 13 | | 194284 | 1 |
| LaLiO₂ | <1E−10 | 0.92 | P2₁/C | 14 | | 239278 | 36 |
| LiBO₂ | 1.00E−08 | 0.71 | P2₁/C | 14 | | 200891 | 34 |
| LiSbO₂ | <1E−10 | 0.88 | P2₁/C | 14 | | 262075 | 39 |
| LiYO₂ | 1.80E−08 | 0.72 | P2₁/C | 14 | | 45511 | 33 |
| LiAlCl₄ | 1.00E−06 | 0.47 | P2₁/C | 14 | | 35275 | 32 |
| Li₃BO₃ | 7.40E−11 | 0.63 | P2₁/C | 14 | | 9105 | 30 |
| Li₂SO₄ | 1.40E−14 | 1.1 | P2₁/C | 14 | | 2512 | 29 |
| Li₆Ge₂O₇ | 8.50E−07 | 0.43 | P2₁/C | 14 | | 31050 | 31 |
| LiGaBr₄ | 7.00E−6 | 0.54 | P2₁/C | 14 | | 61337 | 25 |
| Li₄Zn(PO₄)₂ | <1E−10 | 1.3 | P2₁/C | 14 | α-Li₄Zn(PO₄)₂ | 255464 | 38 |
| La(Li_{0.76}Mg_{0.08})O₂ | 7.27E−10 | 0.66 | P2₁/C | 14 | | 239280 | 36 |
| (La_{0.9}Sr_{0.1})LiO₂ | 6.29E−10 | 0.62 | P2₁/C | 14 | | 239279 | 36 |
| Li₂Sr₂Al(PO₄)₃ | <1E−10 | 1.02 | P2₁/C | 14 | | 431319 | 40 |
| Li_{2.5}V₂(PO₄)₃ | 1.9E−7 | | P2₁/C | 14 | | 240269 | 37 |
| Li₂SnS₃ | 1.50E−05 | 0.59 | C2/c | 15 | | 251656 | 43 |
| LiVO₃ | 2.048E−9 | | C2/c | 15 | | 51443 | 48 |
| Li₆Zr₂O₇ | 5.20E−10 | 0.68 | C2/c | 15 | | 73835 | 41 |
| Li₃AlF₆ | 5.00E−07 | 0.54 | C2/c | 15 | | 85171 | 42 |
| LiTa₂PO₈ | 1.6E−3 | 0.32 | C2/c | 15 | | 267438 | 44 |
| LiBaP₂O₇ | 1.00E−10 | | C2/c | 15 | | 280927 | 45 |
| Li₃Na₅(TiS₄)₂ | 8.80E−06 | 0.4 | C2/c | 15 | | 391258 | 46 |
| LiGd(PO₃)₄ | <1E−10 | 1.7 | C2/c | 15 | | 416442 | 47 |
| Li_{3.7}Zn_{0.7}Ga_{0.3}(PO₄)₂ | <1E−10 | 0.91 | P2₁2₁2₁ | 19 | β′- | 255466 | 38 |
| | | | | | Li_{3.7}Zn_{0.7}Ga_{0.3}(PO₄)₂ | | |
| Li₃SbS₄ | 1.5E−6 | 0.518 | Pmn2₁ | 31 | | 8407 | 51 |
| Li₃PS₄ | 2.60E−07 | 0.49 | Pmn2₁ | 31 | γ-Li₃PS₄ | 180318 | 52 |
| Li₃SbS₃ | 1.00E−07 | 0.4 | Pna2₁ | 33 | | 424834 | 55 |
| LiGaO₂ | 2.40E−14 | 0.86 | Pna2₁ | 33 | | 18152 | 53 |
| LiB₆OgF | 5.40E−24 | 1.38 | Pna2₁ | 33 | | 420286 | 54 |
| LiSi₂N₃ | 6.17E−08 | 0.64 | Cmc2₁ | 36 | | 34118 | 56 |
| Li₂(PO₂N) | <1E−10 | 0.57 | Cmc2₁ | 36 | | 188493 | 57 |
| LiGa₂GeS₆ | 3.80E−08 | 0.47 | Fdd2 | 43 | | 254406 | 58 |
| Li₃AlO₄ | 5.00E−10 | 0.99 | Pmmn | 59 | | 16229 | 64 |
| Li₁₄Nd₅(Si₁₁N₁₉O₅)O₂F₂ | 1.7E−10 | 0.69 | Pmmn | 59 | | 262923 | 65 |
| Li₂SiN₂ | 1.60E−07 | | Pbca | 61 | | 420126 | 66 |
| Li₅GaO₄ | 5.00E−09 | 0.71 | Pbca | 61 | α-Li₅GaO₄ | 9082 | 64 |
| Li₃PS₄ | 1.60E−04 | 0.36 | Pnma | 62 | β-Li₃PS₄ | 180319 | 52 |
| Li₃PO₄ | 4.2E−18 | 1.24 | Pnma | 62 | γ-Li₃PO₄ | 79427 | 70 |
| Li₃PO₄ | <1E−10 | 1.14 | Pnma | 62 | γ-Li₃PO₄ | 20208 | 68 |
| Li₄SnS₄ | 7.0E−5 | 0.29 | Pnma | 62 | | 290832 | 80 |
| Li₄SnSe₄ | 2E−5 | 0.45 | Pnma | 62 | | 193768 | 76 |
| Li₄GeS₄ | 2.00E−07 | 0.53 | Pnma | 62 | | 290831 | 79 |
| Li₄GeS₄ | 2E−7 | 0.53 | Pnma | 62 | | 92200 | 71 |
| Li₂ZnI₄ | 4.00E−08 | 0.58 | Pnma | 62 | | 402062 | 81 |
| Li_{3.5}Ge_{0.5}V_{0.5}O₄ | 1.77E−5 | | Pnma | 62 | | 66576 | 84 |
| Li_{6.6}SiPO₈ | 1.48E−7 | 0.49 | Pnma | 62 | | 238601 | 16 |
| Li_{3.75}Ge_{0.75}V_{0.25}O₄ | 5.66E−6 | | Pnma | 62 | | 150918 | 73 |
| Li₄Zn(PO₄)₂ | <1E−10 | 1.1 | Pnma | 62 | β- | 255465 | 38 |
| | | | | | Li₄Zn(PO₄)₂ | | |
| Li_{2.88}PO_{3.73}N_{0.14} | 1.4E−13 | 0.97 | Pnma | 62 | | 79426 | 70 |
| Li₂Mg₂(MoO₄)₃ | <1E−10 | 0.71 | Pnma | 62 | | 170956 | 75 |
| Li_{3.70}Ge_{0.85}W_{0.15}O₄ | 3.80E−5 | | Pnma | 62 | | 150920 | 73 |
| Li₁₄Zn(GeO₄)₄ | 1.00E−06 | 0.24 | Pnma | 62 | | 100169 | 72 |
| Nd_{0.54}Li_{0.36}TiO₃ | 3.42E−8 | 0.50 | Pnma | 62 | | 81047 | 86 |
| Li_{6.5}O₈P_{1.5}Si_{0.5} | 4.49E−07 | 0.44 | Pnma | 62 | | 238600 | 16 |
| Pr_{0.51}Li_{0.39}TiO_{2.96} | 5.34E−7 | 0.44 | Pnma | 62 | | 81048 | 86 |
| LiZnSO₄F | 2.80E−05 | 0.2455 | Pnma | 62 | | 261343 | 78 |
| Li_{3.5}Zn_{0.5}Ga_{0.5}(PO₄)₂ | <1E−10 | 1.02 | Pnma | 62 | β- | 255468 | 38 |
| | | | | | Li_{3.5}Zn_{0.5}Ga_{0.5}(PO₄)₂ | | |
| Li₄H₈C₁₄O₄ | 1E−8 | 0.777 | Cmcm | 63 | LiCl*H₂O | 281198 | 88 |
| Li₂MgBr₄ | 7.80E−10 | 0.77 | Cmmm | 65 | | 73276 | 89 |
| Li_{0.18}La_{0.61}TiO₃ | 2.0E−4 | 0.432 | Cmmm | 65 | | 99398 | 90 |
| LiBiO₂ | 3.80E−08 | 0.1 | Ibam | 72 | | 46022 | 30 |
| LiZnPS₄ | 5.4E−8 | | I4̅ | 82 | | 95785 | 69 |
| (Li_{1.19}Zn_{0.9})PS₄ | 0.65E−5 | 0.25 | I4̅ | 82 | | 264463 | 69 |
| (Li_{1.69}Zn_{0.66})PS₄ | 1.30E−4 | 0.181 | I4̅ | 82 | | 264462 | 69 |
| (Li_{0.5}Ce_{0.5})(MoO₄) | 1.3E−8 | 0.4 | I4₁/a | 88 | | 186450 | 91 |
| (Li_{0.5}Ce_{0.25}Sm_{0.25})(MoO₄) | 1.8E−10 | 0.5 | I4₁/a | 88 | | 186452 | 91 |
| (Li_{0.5}Ce_{0.25}Pr_{0.25})(MoO₄) | 1E−9 | 0.5 | I4₁/a | 88 | | 186451 | 91 |
| Li₂TeO₄ | <1E−10 | 1.129 | P4₁22 | 91 | | 1485 | 92 |
| Li₃BN₂ | 1.60E−10 | 0.67 | P4₂2₁2 | 94 | α-Li₃BN₂ | 655673 | 93 |
| Li₂B₄O₇ | 1.00E−10 | | I4₁cd | 110 | | 65930 | 94 |
| La_{0.52}Li_{0.45}TiO₃ | 5.01E−4 | | P4/mmm | 123 | | 50434 | 97 |
| Li(NdTiO₄) | <1E−10 | 0.87 | P4/nmmZ | 129 | | 91844 | 99 |
| Li₄PS₄I | 1.2E−4 | 0.37 | P4/nmmZ | 129 | | 432169 | 101 |
| Li(LaTiO₄) | <1E−10 | 0.83 | P4/nmmZ | 129 | | 91843 | 99 |
| La_{0.62}Li_{0.14}(Mg_{0.5}W_{0.5})O₃ | 1.2E−5 | 0.37 | P4/nmm | 129 | | 151902 | 100 |
| Li₆ZnO₄ | 9.40E−09 | 0.61 | P4₂/nmc | 137 | | 62137 | 64 |
| Li₁₀SnP₂S₁₂ | 7E−3 | 0.27 | P4₂/nmc C | 137 | | 193755 | 107 |
| Li₁₀SnP₂S₁₂ | 3.98E−3 | 0.305 | P4₂/nmc | 137 | | 255750 | 108 |
| Li₁₀GePS₁₂ | 1.21E−2 | | P4₂/nmc | 137 | | 188887 | 104 |
| Li₁₀GeP₂S₁₂ | 2.46E−2 | 0.274 | P4₂/nmc | 137 | | 241439 | 108 |
| Li₁₀GeP₂S₁₂ | 1.20E−02 | 0.25 | P4₂/nmc | 137 | | 255749 | 110 |
| Li_{10.35}Ge_{1.35}P_{1.65}S₁₂ | 1.44E−2 | 0.269 | P4₂/nmc S | 137 | | 193947 | 104 |
| Li_{10.35}Si_{1.35}P_{1.65}S₁₂ | 6.5E−3 | | P4₂/nmcS | 137 | | 252037 | 109 |
| Li_{9.81}Sn_{0.81}P_{2.19}S₁₂ | 5.5E−3 | | P4₂/nmc | 137 | | 252040 | 109 |
| Li_{10.2}(Sn_{0.2}Si_{0.8})_{1.2}P_{1.8}S₁₂ | 7.82E−3 | | P4₂/nmcS | 137 | | 5667 | 111 |
| Li_{10.2}(Sn_{0.2}Si_{0.8})_{1.2}P_{1.8}S₁₂ | 2.69E−3 | | P4₂/nmcS | 137 | | 257948 | 111 |
| Li_{10.5}(Sn_{0.2}Si_{0.8})_{1.5}P_{1.5}S₁₂ | 8.79E−3 | | P4₂/nmcS | 137 | | 5668 | 111 |
| Li₁₀(Ge_{0.776}Sn_{0.224})P₂S₁₂ | 1.41E−2 | 0.276 | P4₂/nmc | 137 | | 255748 | 108 |
| LiLaNb₂O₇ | <1E−8 | | I4/mmm | 139 | | 72566 | 114 |
| Li₄Sr₃Nb₆O₂₀ | <1E−10 | | I4/mmm | 139 | | 87824 | 115 |
| Li₄Sr_{3.056}Nb₆O₂₀ | <1E−10 | 0.74 | I4/mmm | 139 | | 109168 | 115 |
| Li₄Sr₃Nb_{5.77}Fe_{0.23}O_{19.77} | <1E−10 | | I4/mmm | 139 | | 87823 | 115 |
| Li₄SrN₂ | 2.30E−13 | 0.9 | I4₁/amd | 141 | | 87413 | 116 |
| LiAlO₂ | 1.10E−12 | 0.97 | I4₁/amd | 141 | r-LiAlO₂ | 99517 | 33 |
| LiSCO₂ | <1E−10 | 1.047 | I4₁/amd | 141 | | 257819 | 117 |
| LiSCO₂ | 1.00E−12 | 0.87 | I4₁/amd | 141 | | 36124 | 33 |
| Li_{0.9}Sc_{0.9}Zr_{0.1}O₂ | <1E−10 | 0.912 | I4₁/amd | 141 | | 257820 | 117 |
| Li₇La₃Zr₂O₁₂ | 1.63E−6 | 0.54 | I4₁/acdZ | 142 | “tetraganol-LLZO” | 183684 | 119 |
| LiAlGeO₄ | <1E−10 | 0.97 | R3H | 146 | | 257741 | 123 |
| LiGaSiO₄ | 3.00E−16 | 0.9 | R3H | 146 | | 65125 | 122 |
| LiGa_{0.5}Al_{0.5}GeO₄ | <1E−10 | 1.06 | R3H | 146 | | 257740 | 123 |
| LiNaSO₄ | 8.80E−10 | | P31c | 159 | | 14364 | 125 |
| Li₅NCl₂ | 1.20E−06 | 0.5 | R3̅m | 166 | | 84763 | 131 |
| LiGe₂(PO₄)₃ | 4.83E−9 | 0.654 | R3̅cH | 167 | | 69763 | 133 |
| LiZr₂(PO₄)₃ | 2.96E−10 | | R3̅cH | 167 | | 201935 | 2 |
| LiTi₂(PO₄)₃ | 7.61E−6 | 0.38 | R3̅cH | 167 | | 95979 | 132 |
| LiGe₂(PO₄)₃ | 3.33E−7 | | R3̅cH | 167 | | 263767 | 2 |
| Li_{1.3}(Al_{0.23}Y_{0.07}Ti_{1.7})(PO₄)₃ | 3.84E−8 | | R3̅cH | 167 | | 253243 | 138 |
| Li₉Mg₃(PO₄)₄F₃ | <1E−10 | 0.835 | P6₃ | 173 | | 426103 | 148 |
| LiLa₉Si₆O₂₆ | <1E−10 | | P6₃/m | 176 | | 291218 | 150 |
| Li_{0.284}Sm_{4.512}Si₃O_{12.91} | <1E−10 | | P6₃/m | 176 | | 83279 | 150 |
| Pb_{6.12}Ca_{1.9}Li_{1.96}(PO₄)₆ | <1E−10 | 1.05 | P6₃/m | 176 | | 59615 | 149 |
| Li₅La₃Nb₂O₁₂ | 8E−6 | 0.43 | I2₁3 | 199 | | 54865 | 159 |
| (K_{0.1}Li_{0.9})(SbO₃) | 1.36E−8 | | Pn3̅Z | 201 | | 200984 | 160 |
| Li₂CoTi₃O₈ | <1E−10 | 1.33 | P4₃32 | 212 | | 86166 | 163 |
| Li₂ZnGe₃O₈ | <1E−10 | 2.14 | P4₃32 | 212 | | 86169 | 163 |
| Li₂MgTi₃O₈ | <1E−10 | 0.71 | P4₃32 | 212 | | 86165 | 163 |
| (Li_{0.55}Mg_{0.45})(Li_{0.445}Mg_{0.055})Ti_{1.504} | 1.53E−11 | 0.786 | P4₃32 | 212 | | 168145 | 164 |
| (Li_{0.61}Mg_{0.39})(Li_{0.46}Mg_{0.005}Ti_{0.035})Ti_{1.504} | 6.56E−10 | 0.685 | P4₃32 | 212 | | 168144 | 164 |
| Li₂VCl₄ | 6.95E−6 | | F4̅3m | 216 | | 74959 | 166 |
| Li₅NI₂ | 4.00E−6 | | F4̅3m | 216 | | 16800 | 165 |
| Li₆PO₅Cl | 5.54E−10 | 0.66 | F4̅3m | 216 | | 421479 | 173 |
| Li₇PN₄ | 1.60E−07 | 0.4 | P4̅3n | 218 | | 69017 | 95 |
| Li₉NS₃ | 8.30E−07 | 0.52 | Pm3̅m | 221 | | 240749 | 185 |
| Li₃OBr | 1.10E−06 | 0.74 | Pm3̅m | 221 | | 67265 | 194,195 |
| Li₂(OH)Br | 1.20E−6 | 0.75 | Pm3̅m | 221 | | 200874 | 184 |
| LiI | 1E−7 | | Fm3̅m | 225 | | 414244 | 197 |
| Li_{7.2}N_{1.6}Cl_{2.4} | 8.4E−7 | 0.49 | Fm3̅m | 225 | | 49646 | 131 |
| Li_{0.19}La_{0.67}(Ti_{0.9}Co_{0.1})O₃ | 1.08E−4 | | Fm3̅m | 225 | | 151535 | 182 |
| LiCdCl₄ | 5.80E−07 | 0.44 | Fd3̅m | 227 | | 74958 | 199 |
| Li₂MnCl₄ | 4.79E−6 | | Fd3̅m | 227 | | 69678 | 166 |
| Li₂MgCl₄ | 6.24E−7 | | Fd3̅m | 227 | | 74957 | 166 |
| LiSrTa₂O₆F | <1E−10 | 0.604 | Fd3̅m | 227 | | 236010 | 200 |
| Li_{1.9}Mn_{0.9}Ga_{0.1}Cl₄ | 2.37E−7 | | Fd3̅m | 227 | | 50305 | 198 |
| Li(Li_{0.34}Ti_{1.66})O₄ | 6.03E−8 | 0.506 | Fd3̅m | 227 | | 168137 | 164 |
| (Li_{0.74}Mg_{0.26})(Li_{0.40}Mg_{0.04}Ti_{1.56})O₄ | 1.51E−9 | 0.639 | Fd3̅m | 227 | | 168142 | 164 |
| (Li_{0.826}Mg_{0.174})(Li_{0.374}Mg_{0.026}Ti_{1.60})O₄ | 4.24E−9 | 0.615 | Fd3̅m | 227 | | 168141 | 164 |

Section III. Labels Used for the Final SOAP Model

Once the best-performing descriptor-simplification is identified, an expanded set of labels can be employed. The mathematical transformation for the SOAP descriptor is compatible with most of the ˜26,000 structures. In addition to the 155 labels used for descriptor comparisons, 64 labels were added. The full list of labels is included in the table below:

| | σ_{25° C.} | Eₐ | Space | Space | Other | | |
|---|---|---|---|---|---|---|---|
| Compound | (S cm⁻¹) | (eV) | Group | Group # | names | ICSD | Citation |
| Li₄P₂O₇₁ | <1E−10 | 1.617 | P1̅ | 2 | | 248414 | 8 |
| Li₇P₃S₁₁ | 3.2E−3 | 0.124 | P1̅ | 2 | | 157654 | 5 |
| Li₇BiO₆ | 8.80E−07 | 0.58 | P1̅ | 2 | | 155950 | 3 |
| Li₇SbO₆ | 6.70E−08 | 0.7 | P1̅ | 2 | | 413370 | 3 |
| Li₆CuB₄O₁₀ | 1.00E−13 | 0.92 | P1̅ | 2 | β-Li₆CuB₄O₁₀ | 4819 | 10 |
| LiAlSi₃O₈ | 1.30E−10 | | C1̅ | 2 | | 81980 | 1 |
| Li₃BP₂O₈ | 9.60E−12 | 0.62 | P1̅ | 2 | | 248343 | 7 |
| LiSn₂(PO₄)₃ | 2.04E−9 | | P1̅ | 2 | | 83832 | 2 |
| LiV(PO₄)F | 8.1E−7 | 0.23 | P1̅ | 2 | | 183876 | 6 |
| LiMgSO₄F | 5.40E−08 | 0.54 | P1̅ | 2 | | 281119 | 9 |
| Li₂NaBP₂O₈ | 4.40E−18 | 1.21 | P1̅ | 2 | | 291512 | 7 |
| Li₂ZnGeO₄ | 1.00E−07 | 0.4 | Pc | 7 | | 34362 | 13 |
| Li₄SiO₄ | 5.00E−10 | 0.55 | P2₁/m | 11 | | 238603 | 17 |
| Li₄SiS₄ | 5.00E−08 | 0.56 | P2₁/m | 11 | | 59708 | 15 |
| Li_{3.7}P_{0.3}Si_{0.7}O₄ | 3.84E−7 | | P2₁/m | 11 | | 35168 | 19 |
| Li_{7.22}Si_{1.5}P_{0.5}O₈ | 1.64E−7 | 0.48 | P2₁/m | 11 | | 238602 | 16 |
| Li₂P₂S₆ | 7.80E−11 | 0.48 | C2/m | 12 | | 253894 | 21 |
| Li₃InCl₆ | 2.04E−3 | 0.35 | C2/m | 12 | | 89617 | 20 |
| Li₁₇Sb₁₃S₂₈ | 1.05E−9 | 0.4 | C2/m | 12 | | 429902 | 24 |
| LiPO₃ | 1.00E−09 | | P2/c | 13 | | 51630 | 28 |
| LiAlSi₄O₁₀ | 1.01E−10 | | P2/c | 13 | | 194284 | 1 |
| LaLiO₂ | <1E−10 | 0.92 | P2₁/c | 14 | | 239278 | 36 |
| LiBO₂ | 1.00E−08 | 0.71 | P2₁/c | 14 | | 200891 | 34 |
| LiSbO₂ | <1E−10 | 0.88 | P2₁/c | 14 | | 262075 | 39 |
| LiYO₂ | 1.80E−08 | 0.72 | P2₁/c | 14 | | 45511 | 33 |
| Li₃BO₃ | 7.40E−11 | 0.63 | P2₁/c | 14 | | 9105 | 30 |
| Li₂SO₄ | 1.40E−14 | 1.1 | P2₁/c | 14 | | 2512 | 29 |
| LiGaBr₄ | 7.00E−6 | 0.54 | P2₁/c | 14 | | 61337 | 25 |
| LiAlCl₄ | 1.00E−06 | 0.47 | P2₁/c | 14 | | 35275 | 32 |
| Li₆Ge₂O₇ | 8.50E−07 | 0.43 | P2₁/c | 14 | | 31050 | 31 |
| Li₄Zn(PO₄)₂ | <1E−10 | 1.3 | P2₁/c | 14 | α-Li₄Zn(PO₄)₂ | 255464 | 38 |
| Li_{2.5}V₂(PO₄)₃ | 1.9E−7 | | P2₁/c | 14 | | 240269 | 37 |
| La(Li_{0.76}Mg_{0.08})O₂ | 7.27E−10 | 0.66 | P2₁/c | 14 | | 239280 | 36 |
| (La_{0.9}Sr_{0.1})LiO₂ | 6.29E−10 | 0.62 | P2₁/c | 14 | | 239279 | 36 |
| Li₂Sr₂Al(PO₄)₃ | <1E−10 | 1.02 | P2₁/c | 14 | | 431319 | 40 |
| LiClC₃H₇NO | 1.6E−4 | 0.881 | P2₁/c | 14 | | 238683 | 35 |
| Li₂CrCl₄ | <1E−10 | 1.22 | C2/c | 15 | | 202627 | 49 |
| Li₂ZrO₃ | 6.10E−10 | 0.78 | C2/c | 15 | | 94894 | 33 |
| Li₆Zr₂O₇ | 5.20E−10 | 0.68 | C2/c | 15 | | 73835 | 41 |
| Li₃AlF₆ | 5.00E−07 | 0.54 | C2/c | 15 | | 85171 | 42 |
| Li₂SnS₃ | 1.50E−05 | 0.59 | C2/c | 15 | | 251656 | 43 |
| LiVO₃ | 2.048E−9 | | C2/c | 15 | | 51443 | 48 |
| LiTa₂PO₈ | 1.6E−3 | 0.32 | C2/c | 15 | | 267438 | 44 |
| LiBaP₂O₇ | 1.00E−10 | | C2/c | 15 | | 280927 | 45 |
| LiGd(PO₃)₄ | <1E−10 | 1.7 | C2/c | 15 | | 416442 | 47 |
| Li₃Na₅(TiS₄)₂ | 8.80E−06 | 0.4 | C2/c | 15 | | 391258 | 46 |
| Li_{3.7}Zn_{0.7}Ga_{0.3}(PO₄)₂ | <1E−10 | 0.91 | P2₁2₁2₁ | 19 | β′-Li_{3.7}Zn_{0.7}Ga_{0.3}(PO₄)₂ | 255466 | 38 |
| Li₃SbS₄ | 1.5E−6 | 0.518 | Pmn2₁ | 31 | | 8407 | 51 |
| Li₃PS₄ | 2.60E−07 | 0.49 | Pmn2₁ | 31 | γ-Li₃PS₄ | 180318 | 52 |
| Li₃SbS₃ | 1.00E−07 | 0.4 | Pna2₁ | 33 | | 424834 | 55 |
| LiGaO₂ | 2.40E−14 | 0.86 | Pna2₁ | 33 | | 18152 | 53 |
| LiB₆O₉F | 5.40E−24 | 1.38 | Pna2₁ | 33 | | 420286 | 54 |
| LiSi₂N₃ | 6.17E−08 | 0.64 | Cmc2₁ | 36 | | 34118 | 56 |
| Li₂(PO₂N) | <1E−10 | 0.57 | Cmc2₁ | 36 | | 188493 | 57 |
| LiGa₂GeS₆ | 3.80E−08 | 0.47 | Fdd2 | 43 | | 254406 | 58 |
| La_{0.595}Li_{0.215}TiO₃ | 8.53E−4 | | Pmmm | 47 | | 92234 | 59 |
| La_{0.62}Li_{0.14}TiO₃ | 4.42E−4 | | Pmmm | 47 | | 92231 | 59 |
| La_{0.64}Li_{0.08}TiO₃ | 3.35E−4 | | Pmmm | 47 | | 92228 | 59 |
| Li_{0.02}Na_{0.48}La_{0.5}Nb₂O₆ | 3.99E−6 | | Pmmm | 47 | | 180635 | 60 |
| Li_{0.04}Na_{0.46}La_{0.5}Nb₂O₆ | 5.91E−6 | | Pmmm | 47 | | 180634 | 60 |
| Li_{0.07}Na_{0.43}La_{0.5}Nb₂O₆ | 1.23E−5 | | Pmmm | 47 | | 180633 | 60 |
| Li_{0.1}Na_{0.4}La_{0.5}Nb₂O₆ | 1.21E−5 | | Pmmm | 47 | | 180632 | 60 |
| Li_{0.2}Na_{0.3}La_{0.5}Nb₂O₆ | 1.18E−5 | | Pmmm | 47 | | 180631 | 60 |
| Li_{0.3}Na_{0.2}La_{0.5}Nb₂O₆ | 1.11E−5 | | Pmmm | 47 | | 180630 | 60 |
| Li_{0.4}Na_{0.1}La_{0.5}Nb₂O₆ | 9.92E−6 | | Pmmm | 47 | | 180629 | 60 |
| Li₅AlO₄ | 5.00E−10 | 0.99 | Pmmn | 59 | | 16229 | 64 |
| Li₁₄Nd₅(Si₁₁N₁₉O₅)O₂F₂ | 1.7E−10 | 0.69 | Pmmn | 59 | | 262923 | 65 |
| Li₂SiN₂ | 1.60E−07 | | Pbca | 61 | | 420126 | 66 |
| Li₅GaO₄ | 5.00E−09 | 0.71 | Pbca | 61 | α-Li₅GaO₄ | 9082 | 64 |
| Li₃PO₄ | 4.2E−18 | 1.24 | Pnma | 62 | γ-Li₃PO₄ | 79427 | 70 |
| Li₃PO₄ | <1E−10 | 1.14 | Pnma | 62 | γ-Li₃PO₄ | 20208 | 68 |
| Li₃PS₄ | 1.60E−04 | 0.36 | Pnma | 62 | β-Li₃PS₄ | 180319 | 52 |
| Li₄SnS₄ | 7.0E−5 | 0.29 | Pnma | 62 | | 290832 | 80 |
| Li₄SnSe₄ | 2E−5 | 0.45 | Pnma | 62 | | 193768 | 76 |
| Li₄GeS₄ | 2.00E−07 | 0.53 | Pnma | 62 | | 290831 | 79 |
| Li₄GeS₄ | 2E−7 | 0.53 | Pnma | 62 | | 92200 | 71 |
| Li(BH₄) | 1E−8 | | Pnma | 62 | | 239763 | 77 |
| Li₂ZnI₄ | 4.00E−08 | 0.58 | Pnma | 62 | | 402062 | 81 |
| Li₄Zn(PO₄)₂ | <1E−10 | 1.1 | Pnma | 62 | β-Li₄Zn(PO₄)₂ | 255465 | 38 |
| Li₂Mg₂(MoO₄)₃ | <1E−10 | 0.71 | Pnma | 62 | | 170956 | 75 |
| Li_{0.2}Ca_{0.4}TaO₃ | 3.53E−9 | 0.54 | Pnma | 62 | | 151936 | 74 |
| Li_{3.5}Ge_{0.5}V_{0.5}O₄ | 1.77E−5 | | Pnma | 62 | | 66576 | 84 |
| Li_{3.75}Ge_{0.75} V_{0.25}O₄ | 5.66E−6 | | Pnma | 62 | | 150918 | 73 |
| Li₁₄Zn(GeO₄)₄ | 1.00E−06 | 0.24 | Pnma | 62 | | 100169 | 72 |
| Li_{3.70}Ge_{0.85}W_{0.15}O₄ | 3.80E−5 | | Pnma | 62 | | 150920 | 73 |
| Li_{6.6}SiPO₈ | 1.48E−7 | 0.49 | Pnma | 62 | | 238601 | 16 |
| Li_{2.88}PO_{3.73}N_{0.14} | 1.4E−13 | 0.97 | Pnma | 62 | | 79426 | 70 |
| Li_{6.5}O₈P_{1.5}Si_{0.5} | 4.49E−07 | 0.44 | Pnma | 62 | | 238600 | 16 |
| Nd_{0.54}Li_{0.36}TiO₃ | 3.42E−8 | 0.50 | Pnma | 62 | | 81047 | 86 |
| Pr_{0.51}Li_{0.39}TiO_{2.96} | 5.34E−7 | 0.44 | Pnma | 62 | | 81048 | 86 |
| LiZnSO₄F | 2.80E−05 | 0.2455 | Pnma | 62 | | 261343 | 78 |
| Li_{3.5}Zn_{0.5}Ga_{0.5}(PO₄)₂ | <1E−10 | 1.02 | Pnma | 62 | β-Li_{3.5}Zn_{0.5}Ga_{0.5}(PO₄)₂ | 255468 | 38 |
| Li_{0.2}(Ca_{0.36}Sr_{0.04})TaO₃ | 9.2E−9 | | Pnma | 62 | | 151937 | 74 |
| Li₄GeO₄ | 2.80E−10 | 0.73 | Cmcm | 63 | | 18096 | 87 |
| Li₄H₈Cl₄O₄ | 1E−8 | 0.777 | Cmcm | 63 | LiCl*H₂O | 281198 | 88 |
| Li₂MgBr₄ | 7.80E−10 | 0.77 | Cmmm | 65 | | 73276 | 89 |
| Li_{0.18}La_{0.61}TiO₃ | 2.0E−4 | 0.432 | Cmmm | 65 | | 99398 | 90 |
| LiBiO₂ | 3.80E−08 | 0.1 | Ibam | 72 | | 46022 | 30 |
| LiZnPS₄ | 5.4E−8 | | I4̅ | 82 | | 95785 | 69 |
| (Li_{1.19}Zn_{0.9})PS₄ | 0.65E−5 | 0.25 | I4̅ | 82 | | 264463 | 69 |
| (Li_{1.69}Zn_{0.66})PS₄ | 1.30E−4 | 0.181 | I4̅ | 82 | | 264462 | 69 |
| (Li_{0.5}Ce_{0.5})(MoO₄) | 1.3E−8 | 0.4 | I4₁/a | 88 | | 186450 | 91 |
| (Li_{0.5}Ce_{0.25}Sm_{0.25})(MoO₄) | 1.8E−10 | 0.5 | I4₁/a | 88 | | 186452 | 91 |
| (Li_{0.5}Ce_{0.25}Pr_{0.25})(MoO₄) | 1E−9 | 0.5 | I4₁/a | 88 | | 186451 | 91 |
| Li₂TeO₄ | <1E−10 | 1.129 | P4₁22 | 91 | | 1485 | 92 |
| Li₃BN₂ | 1.60E−10 | 0.67 | P4₂2₁2 | 94 | α-Li₃BN₂ | 655673 | 93 |
| Li₂B₄O₇ | 1.00E−10 | | I4₁cd | 110 | | 65930 | 94 |
| LiY(BH₄)₄ | 1.26E−6 | | P4̅2c | 112 | | 239762 | 77 |
| LiPN₂ | 1.6E−7 | 0.40 | I4̅2d | 122 | | 66007 | 95 |
| Li_{0.33}La_{0.5}TiO₃ | 1E−3 | 0.15 | P4/mmm | 123 | | 82671 | 96 |
| La_{0.5}Li_{0.5}TiO₃ | 9.25E−4 | 0.39 | P4/mmm | 123 | | 92236 | 59 |
| La_{0.52}Li_{0.45}TiO₃ | 5.01E−4 | | P4/mmm | 123 | | 50434 | 97 |
| La_{0.565}Li_{0.305}TiO₃ | 9.57E−4 | | P4/mmm | 123 | | 92235 | 59 |
| La_{0.58}Li_{0.27}TIO₃ | 5.99E−4 | | P4/mmm | 123 | | 82672 | 97 |
| Li₄PS₄I | 1.2E−4 | 0.37 | P4/nmmZ | 129 | | 432169 | 101 |
| Li(LaTiO₄) | <1E−10 | 0.83 | P4/nmmZ | 129 | | 91843 | 99 |
| Li(NdTiO₄) | <1E−10 | 0.87 | P4/nmmZ | 129 | | 91844 | 99 |
| La_{0.62}Li_{0.14}(Mg_{0.5}W_{0.5})O₃ | 1.2E−5 | 0.37 | P4/nmm | 129 | | 151902 | 100 |
| La_{0.63}Li_{0.11}(Mg_{0.5}W_{0.5})O₃ | 6.8E−6 | 0.38 | P4/nmm | 129 | | 151901 | 100 |
| La_{0.65}Li_{0.05}(Mg_{0.5}W_{0.5})O₃ | 1.8E−7 | 0.46 | P4/nmm | 129 | | 151900 | 100 |
| Li₆ZnO₄ | 9.40E−09 | 0.61 | P4₂/nmc | 137 | | 62137 | 64 |
| Li₁₀SnP₂S₁₂ | 3.98E−3 | 0.305 | P4₂/nmc | 137 | | 255750 | 108 |
| Li₁₀SnP₂S₁₂ | 7E−3 | 0.27 | P4₂/nmc C | 137 | | 193755 | 107 |
| Li₁₀GePS₁₂ | 1.21E−2 | | P4₂/nmc | 137 | | 188887 | 104 |
| Li₁₀GeP₂S₁₂ | 1.20E−02 | 0.25 | P4₂/nmc | 137 | | 255749 | 110 |
| Li₁₀GeP₂S₁₂ | 2.46E−2 | 0.274 | P4₂/nmc | 137 | | 241439 | 108 |
| Li_{10.35}Ge_{1.35}P_{1.65}S₁₂ | 1.44E−2 | 0.269 | P4₂/nmc S | 137 | | 193947 | 104 |
| Li_{10.35}Si_{1.35}P_{1.65}S₁₂ | 6.5E−3 | | P4₂/nmcS | 137 | | 252037 | 109 |
| Li_{9.81}Sn_{0.81}P_{2.19}S₁₂ | 5.5E−3 | | P4₂/nmc | 137 | | 252040 | 109 |
| Li₁₀(Ge_{0.776}Sn_{0.224})P₂S₁₂ | 1.41E−2 | 0.276 | P4₂/nmc | 137 | | 255748 | 108 |
| Li_{10.2}(Sn_{0.2}Si_{0.8})_{1.2}P_{1.8}S₁₂ | 7.82E−3 | | P4₂/nmcS | 137 | | 5667 | 111 |
| Li_{10.2}(Sn_{0.2}Si_{0.8})_{1.2}P_{1.8}S₁₂ | 2.69E−3 | | P4₂/nmcS | 137 | | 257948 | 111 |
| Li_{10.5}(Sn_{0.2}Si_{0.8})_{1.5}P_{1.5}S₁₂ | 8.79E−3 | | P4₂/nmcS | 137 | | 5668 | 111 |
| LiLaNb₂O₇ | <1E−8 | | I4/mmm | 139 | | 72566 | 114 |
| Li₄Sr₃Nb₆O₂₀ | <1E−10 | | I4/mmm | 139 | | 87824 | 115 |
| Li₄Sr_{3.056}Nb₆O₂₀ | <1E−10 | 0.74 | I4/mmm | 139 | | 109168 | 115 |
| Li₄Sr₃Nb_{5.77}Fe_{0.23}O_{19.77} | <1E−10 | | I4/mmm | 139 | | 87823 | 115 |
| Li₃BN₂ | 8.70E−08 | 0.55 | I4₁/amd | 141 | β-Li₃BN₂ | 155126 | 93 |
| LiScO₂ | <1E−10 | 1.047 | I4₁/amd | 141 | | 257819 | 117 |
| LiScO₂ | 1.00E−12 | 0.87 | I4₁/amd | 141 | | 36124 | 33 |
| Li₄SrN₂ | 2.30E−13 | 0.9 | I4₁/amd | 141 | | 87413 | 116 |
| LiAlO₂ | 1.10E−12 | 0.97 | I4₁/amd | 141 | r-LiAlO₂ | 99517 | 33 |
| Li_{0.9}Sc_{0.9}Zr_{0.1}O₂ | <1E−10 | 0.912 | I4₁/amd | 141 | | 257820 | 117 |
| Li₇La₃Zr₂O₁₂ | 1.63E−6 | 0.54 | I4₁/acdZ | 142 | “tetraganol-LLZO” | 183684 | 119 |
| Li₇La₃Zr₂O₁₂ | 9.9E−6 | 0.43 | I4₁/acdZ | 142 | | 238687 | 121 |
| Li₇La₃HfO₁₂ | 9.85E−7 | 0.53 | I4₁/acdZ | 142 | “tetragonal-LLHO” | 174202 | 118 |
| LiAlGeO₄ | <1E−10 | 0.97 | R3H | 146 | | 257741 | 123 |
| LiGaSiO₄ | 3.00E−16 | 0.9 | R3H | 146 | | 65125 | 122 |
| LiGa_{0.5}Al_{0.5}GeO₄ | <1E−10 | 1.06 | R3H | 146 | | 257740 | 123 |
| LiGaGeO₄ | <1E−10 | 1.12 | R3̅ | 148 | | 257739 | 123 |
| LiNaSO₄ | 8.80E−10 | | P31c | 159 | | 14364 | 125 |
| Li₄P₂S₆ | 2.38E−07 | 0.29 | P3̅1m | 162 | | 242170 | 127 |
| Li_{2.667}Mg_{0.667}P₂S₆ | 4.00E−06 | 0.46 | P3̅1m | 162 | | 95607 | 126 |
| Li_{3.333}Mg_{0.333}P₂S₆ | 8.20E−8 | 0.517 | P3̅1m | 162 | | 95606 | 126 |
| Li₃ErCl₆ | 3.3E−4 | 0.41 | P3̅m1 | 164 | | 50151 | 129 |
| Li₅NCl₂ | 1.20E−06 | 0.5 | R3̅m | 166 | | 84763 | 131 |
| LiGe₂(PO₄)₃ | 3.33E−7 | | R3̅cH | 167 | | 263767 | 2 |
| LiGe₂(PO₄)₃ | 4.83E−9 | 0.654 | R3̅cH | 167 | | 69763 | 133 |
| LiZr₂(PO₄)₃ | 2.96E−10 | | R3̅cH | 167 | | 201935 | 2 |
| LiTi₂(PO₄)₃ | 7.61E−6 | 0.38 | R3̅cH | 167 | | 95979 | 132 |
| Li(Ti_{0.4}Sn_{1.6})(PO₄)₃ | 3.15E−6 | | R3̅cH | 167 | | 183677 | 135 |
| Li(Ti_{0.6}Sn_{1.4})(PO₄)₃ | 9.42E−6 | | R3̅cH | 167 | | 183676 | 135 |
| Li(Ti_{1.4}Sn_{0.6})(PO₄)₃ | 2.28E−5 | 0.32 | R3̅cH | 167 | | 183672 | 135 |
| Li_{1.3}Al_{0.3}Ti_{1.7}(PO₄)₃ | 7E−4 | | R3̅cH | 167 | | 257190 | 139 |
| Li_{1.3}(Al_{0.3}Ti_{1.7})(PO₄)₃ | 8.02E−7 | | R3̅cH | 167 | | 253240 | 138 |
| Li_{1.2}Al_{0.2}Ge_{1.8}(PO₄)₃ | 4.83E−5 | 0.387 | R3̅cH | 167 | | 263760 | 133 |
| Li_{1.3}(Al_{0.23}Y_{0.07}Ti_{1.7})(PO₄)₃ | 3.84E−8 | | R3̅cH | 167 | | 253243 | 138 |
| Li_{1.3}(Al_{0.23}Sc_{0.07}Ti_{1.7})(PO₄)₃ | 1.94E−7 | | R3̅cH | 167 | | 253242 | 138 |
| Li_{1.3}(Al_{0.23}Ga_{0.07}Ti_{1.7})(PO₄)₃ | 4.46E−6 | | R3̅cH | 167 | | 253241 | 138 |
| LiIO₃ | 1.90E−07 | | P6₃ | 173 | | 35473 | 147 |
| Li₉Mg₃(PO₄)₄F₃ | <1E−10 | 0.835 | P6₃ | 173 | | 426103 | 148 |
| LiEu₉Si₆O₂₆ | <1E−10 | | P6₃/m | 176 | | 291220 | 150 |
| LiLa₉Si₆O₂₆ | <1E−10 | | P6₃/m | 176 | | 291218 | 150 |
| Li_{0.284}Sm_{4.512}Si₃O_{12.91} | <1E−10 | | P6₃/m | 176 | | 83279 | 150 |
| Pb_{6.12}Ca_{1.9}Li_{1.96}(PO₄)₆ | <1E−10 | 1.05 | P6₃/m | 176 | | 59615 | 149 |
| Li₃(NH₂)₂I | 1E−5 | 0.58 | P6₃mc | 186 | | 167528 | 152 |
| Ba₃LiTa₅ZrSi₄O₂₆ | <1E−10 | 0.79 | P6̅2m | 189 | | 239277 | 153 |
| Li₃N | 1.2E−3 | 0.25 | P6/mmm | 191 | | 26540 | 154 |
| Li₃N | 3.00E−04 | 0.26 | P6/mmm | 191 | | 156894 | 155 |
| Fe₂Na₂K(Li₃Si₁₂O₃₀) | <1E−10 | 1.22 | P6/mcc | 192 | | 235750 | 156 |
| Li₃P | 7.03E−4 | 0.18 | P6₃/mmc | 194 | | 642223 | 157 |
| Li₅La₃Nb₂O₁₂ | 8E−6 | 0.43 | I2₁3 | 199 | | 54865 | 159 |
| (K_{0.1}Li_{0.9})(SbO₃) | 1.36E−8 | | Pn3̅Z | 201 | | 200984 | 160 |
| Li₈SiP₄ | 4.5E−5 | 0.404 | Pa3̅ | 205 | | 235186 | 161 |
| Li₈GeP₄ | 1.8E−5 | 0.435 | Pa3̅ | 205 | α-Li₈GeP₄ | 235184 | 161 |
| Li₃AlN₂ | 5.00E−08 | 0.45 | Ia3̅ | 206 | | 257464 | 162 |
| Li₂ZnGe₃O₈ | <1E−10 | 2.14 | P4₃32 | 212 | | 86169 | 163 |
| Li₂MgTi₃O₈ | <1E−10 | 0.71 | P4₃32 | 212 | | 86165 | 163 |
| Li₂CoTi₃O₈ | <1E−10 | 1.33 | P4₃32 | 212 | | 86166 | 163 |
| (Li_{0.55}Mg_{0.45})(Li_{0.445}Mg_{0.055})Ti_{1.504} | 1.53E−11 | 0.786 | P4₃32 | 212 | | 168145 | 164 |
| (Li_{0.61}Mg_{0.39})(Li_{0.46}Mg_{0.005}Ti_{0.035})Ti_{1.504} | 6.56E−10 | 0.685 | P4₃32 | 212 | | 168144 | 164 |
| Li₂VCl₄ | 6.95E−6 | | F4̅3m | 216 | | 74959 | 166 |
| Li₅NI₂ | 4.00E−6 | | F4̅3m | 216 | | 16800 | 165 |
| Li₆PO₅Cl | 5.54E−10 | 0.66 | F4̅3m | 216 | | 421479 | 173 |
| LiCe(BH₄)₃Cl | 1.03E−4 | | I4̅3m | 217 | | 185218 | 178 |
| Li₇PN₄ | 1.60E−07 | 0.4 | P4̅3n | 218 | | 69017 | 95 |
| Li₄B₇O₁₂Cl | 2.4E−5 | | F4̅3c | 219 | | 1125 | 179 |
| Li₉NS₃ | 8.30E−07 | 0.52 | Pm3̅m | 221 | | 240749 | 185 |
| Li₃OBr | 1.10E−06 | 0.74 | Pm3̅m | 221 | | 67265 | 194, 195 |
| Li₂(OH)Br | 1.20E−6 | 0.75 | Pm3̅m | 221 | | 200874 | 184 |
| (La_{0.55}Li_{0.45})(Ti_{0.9}Al_{0.1})O₃ | 1.51E−3 | | Pm3̅m | 221 | | 254045 | 186 |
| (La_{0.6}Li_{0.4})(Ti_{0.8}Al_{0.2})O₃ | 5.68E−4 | | Pm3̅m | 221 | | 254046 | 186 |
| (La_{0.65}Li_{0.35})(Ti_{0.7}Al_{0.3})O₃ | 1.61E−4 | | Pm3̅m | 221 | | 254047 | 186 |
| (La_{0.402}Li_{0.368}Sr_{0.230})(TiO₃) | 2.87E−5 | 0.36 | Pm3̅m | 221 | | 190827 | 183 |
| (La_{0.46}Li_{0.429}Sr_{0.111})(TiO₃) | 1.97E−4 | 0.33 | Pm3̅m | 221 | | 190826 | 183 |
| (La_{0.49}Li_{0.461}Sr_{0.049})(TiO₃) | 7.09E−4 | 0.33 | Pm3̅m | 221 | | 190825 | 183 |
| (Li_{0.16}Sr_{0.69})(Ga_{0.25}Ta_{0.75})O₃ | 3.69E−6 | 0.359 | Pm3̅m | 221 | | 291520 | 187 |
| Li_{0.31}La_{0.63}((Ti_{0.9}Co_{0.1})O₃ | 2.60E−4 | | Pm3̅m | 221 | | 151533 | 182 |
| LiI | 1E−7 | | Fm3̅m | 225 | | 414244 | 197 |
| Li_{7.2}N_{1.6}Cl_{2.4} | 8.4E−7 | 0.49 | Fm3̅m | 225 | | 49646 | 131 |
| Li_{0.19}La_{0.67}(Ti_{0.9}Co_{0.1})O₃ | 1.08E−4 | | Fm3̅m | 225 | | 151535 | 182 |
| LiCdCl₄ | 5.80E−07 | 0.44 | Fd3̅m | 227 | | 74958 | 199 |
| Li₂MgCl₄ | 6.24E−7 | | Fd3̅m | 227 | | 74957 | 166 |
| Li₂MnCl₄ | 4.79E−6 | | Fd3̅m | 227 | | 69678 | 166 |
| Li(Li_{0.34}Ti_{1.66})O₄ | 6.03E−8 | 0.506 | Fd3̅m | 227 | | 168137 | 164 |
| Li_{1.9}Mn_{0.9}Ga_{0.1}Cl₄ | 2.37E−7 | | Fd3̅m | 227 | | 50305 | 198 |
| (Li_{0.74}Mg_{0.26})(Li_{0.40}Mg_{0.04}Ti_{1.56})O₄ | 1.51E−9 | 0.639 | Fd3̅m | 227 | | 168142 | 164 |
| (Li_{0.826}Mg_{0.174})(Li_{0.374}Mg_{0.026}Ti_{1.60})O₄ | 4.24E−9 | 0.615 | Fd3̅m | 227 | | 168141 | 164 |
| LiSrTa₂O₆F | <1E−10 | 0.604 | Fd3̅m | 227 | | 236010 | 200 |

Section IV. W_{σ} Optimization

Ward's minimum variance method applied to the conductivity labels (Wσ) is used to assess the utility of each descriptor-simplification combination. The Wσ is calculated after agglomerative clustering, for each clustering set:

W_{σ}=Σₖ₌₁ⁿ^{_{C}}Σ_{i∈C}_{ₖ}[log(σ_{RT})ᵢ−l̅o̅g̅(̅σ̅_̅{̅R̅T̅}̅)̅ₖ]²

where n_{C} is the number of clusters in a set, Cₖ is cluster k, and where l̅o̅g̅(̅σ̅_̅{̅R̅T̅}̅)̅ₖ̅ denotes the mean for all labels in cluster k. Lower Wσ values indicate that the descriptor-simplification combination results in clustering where structures with similar conductivity are grouped together. Whereas a large Wσ indicates that the clusters have little correlation to the conductivity labels.

A frozen-state strategy is employed to prevent any label from dropping out of the Wσ calculation. The frozen-state strategy operates by calculating the partial variance (PV) for each label at each clustering depth:

PV_{x,C}_{ₖ}=[log(σ_{RT})ₓ−l̅o̅g̅(̅σ̅_̅{̅R̅T̅}̅)̅ₖ]²

where PV_{x,C}_{ₖ} is the partial variance for label x, when label x is assigned to cluster k. The PV for each label is saved before summing all the partial variances to yield the Wσ. At each subsequent clustering depth, all new clusters are checked to determine whether any cluster contains a single label. If a label is the only label in a cluster, then that label's partial variance is frozen: its PV_{x,C}_{ₖ} becomes equal to the saved state from the previous cluster depth:

PV_{x,C}_{ⱼ}=PV_{x,C}_{ₖ}

where Cj denotes the cluster with only one label and Ck denotes the cluster that label x previously resided in. Without the frozen state strategy, poor models will reach desirable Wσ values at sufficient depths of clustering. The artificial depression of the Wσ value occurs because clusters that contain a single label evaluate to 0 (the label mean and cluster mean are the same). Whereas the frozen state strategy effectively “remembers” how well (or poorly) the label was clustered before it drops out.

Hyperparameter tuning was employed for some of the descriptors. At least one W_{σ} representation exists for each unique combination of structure simplification and descriptor. However, some of the descriptors can be altered by tuning associated hyperparameters, resulting in more W_{σ} representations. The descriptors with hyperparameter tuning are the global instability index, radial distribution function, smooth overlap of atomic positions (SOAP), and mXRD. A grid search was done over the hyperparameters, for each descriptor, with parameters shown in Table 3.

TABLE 3

| | Hyper- | | Values attempted in |
|---|---|---|---|
| Descriptor | parameter | Description | grid search |
| Global | r_cut | The distance, in angstroms, to search | [1.0, 1.1, . . . , 5.9, 6.0] |
| instability | | for neighbors when calculating bond | |
| index | | valences. | |
| Radial | cutoff | The distance, in angstroms, over which | [1, 2, . . . , 29, 30] |
| distribution | | the radial distribution function should | |
| function | | be calculated. | |
| | bin_size | The radial distance, in angstroms, for | [0.01, 0.02, . . . , 0.09, |
| | | each bin. | 0.1, 0.2, . . . , 0.9, 1.0] |
| Smooth | rcut | The radial cutoff for the local region in | [1, 2, . . . , 29, 30] |
| overlap of | | angstroms. | |
| atomic | nmax | The number of radial basis functions | [2, 3, . . . , 8, 9] |
| positions | | used. | |
| (SOAP) | lmax | The maximum degree of spherical | [1, 2, . . . , 8, 9] |
| | | harmonics used. | |
| | average | The averaging mode. | [‘outer’, ‘inner’] |
| mXRD | pattern_length | The number of 2θ values that will be | [101, 201, . . . , 901, |
| | | calculated between 0° and 90°. | 1001] |

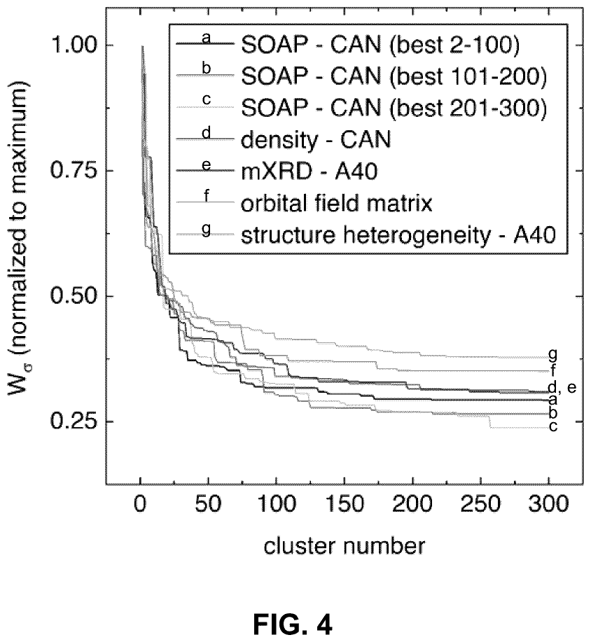

Ultimately, the SOAP-CAN descriptor-simplification outperforms all other descriptor-simplifications when the averaging hyperparameter is set to ‘outer’. Setting the ‘outer’ hyperparameter results in averaging over the power spectrum of different sites. Whereas the ‘inner’ setting averages over the sites first, before summing up the magnetic quantum numbers. The other three hyperparameters (rcut, nmax, and Imax) are less consequential, with most combinations tested outperforming all other non-SOAP descriptors. To illustrate the point, three different SOAP-CAN outcomes are depicted in FIG. 4, plotted against the best-performing outcomes from density-CAN, mXRD-A40, orbital field matrix, and structure heterogeneity-A40. The three SOAP-CAN outcomes are those with the lowest W_{σ} mean for the depth of clustering ranges: 2-100, 101-200, and 201-300. The respective hyperparameters for the three SOAP-CAN descriptors are [rcut=2, nmax=4, Imax=2], [rcut=4, nmax=2, Imax=2], and [rcut=3, nmax=5, Imax=3].

Section V. W_{Ea} Optimization

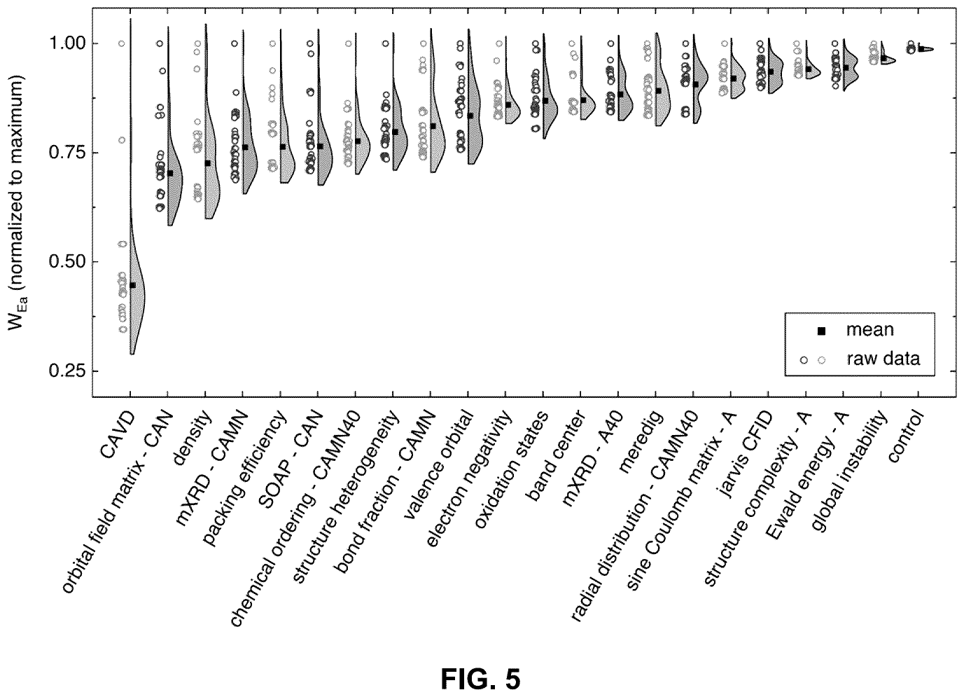

Each clustering outcome is also assessed by labeling with approximate activation energies for ion hopping. The activation energies are calculated using a bond valence site energy (BVSE) method developed by Adams and Rao^{331,332}. The strategy approximates the Eₐ as the sum of an attractive Morse-type potential term and a repulsive Coulombic interaction term. The Morse-type potential term represents mobile ion interactions with lattice anions. While the Coulombic interaction term represents mobile ion interactions with lattice cations. Relative to DFT-based methods, the BVSE method is a computationally lean approach that can be used to readily assess thousands of structures. However, the BVSE method tends to overestimate activation energies because it (1) does not allow for structural relaxation as the mobile ion moves and (2) does not consider repulsive interactions between mobile ions^{331,332}. The BVSE method has been implemented by He et al. and is available for use through their python API³³³. Using the BVSE method, we label 6845 structures with activation energies (6845 is the number of structures successfully solved given a computing time cutoff of 20-minutes for each structure). Ward's minimum variance method applied to the activation energy labels (W_{Ea}) is calculated in a similar manner to the Wu:

$${W}_{Ea} = {\sum }_{k = 1}^{{n}_{c}} {\sum }_{i ∈ {C}_{k}} {[ {( {E}_{a , BVSE} )}_{i} - {( \overline{{E}_{a , BVSE}} )}_{k} ]}^{2}$$

where n_{C} is the number of clusters in a set, Cₖ is cluster k, and where (Eₐ,B_{VSE})ₖ denotes the mean for all labels in cluster k. Each descriptor's W_{Ea} results are shown in FIG. 5 for the first 50 clustering sets. For simplicity, only the best-performing simplification-descriptor combination is shown for each descriptor.

For Eₐ labels, all descriptor-simplification pairings result in better semi-supervised ML performance than randomized clustering. The SOAP descriptor performs well relative to most, but five other descriptors outperform it: CAVD, orbital field matrix-CAN, density, mXRD-CAMN, and the packing efficiency descriptors. The favorable performance of CAVD is anticipated because the BVSE calculation directly uses the CAVD descriptor as a parameter. The favorable performance of the density and packing efficiency descriptors may be explained by their similarity to CAVD: the Voronoi decomposition to encode void space is dependent on the density and packing efficiency of the structure. Similarly, the orbital field matrix descriptor relies on calculation of Voronoi polyhedra to understand the coordination environment for each atom. A mXRD-CAMN descriptor-simplification performs well on the BVSE label set; however, the mXRD representation used by Toyota (mXRD—A40) drops from to 14^{th} best on the Eₐ label set. The result may suggest that the mXRD—A40 pairing does not generalize well. When comparing the top 10 descriptors for each label set, 6 descriptors are common to both approaches: SOAP, density, mXRD, structure heterogeneity, orbital field matrix, and bond fraction.

Section VI. Second-Order SOAP Descriptor

Semi-supervised ML models may be further improved by merging descriptors and clustering on the union representation. Second order descriptor unions are examined by combining the best-performing descriptors with all other descriptors. The two input descriptor vectors (d_{A} and d_{B}) were combined with a mixing ratio (a) to yield the union representation (d_{AB}):

d_{AB}=d_{A}∪αd_{B}

The ideal mixing ratio is unknown for each union and we find that incremental changes to the mixing ratio do not result in continuous changes to the W_{σ}. Thus, outcomes are manually screened for mixing ratios from 10⁻⁶ to 10⁶ (see supplemental information—section VI). Most descriptor unions result in no improvement to the W_{Q}, across all mixing ratios. However, the W_{σ} for SOAP when mixing with the non-simplified sine Coulomb matrix descriptor (for α=2·10⁻⁶-4·10⁻⁶) is lowered by 2-3%, with the exact percentage depending on the depth of clustering.

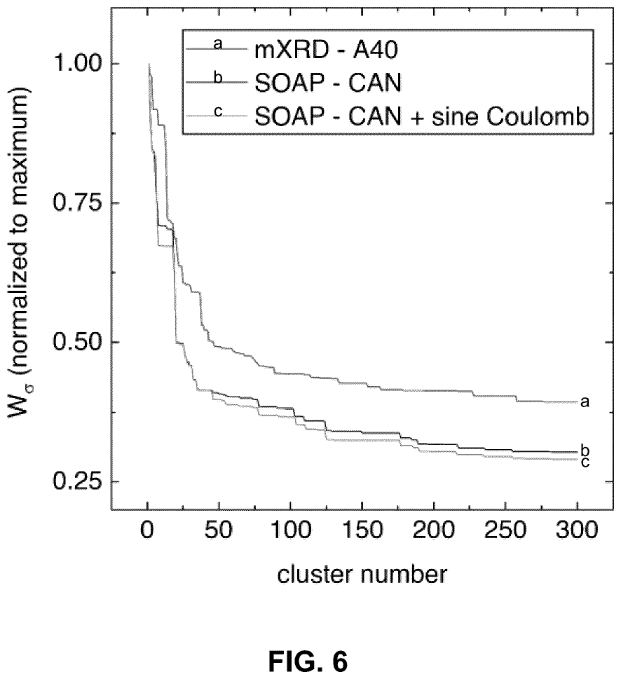

Almost no descriptor combinations are successful in reducing the W_{σ}. Excluding combinations that include the SOAP-CAN descriptor, no combinations outperform the 1^{st} order SOAP-CAN representation. For combinations that include SOAP-CAN, some mixing ratios with the sine Coulomb matrix and the Ewald energy descriptors resulted in modest improvements in the W_{σ}. The best improvement is found when mixing SOAP-CAN with the sine Coulomb descriptor for α=2·10⁻⁶, 3·10⁻⁶, and 4·10⁻⁶. All three combinations result in the same improved curve, plotted below in FIG. 6.

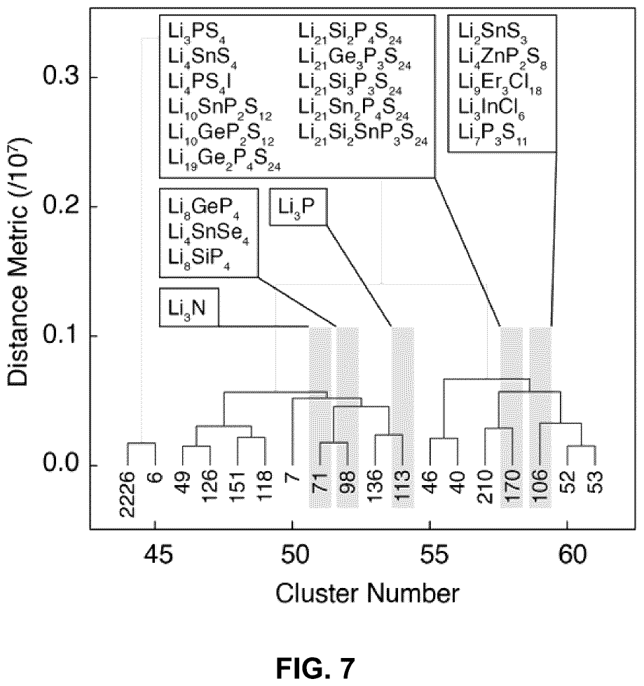

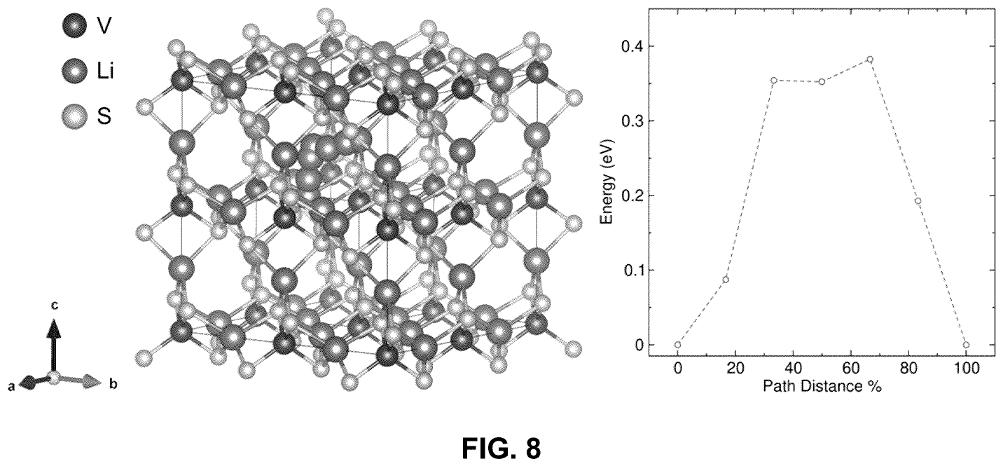

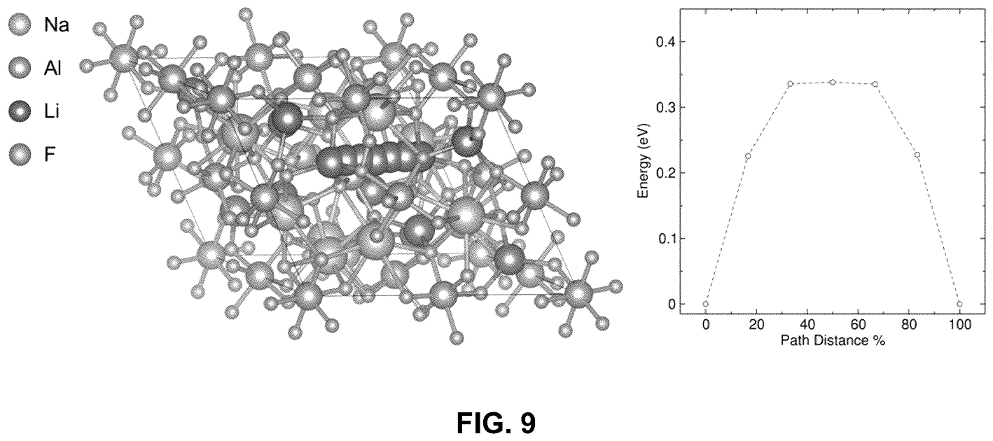

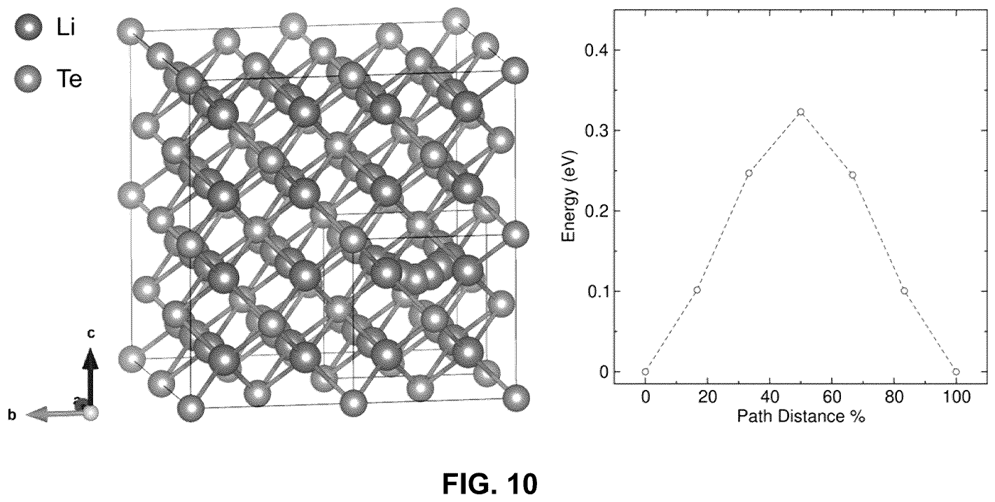

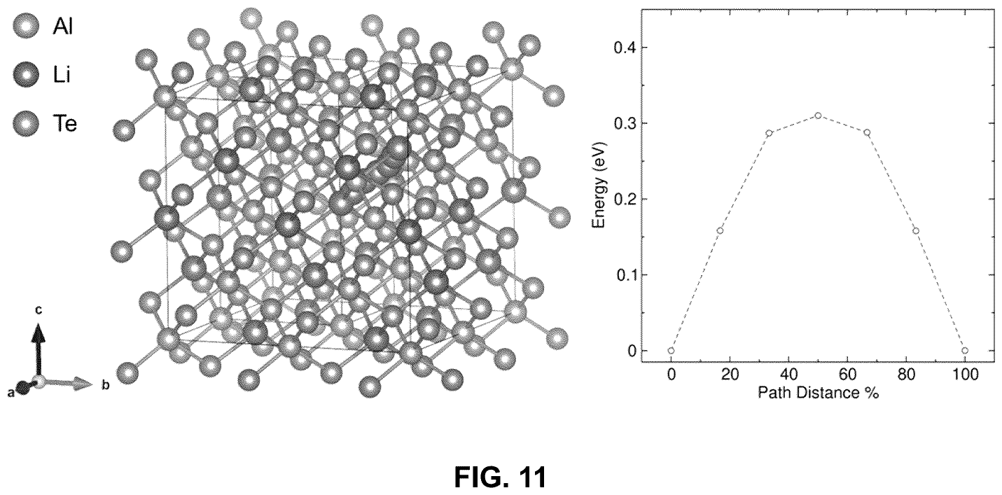

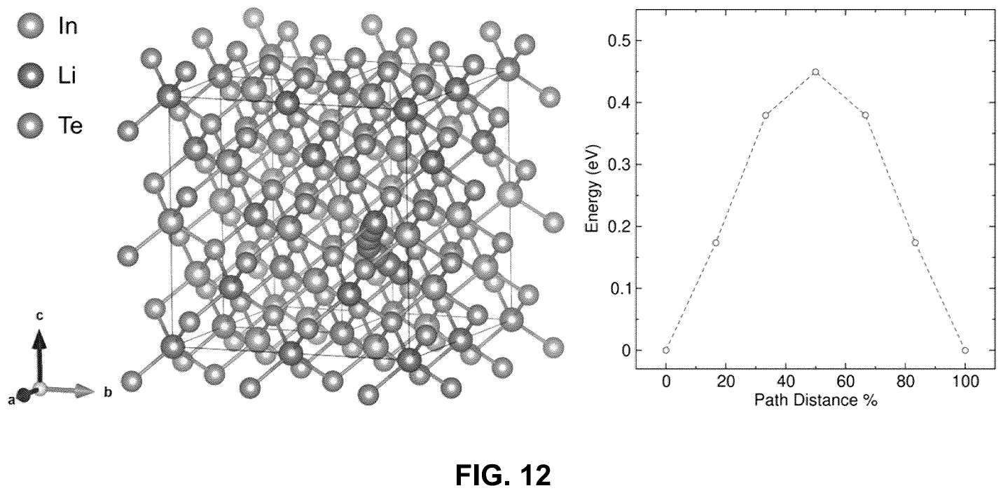

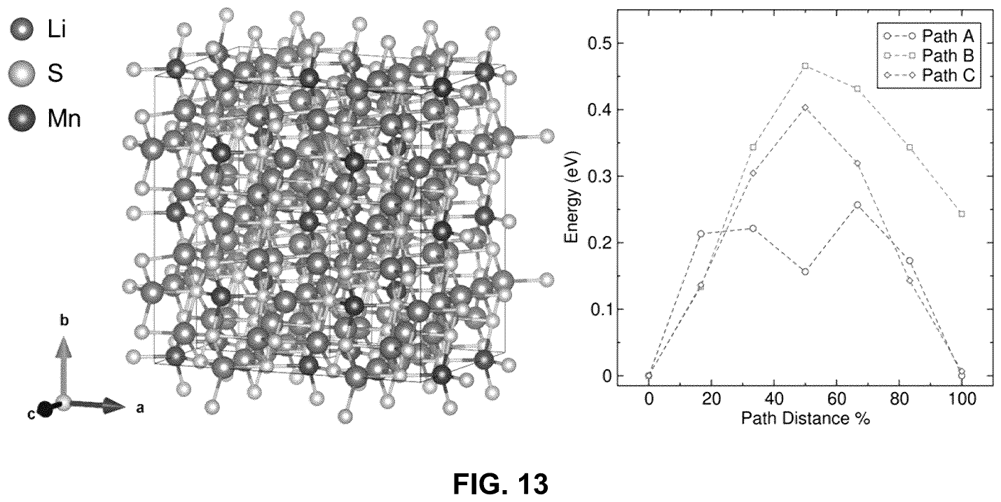

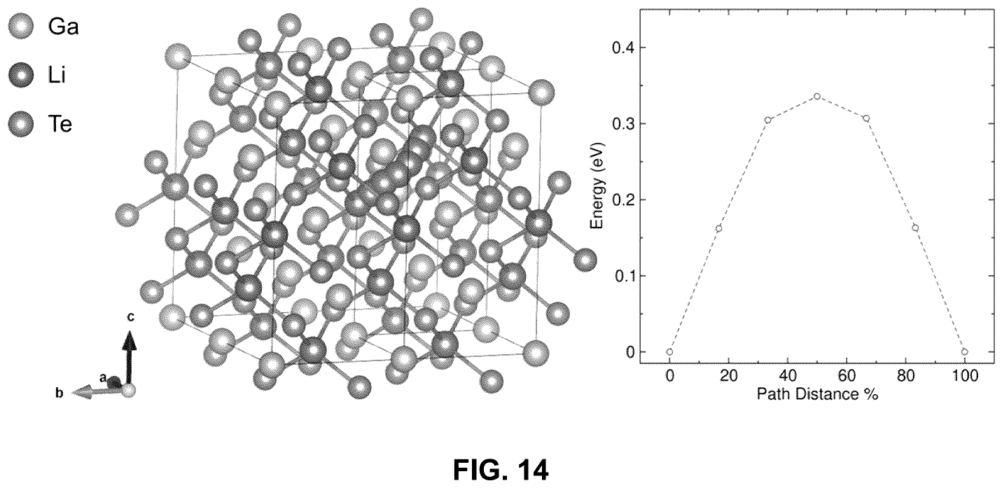

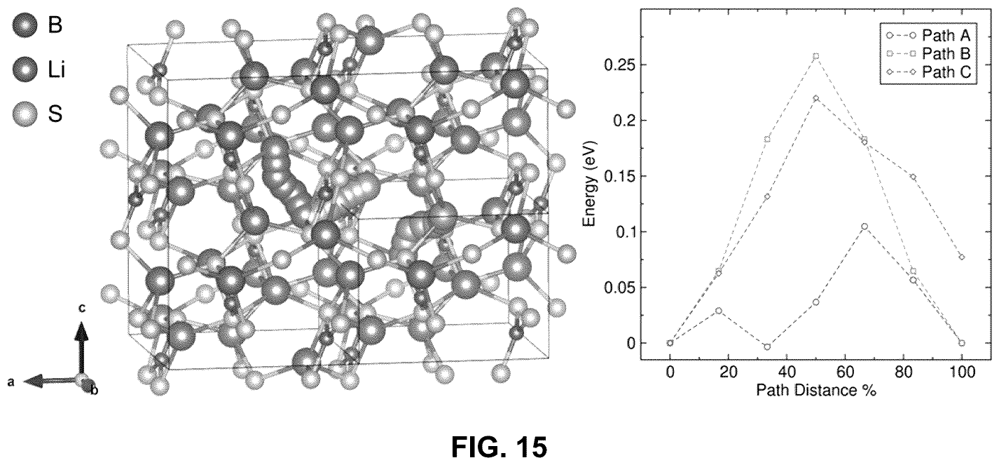

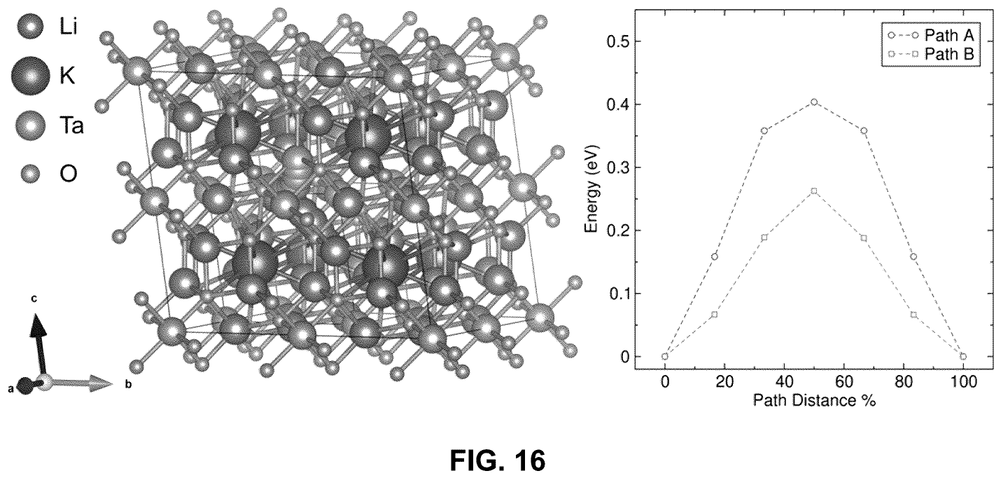

The agglomerative dendrogram in the main text shows that the 2^{nd}-order SOAP-CAN descriptor facilitates aggregation of high-conductivity labels. In the simplified 9-cluster representation, most of the high-conductivity (σ_{RT}>10⁻⁵ S cm⁻¹) labels are contained within the 2^{nd} “mega cluster”. The 2^{nd} mega cluster accounts for only 15% of the input structure. By clustering further, increasingly dense representations are found. For example, at the 241^{st} clustering depth, the 21 high-conductivity labels have been sorted into five subclusters (FIG. 7). Taken together, the five subclusters account for 52.5% of the high conductivity labels while containing only 2.2% of the input structures. We note that the control (random clustering) exhibits a Ward Variance 214% greater than the 2^{nd}-order SOAP-CAN model at the 241^{st} clustering depth. The difference in Ward Variance illustrates that the 2^{nd}-order SOAP-CAN model is much better at identifying high-conductivity structures, relative to random selection.

Section VII. Climbing Image—Nudged Elastic Band

Migration barriers for Li ion hopping are evaluated with the Climbing Image—Nudged Elastic Band (CI-NEB) method as implemented in the QuantumESPRESSO PWneb software package³³⁴⁻³³⁷. Density-functional theory (DFT) calculations are performed using the Perdew-Burke-Ernzerfof (PBE) generalized gradient approximation functional and projector-augmented wave (PAW) sets^{338,339}. Convergence testing for the kinetic-energy cutoff of the plane-wave basis and the k-point sampling is performed for each structure to ensure an accuracy of 1 meV per atom. The lattice parameters and atomic positions of the as-retrieved structure are optimized. Supercells are created for each structure that are a minimum of 10 Å in each lattice direction to minimize interactions between periodic images of the mobile ion. To study the migration barrier in the dilute limit, a single Li vacancy is created in the boundary endpoint structures of each studied pathway. A uniform background charge is used to balance excess charge. Each boundary configuration is relaxed until the force on each atom is less than 3×10⁻⁴ eV/Å. Images are created by linearly interpolating framework atomic positions between the initial and final boundary configurations. The initial pathway for the mobile ion is generated from the BVSE output minimum energy pathway to promote faster convergence of the NEB calculation. An NEB force convergence threshold of 0.05 eV/Å is used. The calculation is first converged using the default NEB algorithm and then restarted with the CI scheme to allow for the maximum energy of the pathway to be determined.

Section VIII. a-Li_{2.95}B_{0.95}Si_{0.05}S₃ Impedance

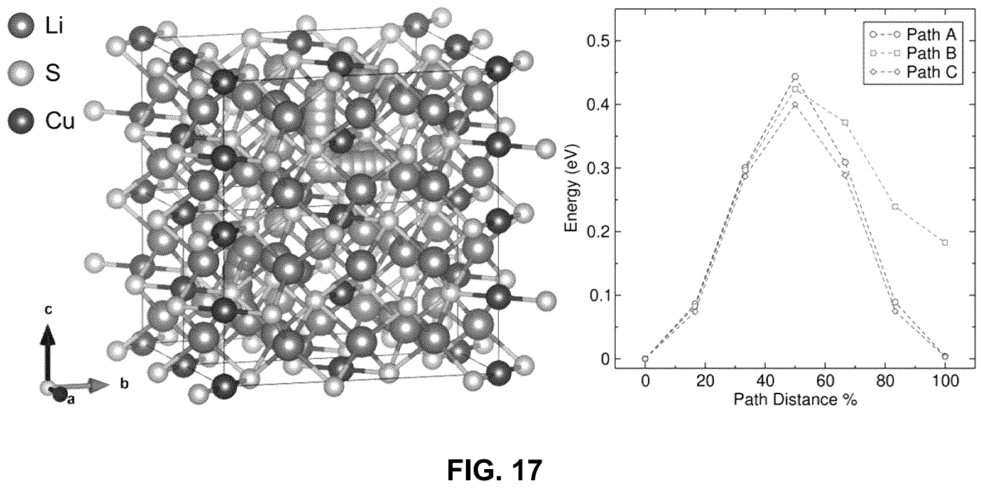

Electrochemical impedance data for the amorphized Si-substituted Li₃BS₃ (a-Li_{2.95}B_{0.95}Si_{0.05}S₃) suggests the presence of two RC features. The VSP-300 potentiostat can supply a maximum sinusoidal frequency of 3 MHz, sufficient to resolve a partial semicircle in the Nyquist impedance plot (FIG. 17). Attempted fits to the partial semicircle reveal that it would not intersect the origin at higher frequencies, suggesting the presence of an additional RC feature. It is plausible that two RC features exist, describing the bulk and grain-boundary transport of Li⁺. A more conservative estimate of the conductivity (σₜₒₜ) can be derived by extrapolating a linear of the Warburg tail to the x intercept. While the more conservative estimate is used in the main manuscript, we note here that the actual bulk conductivity is likely higher.

Section IX. Full List of Promising Structures

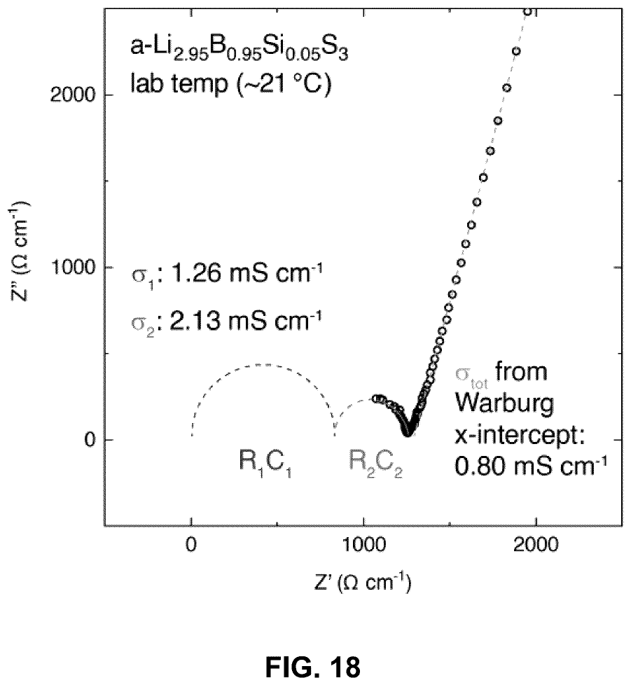

Excluding the labeled dataset, there are 50 compounds that are predicted to be stable and to exhibit a Li-hopping activation energy below 600 meV. Ten of the predicted compounds have already been experimentally examined and are hereafter excluded: Li₂O, Li₂S, LiCl, LiI, LiBr, Li₆AsS₅I, Li₄Ti₅O₁₂, Li₂InCl₃, LiInI₄, Li₆NiCl₈. Another nine are excluded because they are used in cathodes, anodes, or glassy electrolyte formulations: LiFeCl₄, Li₂CO₃, Li₂PtO₃, Li₂NiGe₃O₈, Li₂CrO₄, Li₂SeO₄, LiAlS, Li₂Mn₃NiO₈, LiInSe₂. The remaining 31 promising structures are discussed below and plotted by ascending activation energy in FIG. 18.

a. Stable Compounds

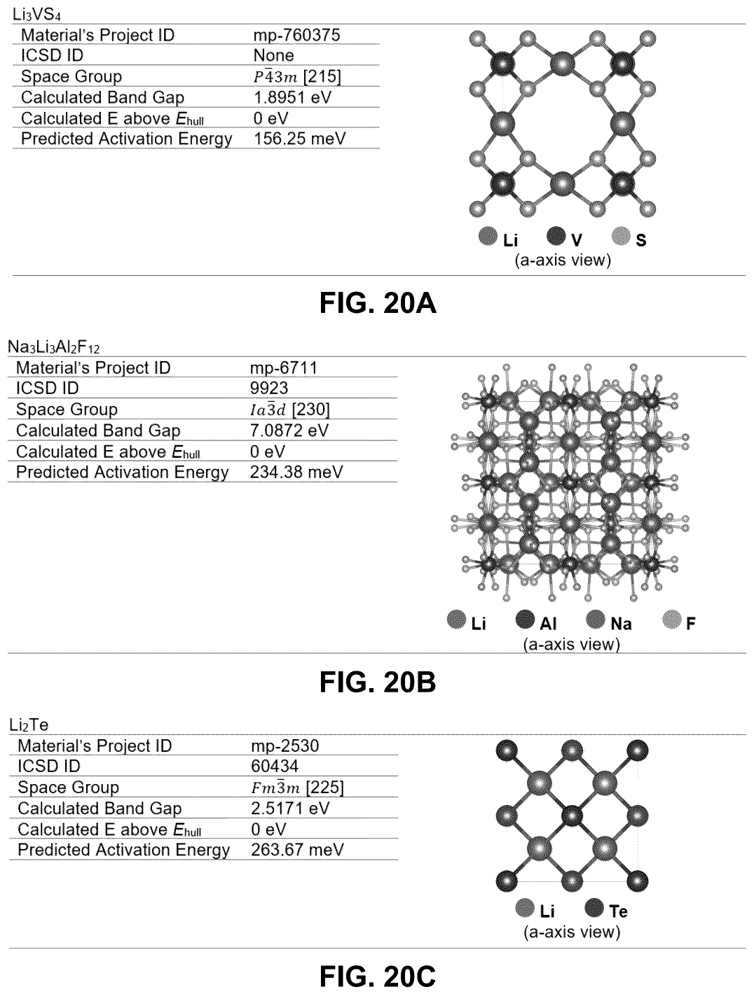

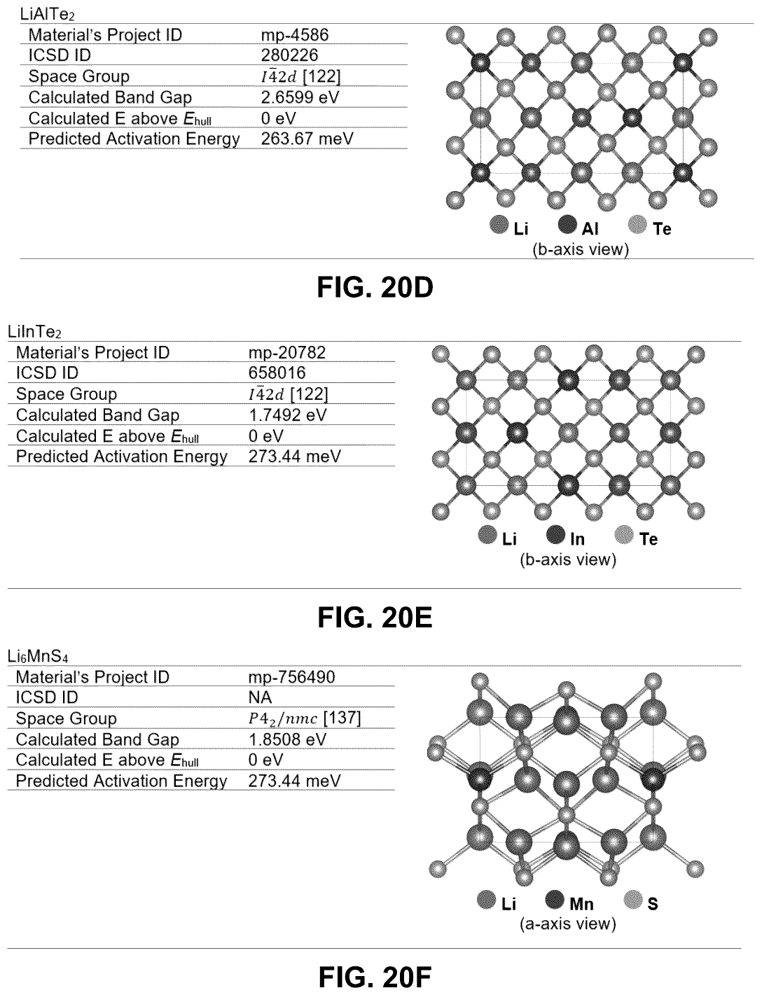

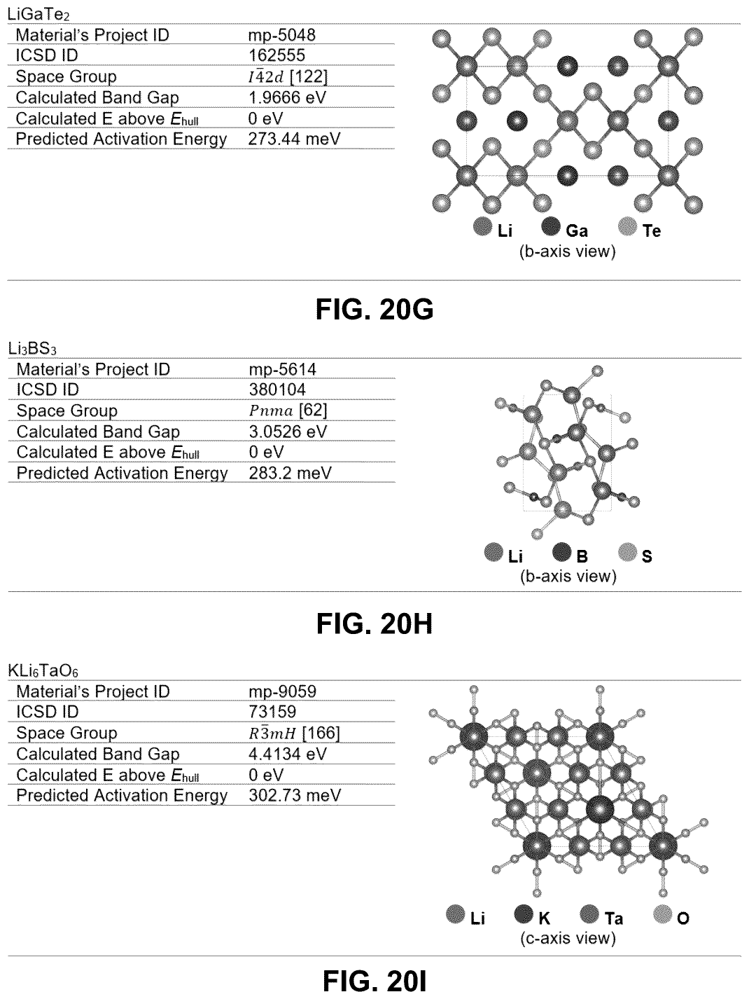

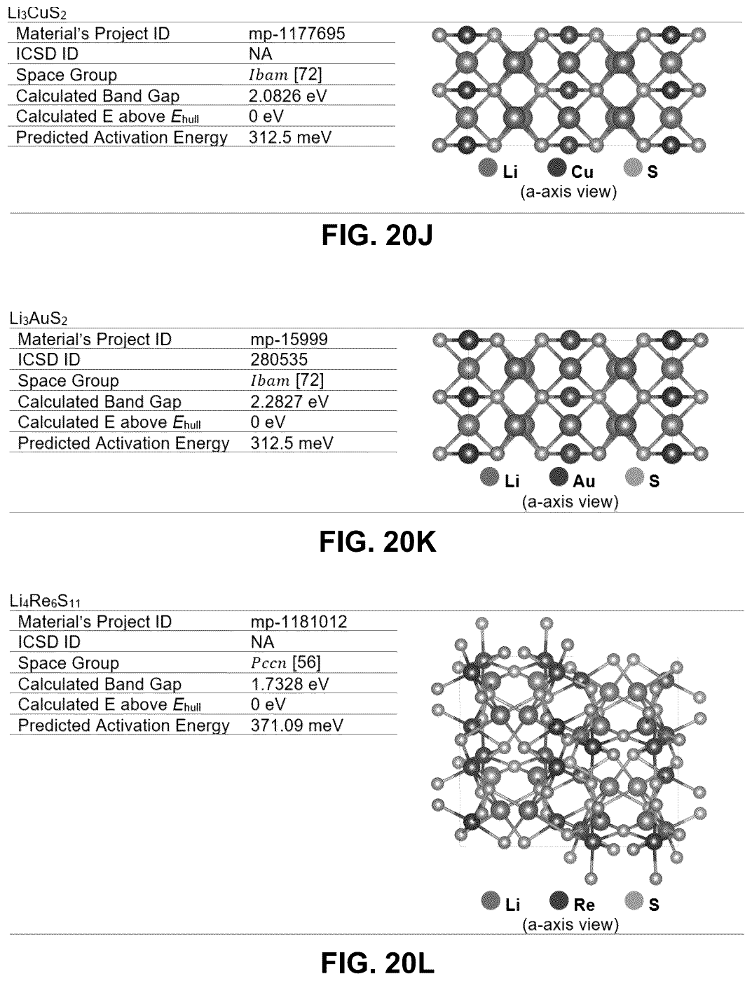

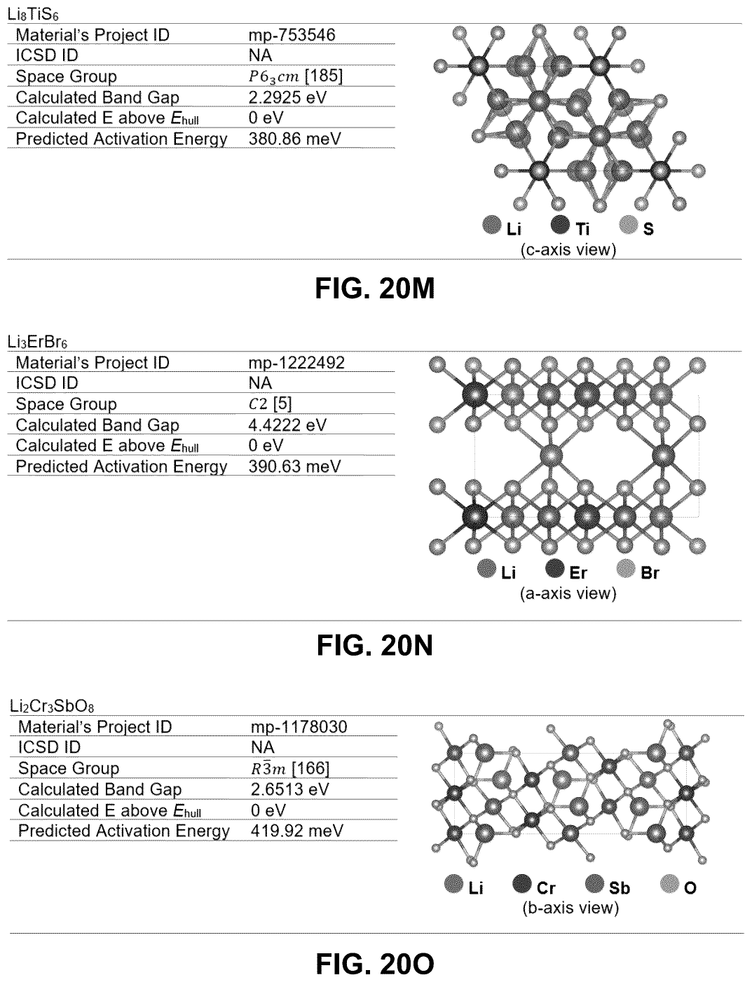

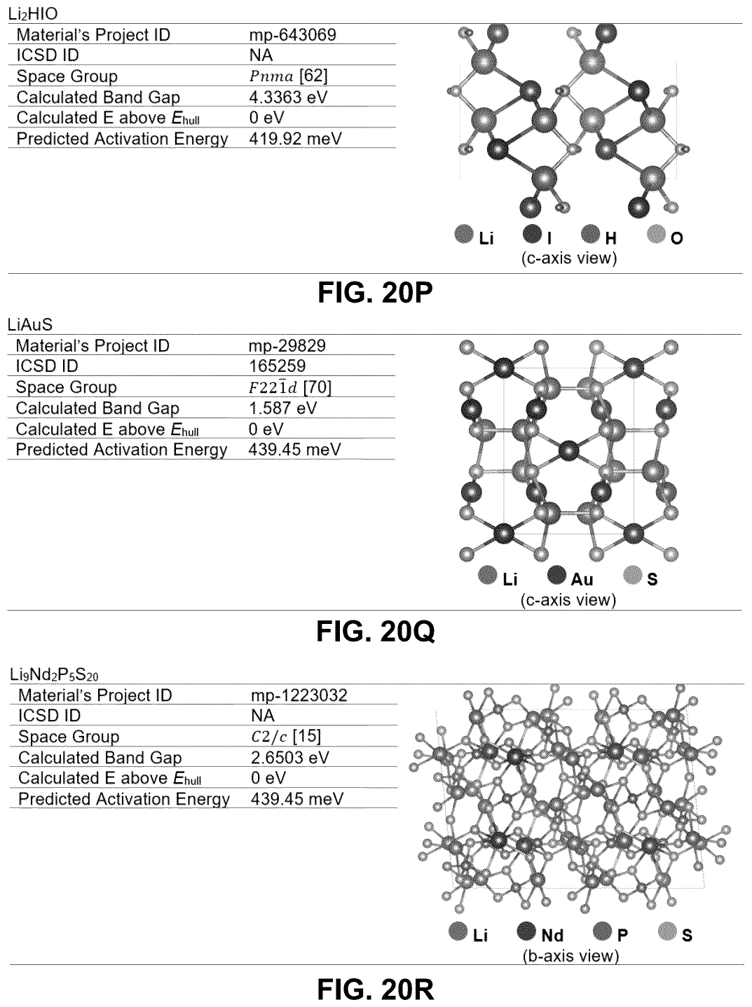

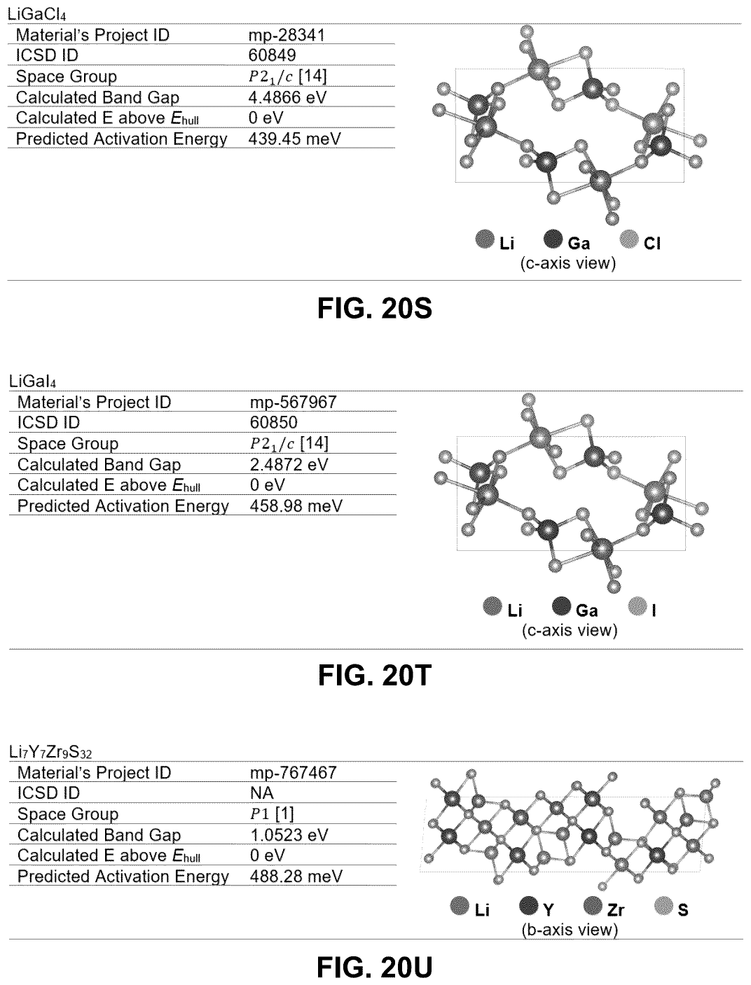

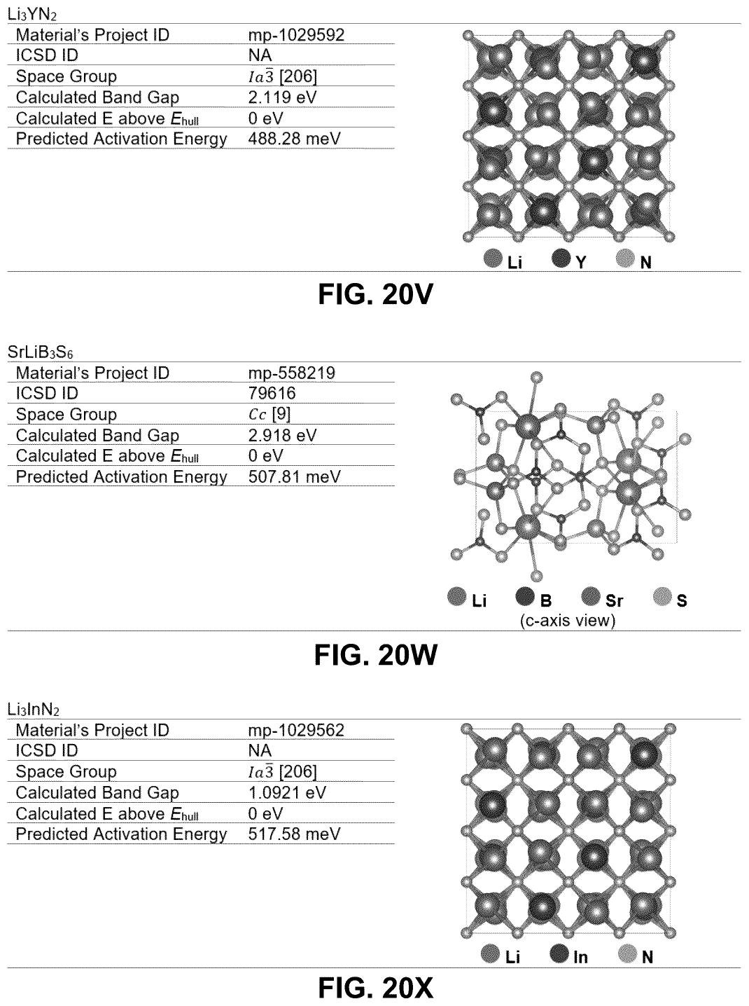

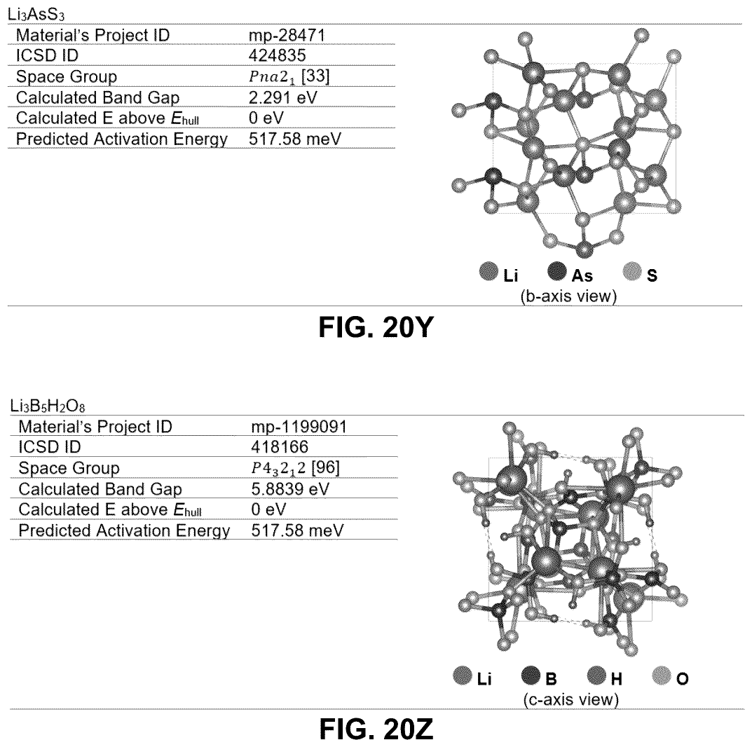

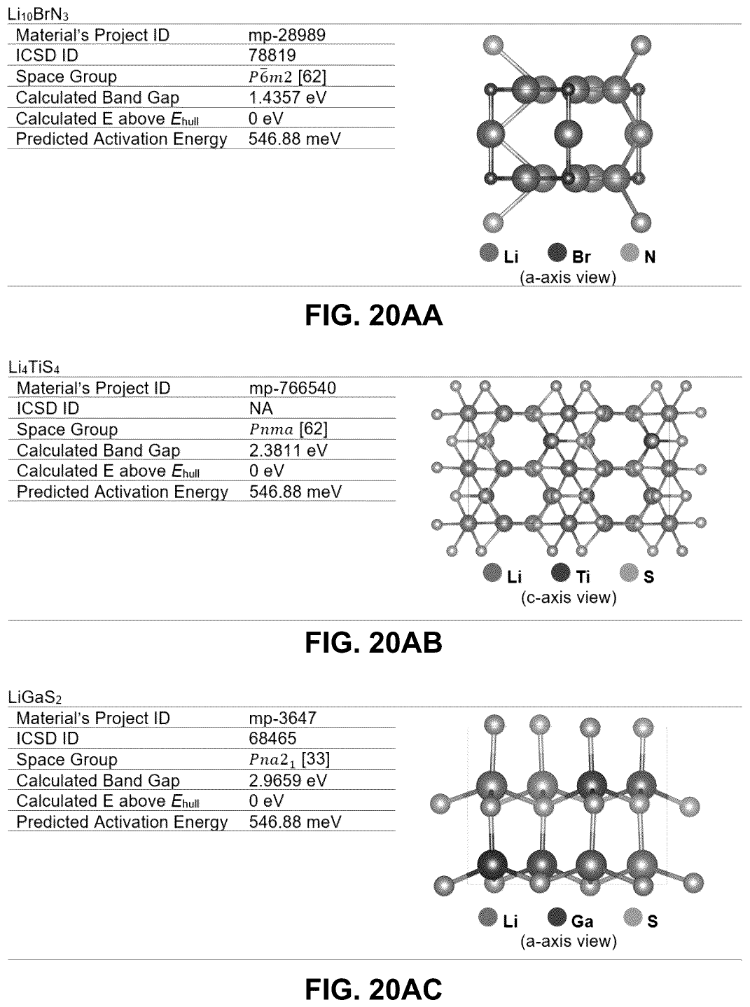

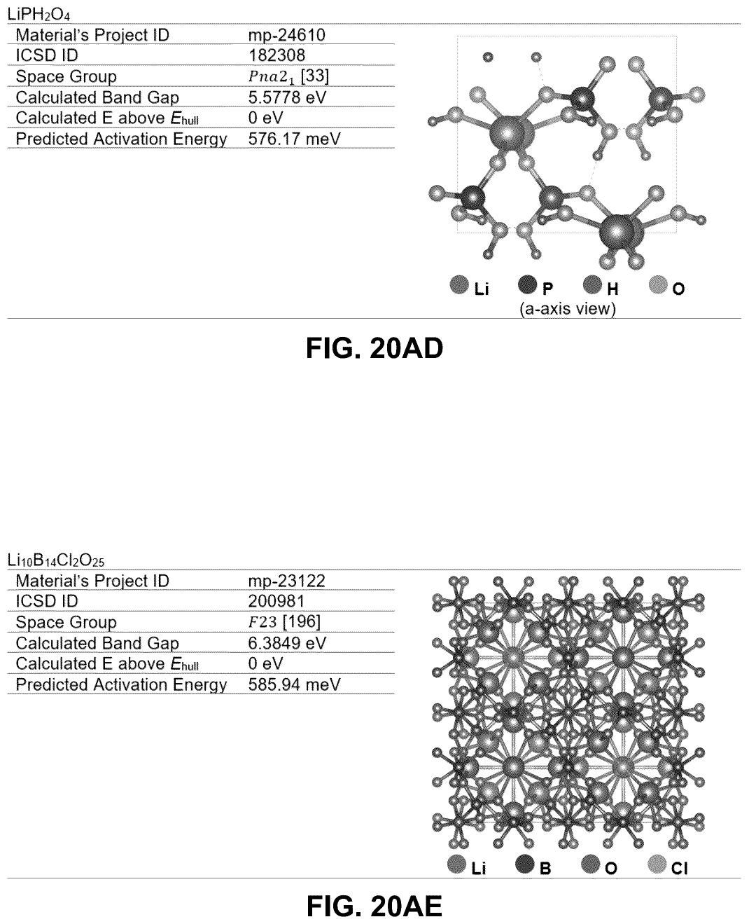

Each structure is examined in order of ascending activation energy in FIGS. 20A-20AE.

b. Quasi-Stable Compounds (Eₕᵤₗₗ below 15 meV)

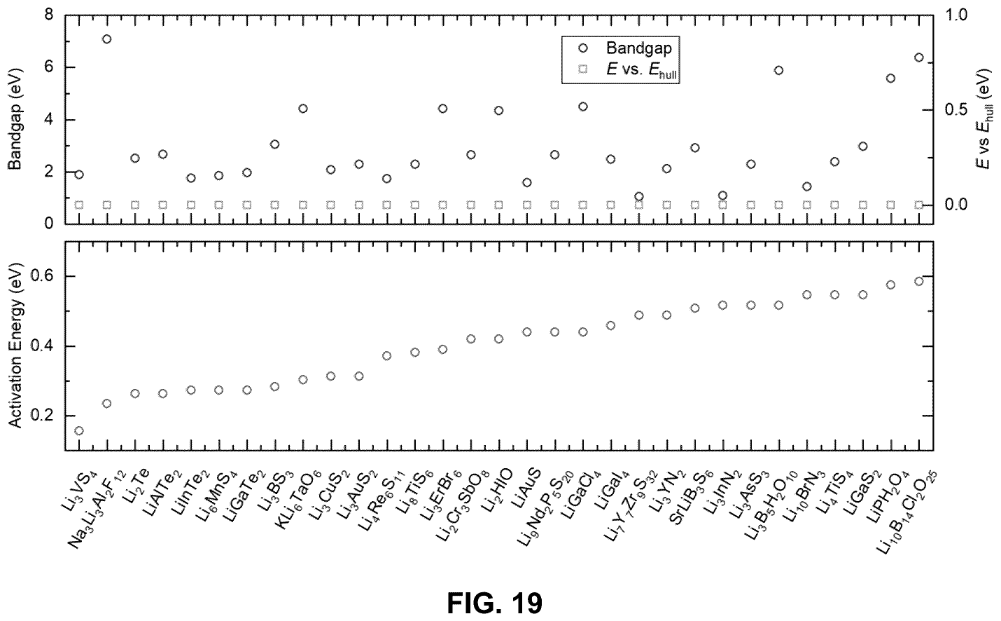

Excluding the labeled dataset, there are 34 compounds that are predicted to be within 15 meV of the convex hull (Eₕᵤₗₗ) and to exhibit a Li-hopping activation energy below 600 meV. Ten of the predicted compounds have already been experimentally examined and are hereafter excluded: Li₃SbS₄, Li₆AsS₅I, Li₆PS₅₁, Li₃ScCl₆, Li₂MnBr₄, Li₃N, LiTi₂P₃O₁₂, Li₁₀SiP₂S₁₂, Li₂ZnCl₄, Li₃InO₃. Another three are currently being excluded because they are used in cathodes: Li₃NbS₄, Li₃CuS₂, Li₆VCl₈. The remaining 21 promising structures are discussed below and plotted by ascending activation energy in FIG. 19.

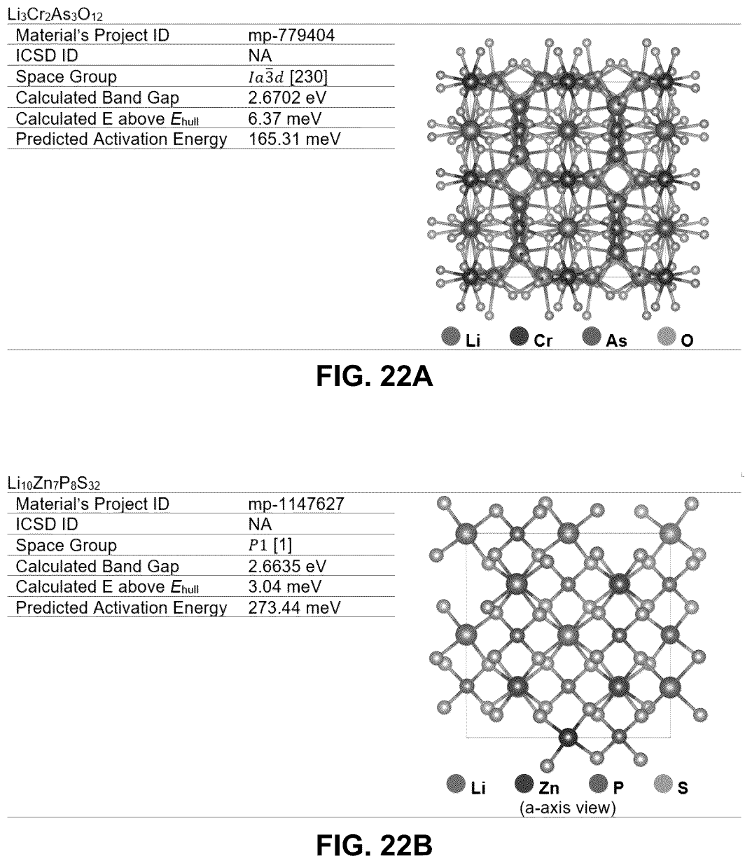

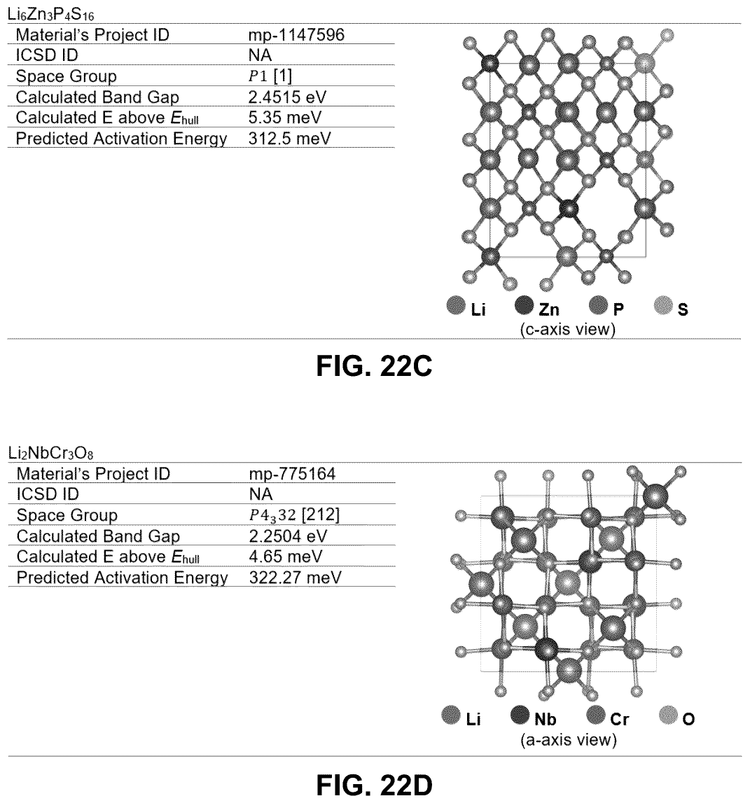

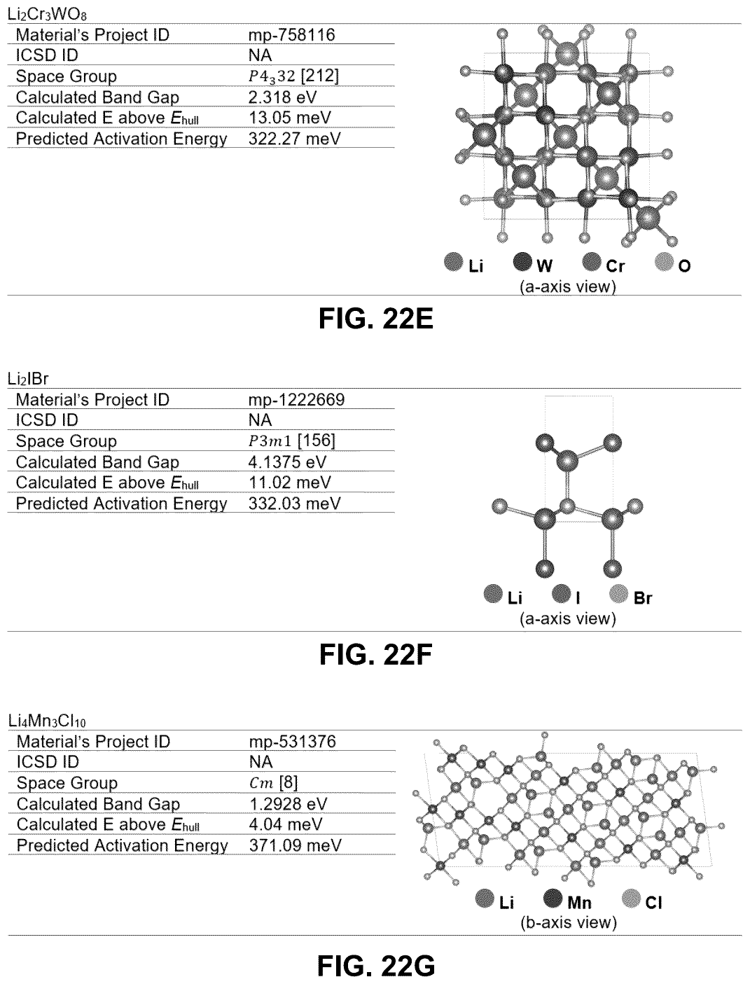

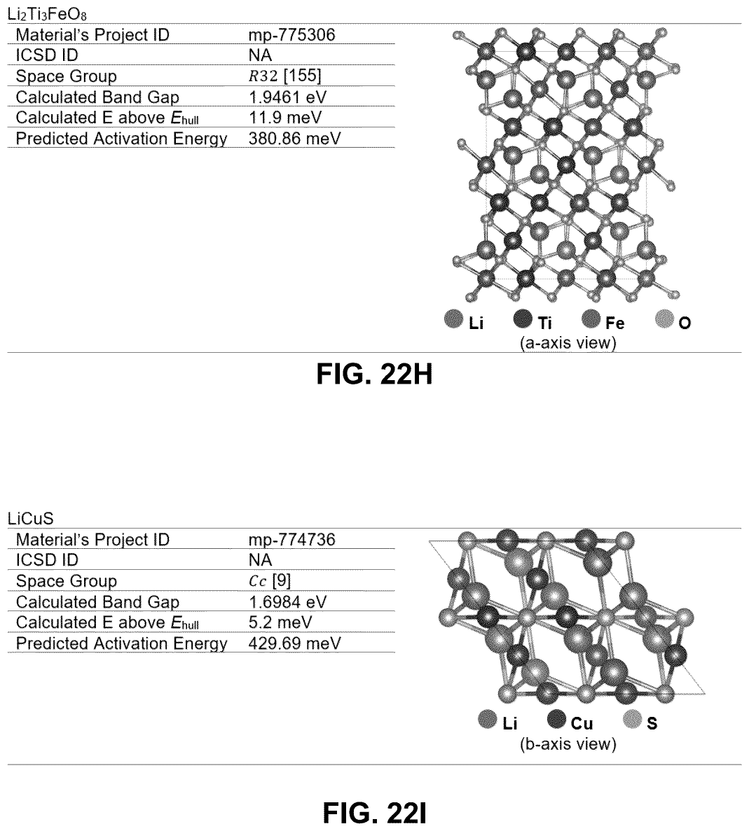

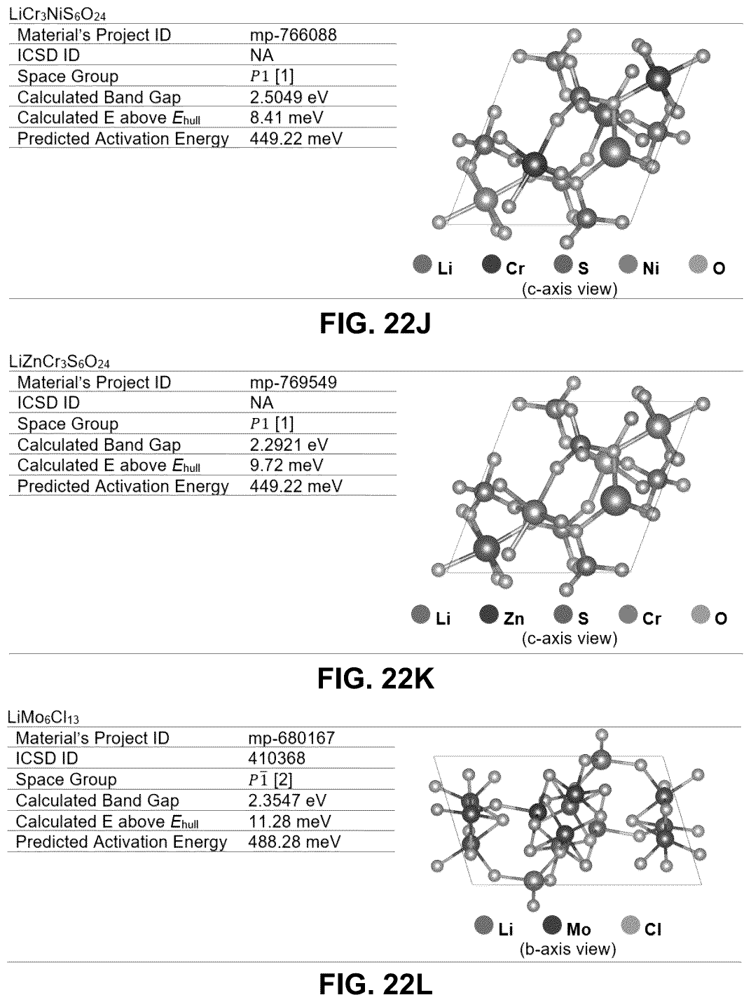

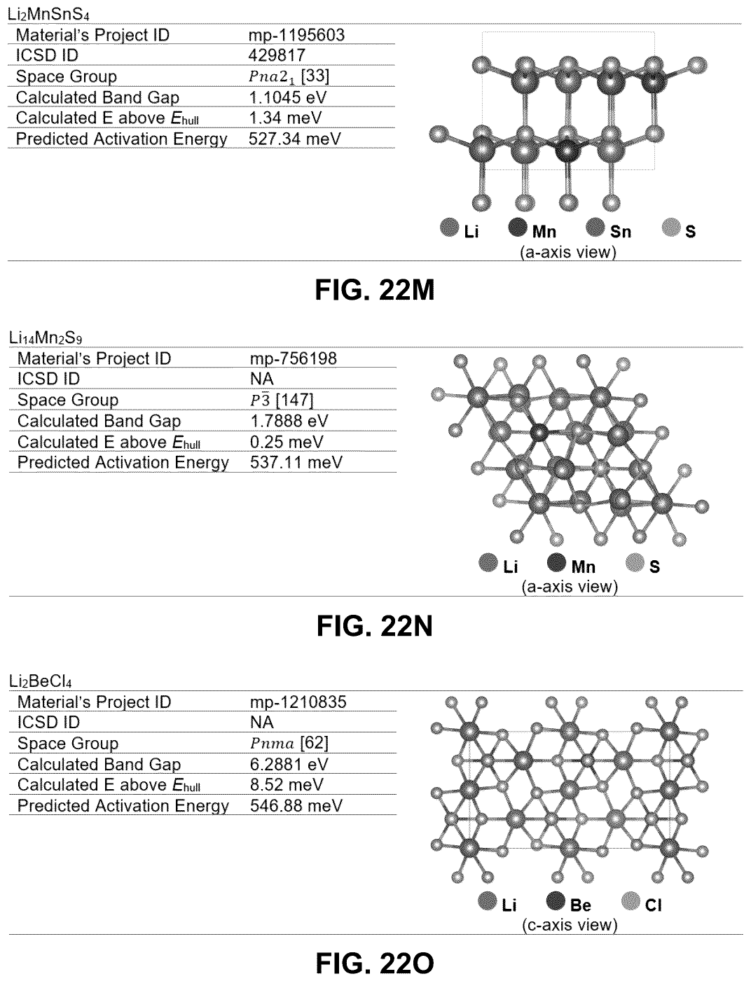

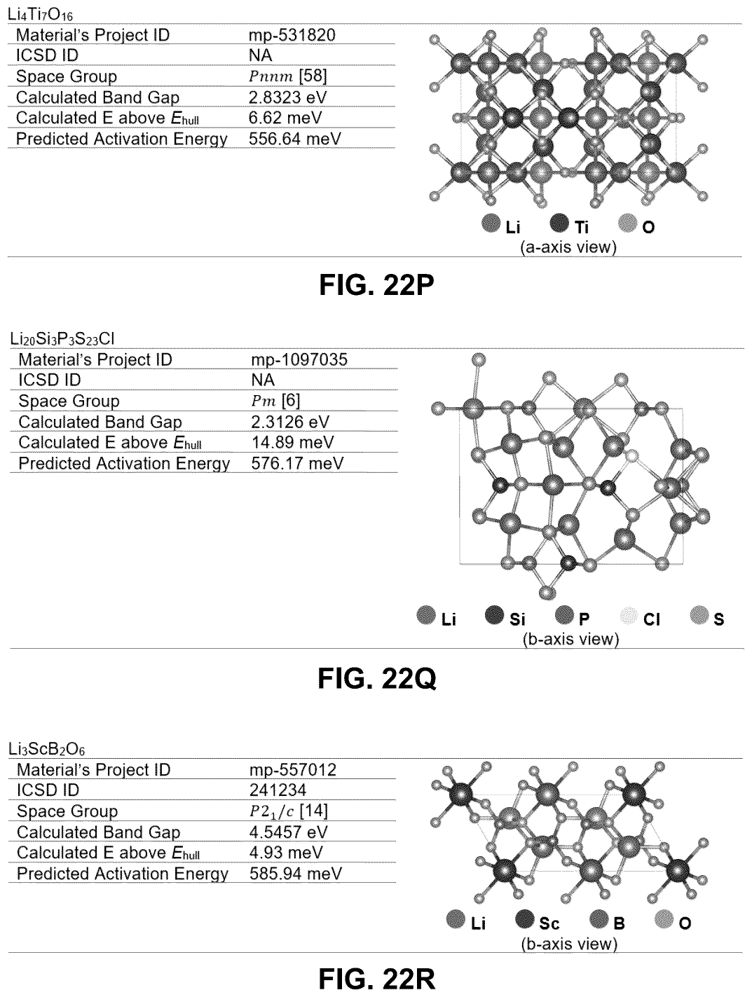

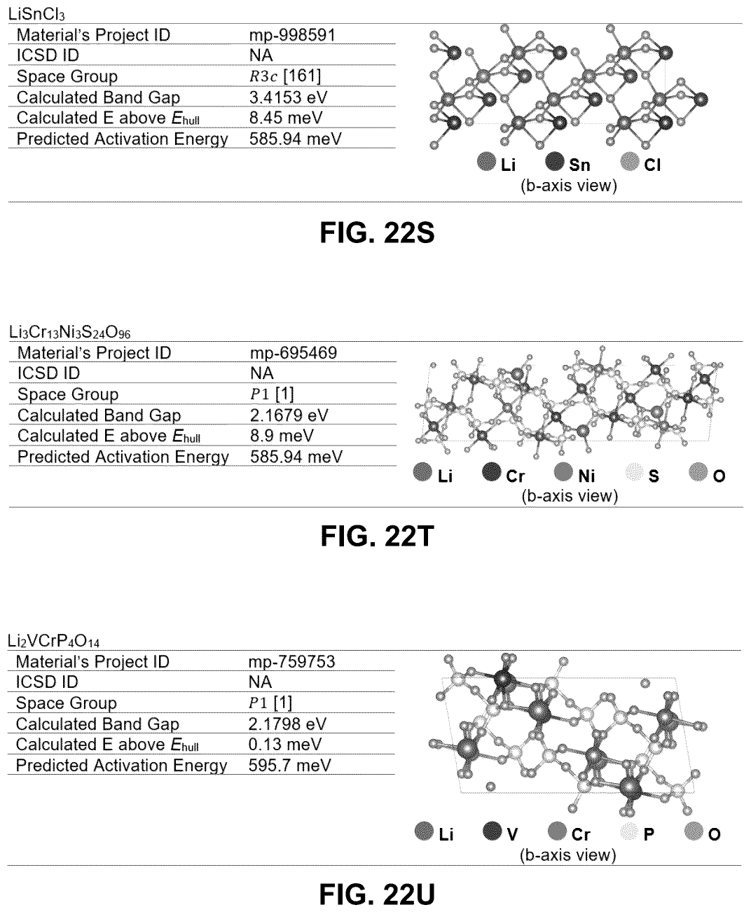

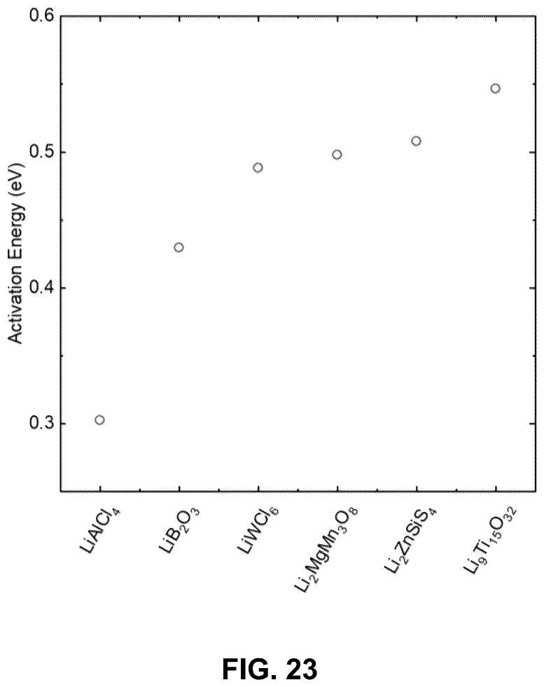

See FIGS. 22A-22U.

c. Unknown-Stability Compounds (Sans Materials Project Entry)

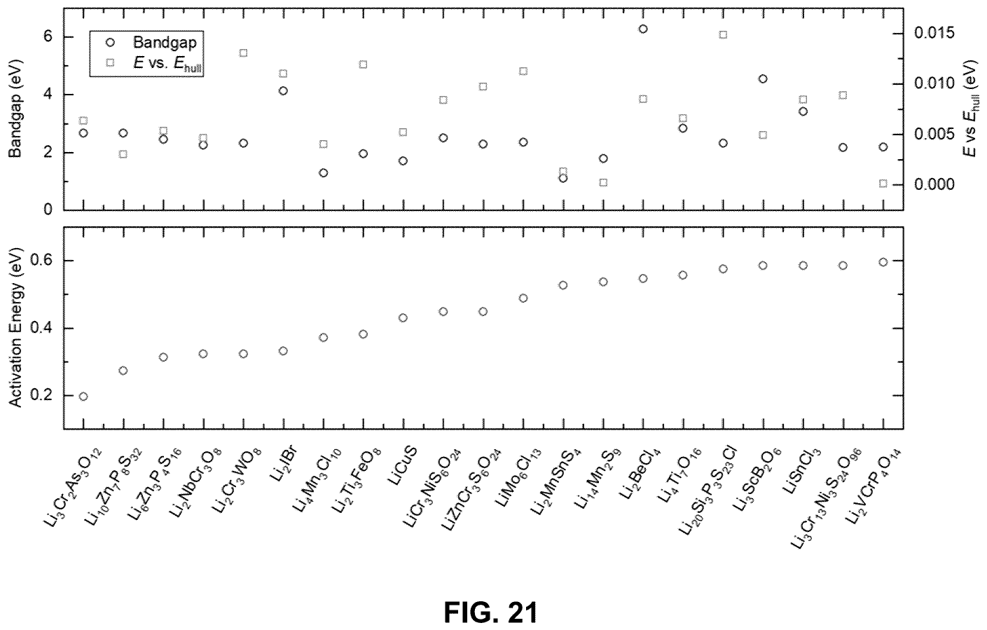

There are 18 predictions that have no associated Material's Project entry. These structures lack stability data. Seven of the predicted compounds have already been experimentally examined and are hereafter excluded: Li₂O, Li₂S, Li₇Y₇Zr₉S₃₂, Li₄SnSe₄O₁₃, Li₂MnBr₄, Li₅AlS₄, Li₃Fe₂P₃O₁₂. Another five are currently being excluded because they are used in cathodes: Li₂Mn₃NiO₈, Li₂Mn₃CoO₈, Li₅Mn₁₆O₃₂, Li₂Mn₁₅AlO₃₂, Li₃V₂P₃O₁₂. The remaining 6 promising structures are discussed below and plotted in order of ascending activation energy in FIG. 21.

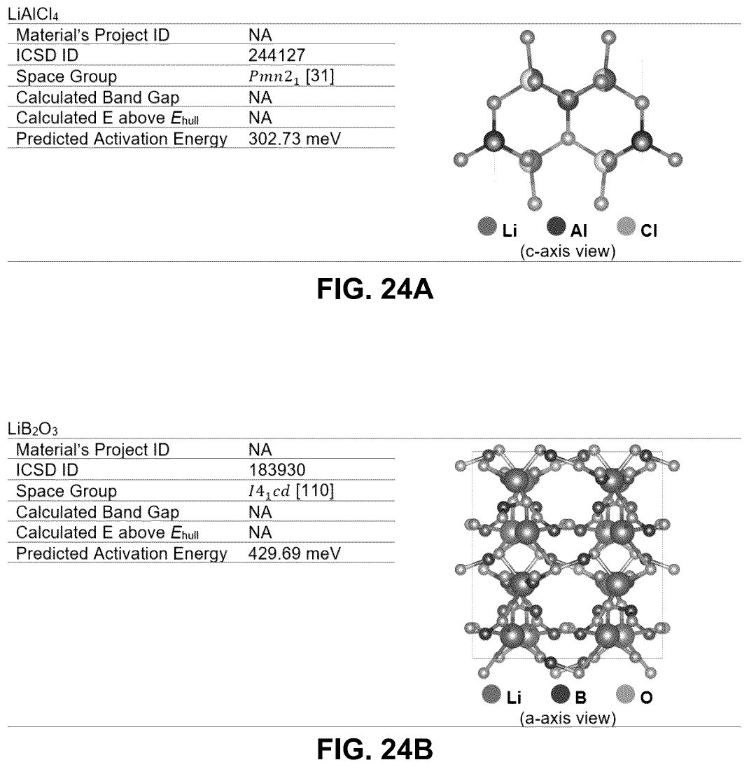

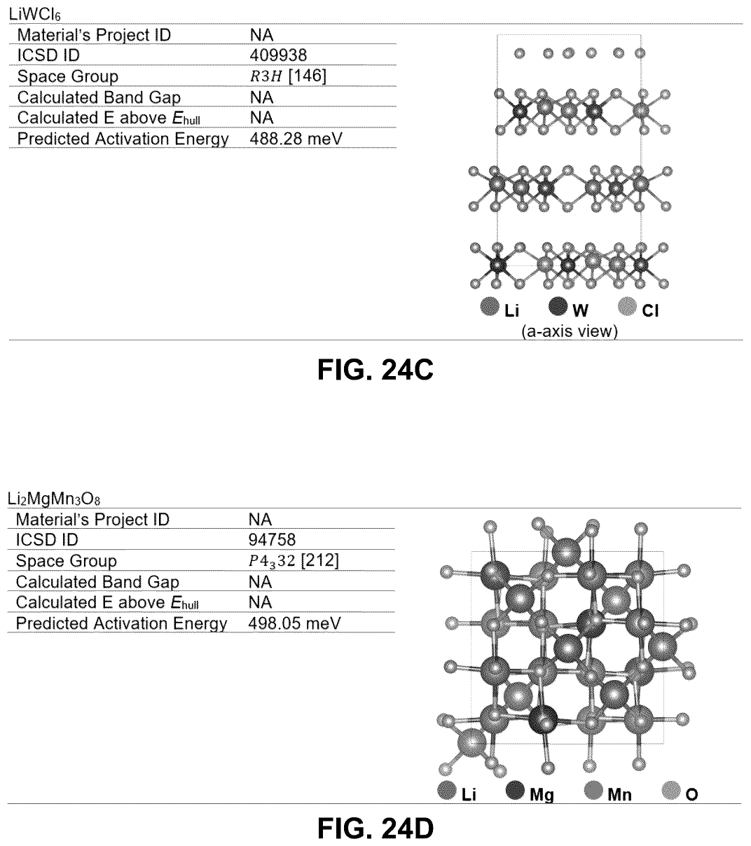

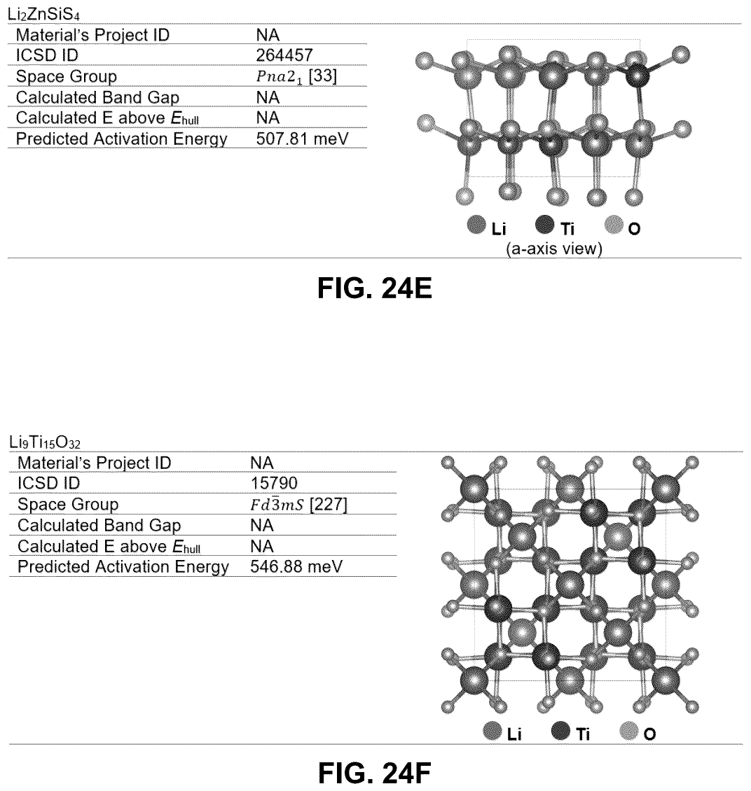

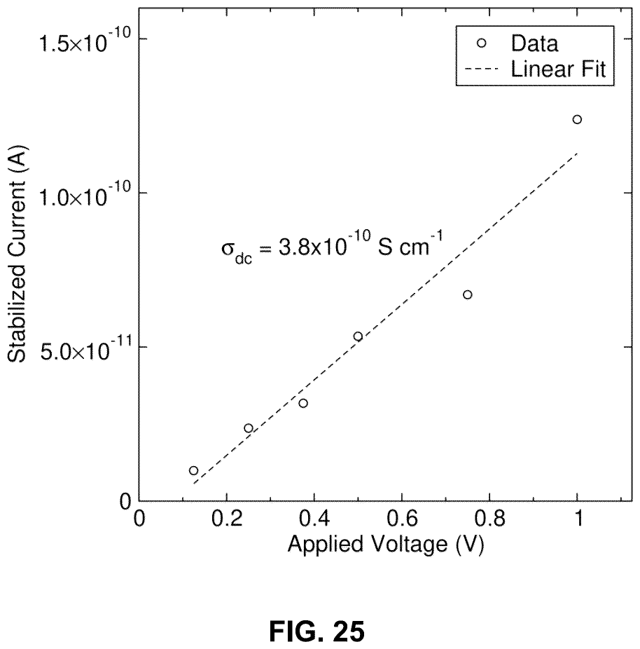

See FIGS. 24A-24F.

### Example 2: Experimental Validation of the Semi-Supervised Learning Model: Li₃BS₃

From the ten most promising candidates, Li₃BS₃ was selected for synthesis and characterization. Li₃BS₃ stands out because it has been explored experimentally and computationally before. Experimentally, Vinatier et al. previously determined that Li₃BS₃ has a total DC conductivity of 2.5·10⁻⁷ S cm⁻¹ with an activation energy of 700 meV⁶². The DC measurement was not included in our label set because DC measurements cannot differentiate between ionic and electronic conductivity, so they were categorically discounted from the label set (see supplemental information I for more details on label selection). Although the conductivity and activation energy reported by Vinatier et al. are underwhelming, there are promising theoretical reports. Density functional theory molecular dynamics (DFT-MD) simulations from Sendek et al.⁶³ suggest that Li₃BS₃ should have a room temperature conductivity between 3.1·10⁻⁶ and 9.7·10⁻³ S cm⁻¹. Our NEB-calculated activation energy for Li₃BS₃ is 260 meV, corroborating a previous NEB result from Bianchini et al.⁶⁴. Additionally, Li₃BS₃ is practically attractive because: (1) Li₃BS₃ contains no redox-active metals, (2) band edge calculations have suggested stability against metallic Li⁶⁵, (3) DFT-MD calculations have suggested a kinetic barrier for decomposition against metallic Li⁶³, and (4) the synthesis is reported⁶⁶. It is simpler to avoid redox active metals in the SSE as they may be reduced and oxidized at electrode interfaces. However, we note that Li_{0.5}La_{0.5}TiO₃ is a widely studied SSE that contains redox active Ti^{67,68} so the compounds we report here that contain Mn, V, and Cu should not be categorically discounted. It is important to note that while studying Li₃BS₃ as a candidate Li-ion conductor for model validation, Kimura et al. reported that a so-called “Li₃BS₃ glass” exhibits an ionic conductivity of 3.6·10⁻⁴ S/cm⁻¹ at 25° C.⁶⁹.

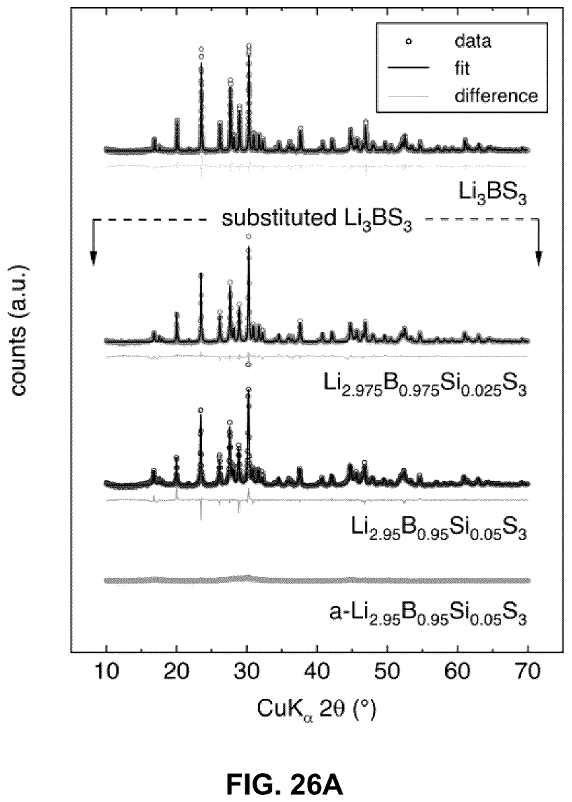

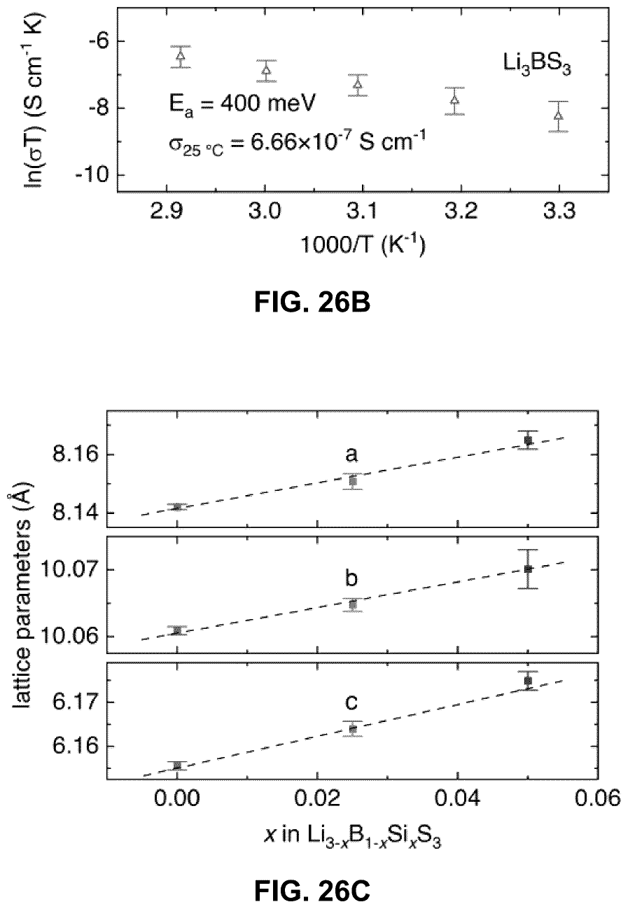

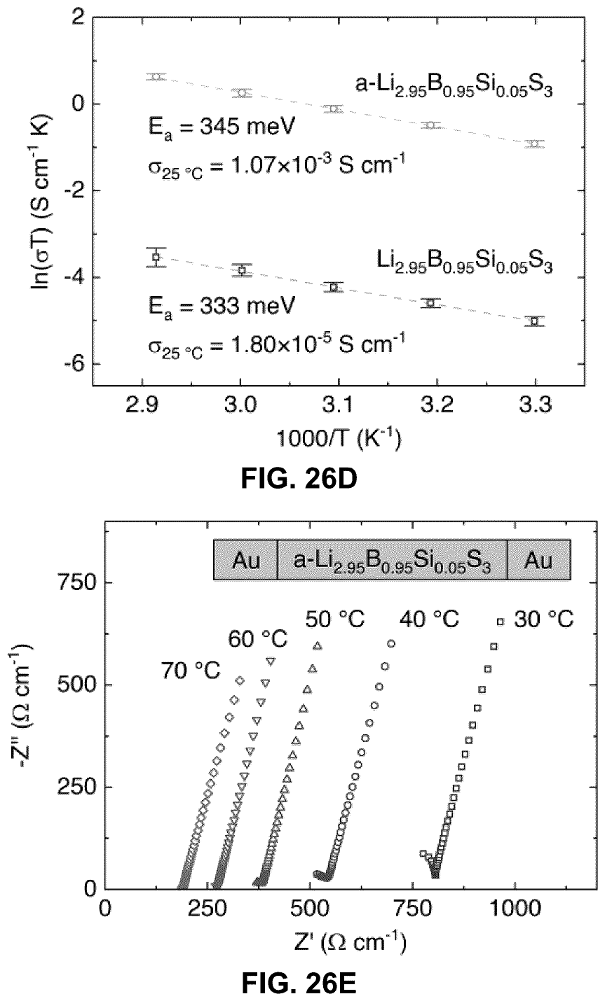

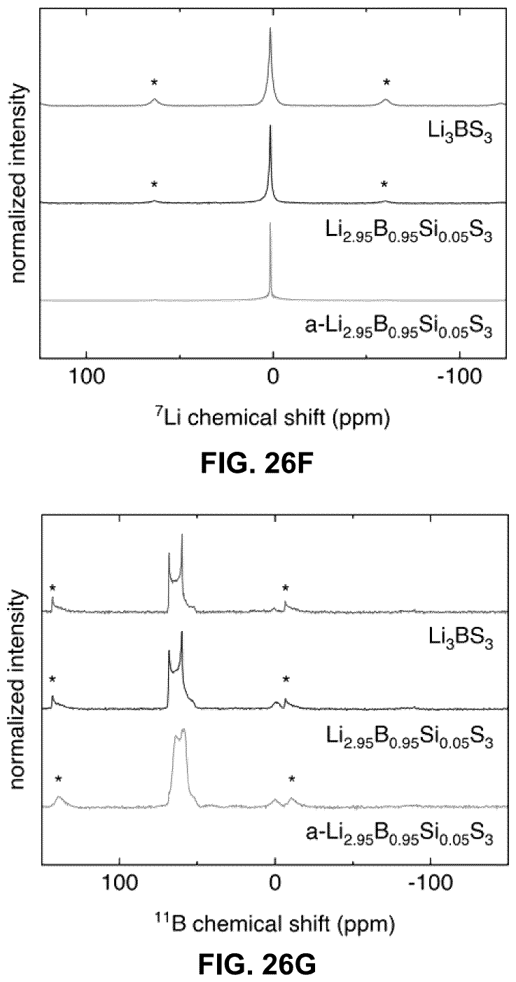

Li₃BS₃ is prepared using solid-state synthesis from Li₂S, B, and S precursors. The diffraction and quantitative Rietveld refinement are shown in FIG. 26A, suggesting a phase pure material. Electrochemical impedance spectroscopy (EIS) is employed at various temperatures and the resultant conductivity is plotted according to the Arrhenius-like relationship (FIG. 26B):

$$σ = \frac{{σ}_{0}}{T} {e}^{- \frac{{E}_{a}}{{k}_{B} T}}$$

where T is the temperature, k_{B} is the Boltzmann's constant, σ₀ is the conductivity prefactor and Eₐ is the activation energy for ionic conductivity. The room temperature ionic conductivity (σ_{25° C.}) is 7.16(±0.21)·10⁻⁷ S cm⁻¹ and the activation energy is 400±47 meV. The low conductivity and high activation energy may be due to lack of charge-carrying defects in the Li₃BS₃ lattice^{70,71}. Although a sufficient carrier concentration is necessary for facile ionic conduction in most materials, the descriptors in the semi-supervised model do not explicitly encode for charge-carrying defects. In the label set, conductivity is likely influenced by the defect concentration but defects are typically not reported. Still, the semi-supervised model may infer a structure's capacity to support conductive defects via correlation with the descriptors.

Li₃BS₃ Synthesis:

Li₃BS₃ is synthesized by reaction of Li₂S (Alfa Aesar, 99.9%), S₈ (Acros Organics, >99.5%), and elemental B (SkySpring Nanomaterials, Inc. 99.99%). The reactants are first mixed stoichiometrically (300 rpm for 1 h) using a planetary ball mill (MSE PMV1-0.4L) in 50 mL ZrO₂ jars with ZrO₂ balls. Two grams of reactants are always combined with 2 large balls (10 mm diameter), 34 medium balls (5 mm diameter), and 8 grams of small balls (3 mm diameter). Loading of ball mill jars occurs in an Ar-filled glovebox (Mbraun) and the jars are sealed before removal. After the 1 h of milling, the precursor mixture is pumped back into the glovebox and 330-340 mg of the powder is loaded into carbon coated vitreous silica ampoules (10 mm ID×12 mm OD). The ampoules are evacuated (<10 mtorr) prior to sealing. Pure Li₃BS₃ is obtained via a four-step heating protocol in a Lindberg/Blue furnace: (1) ramp to 500° C. at 5° C. min-1, (2) hold at 500° C. for 12 h, (3) ramp to 800° C. at 5° C. min-¹, and (4) hold at 800° C. for 6 h. The hot melt is then quenched from 800° C. into room temperature water. Recovered ingots are typically covered in a C shell. The C shell is either sanded off or the ingot is ground into smaller pieces and the C is manually removed.

### Example 3: Defect Engineering of Lithium Solid State Electrolyte Material

To test the hypothesis, we use two strategies to engineer vacancies: aliovalent substitution and amorphization via extended ball milling. Aliovalent substitution has been shown to improve conductivity in Li-argyrodites, -sulfides, and -garnets by introducing vacancies^{70,71}. Similarly, amorphization can introduce defects and vacancies that enable Li⁺ hopping^{69,71-73}.

Aliovalent substitution of Li₃BS₃ is achieved by substituting Si for B. The XRD patterns and quantitative Rietveld refinements of Li_{2.975}B_{0.975}Si_{0.025}S₃ and Li_{2.95}B_{0.95}Si_{0.05}S₃ are shown in FIG. 26A. The lattice parameters from the refinements are plotted vs. stoichiometry with the Li₃BS₃ end-member in FIG. 26E. The linear trend shows that the materials obey Vegard's law and confirms that Si incorporates into the lattice as a solid-solution. Substitution to 7.5% Si continues the Vegard trend but unidentified impurities are present. With 5% Si substitution, the ionic conductivity is improved to 1.82(±0.21)·10⁻⁵ S cm⁻¹ and the activation energy is decreased to 333±47 meV (FIG. 26D). All error bars reported for electrochemical measurements represent the standard deviation of three replicate cells. Kimura et al. demonstrated that extended ball milling of Li₃BS₃ causes amorphization and improves ionic conductivity, likely due to introduction of defects^{62,69}. Extended ball milling is attempted on the 5%-substituted Li₃BS₃ to assess whether both defect engineering strategies are compatible. Planetary ball milling of the 5%-substituted Li₃BS₃ for 100 h achieves amorphization (a-Li_{2.95}B_{0.95}Si_{0.05}S₃), as verified by the lack of distinct peaks in the XRD pattern shown in FIG. 26A.

We find that amorphization significantly improves Li-ion conductivity. EIS measurements of a-Li_{2.95}B_{0.95}Si_{0.05}S₃ are shown in FIG. 26E. A high-frequency semicircle is partially resolved which may represent grain boundary or bulk ionic transport. A Warburg tail is evident at lower frequencies, indicating that electronic charge transfer is blocked. Although multiple high-frequency semicircles may exist (see Example 1B: section VII), a conservative estimate of the ionic conductivity is determined by linear fit of the Warburg tail and extrapolation to the x-intercept. The ˜σ_{25° C.} of a-Li_{2.95}B_{0.95}Si_{0.05}S₃ is 1.07(±0.08)·10⁻³ S cm⁻¹ with an activation energy of 345±2 meV (FIG. 26D). The electronic conductivity as measured by DC polarization is less than 4·10⁻¹⁰ S cm⁻¹.

To determine if the local structure in the crystalline material is maintained after amorphization, we turn to ⁷Li and ¹¹B NMR. If the local structure is not altered by amorphization, then it is likely that the ion diffusion pathways are similar. Comparing the ion diffusion pathways is important because the machine learning points to the structure of the crystalline Li₃BS₃ phase. The ⁷Li NMR spectra of Li₃BS₃, Li_{2.95}B_{0.95}Si_{0.05}S₃, and a-Li_{2.95}B_{0.95}Si_{0.05}S₃ are shown in FIG. 26D. All materials show a single resonance at the same chemical shift, suggesting the Li local environment remains unchanged. The resonance width narrows significantly in the amorphous material due to the higher mobility. The ¹¹B NMR measurements are shown in FIG. 26G. The ¹¹B NMR for Li₃BS₃ and Li_{2.95}B_{0.95}Si_{0.05}S₃ show a single, quadrupolar environment that can be assigned to the [BS₃]³⁻ moieties^{69,74}. The signal from the a-Li_{2.95}B_{0.95}Si_{0.05}S₃ shows a similar signal to that of the crystalline phases but the shape changes, similarly to the previous measurement for amorphous Li₃BS₃⁶⁹. Li₃BS₃, Li_{2.95}B_{0.95}Si_{0.05}S₃, and a-Li_{2.95}B_{0.95}Si_{0.05}S₃ all exhibit a major peak at ˜60 ppm and a relatively minor peak ˜0 ppm. The major peak is assigned to trigonal planar [BS₃]³⁻ while the minor peak likely indicates a minor impurity with tetrahedrally coordinated B⁷⁵⁻⁷⁷. The change in shape of the ¹¹B spectrum upon amorphization is likely due an averaging of the quadrupolar couplings due to the fast Li dynamics. Thus, Li₃BS₃ and a-Li_{2.95}B_{0.95}Si_{0.05}S₃ have similar local structures and we can attribute the faster Li dynamics to the introduction of charge-carrying defects.

Although investigation of interfacial stability is beyond the scope of the model, we note that the Si-substituted Li₃BS₃ is a promising candidate for future investigations into interfacial stability. Work by Park et al. demonstrated that the (010) facet for Li₃BS₃ has a conduction band minimum 0.5 eV above the Li/Li⁺ couple⁶⁵. Since decomposition of Li₃BS₃ is likely to be mediated by electron injection from Li, their results suggest that thermodynamic stability can be engineered via orientation. From a kinetic perspective, high-temperature DFT-MD simulations show no mobility for B and S, suggesting large kinetic diffusion barriers⁶³. Since decomposition of Li₃BS₃ would entail the diffusion of these species, the reaction may be sluggish or wholly precluded. Interfacial stability has been previously demonstrated for a glassy electrode in the Li—B—S—Si—O phase space⁷⁸. The result may indicate that stability can be engineered into Si-substituted Li₃BS₃ by partial isovalent substitution of 0 for S. Finally, recently-synthesized Li—B—S—X (X═Cl, Br, I) quaternaries have exhibited promising conductivities⁷⁹. With similar elemental composition, the Si-substituted Li₃BS₃ may be a good candidate for a multi-electrolyte architecture with the halide-containing quaternaries¹³

In addition to our experimental model validation, another of the predicted materials, KLi₆TaO₆, was recently synthesized with aliovalent Sn-substitution by Suzuki et al⁸⁰. With a reported ionic conductivity near 10⁻⁵ S cm⁻¹, KLi₆TaO₆ is better than 70% of the SSEs in the semi-supervised labels. Further improvement may be possible via extended amorphization to introduce structural defects, as is observed for Li₃BS₃.

Substituted Li₃BS₃:

Aliovalent substitution is accomplished by adding elemental Si (Acros, 99+%) into the precursor mixture prior to the 1 h mix. Si-substitution stoichiometry assumed that each Si atom replaces one Li and B: Li₃₋ₓB₁₋ₓSiₓS₃. Aside from the addition of Si, all steps are the same as for the synthesis of Li₃BS₃. Amorphization is accomplished via extended planetary ball milling in Ar of the 5% Si-substituted Li₃BS₃ (Li_{2.95}B_{0.95}Si_{0.05}S₃). Approximately 1 g of Li_{2.95}B_{0.95}Si_{0.05}S₃ is combined in a ZrO₂ ball mill jar with 3 large balls (10 mm diameter), 51 medium balls (5 mm diameter), and 12 g of small balls (3 mm diameter). The powder is ground in a planetary ball mill (MSE PMV1-0.4L), under Ar atmosphere, for 100 h.

Material Characterization:

Li₃BS₃ materials are characterized using powder X-ray diffraction (XRD) and electrochemical impedance spectroscopy (EIS). XRD patterns are attained on a Rigaku Smartlab by scanning from 10° to 70° 2θ at 2 degrees per minute. The Smartlab employs a Cu-Kα source with a 20 kV accelerating voltage. For EIS measurements, 50-100 mg of powder is first hot-pressed (100° C., 5 min) into a ¼″ diameter pellet. The pellet faces are polished using diamond lapping powder (Allied High Tech Products Inc.) in sequentially finer grits: 60, 30, 6, 0.5, and 0.1 micron. Au contacts are sputtered (90 s at 40 mA) onto the polished surfaces using a 108 Auto Sputter Coater (Cressington). Pellets are then assembled into a Swagelok ¼″ cell with stainless steel current collectors. After applying pressure with a hand vise (˜100 MPa), EIS data is collected on a VSP-300 with a Biologic low-current channel. All EIS data is collected to an upper frequency of 3 MHz. The lower frequency is case dependent, with a frequency cutoff selected such that the Warburg polarization feature is visible. ⁷Li and ¹¹B MAS MAS NMR spectra were acquired using a Bruker DSX-500 spectrometer with a 4 mm ZrO₂ rotor. The operating frequencies for ⁷Li and ¹¹B are 190.5 and 160.5 MHz, respectively. The ⁷Li and ¹¹B spectra were referenced to a 1 M LiCl aq. solution and BF₃-OEt₂, respectively. A spinning speed of 12 kHz was used, and the spectra were gathered after applying a single 0.5 μs to 15° pulse for both ⁷Li and ¹¹B.

Further Discussion for Examples 1-3

Identification of functional materials is critical for improving technologies. Here, we show the utility of using semi-supervised learning as a method for guiding next-generation materials discovery in emerging fields. The method's focus on identifying the relationships between descriptors, prior to labeling, enables understanding of compositional spaces where most inputs are unlabeled. We demonstrate how semi-supervised learning can be used to identify descriptors correlated with superionic conductivity in Li SSEs. By analyzing all Li-containing structures from the ICSD and MP database, we identify 212 materials that show promise as SSEs. All 212 structures exhibit a BVSE-predicted Eₐ below 0.6 eV.

The results illustrate why careful screening of descriptors is useful when identifying new materials. While chemical intuition can be useful for descriptor selection, chemical intuition is often biased to favor previously investigated compositional spaces. For material discovery in emerging fields, use of handpicked descriptors may miss complex phenomena that more generally describe the dataset. Descriptor screening reveals which material properties are correlated to a property of interest to help enhance chemical intuition. In the case of Li SSEs, spatial descriptors excel over compositional, bonding, and electronic descriptors: the Smooth Overlap of Atomic Positions (SOAP), modified X-ray diffraction (mXRD), and general density descriptors are within the top four models. For spatial descriptors, simplification of the input structure tends to improve clustering outcomes. Removing the mobile ions from the structure and simplifying the remaining atoms, i.e. the “CAN” simplification, is most effective. Thus, the placement of framework atoms, but not their precise identity, is most correlated with ionic conductivity. Specifying the mobile ion positions hurts the model performance, suggesting a low correlation of mobile ion positions with ionic conductivity.

Predictions from the semi-supervised method are promising starting points for experimental identification of new superionic conductors but defects must be considered. The proposed materials are diverse, with the top thirty including halides, sulfides, tellurides, nitrides, oxides, and oxyhalides (see Example 1B: section IX). As a structure that falls outside of the eight routinely studied SSE classes, we demonstrate experimental characterization of Li₃BS₃ to confirm the utility of the approach. However, pure Li₃BS₃ exhibits poor ionic conductivity. Defects must be introduced into the material to achieve a superionic conductivity above 10⁻³ S cm⁻¹, a value that surpasses most reported SSEs. We note that the defects are introduced while maintaining the local structure of the crystalline material and thus the ionic conduction pathways are likely similar. The need to introduce defects highlights the paramount importance that defects play when measuring real materials. Many of the highest performing SSEs contain charge-carrying defects that are not explicitly encoded in their structure files. It is likely that some of the descriptors indirectly encode information about defects. By using experimental conductivity values as the evaluation metric, we may be prioritizing descriptors that encode information about a structures ability to support charge-carrying defects. Although Li₃BS₃ is a poor conductor, it is clearly able to support charge-carrying defects. The large conductivity difference between pristine Li₃BS₃ and a-Li_{2.95}B_{0.95}Si_{0.05}S₃ highlights the importance of these defects. To improve predictive models and enhance chemical intuition, descriptors that explicitly encode defects are needed.

Now developed, the semi-supervised learning approach can serve as a template for material discovery beyond Li SSEs. The code is thoroughly documented following pythonic coding standards and made freely available on Github. Although the present effort focuses on Li SSEs, the approach is applicable to any material discovery space where labels are sparse. Discovery of new Li cathodes could be accomplished by using Li diffusivity, cathode capacity, and metal redox couple voltages as labels. Discovery of divalent SSEs (e.g. Mg²⁺, Ca²⁺, Zn²⁺) could foreseeably be accomplished in a similar manner. The semi-supervised learning strategy may accelerate identification of fast ionic conductors for ion exchange membranes, solid oxide fuel cells, and various sensor applications.

### Example 4: Optional Aspects with Respect to Substitution for B in Lithium Thioborate

In some aspects, the “first dopant” Q in FX1 (Li_{3-z}[B+Q]₁[S+G]₃) optionally comprises one or more transition metal elements. On the other hand, in some aspects, the “first dopant” Q in FX1 is free of transitional metal elements due to the propensity of transition metal elements to participate in redox reactions occurring in a solid state battery. Selection of the first dopant element (the one or more dopant element corresponding to first dopant Q) is generally dependent on application-specific particular chemistry, redox reactions, voltages, and other conditions.

### Example 5: Particularly Useful Aspects

In an aspect, a particularly useful material disclosed herein has a composition characterized by formula FX15A: Li₃₋ₓB₁₋ₓSiₓS₃ (FX15A); wherein x is greater than 0 and less than or approximately equal to 0.05. For example, in an aspect, a furthermore particularly useful material disclosed herein has a composition characterized by formula FX15B: LiₐB_{b}SiₓS_{c} (FX15B); wherein a is approximately 2.95, b is approximately 0.95, x is approximately 0.05, and c is approximately 3.0. For example, in an aspect, a yet furthermore particularly useful material disclosed herein has a composition characterized by formula FX15C: Li_{2.95}B_{0.95}Si_{0.05}S₃ (FX15C). It is found that the compositions of FX15A, FX15B, and FX15C may correspond to an optimum or near-optimum doped composition of lithium thioborate with respect to ionic conductivity, optionally with respect to other additional features, where the undoped composition and low-doped composition (e.g., x being less than 0.025) have lower ionic conductivity and higher dopant amounts (e.g., x being greater than or equal to 0.075) cause formation of unfavorable impurities and/or other unfavorable features (e.g., too much disruption of crystallographic structure with respect to that of Li₃BS₃). It is found that compositions of FX15A, FX15B, and FX15C have high ionic conductivity and low electronic conductivity, especially if the material is amorphized. For example, as also discussed in Examples 1A-3, whereas a room temperature (e.g., 25° C.) ionic conductivity of undoped Li₃BS₃ without substitution may be approximately 7.2·10⁻⁷ S/cm substitution/doping of the composition thereby making Li_{2.95}B_{0.95}Si_{0.05}S₃ (FX15C) may result in an increase of ionic conductivity (relative to that of the undoped Li₃BS₃) by a factor of approximately 25 such as to an ionic conductivity of approximately 1.82(±0.21)·10⁻⁵ S cm⁻¹ at room temperature (e.g., 25° C.). Amorphization of the composition Li_{2.95}B_{0.95}Si_{0.05}S₃ (FX15C) may further increase the ionic conductivity (relative to that of the undoped Li₃BS₃) by a factor of at least 1375 such as to an ionic conductivity of approximately 1.07(±0.08)·10⁻³ S cm⁻¹ at room temperature (e.g., 25° C.) or even about 3·10⁻³ S cm⁻¹ according to some aspects. In contrast, the electronic conductivity of these doped compositions of FX15A, FX15B, and FX15C have low electronic conductivity, such as, for example, in aspects, less than or equal to about 4·10⁻¹⁰ S/cm as measured by DC polarization at room temperature (e.g., 25° C.).

### REFERENCES CORRESPONDING TO EXAMPLES 1A, 2 AND 3

1. Bachman, J. C. et al. Inorganic Solid-State Electrolytes for Lithium Batteries: Mechanisms and Properties Governing Ion Conduction. Chem. Rev. 116, 140-162 (2016).
2. Kamaya, N. et al. A lithium superionic conductor. Nat. Mater. 10, 682-686 (2011).
3. Adeli, P. et al. Boosting solid-state diffusivity and conductivity in lithium superionic argyrodites by halide substitution. Angew. Chem. 131, 8773-8778 (2019).
4. Seino, Y., Ota, T., Takada, K., Hayashi, A. & Tatsumisago, M. A sulphide lithium super ion conductor is superior to liquid ion conductors for use in rechargeable batteries. Energy Environ. Sci. 7, 627-631 (2014).
5. Zhu, Y., He, X. & Mo, Y. First principles study on electrochemical and chemical stability of solid electrolyte-electrode interfaces in all-solid-state Li-ion batteries. J. Mater. Chem. A 4, 3253-3266 (2016).
6. Richards, W. D., Miara, L. J., Wang, Y., Kim, J. C. & Ceder, G. Interface stability in solid-state batteries. Chem. Mater. 28, 266-273 (2016).
7. Kerman, K., Luntz, A., Viswanathan, V., Chiang, Y.-M. & Chen, Z. Review-practical challenges hindering the development of solid state li ion batteries. J. Electrochem. Soc. 164, Al₇₃₁ (2017).
8. Wenzel, S. et al. Direct observation of the interfacial instability of the fast ionic conductor Li₁₀GeP₂S₁₂ at the lithium metal anode. Chem. Mater. 28, 2400-2407 (2016).
9. Zhu, Y., He, X. & Mo, Y. Origin of outstanding stability in the lithium solid electrolyte materials: insights from thermodynamic analyses based on first-principles calculations. ACS Appl. Mater. Interfaces 7, 23685-23693 (2015).
10. Wenzel, S., Sedlmaier, S. J., Dietrich, C., Zeier, W. G. & Janek, J. Interfacial reactivity and interphase growth of argyrodite solid electrolytes at lithium metal electrodes. Solid State Ion. 318, 102-112 (2018).
11. Ding, Z., Li, J., Li, J. & An, C. Review-interfaces: key issue to be solved for all solid-state lithium battery technologies. J. Electrochem. Soc. 167, 070541 (2020).
12. Wang, S. et al. Interfacial challenges for all-solid-state batteries based on sulfide solid electrolytes. J. Materiomics 7, 209-218 (2021).
13. Sendek, A. D., Cheon, G., Pasta, M. & Reed, E. J. Quantifying the Search for Solid Li-Ion Electrolyte Materials by Anion: A Data-Driven Perspective. J. Phys. Chem. C 124, 8067-8079 (2020).
14. Ren, F. et al. Accelerated discovery of metallic glasses through iteration of machine learning and high-throughput experiments. Sci. Adv. 4, eaaq1566 (2018).
15. Tran, K. & Ulissi, Z. W. Active learning across intermetallics to guide discovery of electrocatalysts for CO₂ reduction and H₂ evolution. Nat. Catal. 1, 696-703 (2018).
16. Lu, S. et al. Accelerated discovery of stable lead-free hybrid organic-inorganic perovskites via machine learning. Nat. Commun. 9, 3405 (2018).
17. Xue, D. et al. Accelerated search for materials with targeted properties by adaptive design. Nat. Commun. 7, 11241 (2016).
18. D. Sendek, A. et al. Holistic computational structure screening of more than 12000 candidates for solid lithium-ion conductor materials. Energy Environ. Sci. 10, 306-320 (2017).
19. Butler, K. T., Davies, D. W., Cartwright, H., Isayev, O. & Walsh, A. Machine learning for molecular and materials science. Nature 559, 547-555 (2018).
20. Liu, Y., Zhao, T., Ju, W. & Shi, S. Materials discovery and design using machine learning. J. Materiomics 3, 159-177 (2017).
21. Ziletti, A., Kumar, D., Scheffler, M. & Ghiringhelli, L. M. Insightful classification of crystal structures using deep learning. Nat. Commun. 9, 2775 (2018).
22. Isayev, O. et al. Universal fragment descriptors for predicting properties of inorganic crystals. Nat. Commun. 8, 15679 (2017).
23. Schuitt, K. T., Arbabzadah, F., Chmiela, S., Müller, K. R. & Tkatchenko, A. Quantum-chemical insights from deep tensor neural networks. Nat. Commun. 8, 13890 (2017).
24. Ward, L. et al. Matminer: An open source toolkit for materials data mining. Comput. Mater. Sci. 152, 60-69 (2018).
25. Himanen, L. et al. DScribe: Library of descriptors for machine learning in materials science. Comput. Phys. Commun. 247, 106949 (2020).
26. Juan, Y., Dai, Y., Yang, Y. & Zhang, J. Accelerating materials discovery using machine learning. J. Mater. Sci. Technol. 79, 178-190 (2021).
27. Suzuki, K. et al. Fast material search of lithium ion conducting oxides using a recommender system. J. Mater. Chem. A 8, 11582-11588 (2020).
28. Wang, Z. et al. Harnessing artificial intelligence to holistic design and identification for solid electrolytes. Nano Energy 89, 106337 (2021).
29. Zhong, M. et al. Accelerated discovery of CO₂ electrocatalysts using active machine learning. Nature 581, 178-183 (2020).
30. Wang, Z., Zhang, H. & Li, J. Accelerated discovery of stable spinels in energy systems via machine learning. Nano Energy 81, 105665 (2021).
31. Yuan, R. et al. Accelerated discovery of large electrostrains in BaTiO₃-based piezoelectrics using active learning. Adv. Mater. 30, 1702884 (2018).
32. Li, J. et al. Accelerated discovery of high-strength aluminum alloys by machine learning. Commun. Mater. 1, 1-10 (2020).
33. Butler, K. T., Oviedo, F. & Canepa, P. Machine Learning in Materials Science. vol. 29 (American Chemical Society, 2022).
34. Zhang, Y. et al. Unsupervised discovery of solid-state lithium ion conductors. Nat. Commun. 10, 1-7 (2019).
35. Liu, Y., Zhou, Q. & Cui, G. Machine learning boosting the development of advanced lithium batteries. Small Methods 5, 2100442 (2021).
36. Forestier, G. & Wemmert, C. Semi-supervised learning using multiple clusterings with limited labeled data. Inf. Sci. 361-362, 48-65 (2016).
37. Thangadurai, V., Narayanan, S. & Pinzaru, D. Garnet-type solid-state fast Li ion conductors for Li batteries: critical review. Chem. Soc. Rev. 43, 4714-4727 (2014).
38. Gorai, P., Famprikis, T., Singh, B., Stevanović, V. & Canepa, P. Devil is in the defects: electronic conductivity in solid electrolytes. Chem. Mater. 33, 7484-7498 (2021).
39. van Engelen, J. E. & Hoos, H. H. A survey on semi-supervised learning. Mach. Learn. 109, 373-440 (2020).
40. Schuitt, K. T. et al. SchNet: A continuous-filter convolutional neural network for modeling quantum interactions. ArXiv170608566 Phys. Stat (2017).
41. Artrith, N. & Urban, A. An implementation of artificial neural-network potentials for atomistic materials simulations: Performance for TiO₂. Comput. Mater. Sci. 114, 135-150 (2016).
42. Adams, S. & Rao, R. P. In structure and bonding, Vol. 158, Bond Valences, edited by ID Brown and KR Poeppelmeier. (Berlin, Heidelberg: Springer, 2014).
43. Hansen, K. et al. Machine learning predictions of molecular properties: accurate many-body potentials and nonlocality in chemical space. J. Phys. Chem. Lett. 6, 2326-2331 (2015).
44. Butler, M. A. & Ginley, D. S. Prediction of flatband potentials at semiconductor-electrolyte interfaces from atomic electronegativities. J. Electrochem. Soc. 125, 228 (1978).
45. He, B. et al. CAVD, towards better characterization of void space for ionic transport analysis. Sci. Data 7, 153 (2020).
46. Ward, L. et al. Including crystal structure attributes in machine learning models of formation energies via Voronoi tessellations. Phys. Rev. B 96, 024104 (2017).
47. Ong, S. P. et al. Python Materials Genomics (pymatgen): A robust, open-source python library for materials analysis. Comput. Mater. Sci. 68, 314-319 (2013).
48. DemI, A. M., O'Hayre, R., Wolverton, C. & Stevanović, V. Predicting density functional theory total energies and enthalpies of formation of metal-nonmetal compounds by linear regression. Phys. Rev. B 93, 085142 (2016).
49. Ewald, P. P. Die Berechnung optischer und elektrostatischer Gitterpotentiale. Ann. Phys. 369, 253-287 (1921).
50. Choudhary, K. et al. The joint automated repository for various integrated simulations (JARVIS) for data-driven materials design. Npj Comput. Mater. 6, 1-13 (2020).
51. Meredig, B. et al. Combinatorial screening for new materials in unconstrained composition space with machine learning. Phys. Rev. B 89, 094104 (2014).
52. Pham, T. L. et al. Machine learning reveals orbital interaction in materials. Sci. Technol. Adv. Mater. 18, 756-765 (2017).
53. Rupp, M., Tkatchenko, A., Müller, K.-R. & von Lilienfeld, O. A. Fast and accurate modeling of molecular atomization energies with machine learning. Phys. Rev. Lett. 108, 058301 (2012).
54. Faber, F., Lindmaa, A., Lilienfeld, O. A. von & Armiento, R. Crystal structure representations for machine learning models of formation energies. Int. J. Quantum Chem. 115, 1094-1101 (2015).
55. Krivovichev, S. V. Structural complexity of minerals: information storage and processing in the mineral world. Mineral. Mag. 77, 275-326 (2013).
56. Ward, L., Agrawal, A., Choudhary, A. & Wolverton, C. A general-purpose machine learning framework for predicting properties of inorganic materials. Npj Comput. Mater. 2, 1-7 (2016).
57. Ward, J. H. Hierarchical grouping to optimize an objective function. J. Am. Stat. Assoc. 58, 236-244 (1963).
58. Fung, V., Zhang, J., Juarez, E. & Sumpter, B. G. Benchmarking graph neural networks for materials chemistry. Npj Comput. Mater. 7, 1-8 (2021).
59. He, X., Zhu, Y. & Mo, Y. Origin of fast ion diffusion in super-ionic conductors. Nat. Commun. 8,15893 (2017).
60. Sun, W. et al. The thermodynamic scale of inorganic crystalline metastability. Sci. Adv. 2, e1600225 (2016).
61. Electronic Structure. https://docs.materialsproject.org/methodology/materials-methodology/electronic-structure.
62. Vinatier, P., Ménétrier, M. & Levasseur, A. Structure and ionic conduction in lithium thioborate glasses and crystals. Phys. Chem. Glas. 44, 135-142 (2003).
63. Sendek, A. D. et al. Combining superionic conduction and favorable decomposition products in the crystalline lithium-boron-sulfur system: a new mechanism for stabilizing solid li-ion electrolytes. ACS Appl. Mater. Interfaces 12, 37957-37966 (2020).
64. Bianchini, F., Fjellvåg, H. & Vajeeston, P. A first-principle investigation of the Li diffusion mechanism in the super-ionic conductor lithium orthothioborate Li₃BS₃ structure. Mater. Lett. 219, 186-189 (2018).
65. Park, H., Yu, S. & Siegel, D. J. Predicting charge transfer stability between sulfide solid electrolytes and Li metal anodes. ACS Energy Lett. 6, 150-157 (2021).
66. Vinatier, P., Gravereau, P., Ménétrier, M., Trut, L. & Levasseur, A. Li₃BS₃. Acta Crystallogr. C 50, 1180-1183 (1994).
67. Zhang, L. et al. Lithium lanthanum titanate perovskite as an anode for lithium ion batteries. Nat. Commun. 11, 3490 (2020).
68. Belous, A. G., Novitskaya, G. N., Polyanetskaya, S. V. & Gornikov, Y. I. Investigation into complex oxides of La_{2/3-x}Li₃ₓTiO₃ composition. Izv Akad Nauk SSSR Neorg Mater 23, 470-472 (1987).
69. Kimura, T. et al. Characteristics of a Li₃BS₃ thioborate glass electrolyte obtained via a mechanochemical process. ACS Appl. Energy Mater. 5, 1421-1426 (2022).
70. Zhou, L., Minafra, N., Zeier, W. G. & Nazar, L. F. Innovative approaches to Li-argyrodite solid electrolytes for all-solid-state lithium batteries. Acc. Chem. Res. 54, 2717-2728 (2021).
71. Zhao, W., Yi, J., He, P. & Zhou, H. Solid-state electrolytes for lithium-ion batteries: fundamentals, challenges and perspectives. Electrochem. Energy Rev. 2, 574-605 (2019).
72. Lacivita, V., Artrith, N. & Ceder, G. Structural and compositional factors that control the Li-ion conductivity in LIPON electrolytes. Chem. Mater. 30, 7077-7090 (2018).
73. Knauth, P. Inorganic solid Li ion conductors: An overview. Solid State Ion. 180, 911-916 (2009).
74. Larink, D., Eckert, H. & Martin, S. W. Structure and ionic conductivity in the mixed-network former chalcogenide glass system [Na₂S]_{2/3}[(B₂S₃)ₓ(P₂S₅)₁₋ₓ]_{1/3}. J. Phys. Chem. C 116, 22698-22710 (2012).
75. Hwang, S.-J. et al. Structural study of xNa₂S+(1−x)B₂S₃ glasses and polycrystals by multiple-quantum MAS NMR of ¹¹B and ²³Na. J. Am. Chem. Soc. 120, 7337-7346 (1998).
76. Kaup, K. et al. A lithium oxythioborosilicate solid electrolyte glass with superionic conductivity. Adv. Energy Mater. 10, 1902783 (2020).
77. Curtis, B., Francis, C., Kmiec, S. & Martin, S. W. Investigation of the short range order structures in sodium thioborosilicate mixed glass former glasses. J. Non-Cryst. Solids 521, 119456 (2019).
78. Seino, Y. et al. Synthesis and electrochemical properties of Li₂S—B₂S₃—Li₄SiO₄. Solid State Ion. 177, 2601-2603 (2006).
79. Kaup, K., Assoud, A., Liu, J. & Nazar, L. F. Fast Li-Ion Conductivity in Superadamantanoid Lithium Thioborate Halides. Angew. Chem. Int. Ed. 60, 6975-6980 (2021).
80. Suzuki, N. et al. Theoretical and experimental studies of KLi₆TaO₆ as a Li-ion solid electrolyte. Inorg. Chem. 60, 10371-10379 (2021).
81. Henkelman, G., Uberuaga, B. P. & Jonsson, H. A climbing image nudged elastic band method for finding saddle points and minimum energy paths. J. Chem. Phys. 113, 9901-9904 (2000).
82. Henkelman, G. & Jonsson, H. Improved tangent estimate in the nudged elastic band method for finding minimum energy paths and saddle points. J. Chem. Phys. 113, 9978-9985 (2000).
83. Giannozzi, P. et al. QUANTUM ESPRESSO: a modular and open-source software project for quantum simulations of materials. J. Phys. Condens. Matter 21, 395502 (2009).
84. Giannozzi, P. et al. Advanced capabilities for materials modelling with Quantum ESPRESSO. J. Phys. Condens. Matter 29, 465901 (2017).
85. Perdew, J. P., Burke, K. & Ernzerhof, M. Generalized gradient approximation made simple. Phys. Rev. Lett. 77, 3865-3868 (1996).
86. Dal Corso, A. Pseudopotentials periodic table: From H to Pu. Comput. Mater. Sci. 95, 337-350 (2014).

### CITATIONS ASSOCIATED WITH EXAMPLE 1B

1. Ross, S., Welsch, A.-M. & Behrens, H. Lithium conductivity in glasses of the Li₂O—Al₂O₃—SiO₂ system. Phys. Chem. Chem. Phys. 17, 465-474 (2015).
2. Aono, H., Sugimoto, E., Sadaoka, Y., Imanaka, N. & Adachi, G. The electrical properties of ceramic electrolytes for LiMₓTi₂₋ₓ(PO₄)_{3+y}Li₂O, M=Ge, Sn, Hf, and Zr systems. J. Electrochem. Soc. 140, 1827 (1993).
3. Muhle, C., Dinnebier, R. E., van Willen, L., Schwering, G. & Jansen, M. New insights into the structural and dynamical features of lithium hexaoxometalates Li₇MO₆ (M=Nb, Ta, Sb, Bi). Inorg. Chem. 43, 874-881 (2004).
4. Mizuno, F., Hayashi, A., Tadanaga, K. & Tatsumisago, M. New, highly ion-conductive crystals precipitated from Li₂S—P₂S₅ glasses. Adv. Mater. 17, 918-921 (2005).
5. Yamane, H. et al. Crystal structure of a superionic conductor, Li₇P₃S₁₁. Solid State Ion. 178, 1163-1167 (2007).
6. Xiao, P. F., Lai, M. O. & Lu, L. Transport and electrochemical properties of high potential tavorite LiVPO₄F. Solid State Ion. 242, 10-19 (2013).
7. Hasegawa, T. & Yamane, H. Synthesis and crystal structure analysis of Li₂NaBP₂O₈ and LiNa₂B₅P₂O₁₄. J. Solid State Chem. 225, 65-71 (2015).
8. Voronin, V. I., Sherstobitova, E. A., Blatov, V. A. & Shekhtman, G. Sh. Lithium-cation conductivity and crystal structure of lithium diphosphate. J. Solid State Chem. 211, 170-175 (2014).
9. Salanne, M., Marrocchelli, D. & Watson, G. W. Cooperative mechanism for the diffusion of Li⁺ ions in LiMgSO₄F. J. Phys. Chem. C 116, 18618-18625 (2012).
10. Strauss, F. et al. Impact of structural polymorphism on ionic conductivity in lithium copper pyroborate Li₆CuB₄O₁₀. Inorg. Chem. 57, 11646-11654 (2018).
11. Losilla, E. R., Aranda, M. A. G., Martinez-Lara, M. & Bruque, S. Reversible triclinic-rhombohedral phase transition in LiHf₂(PO₄)₃: crystal structures from neutron powder diffraction. Chem. Mater. 9, 1678-1685 (1997).
12. Busche, M. R. et al. In situ monitoring of fast li-ion conductor Li₇P₃S₁₁ crystallization inside a hot-press setup. Chem. Mater. 28, 6152-6165 (2016).
13. Ohtsuka, H. & Yamaji, A. Preparation and electrical conductivity of LISICON thin films. Solid State Ion. 8, 43-48 (1983).
14. Kanno, R. & Murayama, M. Lithium ionic conductor thio-LISICON: The Li₂S—GeS₂—P₂S₅ system. J. Electrochem. Soc. 148, A742 (2001).
15. Ahn, B. T. & Huggins, R. A. Synthesis and lithium conductivities of Li₂SiS₃ and Li₄SiS₄. Mater. Res. Bull. 24, 889-897 (1989).
16. Deng, Y. et al. Structural and mechanistic insights into fast lithium-ion conduction in Li₄SiO₄—Li₃PO₄ solid electrolytes. J. Am. Chem. Soc. 137, 9136-9145 (2015).
17. Khorassani, A. & West, A. R. Li⁺ ion conductivity in the system Li₄SiO_{4□}Li₃VO₄. J. Solid State Chem. 53, 369-375 (1984).
18. Murayama, M. et al. Synthesis of new lithium ionic conductor thio-lisicon—lithium silicon sulfides system. J. Solid State Chem. 168, 140-148 (2002).
19. Adachi, G., Imanaka, N. & Aono, H. Fast Li⁺ conducting ceramic electrolytes. Adv. Mater. 8, 127-135 (1996).
20. Li, X. et al. Water-mediated synthesis of a superionic halide solid electrolyte. Angew. Chem. Int. Ed. 58, 16427-16432 (2019).
21. Dietrich, C. et al. Synthesis, structural characterization, and lithium ion conductivity of the lithium thiophosphate Li₂P₂S₆. Inorg. Chem. 56, 6681-6687 (2017).
22. Holzmann, T. et al. Li_{0.6}[Li_{0.2}Sn_{0.8}S₂]—a layered lithium superionic conductor. Energy Environ. Sci. 9, 2578-2585 (2016).
23. Dolbecq, A. et al. Synthesis, X-ray and neutron diffraction characterization, and ionic conduction properties of a new oxothiomolybdate Li₃[Mo₈S₈O₈(OH)₈{HWO₅(H₂O)}]·18H₂O. Chem.—Eur. J. 8, 349-356 (2002).
24. Huber, S. & Pfitzner, A. Li₁₇Sb₁₃S₂₈: A new lithium ion conductor and addition to the phase diagram Li₂S-Sb₂S₃. Chem Eur J 21, 13683-13688 (2015).
25. Tomita, Y., Ohki, H., Yamada, K. & Okuda, T. Ionic conductivity and structure of halocomplex salts of group 13 elements. Solid State Ion. 136-137, 351-355 (2000).
26. Asano, T. et al. Solid halide electrolytes with high lithium-ion conductivity for application in 4 v class bulk-type all-solid-state batteries. Adv. Mater. 30, 1803075 (2018).
27. Holzmann, T. et al. Li_{0.6}[Li_{0.2}Sn_{0.8}S₂]—a layered lithium superionic conductor. Energy Environ. Sci. 9, 2578-2585 (2016).
28. Hockicko, P., Kudelcik, J., Munoz, F. & Munoz-Senovilla, L. Structural and electrical properties of LiPO₃ glasses. Adv. Electr. Electron. Eng. 13, 198-205-205 (2015).
29. Rao, S. R., Lingam, C. B., Rajesh, D., Vijayalakshmi, R. P. & Sunandana, C. S. Structural, conductivity and dielectric properties of Li₂SO₄. Eur. Phys. J. Appl. Phys. 66, 30906 (2014).
30. Subban, C. V. et al. Search for Li-electrochemical activity and Li-ion conductivity among lithium bismuth oxides. Solid State Ion. 283, 68-74 (2015).
31. Burmakin, E. I., Shehtman, G. S. & Alikin, V. N. Ionic conductivity of Li₆Ge₂O₇ and its solid solutions. Materials Science Forum vol. 76 107-110/MSF.76-107 (1991).
32. Weppner, W. & Huggins, R. A. Ionic conductivity of solid and liquid LiAlCl₄. J. Electrochem. Soc. 124, 35 (1977).
33. Hellstrom, E. E. & Van Gool, W. Li ion conduction in Li₂ZrO₃, Li₄ZrO₄, and LiScO₂. Solid State Ion. 2, 59-64 (1981).
34. Heitjans, P., Tobschall, E. & Wilkening, M. Ion transport and diffusion in nanocrystalline and glassy ceramics. Eur. Phys. J. Spec. Top. 161, 97-108 (2008).
35. Chinnam, P. R., Clymer, R. N., Jalil, A. A., Wunder, S. L. & Zdilla, M. J. Bulk-phase ion conduction in cocrystalline LiCl·N,N-dimethylformamide: a new paradigm for solid electrolytes based upon the pearson hard-soft acid-base concept. Chem. Mater. 27, 5479-5482 (2015).
36. Iqbal, M. et al. Lithium ion conduction in doped LaLiO₂ system. Solid State Ion. 285, 33-37 (2016).
37. Yin, S.-C., Strobel, P. S., Grondey, H. & Nazar, L. F. Li_{2.5}V₂(PO₄)₃: A room-temperature analogue to the fast-ion conducting high-temperature γ-phase of Li₃V₂(PO₄)₃. Chem. Mater. 16, 1456-1465 (2004).
38. Saha, S. et al. Polymorphism in Li₄Zn(PO₄)₂ and stabilization of its structural disorder to improve ionic conductivity. Chem. Mater. 30, 1379-1390 (2018).
39. de Laune, B. P., Bayliss, R. D. & Greaves, C. LiSbO₂: synthesis, structure, stability, and lithium-ion conductivity. Inorg. Chem. 50, 7880-7885 (2011).
40. Kim, S.-C., Kwak, H.-J., Yoo, C.-Y., Yun, H. & Kim, S.-J. Synthesis, crystal structure, and ionic conductivity of a new layered metal phosphate, Li₂Sr₂Al(PO₄)₃. J. Solid State Chem. 243, 12-17 (2016).
41. Pantyukhina, M. I., Shchelkanova, M. S., Stepanov, A. P. & Buzlukov, A. L. Investigation of ion transport in Li₈ZrO₆ and Li₆Zr₂O₇ solid electrolytes. Bull. Russ. Acad. Sci. Phys., 653-655 (2010).
42. Miyazaki, R. & Maekawa, H. Li⁺-ion conduction of Li₃AlF₆ mechanically milled with LiCl. ECS Electrochem. Lett. 1, A87 (2012).
43. Brant, J. A. et al. Fast lithium ion conduction in Li₂SnS₃: synthesis, physicochemical characterization, and electronic structure. Chem. Mater. 27, 189-196 (2015).
44. Kim, J., Kim, J., Avdeev, M., Yun, H. & Kim, S.-J. LiTa₂PO₈: a fast lithium-ion conductor with new framework structure. J. Mater. Chem. A 6, 22478-22482 (2018).
45. Krichen, M., Megdiche, M., Guidara, K. & Gargouri, M. AC conductivity and mechanism of conduction study of lithium barium pyrophosphate Li₂BaP₂O₇ using impedance spectroscopy. Ionics 21, 935-948 (2015).
46. Huang, F. Q., Yao, J., Liu, Z., Yang, J. & Ibers, J. A. Synthesis, structure, and ionic conductivity of Na₅Li₃Ti₂S₈. J. Solid State Chem. 181, 837-841 (2008).
47. Ettis, H., Naili, H. & Mhiri, T. The crystal structure, thermal behaviour and ionic conductivity of a novel lithium gadolinium polyphosphate LiGd(PO₃)₄. J. Solid State Chem. 179, 3107-3113 (2006).
48. Muller, Ch., Valmalette, J.-C., Soubeyroux, J.-L., Bouree, F. & Gavarri, J.-R. Structural disorder and ionic conductivity in LiVO₃: a neutron powder diffraction study from 340 to 890 k. J. Solid State Chem. 156, 379-389 (2001).
49. Kanno, R. et al. Synthesis, structure, ionic conductivity, and phase transformation of new double chloride spinel, Li₂CrCl₄. J. Solid State Chem. 75, 41-51 (1988).
50. Schlem, R. et al. Lattice dynamical approach for finding the lithium superionic conductor Li₃ErI₆. ACS Appl. Energy Mater. 3, 3684-3691 (2020).
51. Kimura, T. et al. Preparation and characterization of lithium ion conductive Li₃SbS₄ glass and glass-ceramic electrolytes. Solid State Ion. 333, 45-49 (2019).
52. Liu, Z. et al. Anomalous high ionic conductivity of nanoporous β-Li₃PS₄. J. Am. Chem. Soc. 135, 975-978 (2013).
53. Almond, D. P., Hunter, C. C. & West, A. R. The extraction of ionic conductivities and hopping rates from a.c. conductivity data. J. Mater. Sci. 19, 3236-3248 (1984).
54. Cakmak, G., Nuss, J. & Jansen, M. LiB₆O₉F, the first lithium fluorooxoborate—crystal structure and ionic conductivity. Z. Für Anorg. Allg. Chem. 635, 631-636 (2009).
55. Olivier-Fourcade, J., Maurin, M. & Philippot, E. Modification de la nature de la conductivite electrique par creation de sites vacants dans les phases a caractere semi-conducteur du systeme Li₂SSb₂S₃. Solid State Ion. 9-10, 135-137 (1983).
56. Yamane, H., Kikkawa, S. & Koizumi, M. Preparation of lithium silicon nitrides and their lithium ion conductivity. Solid State Ion. 25, 183-191 (1987).
57. Senevirathne, K., Day, C. S., Gross, M. D., Lachgar, A. & Holzwarth, N. A. W. A new crystalline LiPON electrolyte: Synthesis, properties, and electronic structure. Solid State Ion. 233, 95-101 (2013).
58. Seo, I. & Kim, Y. Synthesis and characterization of lithium germanogallium sulfide, Li₂GeGa₂S₆. Solid State Ion. 261, 106-110 (2014).
59. Ibarra, J. et al. Influence of composition on the structure and conductivity of the fast ionic conductors La_{2/3-x}Li₃ₓTiO₃ (0.03≤x≤0.167). Solid State Ion. 134, 219-228 (2000).
60. Belous, A. G., Gavrilenko, O. N., V'yunov, O. I., Kobilyanskaya, S. D. & Trachevskii, V. V. Effect of isovalent substitution on the structure and ionic conductivity of Li_{0.5-y}Na_{y}La_{0.5}Nb₂O₆. Inorg. Mater. 47, 308-312 (2011).
61. Bohnke, O. et al. Lithium ion conductivity in new perovskite oxides [Ag_{y}Li_{1-y}]₃ₓLa_{2/3-x}TiO₃ (x=0.09 and 0≤y≤1). Chem. Mater. 13, 1593-1599 (2001).
62. Itoh, M., Inaguma, Y., Jung, W.-H., Chen, L. & Nakamura, T. High lithium ion conductivity in the perovskite-type compounds LnI₂LiI₂TiO₃(Ln=La,Pr,Nd,Sm). Solid State Ion. 70-71, 203-207 (1994).
63. Geng, H., Lan, J., Mei, A., Lin, Y. & Nan, C. W. Effect of sintering temperature on microstructure and transport properties of Li₃ₓLa_{2/3-x}TiO₃ with different lithium contents. Electrochimica Acta 56, 3406-3414 (2011).
64. Raistrick, I. D., Ho, C. & Huggins, R. A. Lithium ion conduction in Li₅A10₄, Li₅GaO₄ and Li₆ZnO₄. Mater. Res. Bull. 11, 953-957 (1976).
65. Saskia Lupart, Gregori, G., Maier, J. & Schnick, W. Li₁₄Ln₅[Si₁₁N₁₉O₅]O₂F₂ with Ln=Ce, Nd-representatives of a family of potential lithium ion conductors. J. Am. Chem. Soc. 134, 10132-10137 (2012).
66. Narimatsu, E., Yamamoto, Y., Takeda, T., Nishimura, T. & Hirosaki, N. High lithium conductivity in Li₁₋₂ₓCaₓSi₂N₃. J. Mater. Res. 26, 1133-1142 (2011).
67. Dissanayake, M. a. K. L. & West, A. R. Structure and conductivity of an Li₄SiO₄—Li₂SO₄ solid solution phase. J. Mater. Chem. 1, 1023-1025 (1991).
68. Ivanov-Shitz, A. K., Kireev, V. V., Mel'nikov, 0. K. & Demianets, L. N. Growth and ionic conductivity of γ-Li₃PO₄. Crystallogr. Rep. 46, 864-867 (2001).
69. Kaup, K. et al. Correlation of structure and fast ion conductivity in the solid solution series Li₁₊₂ₓZn₁₋ₓPS₄. Chem. Mater. 30, 592-596 (2018).
70. Wang, B., Chakoumakos, B. C., Sales, B. C., Kwak, B. S. & Bates, J. B. Synthesis, crystal structure, and ionic conductivity of a polycrystalline lithium phosphorus oxynitride with the γ-Li₃PO₄ structure. J. Solid State Chem. 115, 313-323 (1995).
71. Kanno, R., Hata, T., Kawamoto, Y. & Irie, M. Synthesis of a new lithium ionic conductor, thio-LISICON-lithium germanium sulfide system. Solid State Ion. 130, 97-104 (2000).
72. Abrahams, I., Bruce, P. G., West, A. R. & David, W. I. F. Structure determination of LISICON solid solutions by powder neutron diffraction. J. Solid State Chem. 75, 390-396 (1988).
73. Burmakin, E. I., Voronin, V. I. & Shekhtman, G. Sh. Crystalline structure and electroconductivity of solid electrolytes Li_{3.75}Ge_{0.75}V_{0.25}O₄ and Li_{3.70}Ge_{0.85}W_{0.15}O₄. Russ. J. Electrochem. 39, 1124-1129 (2003).
74. Pham, Q. N., Crosnier-Lopez, M.-P., Le Berre, F., Fauth, F. & Fourquet, J.-L. Crystal structure of new Li⁺ ion conducting perovskites: Li₂ₓCa_{0.5-x}TaO₃ and Li_{0.2}[Ca_{1-y}Sr_{y}]_{0.4}TaO₃. Solid State Sci. 6, 923-929 (2004).
75. Sebastian, L., Piffard, Y., K. Shukla, A., Taulelle, F. & Gopalakrishnan, J. Synthesis, structure and lithium-ion conductivity of Li₂₋₂ₓMg₂₊ₓ(MoO₄)₃ and Li₃M(MoO₄)₃ (M III=Cr, Fe). J. Mater. Chem. 13, 1797-1802 (2003).
76. Kaib, T. et al. Lithium chalcogenidotetrelates: LiChT—synthesis and characterization of new Li⁺ ion conducting Li/Sn/Se compounds. Chem. Mater. 25, 2961-2969 (2013).
77. Roedern, E. et al. Solid state synthesis, structural characterization and ionic conductivity of bimetallic alkali-metal yttrium borohydrides M_{Y}(BH₄)₄ (M=Li and Na). J. Mater. Chem. A 4, 8793-8802 (2016).
78. Barpanda, P. et al. LiZnSO₄F made in an ionic liquid: a ceramic electrolyte composite for solid-state lithium batteries. Angew. Chem. Int. Ed. 50, 2526-2531 (2011).
79. Murayama, M., Sonoyama, N., Yamada, A. & Kanno, R. Material design of new lithium ionic conductor, thio-LISICON, in the Li₂S—P₂S₅ system. Solid State Ion. 170, 173-180 (2004).
80. Kaib, T. et al. New lithium chalcogenidotetrelates, LiChT: synthesis and characterization of the Li⁺-conducting tetralithium ortho-sulfidostannate Li₄SnS₄. Chem. Mater. 24, 2211-2219 (2012).
81. Maekawa, H., Iwatani, T., Shen, H., Yamamura, T. & Kawamura, J. Enhanced lithium ion conduction and the size effect on interfacial phase in Li₂ZnI₄-mesoporous alumina composite electrolyte. Solid State Ion. 178, 1637-1641 (2008).
82. Morales, M. & West, A. R. Phase diagram, crystal chemistry and lithium ion conductivity in the perovskite-type system Pr_{0.5+x}Li_{0.5-3x}TiO₃. Solid State Ion. 91, 33-43 (1996).
83. Park, K.-H. et al. High-voltage superionic halide solid electrolytes for all-solid-state Li-ion batteries. ACS Energy Lett. 5, 533-539 (2020).
84. Kuwano, J. & West, A. R. New Li⁺ ion conductors in the system, Li₄GeO₄-Li₃VO₄. Mater. Res. Bull. 15, 1661-1667 (1980).
85. Sahu, G. et al. Air-stable, high-conduction solid electrolytes of arsenic-substituted Li₄SnS₄. Energy Environ. Sci. 7, 1053-1058 (2014).
86. Inaguma, Y. et al. Effect of substitution and pressure on lithium ion conductivity in perovskites Ln₁₂Li₁₂TiO₃ (Ln=La, Pr, Nd AND Sm). J. Phys. Chem. Solids 58, 843-852 (1997).
87. Hodge, I. M., Ingram, M. D. & West, A. R. Ionic conductivity of Li₄SiO₄, Li₄GeO₄, and their solid solutions. J. Am. Ceram. Soc. 59, 360-366 (1976).
88. Schwering, G., Hönnerscheid, A., van Wüllen, L. & Jansen, M. High lithium ionic conductivity in the lithium halide hydrates Li₃₋ₙ(OHₙ)Cl (0.83≤n≤2) and Li₃₋ₙ(OHₙ)Br (1≤n≤2) at ambient temperatures. ChemPhysChem 4, 343-348 (2003).
89. Kanno, R. et al. Ionic conductivity and phase transition of the bromide spinels, Li₂₋₂ₓM₁₊ₓBr₄ (M=Mg, Mn). J. Electrochem. Soc. 133, 1052 (1986).
90. Kwon, W. J. et al. Enhanced Li⁺ conduction in perovskite Li₃ₓLa_{2/3-x□1/3-2x}TiO₃ solid-electrolytes via microstructural engineering. J. Mater. Chem. A 5, 6257-6262 (2017).
91. Saha, D., Madras, G., Bhattacharyya, A. J. & Guru Row, T. N. Synthesis, structure and ionic conductivity in scheelite type Li_{0.5}Ce_{0.5-x}LnₓMoO₄ (x=0 and 0.25, Ln=Pr, Sm). J. Chem. Sci. 123, 5-13 (2011).
92. González, C., López, M. L., Gaitán, M., Veiga, M. L. & Pico, C. Relationship between crystal structure and electric properties for lithium-containing spinels. Mater. Res. Bull. 29, 903-910 (1994).
93. Yamane, H., Kikkawa, S. & Koizumi, M. High- and low-temperature phases of lithium boron nitride, Li₃BN₂: Preparation, phase relation, crystal structure, and ionic conductivity. J. Solid State Chem. 71, 1-11 (1987).
94. Kim, C.-S., Hwang, Y.-H., Kim, H. K. & Kim, J. N. Ionic conductivity of crystalline and glassy Li₂B₄O₇. Phys. Chem. Glas. 44, 166-169 (2003).
95. Schnick, W. & Luecke, J. Lithium ion conductivity of LiPN₂ and Li₇PN₄. Solid State Ion. 38, 271-273 (1990).
96. Inaguma, Y. et al. High ionic conductivity in lithium lanthanum titanate. Solid State Commun. 86, 689-693 (1993).
97. Harada, Y., Ishigaki, T., Kawai, H. & Kuwano, J. Lithium ion conductivity of polycrystalline perovskite La_{0.67-x}Li₃ₓTiO₃ with ordered and disordered arrangements of the A-site ions. Solid State Ion. 108, 407-413 (1998).
98. Zhang, H., Liu, X., Qi, Y. & Liu, V. On the La_{2/3-x}Li₃ₓTiO₃/Al₂O₃ composite solid-electrolyte for Li-ion conduction. J. Alloys Compd. 577, 57-63 (2013).
99. Thangadurai, V. et al. X-ray powder diffraction study of LiLnTiO₄ (Ln=La, Nd): a lithium-ion conductor. Materials Science Forum vols 321-324 965-970/MSF.321-324.965 (2000).
100. Katsumata, T., Takahata, M., Mochizuki, N. & Inaguma, Y. The relationship between Li ion conductivity and crystal structure for ordered perovskite compounds, (La_{2/3-1/3p}Liₚ)(Mg_{1/2}W_{1/2})O₃ (p=0.05, 0.11 and 0.14). Solid State Ion. 171, 191-198 (2004).
101. Sedlmaier, S. J. et al. Li₄PS₄₁: A Li⁺ superionic conductor synthesized by a solvent-based soft chemistry approach. Chem. Mater. 29, 1830-1835 (2017).
102. Kato, Y. et al. High-power all-solid-state batteries using sulfide superionic conductors. Nat. Energy 1, 1-7 (2016).
103. Takada, K. et al. Lithium ion conductive oxysulfide, Li₃PO₄—Li₃PS₄. Solid State Ion. 176, 2355-2359 (2005).
104. Kwon, O. et al. Synthesis, structure, and conduction mechanism of the lithium superionic conductor Li_{10+δ}Ge_{1+δ}P_{2-δ}S₁₂. J. Mater. Chem. A 3, 438-446 (2015).
105. Hori, S. et al. Synthesis, structure, and ionic conductivity of solid solution, Li_{10+δ}M_{1.6}P₂-6S₁₂ (M=Si, Sn). Faraday Discuss. 176, 83-94 (2015).
106. Whiteley, J. M., Woo, J. H., Hu, E., Nam, K.-W. & Lee, S.-H. Empowering the lithium metal battery through a silicon-based superionic conductor. J. Electrochem. Soc. 161, A1812 (2014).
107. Bron, P. et al. Li₁₀SnP₂S₁₂: an affordable lithium superionic conductor. J. Am. Chem. Soc. 135, 15694-15697 (2013).
108. Krauskopf, T., Culver, S. P. & Zeier, W. G. Bottleneck of diffusion and inductive effects in Li₁₀Ge₁₋ₓSnₓP₂S₁₂. Chem. Mater. 30, 1791-1798 (2018).
109. Hori, S. et al. Structure-property relationships in lithium superionic conductors having a Li₁₀GeP₂S₁₂-type structure. Acta Crystallogr. Sect. B Struct. Sci. Cryst. Eng. Mater. 71, 727-736 (2015).
110. Kamaya, N. et al. A lithium superionic conductor. Nat. Mater. 10, 682-686 (2011).
111. Sun, Y., Suzuki, K., Hori, S., Hirayama, M. & Kanno, R. Superionic Conductors: Li_{10+δ}[Sn_{y}Si_{1-y}]_{1+δ}P_{2-δ}S₁₂ with a Li₁₀GeP₂S₁₂-type Structure in the Li₃PS₄—Li₄SnS₄—Li₄SiS₄ Quasi-ternary System. Chem. Mater. 29, 5858-5864 (2017).
112. Sun, Y. et al. A facile strategy to improve the electrochemical stability of a lithium ion conducting Li₁₀GeP₂S₁₂ solid electrolyte. Solid State Ion. 301, 59-63 (2017).
113. Weber, D. A. et al. Structural insights and 3D diffusion pathways within the lithium superionic conductor Li₁₀GeP₂S₁₂. Chem. Mater. 28, 5905-5915 (2016).
114. Sato, M., Abo, J., Jin, T. & Ohta, M. Structure and ionic conductivity of MLaNb₂O₇ (M=K, Na, Li, H). J. Alloys Compd. 192, 81-83 (1993).
115. Bhuvanesh, N. S. P., Crosnier-Lopez, M. P., Bohnke, O., Emery, J. & Fourquet, J. L. Synthesis, crystal structure, and ionic conductivity of novel Ruddlesden-Popper related phases, Li₄Sr₃Nb_{5.77}Fe_{0.23}O_{19.77} and Li₄Sr₃Nb₆O₂₀. Chem. Mater. 11, 634-641 (1999).
116. Cordier, G., Gudat, A., Kniep, R. & Rabenau, A. LiCaN and Li₄SrN₂, derivatives of the fluorite and lithium nitride structures. Angew. Chem. Int. Ed. Engl. 28, 1702-1703 (1989).
117. Zhao, G., Muhammad, I., Suzuki, K., Hirayama, M. & Kanno, R. Synthesis, crystal structure, and the ionic conductivity of new lithium ion conductors, M-doped LiScO₂ (M=Zr, Nb, Ta). Mater. Trans. 57, 1370-1373 (2016).
118. Awaka, J. et al. Neutron powder diffraction study of tetragonal Li₇La₃Hf₂O₁₂ with the garnet-related type structure. J. Solid State Chem. 183, 180-185 (2010).
119. Awaka, J., Kijima, N., Hayakawa, H. & Akimoto, J. Synthesis and structure analysis of tetragonal Li₇La₃Zr₂O₁₂ with the garnet-related type structure. J. Solid State Chem. 182, 2046-2052 (2009).
120. Il'ina, E. A. & Pershina, S. V. Composite electrolytes based on tetragonal Li₇La₃Zr₂O₁₂ for lithium batteries. in Solid Electrolytes for Advanced Applications: Garnets and Competitors (eds. Murugan, R. & Weppner, W.) 167-193 (Springer International Publishing, 2019). doi:10-1007/978-3-030-31581-8_8.
121. Inada, R., Kusakabe, K., Tanaka, T., Kudo, S. & Sakurai, Y. Synthesis and properties of Al-free Li₇₋ₓLa₃Zr₂₋ₓTaₓO₁₂ garnet related oxides. Solid State Ion. 262, 568-572 (2014).
122. Quintana, P. & West, A. R. Conductivity of lithium gallium silicates. Solid State Ion. 23, 179-182 (1987).
123. Mukai, K. & Nunotani, N. Crystal structure and li-ion conductivity of LiGa₁₋ₓAlₓGeO₄ phenacite compounds with 0≤x≤1. J. Electrochem. Soc. 163, A2371 (2016).
124. Arbi, K., Hoelzel, M., Kuhn, A., García-Alvarado, F. & Sanz, J. Structural factors that enhance lithium mobility in fast-ion Li₁₊ₓTi₂₋ₓAlₓ(PO₄)₃ (0≤x≤0.4) conductors investigated by neutron diffraction in the temperature range 100-500 K. Inorg. Chem. 52, 9290-9296 (2013).
125. Mellander, B.-E., Granéli, B. & Roos, J. Ionic conductivity of single crystal LiNaSO₄. Solid State Ion. 40-41, 162-164 (1990).
126. Takada, K. et al. Lithium ion conduction in lithium magnesium thio-phosphate. Solid State Ion. 147, 23-27 (2002).
127. Hood, Z. D. et al. Structural and electrolyte properties of Li₄P₂S₆. Solid State Ion. 284, 61-70 (2016).
128. Dietrich, C. et al. Local structural investigations, defect formation, and ionic conductivity of the lithium ionic conductor Li₄P₂S₆. Chem. Mater. 28, 8764-8773 (2016).
129. Muy, S. et al. High-throughput screening of solid-state Li-ion conductors using lattice-dynamics descriptors. iScience 16, 270-282 (2019).
130. Leube, B. T. et al. Lithium transport in Li_{4.4}M_{0.4}M′_{0.6}S₄ (M=A13+, Ga³⁺, and M′=Ge⁴⁺, Sn⁴⁺): Combined crystallographic, conductivity, solid state NMR, and computational studies. Chem. Mater. 30, 7183-7200 (2018).
131. Hartwig, P., Weppner, W. & Wichelhaus, W. Fast ionic lithium conduction in solid lithium nitride chloride. Mater. Res. Bull. 14, 493-498 (1979).
132. Kahlaoui, R. et al. Cation miscibility and lithium mobility in NASICON Li₁₊ₓTi₂₋ₓScₓ(PO₄)₃ (0≤x≤0.5) series: A combined NMR and impedance study. Inorg. Chem. 56, 1216-1224 (2017).
133. Weiss, M., Weber, D. A., Senyshyn, A., Janek, J. & Zeier, W. G. Correlating transport and structural properties in Li₁₊ₓAlₓGe₂₋ₓ(PO₄)₃ (LAGP) prepared from aqueous solution. ACS Appl. Mater. Interfaces 10, 10935-10944 (2018).
134. Aono, H., Sugimoto, E., Sadaoka, Y., Imanaka, N. & Adachi, G. Ionic conductivity of solid electrolytes based on lithium titanium phosphate. J. Electrochem. Soc. 137, 1023 (1990).
135. Bounar, N., Benabbas, A., Bouremmad, F., Ropa, P. & Carru, J.-C. Structure, microstructure and ionic conductivity of the solid solution LiTi₂₋ₓSnₓ(PO₄)₃. Phys. B Condens. Matter 407, 403-407 (2012).
136. Li, Y., Liu, M., Liu, K. & Wang, C.-A. High Li⁺ conduction in NASICON-type Li₁₊ₓYₓZr₂₋ₓ(PO₄)₃ at room temperature. J. Power Sources 240, 50-53 (2013).
137. Petit, D., Colomban, Ph., Collin, G. & Boilot, J. P. Fast ion transport in LiZr₂(PO₄)₃: Structure and conductivity. Mater. Res. Bull. 21, 365-371 (1986).
138. Kothari, D. H. & Kanchan, D. K. Effect of doping of trivalent cations Ga³⁺, Sc³⁺, Y³⁺ in Li_{1.3}Al_{0.3}Ti_{1.7}(PO₄)₃ (LATP) system on Li⁺ ion conductivity. Phys. B Condens. Matter 501, 90-94 (2016).
139. Aono, H., Sugimoto, E., Sadaaka, Y., Imanaka, N. & Adachi, G. Y. Ionic conductivity of the lithium titanium phosphate (Li₁₊ₓMₓTi₂₋ₓ(PO₄)₃, M=Al, Sc, Y, and La) systems. J. Electrochem. Soc. 136, 590 (1989).
140. Xu, H., Wang, S., Wilson, H., Zhao, F. & Manthiram, A. Y-doped NASICON-type LiZr₂(PO₄)₃ solid electrolytes for lithium-metal batteries. Chem. Mater. 29, 7206-7212 (2017).
141. Fu, J. Fast Li⁺ ion conducting glass-ceramics in the system Li₂O—Al₂O₃—GeO₂—P₂O₅. Solid State Ion. 104, 191-194 (1997).
142. Best, A. S., Forsyth, M. & MacFarlane, D. R. Stoichiometric changes in lithium conducting materials based on Li₁₊ₓAl_{X}Ti₂₋ₓ(PO₄)₃: impedance, X-ray and NMR studies. Solid State Ion. 136-137, 339-344 (2000).
143. Arbi, K. et al. Lithium mobility in Li_{1.2}Ti_{1.8}R_{0.2}(PO₄)₃ compounds (R═Al, Ga, Sc, In) as followed by NMR and impedance spectroscopy. Chem. Mater. 16, 255-262 (2004).
144. Šalkus, T. et al. Ionic conductivity of Li_{1.3}Al_{0.3-x}ScₓTi_{1.7}(PO₄)₃ (x=0, 0.1, 0.15, 0.2, 0.3) solid electrolytes prepared by Pechini process. Solid State Ion. 225, 615-619 (2012).
145. Pérez-Estébanez, M., Isasi-Marin, J., Többens, D. M., Rivera-Calzada, A. & Leon, C. A systematic study of Nasicon-type Li₁₊ₓMₓTi₂₋ₓ(PO₄)₃ (M: Cr, Al, Fe) by neutron diffraction and impedance spectroscopy. Solid State Ion. 266, 1-8 (2014).
146. Aono, H., Sugimoto, E., Sadaoka, Y., Imanaka, N. & Adachi, G. Electrical properties and sinterability for lithium germanium phosphate Li₁₊ₓMₓGe₂₋ₓ(PO₄)₃, M=Al, Cr, Ga, Fe, Sc, and In systems. Bull. Chem. Soc. Jpn. 65, 2200-2204 (1992).
147. Mugnier, Y., Galez, C., Crettez, J. M., Bourson, P. & Bouillot, J. Dielectric characterization and ionic conductivity of α-LiIO₃ crystals related to the growth conditions. Solid State Commun. 115, 619-623 (2000).
148. Yahia, H. B., Shikano, M., Takeuchi, T., Kobayashi, H. & Itoh, M. Crystal structures of the new fluorophosphates Li₉Mg₃[PO₄]₄F₃ and Li₂Mg[PO₄]F and ionic conductivities of selected compositions. J. Mater. Chem. A 2, 5858-5869 (2014).
149. Naddari, T., Savariault, J.-M., Feki, H. E., Salles, P. & Salah, A. B. Conductivity and structural investigations in Lacunary Pb₆Ca₂Li₂(PO₄)₆ Apatite. J. Solid State Chem. 166, 237-244 (2002).
150. Sato, M., Kono, Y., Ueda, H., Uematsu, K. & Toda, K. Bulk and grain boundary ionic conduction in lithium rare earth-silicates “LiLnSiO₄” (Ln=La, Nd, Sm, Eu, Gd, Dy). Solid State Ion. 83, 249-256 (1996).
151. Johnson, R. T., Morosin, B., Knotek, M. L. & Biefeld, R. M. Ionic conductivity in LiAlSiO₄. Phys. Lett. A 54, 403-404 (1975).
152. Matsuo, M. et al. Synthesis and lithium fast-ion conductivity of a new complex hydride Li₃(NH₂)₂I with double-layered structure. Chem. Mater. 22, 2702-2704 (2010).
153. Aimi, A. et al. Synthesis, structure and ionic conductivities of novel Li-ion conductor A₃LiₓTa₆₋ₓZrₓSi₄O₂₆ (A=Sr and Ba). Solid State Ion. 285, 19-28 (2016).
154. Alpen, U. v., Rabenau, A. & Talat, G. H. Ionic conductivity in Li₃N single crystals. Appl. Phys. Lett. 30, 621-623 (1977).
155. Lapp, T., Skaarup, S. & Hooper, A. Ionic conductivity of pure and doped Li₃N. Solid State Ion. 11, 97-103 (1983).
156. Röska, B., Akter, I., Hoelzel, M. & Park, S.-H. Na⁺/Li⁺-ionic conductivity in Fe₂Na₂K[Li₃SiI₂O₃₀]. J. Solid State Chem. 264, 98-107 (2018).
157. Nazri, G. Preparation, structure and ionic conductivity of lithium phosphide. Solid State Ion. 34, 97-102 (1989).
158. Thangadurai, V. & Weppner, W. Effect of sintering on the ionic conductivity of garnet-related structure Li₅La₃Nb₂O₁₂ and In- and K-doped Li₅La₃Nb₂O₁₂. J. Solid State Chem. 179, 974-984 (2006).
159. Thangadurai, V. & Weppner, W. Li₆ALa₂Nb₂O₁₂ (A=Ca, Sr, Ba): A new class of fast lithium ion conductors with garnet-like structure. J. Am. Ceram. Soc. 88, 411-418 (2005).
160. Watelet, H., Picard, J.-P., Besse, J.-P., Baud, G. & Chevalier, R. Structure et proprietes de conduction du compose K_{0.1}Li_{0.9}SbO₃. Solid State Ion. 2, 191-194 (1981).
161. Eickhoff, H. et al. Lithium phosphidogermanates α- and β-Li₈GeP₄—A novel compound class with mixed Li⁺ ionic and electronic conductivity. Chem. Mater. 30, 6440-6448 (2018).
162. Yamane, H., Kikkawa, S. & Koizumi, M. Lithium aluminum nitride, Li₃AlN₂ as a lithium solid electrolyte. Solid State Ion. 15, 51-54 (1985).
163. Kawai, H., Tabuchi, M., Nagata, M., Tukamoto, H. & West, A. R. Crystal chemistry and physical properties of complex lithium spinels Li₂MM′₃O₈ (M=Mg, Co, Ni, Zn; M′=Ti, Ge). J. Mater. Chem. 8, 1273-1280 (1998).
164. Shiiba, H., Nakayama, M. & Nogami, M. Ionic conductivity of lithium in spinel-type Li_{4/3}Ti_{5/3}O₄—LiMg_{1/2}Ti_{3/2}O₄ solid-solution system. Solid State Ion. 181, 994-1001 (2010).
165. Obayashi, H., Gotoh, A. & Nagai, R. Composition dependence of lithium ionic conductivity in lithium nitride-lithium iodide system. Mater. Res. Bull. 16, 581-585 (1981).
166. Cros, C., Hanebali, L., Latie', L., Villeneuve, G. & Gang, W. Structure, ionic motion and conductivity in some solid-solutions of the LiClMCl₂ systems (M=Mg,V,Mn). Solid State Ion. 9-10, 139-147 (1983).
167. Kraft, M. A. et al. Influence of lattice polarizability on the ionic conductivity in the lithium superionic argyrodites Li₆PS₅X (X=cl, br, i). J. Am. Chem. Soc. 139, 10909-10918 (2017).
168. Minafra, N., P. Culver, S., Krauskopf, T., Senyshyn, A. & G. Zeier, W. Effect of Si substitution on the structural and transport properties of superionic Li-argyrodites. J. Mater. Chem. A 6, 645-651 (2018).
169. Inoue, Y., Suzuki, K., Matsui, N., Hirayama, M. & Kanno, R. Synthesis and structure of novel lithium-ion conductor Li₇Ge₃PS₁₂. J. Solid State Chem. 246, 334-340 (2017).
170. Sakuda, A. et al. Mechanochemically prepared Li₂S—P₂S₅—LiBH₄ solid electrolytes with an argyrodite structure. ACS Omega 3, 5453-5458 (2018).
171. Boulineau, S., Courty, M., Tarascon, J.-M. & Viallet, V. Mechanochemical synthesis of Li-argyrodite Li₆PS₅X (X=Cl, Br, I) as sulfur-based solid electrolytes for all solid state batteries application. Solid State Ion. 221, 1-5 (2012).
172. Bernges, T., Culver, S. P., Minafra, N., Koerver, R. & Zeier, W. G. Competing structural influences in the Li superionic conducting argyrodites Li₆PS₅₋ₓSeₓBr (0≤x≤1) upon Se substitution. Inorg. Chem. 57, 13920-13928 (2018).
173. Kong, S.-T. et al. Li₆PO₅Br and Li₆PO₅Cl: The first lithium-oxide-argyrodites. Z. Für Anorg. Allg. Chem. 636, 1920-1924 (2010).
174. Rao, R. P. & Adams, S. Studies of lithium argyrodite solid electrolytes for all-solid-state batteries. Phys. Status Solidi A 208, 1804-1807 (2011).
175. Kraft, M. A. et al. Inducing high ionic conductivity in the lithium superionic argyrodites Li₆₊ₓP₁₋ₓGeₓS₅I for all-solid-state batteries. J. Am. Chem. Soc. 140, 16330-16339 (2018).
176. Deiseroth, H.-J. et al. Li₇PS₆ and Li₆PS₅X (X: Cl, Br, I): possible three-dimensional diffusion pathways for lithium ions and temperature dependence of the ionic conductivity by impedance measurements. Z. Für Anorg. Allg. Chem. 637, 1287-1294 (2011).
177. Song, Y. B. et al. Tailoring solution-processable li argyrodites Li₆₊ₓP₁₋ₓMₓS₅I (M=Ge, Sn) and their microstructural evolution revealed by cryo-tem for all-solid-state batteries. Nano Lett. 20, 4337-4345 (2020).
178. Ley, M. B. et al. LiCe(BH₄)₃Cl, a new lithium-ion conductor and hydrogen storage material with isolated tetranuclear anionic clusters. Chem. Mater. 24, 1654-1663 (2012).
179. Jeitschko, W., Bither, T. A. & Bierstedt, P. E. Crystal structure and ionic conductivity of Li boracites. Acta Crystallogr. B 33, 2767-2775 (1977).
180. Wagner, R. et al. Fast Li-ion-conducting garnet-related Li₇₋₃ₓFeₓLa₃Zr₂O₁₂ with uncommon 143d structure. Chem. Mater. 28, 5943-5951 (2016).
181. H. Braga, M., A. Ferreira, J., Stockhausen, V., E. Oliveira, J. & El-Azab, A. Novel Li₃ClO based glasses with superionic properties for lithium batteries. J. Mater. Chem. A 2, 5470-5480 (2014).
182. Stramare, S. & Weppner, W. Structure and conductivity of B-site substituted (Li,La)TiO₃. Mater. Sci. Eng. B 113, 85-90 (2004).
183. Sotomayor, M. E., Verez, A., Bucheli, W., Jimenez, R. & Sanz, J. Structural characterisation and Li conductivity of Li_{1/2-x}Sr₂ₓLa_{1/2-x}TiO₃ (0<x<0.5) perovskites. Ceram. Int. 39, 9619-9626 (2013).
184. Li, Y. et al. Fluorine-doped antiperovskite electrolyte for all-solid-state lithium-ion batteries. Angew. Chem. 128, 10119-10122 (2016).
185. J. Miara, L. et al. Li-ion conductivity in Li₉S₃N. J. Mater. Chem. A 3, 20338-20344 (2015).
186. Sotomayor, M. E., Levenfeld, B., Varez, A. & Sanz, J. Study of the La_{1/2+1/2x}Li_{1/2-1/2x}Ti₁₋ₓAlₓO₃ (0≤x≤1) solid solution. A new example of percolative system in fast ion conductors. J. Alloys Compd. 720, 460-465 (2017).
187. Phraewphiphat, T. et al. Syntheses, structures, and ionic conductivities of perovskite-structured lithium-strontium-aluminum/gallium-tantalum-oxides. J. Solid State Chem. 225, 431-437 (2015).
188. Chen, C. H. et al. Stable lithium-ion conducting perovskite lithium-strontium-tantalum-zirconium-oxide system. Solid State Ion. 167, 263-272 (2004).
189. Huang, B. et al. Li-ion conduction and stability of perovskite Li_{3/8}Sr_{7/16}Hf_{1/4}Ta_{3/4}O₃. ACS Appl. Mater. Interfaces 8, 14552-14557 (2016).
190. Yu, R., Du, Q.-X., Zou, B.-K., Wen, Z.-Y. & Chen, C.-H. Synthesis and characterization of perovskite-type (Li,Sr)(Zr,Nb)O₃ quaternary solid electrolyte for all-solid-state batteries. J. Power Sources 306, 623-629 (2016).
191. Braga, M. H., Ferreira, J. A., Stockhausen, V., Oliveira, J. E. & El-Azab, A. Novel Li₃ClO based glasses with superionic properties for lithium batteries. J. Mater. Chem. A 2, 5470-5480 (2014).
192. Inaguma, Y. & Itoh, M. Influences of carrier concentration and site percolation on lithium ion conductivity in perovskite-type oxides. Solid State Ion. 86-88, 257-260 (1996).
193. Morata-Orrantia, A., García-Martin, S. & Alario-Franco, M. Á. New La_{2/3-x}SrₓLiₓTiO₃ solid solution: structure, microstructure, and Li⁺ conductivity. Chem. Mater. 15, 363-367 (2003).
194. Zhao, Y. & Daemen, L. L. Superionic conductivity in lithium-rich anti-perovskites. J. Am. Chem. Soc. 134, 15042-15047 (2012).
195. Li, S. et al. Reaction mechanism studies towards effective fabrication of lithium-rich anti-perovskites Li₃₀X (X=Cl, Br). Solid State Ion. 284, 14-19 (2016).
196. Howard, M. A., Clemens, O., Slater, P. R. & Anderson, P. A. Hydrogen absorption and lithium ion conductivity in Li₆NBr₃. J. Alloys Compd. 645, S₁₇₄-S₁₇₇ (2015).
197. Liang, C. C. Conduction characteristics of the lithium iodide-aluminum oxide solid electrolytes. J. Electrochem. Soc. 120, 1289 (1973).
198. Lutz, H. D., Steiner, H.-J. & Wickel, Ch. Fast ionic conductivity and crystal structure of spinel-type Li₂₋ₓMn₁₋ₓMₓCl₄ (M=Ga, In). Solid State Ion. 95, 173-181 (1997).
199. Kanno, R., Takeda, Y. & Yamamoto, O. Ionic conductivity of solid lithium ion conductors with the spinel structure: Li₂MCl₄ (M=Mg, Mn, Fe, Cd). Mater. Res. Bull. 16, 999-1005 (1981).
200. Phraewphiphat, T., Iqbal, M., Suzuki, K., Hirayama, M. & Kanno, R. Synthesis and lithium-ion conductivity of LiSrB₂O₆F (B═Nb⁵⁺, Ta⁵⁺) with a pyrochlore structure. [symbol] [symbol] [symbol] 65, 26-33 (2018).
201. Murugan, R., Thangadurai, V. & Weppner, W. Lithium ion conductivity of Li₅₊ₓBaₓLa₃₋ₓTa₂O₁₂ (x=0-2) with garnet-related structure in dependence of the barium content. Ionics 13, 195-203 (2007).
202. Raskovalov, A. A., Il'ina, E. A. & Antonov, B. D. Structure and transport properties of Li₇La₃Zr_{2-0.75x}AlₓO₁₂ superionic solid electrolytes. J. Power Sources 238, 48-52 (2013).
203. Murugan, R., Ramakumar, S. & Janani, N. High conductive yttrium doped Li₇La₃Zr₂O₁₂ cubic lithium garnet. Electrochem. Commun. 13, 1373-1375 (2011).
204. Wolfenstine, J., Ratchford, J., Rangasamy, E., Sakamoto, J. & Allen, J. L. Synthesis and high Li-ion conductivity of Ga-stabilized cubic Li₇La₃Zr₂O₁₂. Mater. Chem. Phys. 134, 571-575 (2012).
205. Li, Y., Tao Han, J.-, An Wang, C.-, Xie, H. & B. Goodenough, J. Optimizing Li⁺ conductivity in a garnet framework. J. Mater. Chem. 22, 15357-15361 (2012).
206. Wang, Y. & Lai, W. High ionic conductivity lithium garnet oxides of Li₇₋ₓLa₃Zr₂₋ₓTaₓO₁₂ compositions. Electrochem. Solid State Lett. 15, A68 (2012).
207. Lu, Y., Meng, X., Alonso, J. A., Fernández-Díaz, M. T. & Sun, C. Effects of fluorine doping on structural and electrochemical properties of Li_{6.25}Ga_{0.25}La₃Zr₂O₁₂ as electrolytes for solid-state lithium batteries. ACS Appl. Mater. Interfaces 11, 2042-2049 (2019).
208. Wang, D. et al. Toward understanding the lithium transport mechanism in garnet-type solid electrolytes: Li⁺ ion exchanges and their mobility at octahedral/tetrahedral sites. Chem. Mater. 27, 6650-6659 (2015).
209. Rettenwander, D. et al. Synthesis, crystal chemistry, and electrochemical properties of Li₇₋₂ₓLa₃Zr₂₋ₓMoₓO₁₂ (x=0.1-0.4): stabilization of the cubic garnet polymorph via substitution of Zr⁴⁺ by Mo⁶⁺. Inorg. Chem. 54, 10440-10449 (2015).
210. Deviannapoorani, C., Dhivya, L., Ramakumar, S. & Murugan, R. Lithium ion transport properties of high conductive tellurium substituted Li₇La₃Zr₂O₁₂ cubic lithium garnets. J. Power Sources 240, 18-25 (2013).
211. He, M., Cui, Z., Chen, C., Li, Y. & Guo, X. Formation of self-limited, stable and conductive interfaces between garnet electrolytes and lithium anodes for reversible lithium cycling in solid-state batteries. J. Mater. Chem. A 6, 11463-11470 (2018).
212. Thangadurai, V., Kaack, H. & Weppner, W. J. F. Novel fast lithium ion conduction in garnet-type Li₅La₃M₂O₁₂ (M=Nb, Ta). J. Am. Ceram. Soc. 86, 437-440 (2003).
213. Murugan, R., Weppner, W., Schmid-Beurmann, P. & Thangadurai, V. Structure and lithium ion conductivity of bismuth containing lithium garnets Li₅La₃Bi₂O₁₂ and Li₆SrLa₂Bi₂O₁₂. Mater. Sci. Eng. B 143, 14-20 (2007).
214. Percival, J., Kendrick, E. & Slater, P. R. Synthesis and characterisation of the garnet-related Li ion conductor, Li₅Nd₃Sb₂O₁₂. Mater. Res. Bull. 43, 765-770 (2008).
215. O'Callaghan, M. P., Powell, A. S., Titman, J. J., Chen, G. Z. & Cussen, E. J. Switching on fast lithium ion conductivity in garnets: the structure and transport properties of Li₃₊ₓNd₃Te₂₋ₓSbₓO₁₂. Chem. Mater. 20, 2360-2369 (2008).
216. Murugan, R., Weppner, W., Schmid-Beurmann, P. & Thangadurai, V. Structure and lithium ion conductivity of garnet-like Li₅La₃Sb₂O₁₂ and Li₆SrLa₂Sb₂O₁₂. Mater. Res. Bull. 43, 2579-2591 (2008).
217. Percival, J., Apperley, D. & Slater, P. R. Synthesis and structural characterisation of the Li ion conducting garnet-related systems, Li₆ALa₂Nb₂O₁₂ (A=Ca, Sr). Solid State Ion. 179, 1693-1696 (2008).
218. Awaka, J., Kijima, N., Takahashi, Y., Hayakawa, H. & Akimoto, J. Synthesis and crystallographic studies of garnet-related lithium-ion conductors Li₆CaLa₂Ta₂O₁₂ and Li₆BaLa₂Ta₂O₁₂. Solid State Ion. 180, 602-606 (2009).
219. Allen, J. L., Wolfenstine, J., Rangasamy, E. & Sakamoto, J. Effect of substitution (Ta, Al, Ga) on the conductivity of Li₇La₃Zr₂O₁₂. J. Power Sources 206, 315-319 (2012).
220. Janani, N., Deviannapoorani, C., Dhivya, L. & Murugan, R. Influence of sintering additives on densification and Li⁺ conductivity of Al doped Li₇La₃Zr₂O₁₂ lithium garnet. RSC Adv. 4, 51228-51238 (2014).
221. Buschmann, H. et al. Structure and dynamics of the fast lithium ion conductor “Li₇La₃Zr₂O₁₂”. Phys. Chem. Chem. Phys. 13, 19378-19392 (2011).
222. Kokal, I., Ramanujachary, K. V., Notten, P. H. L. & Hintzen, H. T. Sol-gel synthesis and lithium ion conduction properties of garnet-type Li₆BaLa₂Ta₂O₁₂. Mater. Res. Bull. 47, 1932-1935 (2012).
223. A. Howard, M. et al. Synthesis, conductivity and structural aspects of Nd₃Zr₂Li₇₋₃ₓAlₓO₁₂. J. Mater. Chem. A 1, 14013-14022 (2013).
224. Matsuda, Y. et al. Phase formation of a garnet-type lithium-ion conductor Li₇₋₃ₓAlₓLa₃Zr₂O₁₂. Solid State Ion. 277, 23-29 (2015).
225. Narayanan, S., Ramezanipour, F. & Thangadurai, V. Enhancing Li ion conductivity of garnet-type Li₅La₃Nb₂O₁₂ by Y- and Li-codoping: synthesis, structure, chemical stability, and transport properties. J. Phys. Chem. C 116, 20154-20162 (2012).
226. Zeier, W. G., Zhou, S., Lopez-Bermudez, B., Page, K. & Melot, B. C. Dependence of the Li-ion conductivity and activation energies on the crystal structure and ionic radii in Li₆MLa₂Ta₂O₁₂. ACS Appl. Mater. Interfaces 6, 10900-10907 (2014).
227. Thangadurai, V. & Weppner, W. Li₆ALa₂Ta₂O₁₂ (A=Sr, Ba): Novel garnet-like oxides for fast lithium ion conduction. Adv. Funct. Mater. 15, 107-112 (2005).
228. Thompson, T. et al. A tale of two sites: on defining the carrier concentration in garnet-based ionic conductors for advanced Li batteries. Adv. Energy Mater. 5, 1500096 (2015).
229. Shin, D. O. et al. Synergistic multi-doping effects on the Li₇La₃Zr₂O₁₂ solid electrolyte for fast lithium ion conduction. Sci. Rep. 5, 18053 (2015).
230. Hamao, N., Kataoka, K. & Akimoto, J. Li-ion conductivity and crystal structure of garnet-type Li_{6.5}La₃M_{1.5}Ta_{0.5}O₁₂ (M=Hf, Sn) oxides. J. Ceram. Soc. Jpn. 125, 272-275 (2017).
231. Abdel-Basset, D. M., Mulmi, S., El-Bana, M. S., Fouad, S. S. & Thangadurai, V. Structure, ionic conductivity, and dielectric properties of Li-rich garnet-type Li₅₊₂ₓLa₃Ta₂₋ₓSmₓO₁₂ (0≤x≤0.55) and their chemical stability. Inorg. Chem. 56, 8865-8877 (2017).
232. Shimonishi, Y. et al. Synthesis of garnet-type Li₇₋ₓLa₃Zr₂O_{12-1/2x} and its stability in aqueous solutions. Solid State Ion. 183, 48-53 (2011).
233. Narayanan, S. & Thangadurai, V. Effect of Y substitution for Nb in Li₅La₃Nb₂O₁₂ on Li ion conductivity of garnet-type solid electrolytes. J. Power Sources 196, 8085-8090 (2011).
234. Rangasamy, E., Wolfenstine, J. & Sakamoto, J. The role of Al and Li concentration on the formation of cubic garnet solid electrolyte of nominal composition Li₇La₃Zr₂O₁₂. Solid State Ion. 206, 28-32 (2012).
235. El Shinawi, H. & Janek, J. Stabilization of cubic lithium-stuffed garnets of the type “Li₇La₃Zr₂O₁₂” by addition of gallium. J. Power Sources 225, 13-19 (2013).
236. Howard, M. A. et al. Effect of Ga incorporation on the structure and Li ion conductivity of La₃Zr₂Li₇O₁₂. Dalton Trans. 41, 12048-12053 (2012).
237. Ramakumar, S., Satyanarayana, L., Manorama, S. V. & Murugan, R. Structure and Li⁺ dynamics of Sb-doped Li₇La₃Zr₂O₁₂ fast lithium ion conductors. Phys. Chem. Chem. Phys. 15, 11327-11338 (2013).
238. Wang, D. et al. The synergistic effects of Al and Te on the structure and Li⁺-mobility of garnet-type solid electrolytes. J. Mater. Chem. A 2, 20271-20279 (2014).
239. Tong, X., Thangadurai, V. & Wachsman, E. D. Highly conductive Li garnets by a multielement doping strategy. Inorg. Chem. 54, 3600-3607 (2015).
240. O'Callaghan, M. P., Lynham, D. R., Cussen, E. J. & Chen, G. Z. Structure and ionic-transport properties of lithium-containing garnets Li₃Ln₃Te₂O₁₂ (Ln=Y, Pr, Nd, Sm—Lu). Chem. Mater. 18, 4681-4689 (2006).
241. Chen, R.-J. et al. Effect of calcining and Al doping on structure and conductivity of Li₇La₃Zr₂O₁₂. Solid State Ion. 265, 7-12 (2014).
242. Cussen, E. J., Yip, T. W. S., O'Neill, G. & O'Callaghan, M. P. A comparison of the transport properties of lithium-stuffed garnets and the conventional phases Li₃Ln₃Te₂O₁₂. J. Solid State Chem. 184, 470-475 (2011).
243. Arbi, K., Bucheli, W., Jiménez, R. & Sanz, J. High lithium ion conducting solid electrolytes based on NASICON Li₁₊ₓAlₓM₂₋ₓ(PO₄)₃ materials (M=Ti, Ge and 0≤x≤0.5). J. Eur. Ceram. Soc. 35, 1477-1484 (2015).
244. Rangasamy, E., Wolfenstine, J., Allen, J. & Sakamoto, J. The effect of 24c-site (A) cation substitution on the tetragonal-cubic phase transition in Li₇₋ₓLa₃₋ₓAₓZr₂O₁₂ garnet-based ceramic electrolyte. J. Power Sources 230, 261-266 (2013).
245. Xu, X., Wen, Z., Yang, X. & Chen, L. Dense nanostructured solid electrolyte with high Li-ion conductivity by spark plasma sintering technique. Mater. Res. Bull. 43, 2334-2341 (2008).
246. Hayashi, A., Hama, S., Minami, T. & Tatsumisago, M. Formation of superionic crystals from mechanically milled Li₂S—P₂S₅ glasses. Electrochem. Commun. 5, 111-114(2003).
247. Minami, K., Hayashi, A., Ujiie, S. & Tatsumisago, M. Electrical and electrochemical properties of glass-ceramic electrolytes in the systems Li₂S—P₂S₅—P₂S₃ and Li₂S—P₂S₅—P₂O₅. Solid State Ion. 192, 122-125 (2011).
248. Fukushima, A., Hayashi, A., Yamamura, H. & Tatsumisago, M. Mechanochemical synthesis of high lithium ion conducting solid electrolytes in a Li₂S—P₂S₅—Li₃N system. Solid State Ion. 304, 85-89 (2017).
249. Ohta, S., Kobayashi, T. & Asaoka, T. High lithium ionic conductivity in the garnet-type oxide Li₇₋ₓLa₃(Zr₂₋ₓ, Nbₓ)O₁₂ (X=0-2). J. Power Sources 196, 3342-3345 (2011).
250. ZaiB, T., Ortner, M., Murugan, R. & Weppner, W. Fast ionic conduction in cubic hafnium garnet Li₇La₃Hf₂O₁₂. Ionics 16, 855-858 (2010).
251. Kuhn, A., Duppel, V. & V. Lotsch, B. Tetragonal Li₁₀GeP₂S₁₂ and Li₇GePS₈—exploring the Li ion dynamics in LGPS Li electrolytes. Energy Environ. Sci. 6, 3548-3552 (2013).
252. Kato, Y. et al. Synthesis, structure and lithium ionic conductivity of solid solutions of Li₁₀(Ge_{1-X}M_{X})P₂S₁₂ (M=Si, Sn). J. Power Sources 271, 60-64 (2014).
253. Pradel, A., Pagnier, T. & Ribes, M. Effect of rapid quenching on electrical properties of lithium conductive glasses. Solid State Ion. 17, 147-154 (1985).
254. Bernuy-Lopez, C. et al. Atmosphere controlled processing of Ga-substituted garnets for high Li-ion conductivity ceramics. Chem. Mater. 26, 3610-3617 (2014).
255. Ramakumar, S., Satyanarayana, L., V. Manorama, S. & Murugan, R. Structure and Li⁺ dynamics of Sb-doped Li₇La₃Zr₂O₁₂ fast lithium ion conductors. Phys. Chem. Chem. Phys. 15, 11327-11338 (2013).
256. Gombotz, M., Rettenwander, D. & Wilkening, H. M. R. Lithium-ion transport in nanocrystalline spinel-type Li[InₓLi_{y}]Br₄ as seen by conductivity spectroscopy and NMR. Front. Chem. 8, (2020).
257. Tomita, Y., Matsushita, H., Kobayashi, K., Maeda, Y. & Yamada, K. Substitution effect of ionic conductivity in lithium ion conductor, Li₃InBr₆₋ₓClₓ. Solid State Ion. 179, 867-870 (2008).
258. Kanno, R., Takeda, Y., Takada, K. & Yamamoto, 0. Ionic conductivity and phase transition of the spinel system Li₂₋₂ₓM₁₊ₓCl₄ (M=Mg, Mn, Cd). J. Electrochem. Soc. 131, 469 (1984).
259. Yin, L., Yuan, H., Kong, L., Lu, Z. & Zhao, Y. Engineering Frenkel defects of anti-perovskite solid-state electrolytes and their applications in all-solid-state lithium-ion batteries. Chem. Commun. 56, 1251-1254 (2020).
260. Hood, Z. D., Wang, H., Samuthira Pandian, A., Keum, J. K. & Liang, C. Li₂OHCl crystalline electrolyte for stable metallic lithium anodes. J. Am. Chem. Soc. 138, 1768-1771 (2016).
261. Bruce, P. G. & West, A. R. Ionic conductivity of LISICON solid solutions, Li₂₊₂ₓZn₁₋ₓGeO₄. J. Solid State Chem. 44, 354-365 (1982).
262. Han, X. et al. Negating interfacial impedance in garnet-based solid-state Li metal batteries. Nat. Mater. 16, 572-579 (2017).
263. Inoishi, A., Nishio, A., Yoshioka, Y., Kitajou, A. & Okada, S. A single-phase all-solid-state lithium battery based on Li_{1.5}Cr_{0.5}Ti_{1.5}(PO₄)₃ for high rate capability and low temperature operation. Chem. Commun. 54, 3178-3181 (2018).
264. Wu, Z. et al. Utmost limits of various solid electrolytes in all-solid-state lithium batteries: A critical review. Renew. Sustain. Energy Rev. 109, 367-385 (2019).
265. Pradel, A. & Ribes, M. Electrical properties of lithium conductive silicon sulfide glasses prepared by twin roller quenching. Solid State Ion. 18-19, 351-355 (1986).
266. Mercier, R., Malugani, J.-P., Fahys, B. & Robert, G. Superionic conduction in Li₂S—P₂S₅—LiI—glasses. Solid State Ion. 5, 663-666 (1981).
267. Kennedy, J. H. Ionically conductive glasses based on SiS₂. Mater. Chem. Phys. 23, 29-50 (1989).
268. Wada, H., Menetrier, M., Levasseur, A. & Hagenmuller, P. Preparation and ionic conductivity of new B₂S₃—Li₂S—LiI glasses. Mater. Res. Bull. 18, 189-193 (1983).
269. Sahami, S., Shea, S. W. & Kennedy, J. H. Preparation and conductivity measurements of SiS₂—Li₂S—LiBr lithium ion conductive glasses. J. Electrochem. Soc. 132, 985 (1985).
270. Kennedy, J. H., Sahami, S., Shea, S. W. & Zhang, Z. Preparation and conductivity measurements of SiS_{2□}Li₂S glasses doped with LiBr and LiCl. Solid State Ion. 18-19, 368-371 (1986).
271. Kennedy, J. H. & Yang, Y. A highly conductive Li+-glass system: (1−x) (0.4SiS₂-0.6Li₂S)-xLiI. J. Electrochem. Soc. 133, 2437 (1986).
272. Kennedy, J. H. & Yang, Y. Glass-forming region and structure in SiS_{2□}Li₂S_{□}LiX (X═Br, I). J. Solid State Chem. 69, 252-257 (1987).
273. Kennedy, J. H. & Zhang, Z. Improved stability for the SiS₂—P₂S₅—Li₂S—LiI glass system. Solid State Ion. 28-30, 726-728 (1988).
274. Ribes, M., Barrau, B. & Souquet, J. L. Sulfide glasses: Glass forming region, structure and ionic conduction of glasses in Na₂S—XS₂ (X═Si; Ge), Na₂S—P₂S₅ and Li₂S—GeS₂ systems. J. Non-Cryst. Solids 38-39, 271-276 (1980).
275. Seino, Y., Ota, T., Takada, K., Hayashi, A. & Tatsumisago, M. A sulphide lithium super ion conductor is superior to liquid ion conductors for use in rechargeable batteries. Energy Environ. Sci. 7, 627-631 (2014).
276. Mizuno, F., Hayashi, A., Tadanaga, K. & Tatsumisago, M. High lithium ion conducting glass-ceramics in the system Li₂S—P₂S₅. Solid State Ion. 177, 2721-2725 (2006).
277. Morimoto, H., Yamashita, H., Tatsumisago, M. & Minami, T. Mechanochemical synthesis of new amorphous materials of 60Li₂S·40SiS₂ with high lithium ion conductivity. J. Am. Ceram. Soc. 82, 1352-1354 (1999).
278. Minami, T., Hayashi, A. & Tatsumisago, M. Preparation and characterization of lithium ion-conducting oxysulfide glasses. Solid State Ion. 136-137, 1015-1023 (2000).
279. Hirai, K., Tatsumisago, M. & Minami, T. Thermal and electrical properties of rapidly quenched glasses in the systems Li₂S—SiS₂-LiₓMO_{y} (LiₓMO_{y}=Li₄SiO₄, Li₂SO₄). Solid State Ion. 78, 269-273 (1995).
280. Abrahams, I. & Hadzifejzovic, E. Lithium ion conductivity and thermal behaviour of glasses and crystallised glasses in the system Li₂O—Al₂O₃—TiO₂—P₂O₅. Solid State Ion. 134, 249-257 (2000).
281. Hayashi, A., Yamashita, H., Tatsumisago, M. & Minami, T. Characterization of Li₂S—SiS₂-LiₓMO_{y} (M=Si, P, Ge) amorphous solid electrolytes prepared by melt-quenching and mechanical milling. Solid State Ion. 148, 381-389 (2002).
282. Hayashi, A., Hama, S., Morimoto, H., Tatsumisago, M. & Minami, T. High lithium ion conductivity of glass-ceramics derived from mechanically milled glassy powders. Chem. Lett. 30, 872-873 (2001).
283. Mizuno, F., Hayashi, A., Tadanaga, K. & Tatsumisago, M. New lithium-ion conducting crystal obtained by crystallization of the Li₂S—P₂S₅ glasses. Electrochem. Solid State Lett. 8, A603 (2005).
284. Hayashi, A., Komiya, R., Tatsumisago, M. & Minami, T. Characterization of Li₂S—SiS₂-Li₃MO₃ (M=B, Al, Ga and In) oxysulfide glasses and their application to solid state lithium secondary batteries. Solid State Ion. 152-153, 285-290 (2002).
285. Hayashi, A., Ishikawa, Y., Hama, S., Minami, T. & Tatsumisago, M. Fast lithium-ion conducting glass-ceramics in the system Li₂S—SiS₂—P₂S₅. Electrochem. Solid State Lett. 6, A47 (2003).
286. Iio, K., Hayashi, A., Morimoto, H., Tatsumisago, M. & Minami, T. Mechanochemical synthesis of high lithium ion conducting materials in the system Li₃N-SiS₂. Chem. Mater. 14, 2444-2449 (2002).
287. Machida, N., Yamamoto, H. & Shigematsu, T. A new amorphous lithium-ion conductor in the system Li₂S—P₂S₃. Chem. Lett. 33, 30-31 (2003).
288. Sakamoto, R., Tatsumisago, M. & Minami, T. Preparation of fast lithium ion conducting glasses in the system Li₂S—SiS₂—Li₃N. J. Phys. Chem. B 103, 4029-4031 (1999).
289. Abdel-Baki, M., Salem, A. M., Abdel-Wahab, F. A. & El-Diasty, F. Bond character, optical properties and ionic conductivity of Li₂O/B₂O₃/SiO₂/Al₂O₃ glass: Effect of structural substitution of Li₂O for LiCl. J. Non-Cryst. Solids 354, 4527-4533 (2008).
290. Machida, N., Yoneda, Y. & Shigematsu, T. Mechano-chemical synthesis of lithium ion conducting materials in the system Li₂O—Li₂S—P₂S₅. J. Jpn. Soc. Powder Powder Metall. 51, 91-97 (2004).
291. Hayashi, A. et al. Thermal and electrical properties of rapidly quenched Li₂S—SiS₂—Li₂O—P₂O₅ oxysulfide glasses. Solid State Ion. 113-115, 733-738 (1998).
292. Zhang, Y., Chen, K., Shen, Y., Lin, Y. & Nan, C.-W. Synergistic effect of processing and composition x on conductivity of xLi₂S-(100−x)P₂S₅ electrolytes. Solid State Ion. 305, 1-6 (2017).
293. [symbol] , [symbol] [symbol] . [symbol] [symbol] LiI—Li₂S—SiS₂ [symbol] [symbol] [symbol] [symbol] [symbol] . [symbol] [symbol] 49, 799-806 (2002).
294. Hayashi, A., Hirai, K., Tatsumisago, M., Takahashi, M. & Minami, T. Preparation of Li₆Si₂S₇—Li₆B₄X9 (X═S, O) glasses by rapid quenching and their lithium ion conductivities. Solid State Ion. 86-88, 539-542 (1996).
295. Yersak, T. A., Salvador, J. R., Pieczonka, N. P. W. & Cai, M. Dense, melt cast sulfide glass electrolyte separators for Li metal batteries. J. Electrochem. Soc. 166, A1535 (2019).
296. Dietrich, C. et al. Lithium ion conductivity in Li₂S—P₂S₅ glasses—building units and local structure evolution during the crystallization of superionic conductors Li₃PS₄, Li₇P₃S₁₁ and Li₄P₂S₇. J. Mater. Chem. A 5, 18111-18119 (2017).
297. Yamauchi, A., Sakuda, A., Hayashi, A. & Tatsumisago, M. Preparation and ionic conductivities of (100−x)(0.75Li₂S-0.25P₂S₅)·xLiBH₄ glass electrolytes. J. Power Sources 244, 707-710 (2013).
298. Xu, R., Xia, X., Wang, X., Xia, Y. & Tu, J. Tailored Li₂S—P₂S₅ glass-ceramic electrolyte by MoS₂ doping, possessing high ionic conductivity for all-solid-state lithium-sulfur batteries. J. Mater. Chem. A 5, 2829-2834 (2017).
299. Xu, R. et al. All-solid-state lithium-sulfur batteries based on a newly designed Li₇P_{2.9}Mn_{0.1}S_{10.7}I_{0.3} superionic conductor. J. Mater. Chem. A 5, 6310-6317 (2017).
300. Zhou, P., Wang, J., Cheng, F., Li, F. & Chen, J. A solid lithium superionic conductor Li₁₁AlP₂S₁₂ with a thio-LISICON analogous structure. Chem. Commun. 52, 6091-6094 (2016).
301. Hood, Z. D. et al. The “filler effect”: A study of solid oxide fillers with P—Li₃PS₄ for lithium conducting electrolytes. Solid State Ion. 283, 75-80 (2015).
302. Rangasamy, E. et al. A high conductivity oxide-sulfide composite lithium superionic conductor. J. Mater. Chem. A 2, 4111-4116 (2014).
303. Trevey, J. E., Jung, Y. S. & Lee, S.-H. Preparation of Li₂S—GeSe₂—P₂S₅ electrolytes by a single step ball milling for all-solid-state lithium secondary batteries. J. Power Sources 195, 4984-4989 (2010).
304. Trevey, J. E., Gilsdorf, J. R., Miller, S. W. & Lee, S.-H. Li₂S—Li₂O—P₂S₅ solid electrolyte for all-solid-state lithium batteries. Solid State Ion. 214, 25-30 (2012).
305. Hayashi, A., Muramatsu, H., Ohtomo, T., Hama, S. & Tatsumisago, M. Improvement of chemical stability of Li₃PS₄ glass electrolytes by adding MₓO_{y} (M=Fe, Zn, and Bi) nanoparticles. J. Mater. Chem. A 1, 6320-6326 (2013).
306. Huang, B. et al. Li₃PO₄-doped Li₇P₃S₁₁ glass-ceramic electrolytes with enhanced lithium ion conductivities and application in all-solid-state batteries. J. Power Sources 284, 206-211 (2015).
307. Lu, P. et al. Study on (100−x)(70Li₂S-30P₂S₅)-xLi₂ZrO₃ glass-ceramic electrolyte for all-solid-state lithium-ion batteries. J. Power Sources 356, 163-171 (2017).
308. Bates, J. B. et al. Fabrication and characterization of amorphous lithium electrolyte thin films and rechargeable thin-film batteries. J. Power Sources 43, 103-110 (1993).
309. Fleutot, B., Pecquenard, B., Martinez, H., Letellier, M. & Levasseur, A. Investigation of the local structure of LiPON thin films to better understand the role of nitrogen on their performance. Solid State Ion. 186, 29-36 (2011).
310. Suzuki, N., Shirai, S., Takahashi, N., Inaba, T. & Shiga, T. A lithium phosphorous oxynitride (LiPON) film sputtered from unsintered Li₃PO₄ powder target. Solid State Ion. 191, 49-54 (2011).
311. Ménétrier, M., Estournès, C., Levasseur, A. & Rao, K. J. Ionic conduction in B₂S₃—Li₂S—LiI glasses. Solid State Ion. 53-56, 1208-1213 (1992).
312. Takada, K., Aotani, N. & Kondo, S. Electrochemical behaviors of Li⁺ ion conductor, Li₃PO₄—Li₂S—SiS₂. J. Power Sources 43, 135-141 (1993).
313. Minami, K., Hayashi, A. & Tatsumisago, M. Crystallization process for superionic Li₇P₃S₁₁ glass-ceramic electrolytes. J. Am. Ceram. Soc. 94, 1779-1783 (2011).
314. Schlaikjer, C. R. & Liang, C. C. Ionic conduction in calcium doped polycrystalline lithium iodide. J. Electrochem. Soc. 118, 1447 (1971).
315. Poulsen, F. W., Andersen, N. H., Kindl, B. & Schoonman, J. Properties of LiI-Alumina composite electrolytes. Solid State Ion. 9-10, 119-122 (1983).
316. Aono, H., Sugimoto, E., Sadaoka, Y., Imanaka, N. & Adachi, G. Electrical property and sinterability of LiTi₂(PO₄)₃ mixed with lithium salt (Li₃PO₄ or Li₃BO₃). Solid State Ion. 47, 257-264 (1991).
317. Aono, H., Sugimoto, E., Sadaoka, Y., Imanaka, N. & Adachi, G. Ionic conductivity of LiTi₂(PO₄)₃ mixed with lithium salts. Chem. Lett. 19, 331-334 (1990).
318. He, L. X. & Yoo, H. I. Effects of B-site ion (M) substitution on the ionic conductivity of (Li₃ₓLa_{2/3-x})_{1+y/2}(MyTi_{1-y})O₃ (M=Al, Cr). Electrochimica Acta 48, 1357-1366 (2003).
319. Inaguma, Y., Chen, L., Itoh, M. & Nakamura, T. Candidate compounds with perovskite structure for high lithium ionic conductivity. Solid State Ion. 70-71, 196-202 (1994).
320. Chung, H.-T., Kim, J.-G. & Kim, H.-G. Dependence of the lithium ionic conductivity on the B-site ion substitution in (Li_{0.5}La_{0.5})Ti₁₋ₓMₓO₃ (M=Sn, Zr, Mn, Ge). Solid State Ion. 107, 153-160 (1998).
321. Thangadurai, V. & Weppner, W. Effect of B-site substitution of (Li,La)TiO₃ perovskites by di-, tri-, tetra- and hexavalent metal ions on the lithium ion conductivity. Ionics 6, 70-77 (2000).
322. Morata-Orrantia, A., García-Martin, S., Moren, E. & Alario-Franco, M. Á. A New La_{2/3}LiₓTi₁₋ₓAlₓO₃ solid solution: structure, microstructure, and Li⁺ conductivity. Chem. Mater. 14, 2871-2875 (2002).
323. Kawai, H. & Kuwano, J. Lithium ion conductivity of A-site deficient perovskite solid solution La_{0.67-x}Li₃ₓTiO₃. J. Electrochem. Soc. 141, L78 (1994).
324. Zhang, Y., Chen, K., Shen, Y., Lin, Y. & Nan, C.-W. Enhanced lithium-ion conductivity in a LiZr₂(PO₄)₃ solid electrolyte by Al doping. Ceram. Int. 43, S598-S602 (2017).
325. Chowdari, B. V. R., Radhakrishnan, K., Thomas, K. A. & Subba Rao, G. V. Ionic conductivity studies on Li₁₋ₓM₂₋ₓM′ₓP₃O₁₂ (H═Hf, Zr; M′=Ti, Nb). Mater. Res. Bull. 24, 221-229 (1989).
326. Ado, K., Saito, Y., Asai, T., Kageyama, H. & Nakamura, O. Li⁺-ion conductivity of Li₁₊ₓMₓTi₂₋ₓ(PO₄)₃ (M: Sc³⁺, Y³⁺). Solid State Ion. 53-56, 723-727 (1992).
327. Xiong, L. et al. LiF assisted synthesis of LiTi₂(PO₄)₃ solid electrolyte with enhanced ionic conductivity. Solid State Ion. 309, 22-26 (2017).
328. Fu, J. Superionic conductivity of glass-ceramics in the system Li₂O—Al₂O₃—TiO₂—P₂O₅. Solid State Ion. 96, 195-200 (1997).
329. Dhivya, L. & Murugan, R. Effect of simultaneous substitution of Y and Ta on the stabilization of cubic phase, microstructure, and Li⁺ conductivity of Li₇La₃Zr₂O₁₂ lithium garnet. ACS Appl. Mater. Interfaces 6, 17606-17615 (2014).
330. Liu, Z., Huang, F., Yang, J., Wang, B. & Sun, J. New lithium ion conductor, thio-LISICON lithium zirconium sulfide system. Solid State Ion. 179, 1714-1716 (2008).
331. Chen, H. & Adams, S. Bond softness sensitive bond-valence parameters for crystal structure plausibility tests. IUCrJ 4, 614-625 (2017).
332. Adams, S. Practical considerations in determining bond valence parameters. in Bond Valences (eds. Brown, I. D. & Poeppelmeier, K. R.) 91-128 (Springer, 2014). doi:10-1007/430_2013_96.
333. He, B. et al. A highly efficient and informative method to identify ion transport networks in fast ion conductors. Acta Mater. 203, 116490 (2021).
334. Henkelman, G., Uberuaga, B. P. & Jonsson, H. A climbing image nudged elastic band method for finding saddle points and minimum energy paths. J. Chem. Phys. 113, 9901-9904 (2000).
335. Henkelman, G. & Jonsson, H. Improved tangent estimate in the nudged elastic band method for finding minimum energy paths and saddle points. J. Chem. Phys. 113, 9978-9985 (2000).
336. Giannozzi, P. et al. QUANTUM ESPRESSO: a modular and open-source software project for quantum simulations of materials. J. Phys. Condens. Matter 21, 395502 (2009).
337. Giannozzi, P. et al. Advanced capabilities for materials modelling with Quantum ESPRESSO. J. Phys. Condens. Matter 29, 465901 (2017).
338. Perdew, J. P., Burke, K. & Ernzerhof, M. Generalized gradient approximation made simple. Phys. Rev. Lett. 77, 3865-3868 (1996).
339. Dal Corso, A. Pseudopotentials periodic table: From H to Pu. Comput. Mater. Sci. 95, 337-350 (2014).
340. Xu, X. et al. Lithium reaction mechanism and high rate capability of VS₄—graphene nanocomposite as an anode material for lithium batteries. J. Mater. Chem. A 2, 10847-10853 (2014).
341. Britto, S. et al. Multiple redox modes in the reversible lithiation of high-capacity, Peierls-distorted vanadium sulfide. J. Am. Chem. Soc. 137, 8499-8508 (2015).
342. Lian, R. et al. Nucleation and conversion transformations of the transition metal polysulfide VS₄ in lithium-ion batteries. ACS Appl. Mater. Interfaces 11, 22307-22313 (2019).
343. Geller, S. Refinement of the crystal structure of cryolithionite, {Na₃}[Al₂](Li₃)F₁₂. Am. Mineral. 56, 18-23 (1971).
344. Xiao, R., Li, H. & Chen, L. Candidate structures for inorganic lithium solid-state electrolytes identified by high-throughput bond-valence calculations. J. Materiomics 1, 325-332 (2015).
345. Liu, Z., Sun, Y., Singh, D. J. & Zhang, L. Switchable out-of-plane polarization in 2D LiAlTe₂. Adv. Electron. Mater. 5, 1900089 (2019).
346. Ma, C.-G. & Brik, M. G. First principles studies of the structural, electronic and optical properties of LiInSe₂ and LiInTe₂ chalcopyrite crystals. Solid State Commun. 203, 69-74 (2015).
347. Augustine, A. M., Sudarsanan, V., Patra, L., Kavitha, M. & Ravindran, P. Li-rich Li₆MnₓFe₍₁₋ₓ₎S₄ as cathode material for Li-ion battery. AIP Conf. Proc. 2115, 030623 (2019).
348. Isaenko, L. et al. LiGaTe₂: A new highly nonlinear chalcopyrite optical crystal for the mid-IR. Cryst. Growth Des. 5, 1325-1329 (2005).
349. Bianchini, F., Fjellvåg, H. & Vajeeston, P. A first-principle investigation of the Li diffusion mechanism in the super-ionic conductor lithium orthothioborate Li₃BS₃ structure. Mater. Lett. 219, 186-189 (2018).
350. Suzuki, N. et al. Theoretical and experimental studies of KLi₆TaO₆ as a Li-ion solid electrolyte. Inorg. Chem. 60, 10371-10379 (2021).
351. Kawasaki, Y. et al. Synthesis and electrochemical properties of Li₃CuS₂ as a positive electrode material for all-solid-state batteries. ACS Appl. Energy Mater. 4, 20-24 (2021).
352. Huang, F. Q., Yang, Y., Flaschenriem, C. & Ibers, J. A. Syntheses and structures of LiAuS and Li₃AuS₂. Inorg. Chem. 40, 1397-1398 (2001).
353. Kahle, L., Marcolongo, A. & Marzari, N. High-throughput computational screening for solid-state Li-ion conductors. Energy Environ. Sci. 13, 928-948 (2020).
354. Muy, S. et al. High-throughput screening of solid-state li-ion conductors using lattice-dynamics descriptors. iScience 16, 270-282 (2019).
355. Li, X. et al. Progress and perspectives on halide lithium conductors for all-solid-state lithium batteries. Energy Environ. Sci. 13, 1429-1461 (2020).
356. Sendek, A. D. et al. Machine learning-assisted discovery of many new solid Li-ion conducting materials. ArXiv180802470 Cond-Mat Physicsphysics (2018).
357. Kim, Y., Martin, S. W., Ok, K. M. & Halasyamani, P. S. Synthesis of the thioborate crystal ZnₓBa₂B₂S₅+x (x≈0.2) for second order nonlinear optical applications. Chem. Mater. 17, 2046-2051 (2005).
358. Wang, Y. et al. Design principles for solid-state lithium superionic conductors. Nat. Mater. 14, 1026-1031 (2015).
359. Li, P. & Liu, Z.-H. Hydrothermal synthesis, characterization, and thermodynamic properties of a new lithium borate, Li₃B₅O₈(OH)₂. J. Chem. Eng. Data 55, 2682-2686 (2010).
360. Snydacker, D. H., Hegde, V. I. & Wolverton, C. Electrochemically stable coating materials for Li, Na, and Mg metal anodes in durable high energy batteries. J. Electrochem. Soc. 164, A3582 (2017).
361. Sakuda, A. et al. Amorphous metal polysulfides: electrode materials with unique insertion/extraction reactions. J. Am. Chem. Soc. 139, 8796-8799 (2017).
362. He, X. et al. Crystal structural framework of lithium super-ionic conductors. Adv. Energy Mater. 9, 1902078 (2019).
363. D. Richards, W., Wang, Y., J. Miara, L., Chul Kim, J. & Ceder, G. Design of Li₁₊₂ₓZn₁₋ₓPS₄, a new lithium ion conductor. Energy Environ. Sci. 9, 3272-3278 (2016).
364. Chen, E. M. & Poudeu, P. F. P. Thermal and electrochemical behavior of Cu₄₋ₓLiₓS₂ (x=1, 2, 3) phases. J. Solid State Chem. 232, 8-13 (2015).
365. Devlin, K. P. et al. Polymorphism and second harmonic generation in a novel diamond-like semiconductor: Li₂MnSnS₄. J. Solid State Chem. 231, 256-266 (2015).
366. Steiner, H. J. & Lutz, H. D. Li₂BeCl₄ and Na₂BeCl₄: Two olivine-type chlorides. J. Solid State Chem. 100, 179-181 (1992).
367. Rao, K. K., Yao, Y. & Grabow, L. C. Accelerated modeling of lithium diffusion in solid state electrolytes using artificial neural networks. Adv. Theory Simul. 3, 2000097 (2020).
368. Körbel, S., L. Marques, M. A. & Botti, S. Stability and electronic properties of new inorganic perovskites from high-throughput ab initio calculations. J. Mater. Chem. C 4, 3157-3167 (2016).
369. Prömper, S. W. & Frank, W. Lithium tetra-chlorido-aluminate, LiAlCl₄: a new polymorph (oP12, Pmn2₁) with Li⁺ in tetra-hedral inter-stices. Acta Crystallogr. Sect. E Crystallogr. Commun. 73, 1426-1429 (2017).
370. Abdel-Khalek, E. K., Mohamed, E. A., Salem, S. M., Ebrahim, F. M. & Kashif, I. Study of glass-nanocomposite and glass-ceramic containing ferroelectric phase. Mater. Chem. Phys. 133, 69-77 (2012).
371. Rousse, G., Baptiste, B. & Lelong, G. Crystal structures of Li₆B₄₀₉ and Li₃B₁₁₀₁₈ and application of the dimensional reduction formalism to lithium borates. Inorg. Chem. 53, 6034-6041 (2014).
372. Branford, W., Green, M. A. & Neumann, D. A. Structure and ferromagnetism in Mn⁴⁺ spinels: AM_{0.5}Mn_{1.504} (A=Li, Cu; M=Ni, Mg). Chem. Mater. 14, 1649-1656 (2002).
373. Li, G., Chu, Y. & Zhou, Z. From AgGaS₂ to Li₂ZnSiS₄: realizing impressive high laser damage threshold together with large second-harmonic generation response. Chem. Mater. 30, 602-606 (2018).

### STATEMENTS REGARDING INCORPORATION BY REFERENCE AND VARIATIONS

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

As used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

When a group of substituents is disclosed herein, it is understood that all individual members of that group and all subgroups, including any isomers, enantiomers, and diastereomers of the group members, are disclosed separately. When a Markush group or other grouping is used herein, all individual members of the group and all combinations and subcombinations possible of the group are intended to be individually included in the disclosure. When a compound is described herein such that a particular isomer, enantiomer or diastereomer of the compound is not specified, for example, in a formula or in a chemical name, that description is intended to include each isomers and enantiomer of the compound described individual or in any combination. Additionally, unless otherwise specified, all isotopic variants of compounds disclosed herein are intended to be encompassed by the disclosure. For example, it will be understood that any one or more hydrogens in a molecule disclosed can be replaced with deuterium or tritium. Isotopic variants of a molecule are generally useful as standards in assays for the molecule and in chemical and biological research related to the molecule or its use. Methods for making such isotopic variants are known in the art. Specific names of compounds are intended to be exemplary, as it is known that one of ordinary skill in the art can name the same compounds differently.

Certain molecules disclosed herein may contain one or more ionizable groups [groups from which a proton can be removed (e.g., —COOH) or added (e.g., amines) or which can be quaternized (e.g., amines)]. All possible ionic forms of such molecules and salts thereof are intended to be included individually in the disclosure herein. With regard to salts of the compounds herein, one of ordinary skill in the art can select from among a wide variety of available counterions those that are appropriate for preparation of salts of this invention for a given application. In specific applications, the selection of a given anion or cation for preparation of a salt may result in increased or decreased solubility of that salt.

Every device, cell, electrolyte, material, composition, and method described or exemplified herein can be used to practice the invention, unless otherwise stated.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

1. A material comprising:
a lithium thioborate composition characterized by formula FX1:
Li_{3-z}[B+Q]₁[S+G]₃ (FX1);
wherein Q is a first dopant being a substitute for B in the composition and being one or more elements each aliovalent with respect to B;
wherein G is a second dopant being a substitute for S in the composition and being one or more elements each aliovalent with respect to S;
wherein z is a number greater than 0 and less than or equal to 0.40; and
wherein the composition comprises only the first dopant, only the second dopant, or both the first dopant and the second dopant.

2. The material of claim 1 having a greater ionic conductivity than that of an undoped stoichiometric Li₃BS₃ material by a factor of at least 10 at 25° C., wherein the undoped stoichiometric Li₃BS₃ material is free of Q and G.

3. The material of claim 1 being characterized by an ionic conductivity greater than 9·10⁻⁶ S/cm at 25° C.

4. The material of claim 1, wherein the composition is characterized by the ratio Q/(B+Q) being greater than 0.001 and less than 0.20.

5. (canceled)

6. The material of claim 1, wherein Q is one or more Group 14 elements and/or one or more metal elements.

7. The material of claim 1, wherein Q is Si and/or Ge.

8. The material of claim 1, wherein the composition is characterized by the ratio G/(S+G) being greater than 0.001 and less than 0.20.

9. (canceled)

10. The material of claim 1, wherein G is one or more Group 17 (halogen) elements.

11. The material of claim 1, wherein G is Cl and/or Br.

12. The material of claim 1, wherein the composition is characterized by formula FX2, FX3, or FX4:
Li_{3-x-y}B₁₋ₓ[Q]ₓS_{3-y}[G]_{y} (FX2);
Li₃₋ₓB₁₋ₓ[Q]ₓS₃ (FX3);
Li_{3-y}B₁S_{3-y}[G]_{y} (FX4); wherein:
x is selected from the range of 0.005 to 0.20; and
y is selected from the range of 0.005 to 0.20.

13. The material of claim 1, wherein the composition is characterized by formula FX3:
Li₃₋ₓB₁₋ₓ[Q]ₓS₃ (FX3); wherein:
x is greater than 0.25 and less than or equal to 0.05.

14. The material of claim 1 having a total crystallinity less than or equal to 20 wt. %.

15. (canceled)

16. The material of claim 1 being characterized by an ionic conductivity greater than or equal to 1·10⁻³ S/cm at 25° C.

17. (canceled)

18. The material of claim 3 being characterized by an electronic conductivity less than 4·10⁻¹⁰ S/cm at 25° C.

19. The material of claim 3 being characterized by an activation energy (Eₐ) for an ionic conductivity of less than 400 meV when its temperature-dependent ionic conductivity is fit to equation EQ1:
$$σ = \frac{{σ}_{0}}{T} {e}^{\frac{- {E}_{a}}{{k}_{B} T}} ; \qquad ( EQ1 )$$
wherein:
σ is the ionic conductivity;
π₀ is a conductivity prefactor;
T is temperature;
k_{B} is the Boltzmann's constant; and
Eₐ is the activation energy for ionic conduction.

20. (canceled)

21. (canceled)

22. (canceled)

23. (canceled)

24. (canceled)

25. A device comprising:
a material, the material comprising:
a lithium thioborate composition characterized by formula FX1:
Li_{3-z}[B+Q]₁[S+G]₃ (FX1);
wherein Q is a first dopant being a substitute for B in the composition and being one or more elements each aliovalent with respect to B;
wherein G is a second dopant being a substitute for S in the composition and being one or more elements each aliovalent with respect to S;
wherein z is a number greater than 0 and less than or equal to 0.40; and
wherein the composition comprises only the first dopant, only the second dopant, or both the first dopant and the second dopant.

26. The device of claim 25 being an electrochemical cell.

27. (canceled)

28. (canceled)

29. A solid state electrolyte comprising:
a lithium thioborate composition characterized by formula FX1:
Li_{3-z}[B+Q]₁[S+G]₃ (FX1);
wherein Q is a first dopant being a substitute for B in the composition and being one or more elements each aliovalent with respect to B;
wherein G is a second dopant being a substitute for S in the composition and being one or more elements each aliovalent with respect to S;
wherein z is a number greater than 0 and less than or equal to 0.40; and
wherein the composition comprises only the first dopant, only the second dopant, or both the first dopant and the second dopant.

30. A method of making a material, the method comprising:
combining a plurality of precursors comprising lithium, boron, sulfur, and at least one of a first dopant and a second dopant; and
heating the combined plurality of precursors to form the material having a lithium thioborate composition;
wherein the lithium thioborate composition is characterized by formula FX1:
Li_{3-z}[B+Q]₁[S+G]₃ (FX1);
wherein Q is the first dopant being a substitute for B in the composition and being one or more elements each aliovalent with respect to B;
wherein G is the second dopant being a substitute for S in the composition and being one or more elements each aliovalent with respect to S;
wherein z is a number greater than 0 and less than or equal to 0.40; and
wherein the composition comprises only the first dopant, only the second dopant, or both the first dopant and the second dopant.

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. A method for increasing an ionic conductivity of a reference lithium solid state electrolyte, the method comprising:
forming a doped lithium solid state electrolyte having a doped composition;
wherein the reference lithium solid state electrolyte has a reference composition, and wherein the doped composition has up to 20 at. % of one or more principal elements substituted with at least one dopant relative to the reference composition;
wherein each element of the at least one dopant is aliovalent with respect to the respective substituted principal element; and
wherein the doped lithium solid state electrolyte has a greater ionic conductivity than the reference lithium solid state electrolyte by a factor of at least 10.

46. (canceled)

47. (canceled)

48. (canceled)

49. (canceled)

50. (canceled)

51. The material of claim 1 wherein the material is part of a glass electrolyte.

52. The material of claim 1 being amorphous.

53. The material of claim 1 having a total crystallinity less than or equal to 50 wt. %.

54. The material of claim 1 having a total crystallinity less than or equal to 10 wt. %.

55. The material of claim 1 having a total crystallinity less than or equal to 5 wt. %.

56. The material of claim 1, wherein the material has been amorphized to increase its ionic conductivity.

57. The material of claim 56, wherein the amorphized material has an increased amorphous content of the lithium thioborate composition, a decreased total crystallinity of the lithium thioborate composition, and/or an increased concentration of defects in the lithium thioborate composition compared to an equivalent material not having been amorphized.
